(19) United States
(12) Patent Application Publication
(10) Pub. No.: US 2003/0065176 A1
(43) Pub. Date: Apr. 3, 2003

(54) Factor xa inhibitors with aryl-amidines and derivatives, and prodrugs thereof

(76) Inventors: Myung-Gyun Kang, Taejon (KR); Doo-Hee Park, Taejon (KR); Oh-Hwan Kwon, Taejon (KR); Eunice Eun-Kyeong Kim, Taejon (KR); Kwang-Yeon Hwang, Taejon (KR); Yong-Seok Heo, Taejon (KR); Tae-Kyo Park, Taejon (KR); Tae-Hee Lee, Taejon (KR); Kwang-Yul Moon, Taejon (KR); Jong-Woo Park, Seoul (KR); Hye-Kyung Chang, Taejon (KR); Sang-Koo Lee, Taejon (KR); Sun-Hwa Lee, Taejon (KR); Su-Kyung Park, Taejon (KR); Sung-Hack Lee, Taejon (KR); Hae-Dong Park, Taejon (KR)

Correspondence Address: BIRCH STEWART KOLASCH & BIRCH, PO BOX 747, FALLS CHURCH, VA, 22040-0747, US

(21) Appl. No.: 10/181,975

(22) PCT Filed: Jan. 4, 2001
(86) PCT No.: PCT/KR01/00013

(30) Foreign Application Priority Data
Jan. 29, 2000 (KR) 2000/4458
Feb. 11, 2000 (KR) 2000/6354
Feb. 17, 2000 (KR) 2000/7487
Feb. 17, 2000 (KR) 2000/7489

(51) Int. Cl. C07F 9/6533; C07F 9/6509; C07F 9/62; C07F 9/28

(52) U.S. Cl. 544/128; 546/22; 546/23; 549/6; 544/337; 544/157

(57) ABSTRACT

The present invention relates to a compound with aryl-amidines, particularly amidinoaryl-cyclopropanes, amidinoarylmethyl-pyrroles, amidinoaryl-benzenes, amidinoaryl-pyridines, or amindonoaryl-alanines, represented by formula (1), a pharmaceutically acceptable salt, a prodrug, a hydrate, a solvate or an isomer thereof, which are inhibitors of coagulation enzyme, factor Xa (FXa). The present invention also relates to a pharmaceutical composition containing the compound, and a method of using the same as an anticoagulant agent for treatment and prevention of thrombosis disorders.

### TECHNICAL FIELD

This invention relates generally to compounds with aryl-amidines, particularly amidinoaryl-cyclopropanes, amidinoarylmethyl-pyrroles, amidinoaryl-benzenes, amidinoaryl-pyridines, amidinoaryl-alanines, and their derivatives and/or prodrugs which are inhibitors of coagulation enzyme, factor Xa (FXa), pharmaceutical compositions containing the same, and methods of using the same as anticoagulant agents for treatment and prevention of thrombosis.

### BACKGROUND ART

It has been generally known that various complicated enzyme reactions are related to blood coagulation processes. The final step of the reactions is a reaction converting prothrombin to thrombin, and FXa is an enzyme involved in this process. Thrombin produced by the reaction plays a role in activating platelet and converting fibrinogen to fibrin. Fibrin may be polymerized and converted to a polymer. The polymer is cross-linked with an activated blood factor XIII to produce an insoluble coagulated blood. Thrombin also plays a role in activating blood factors V and VIII, which participate in the blood coagulation process. Thus, it accelerates the blood coagulation reaction. An inhibitor of thrombin acts as an effective anticoagulant agent, inhibits activity of platelet, and avoids producing and stabilizing fibrin. Therefore, by developing novel compounds having a capability to inhibit thrombin activity, attempts have been made to prevent blood coagulation and treat many kinds of thrombosis.

In a clinical test using inhibitors of thrombin, some inhibitors inhibited effectively thrombin in blood, but did not inhibit a reaction that does newly produce thrombin. Therefore, they did not show sufficient effects. In order to control thrombin to be newly produced, excess of an inhibitor must be administrated. Therefore, many side effects such as hemorrhage were reported. However, FXa inhibitors blocked the activity of FXa, which was directly involved in producing thrombin. For this reason, attempts for developing the FXa inhibitors have been made to treat and prevent thrombosis and diseases associated with the same.

It has been proved through animal tests of these FXa inhibitors that disadvantages of thrombin inhibitors, such as lack of ability to block producing thrombin and side effects, for example, hemorrhage, etc, could be solved. Such viewpoints had been supported by substantially many scientific evidences. The best important example is a fact that a protein inhibiting FXa has been found from animals sucking blood, such as a mite or a leech etc. It has been proved through some animal model experiments that the protein has an effect as an anticoagulant agent. Alternatively, it has been known that the above approach has an effect from animal model experiments of deep-vein thrombosis and canine arterial thrombosis using proteins (DEGR-Xa) active sites of which FXa were chemically interrupted.

Human FXa is activated from a human factor X. The human factor X is a protein that a light-chain consisting of 139 amino acids is connected to a heavy-chain consisting of 303 amino acids by one disulfide bond. The light-chain includes 11 γ-carboxylated glutamic acids and one β-hydroxylated aspartic acid after protein expression. The heavy-chain has about 15% of glycosylated amino acids and includes also catalytic domains.

A process for activating from factor X to FXa comprises an intrinsic or extrinsic pathway. When all materials required for blood coagulation process are presented in blood, it is said ‘intrinsic pathway.’ Materials associated herewith include factor IX and factor XI of a serine protease type protein, and factor VIIIc of a non-enzymatic co-factor, etc. The blood coagulation process begins activating factor XI to factor XIa. Factor XIa allows for factor IX to be converted to factor IXa, and the resulting factor IXa binds to factor VIII on a phospholipid surface to produce a tenase complex. This tenase plays a role in converting factor X to FXa. When a tissue factor is introduced outside in blood, it is said “extrinsic pathway.” The tissue factor binds to factor VII and activates the bound factor complex. The resulting factor VIIa-tissue factor complex plays a role in directly converting factor X to FXa. Such resulting FXa binds to co-factor Va on phospholipid surface to comprise a prothrombinase complex. This complex allows for prothrombin to be activated to thrombin.

One molecule of FXa produces theoretically 138 molecules of thrombin. However, prothrombin concentration in blood is about 10 times or more as high as that of FXa. Thus, high concentration of drug is required for inhibiting thrombin. FXa inhibitors maintain the thrombin concentration in blood at a physiologically required level for thrombogenesis, but thrombin inhibitors do not. Therefore, as mentioned above, FXa inhibitors reduce side effects such as hemorrhage and thus have an important advantage in terms of safety.

For the above reasons, there is a need for FXa inhibitors as well as thrombin inhibitors. Worldwide research institutions have actively conducted efforts to develop FXa inhibitors.

Bis amidine-based compounds which have been developed as an effective FXa inhibitor are represented by DX9065a (EP 0540051-A1) of Daiichi Pharmaceutical Co., Ltd., YM-60828 (J. Med. Chem. 1999, 42, 2752-2759) of Yananouchi Company, ZK-80719 (WO 97/29067) and ZK-807369 (WO 97/21437) of Berlex Laboratories, Inc. As mentioned above, it has been known that these compounds have commonly one carboxylic acid as a bis amidine-based compound and are capable of being absorbed orally.

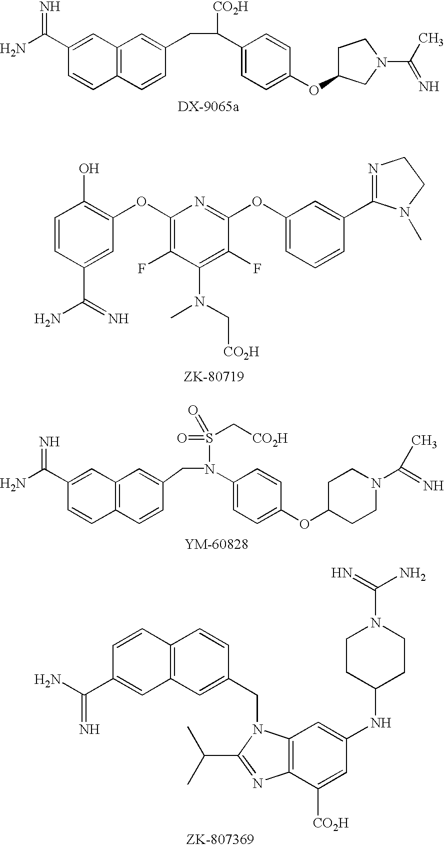

Mono amidine-based compounds include SK-549 (J. Med. Chem. 1999, 42, 2760-2773) of Duponte-Merck Company and RPR-130737 (WO 96/40679) of Rhone-Poulenc Rorer Pharmaceuticals Inc., etc. These compounds have an excellent selectivity against thrombin, trypsin and the like enzymes, and have an excellent effect as a Fxa inhibitor. However, it has not been known whether or not the compounds may be absorbed.

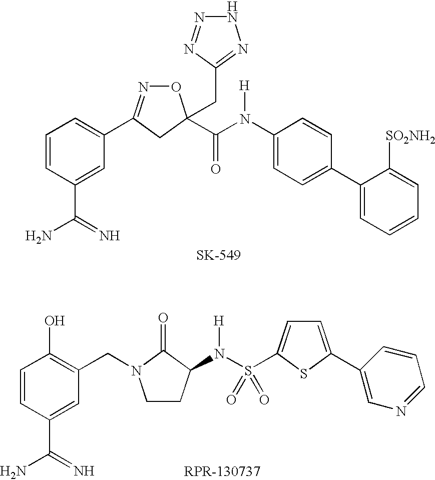

### DISCLOSURE OF INVENTION

In view of the above, the present inventors have conducted intensive studies to develop novel compounds having a good FXa inhibition activity and consequently an excellent selectivity against trypsin and thrombin. As a result, they have found that such purposes may be effectively accomplished by a compound having formula 1 below, and have completed the present invention.

Accordingly, in one aspect, the present invention provides a compound represented by the following formula 1, a pharmaceutically acceptable salt, a prodrug a hydrate, a solvate or an isomer thereof.

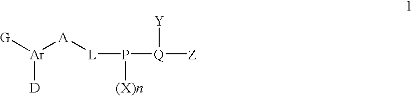

wherein,

Ar is selected from the group consisting of benzene, pyridine, thiophene, naphthalene and isoquinoline,

G is selected from the group consisting of R, F, Cl, Br, I, CN, OR, OCOR, CO₂R, and CONR₂; where R represents H or a linear, branched, cyclic or branched cyclic alkyl group having 1 to 10 of carbon atoms,

A is selected from the group consisting of A1, A2, A3 and A4 below:

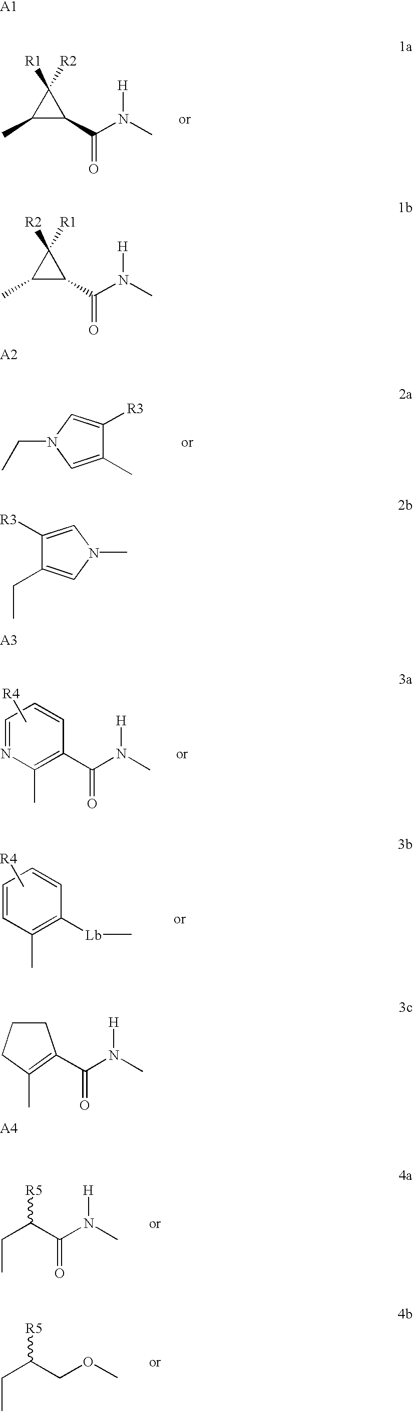

where

R1 and R2 are each independently selected from the group consisting of F, Cl, Br, I, R, CH₂OR, CH₂OCOR, CO₂R, CONR₂, CON(CH₂)ₘ_{¹} (m¹=2, 3, 4, 5, 6, 7), CO-morpholine (N—), CO-piperazine-(N4—R), and CO-piperazine-(N4—COR),

R3 is selected from the group consisting of F, Cl, Br, I, R, CH₂OR, CH₂OCOR, CO₂R, CONR₂, CON (CH₂)ₘ_{²} (m²=2, 3, 4, 5, 6, 7), CO-morpholine (N—), CO-piperazine(N4—R), CO-piperazine-(N4—COR), CONH-(amino acid), CONH-amino acid ester), and CONH-(amino acid amide),

R4 is selected from the group consisting of F, Cl, Br, I, CN, OR, and R;

R5 is selected from the group consisting of NR₂, NR(COR), NR(CH₂)ₘ_{³}CO₂R (where m³=0,1,2,3), NR(CH)ₘ_{³}CONR (where m³=0,1,2,3), NRCONR₂, N(R)SO₂R, and N(SO₂R)₂, or selected from one of the groups below:

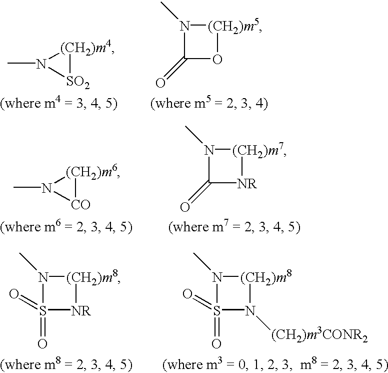

R6 is selected from the group consisting of CO₂R, CONR₂, and CH₂OR,

Lb is selected from the group consisting of CONH, CONHCH₂, CH₂NHCO, NHCONH, CH₂OCH₂, NHCOCH₂, NHCO, and CH₂CONH,

D represents —NH₂, or —CH₂NH₂; or is selected from one of the groups below:

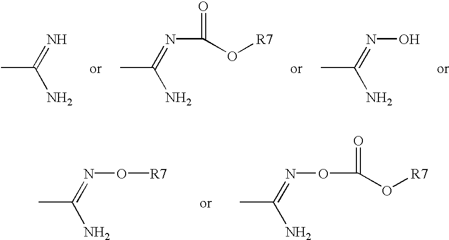

where

R7 is selected from the group consisting of a linear, branched, cyclic or branched cyclic alkyl group having 1 to 10 carbon atoms, a phenyl group and a benzyl group

L is a simple liner and represents —(CH₂)ₘ—(m=0,1),

P is selected from the group consisting of phenyl, pyridine, pyrrole, furan, thiophene, oxazole, isoxazole, imidazole, 1,2-diazole, thiazole, isothiazole, pyridiazine (1,2-diazine), pyrimidine, pyrazine (1,4-diazine), naphthalene, quinoline, isoquinoline, benzofuran, benzothiophene, and indole,

X is selected from the group consisting of R, F, Cl, Br, I, CN, OR, CO₂R, COR, CONR₂, NR₂, NR[(C═O)R], CF₃, OCF₃, SO₂NR₂, SONR₂, SO₂R, SOR, N[(C═O)R]₂, imidazole, 1,2-diazole, thiazole, isothiazole, pyridazine(=1,2-diazine), pyrimidine, pyrazine (=1,4-diazine), 1,2,3-triazole, 1,2,4-triazole, tetrazole, 1,3,5-triazine, (1,2)-imidazoline-2-yl, N-methyl-(1,2)-imidazoline-2-yl, and NHC(═NR)R,

n represents a number of 0, 1 or 2,

Q represents hydrogen or is selected from the group consisting of phenyl, pyridine, pyrrole, furan, thiophene, oxazole, isoxazole, imidazole, 1,2-diazole, thiazole, isothiazole, pyridiazine(=1,2-diazine), pyrimidine, and pyrazine (=1,4-diazine), provided that when Q represents hydrogen, the substituents Y and Z are meant to be directly connected to P,

Y and Z are each independently selected from the group consisting of R, F, Cl, Br, I, CN, OR, CO₂R, COR, CONR₂, NR₂, NR[(C═O)R], N[(C═O)R]₂, CF₃, OCF₃, SO₂NR₂, SONR₂, SO₂R, SOR, imidazole, 1,2-diazole, thiazole, isothiazole, pyridiazine(=1,2-diazine), pyrimidine, pyrazine (=1,4-diazine), 1,2,3-triazole, 1,2,4-triazole, tetrazole and 1,3,5-triazine.

In another aspect, the present invention provides a pharmaceutical composition for preventing blood coagulation and treating thrombosis, which comprises a compound of the above formula 1, a pharmaceutically acceptable salt, a prodrug, a hydrate, a solvate or an isomer thereof as an effective ingredient together with a pharmaceutically acceptable excipient.

### BEST MODE FOR CARRYING OUT THE INVENTION

The present invention relates to a compound represented by the above formula 1, a pharmaceutically acceptable salt, a prodrug, a hydrate, a solvate or an isomer thereof.

The compounds of the present invention with A groups (A1-A4) scaffold may be represented as follows:

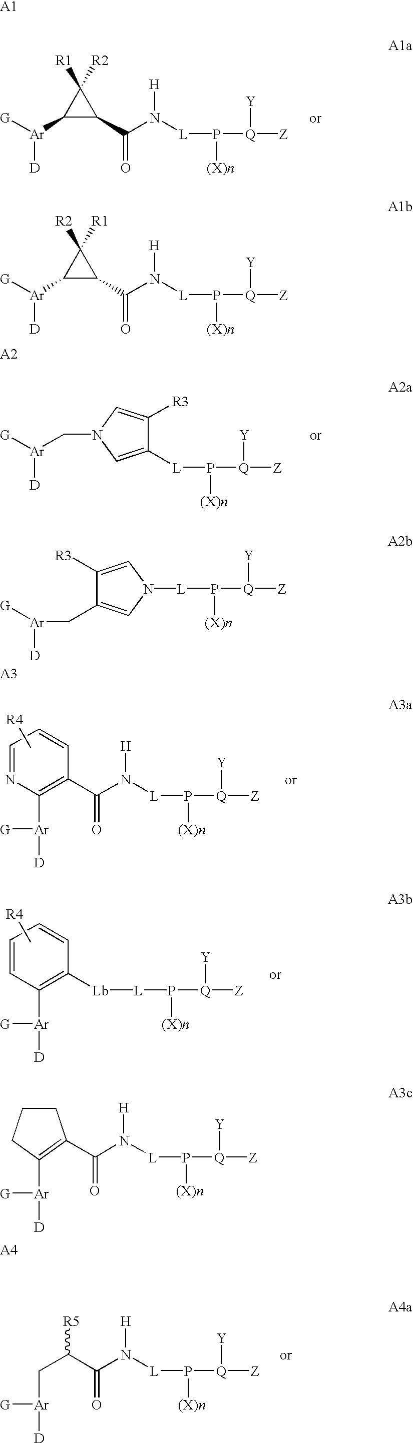

The formulas of compounds substituted by A1. A2, A3, and A4 groups are (A1a or A1b), (A2a or A2b), (A3a, A3b or A3c) and (A4a, A4b or A4c), respectively. General processes for synthesizing the compounds of formula 1 are depicted by A1-A4 groups below. Only the representative reactions and the important conversion processes are explained herein, except for usual reactions. The corresponding reactions herein are specifically described in examples. Synthesizing processes are described in accordance with the following general method. The compounds of formula 1 are synthesized with various unit operation processes. However, various possible pathways are simplified. The functional groups with a prime symbol (for example Y′) appeared on the reaction schemes below are meant that the functional groups may be converted to the desired functional groups (for example, Y). The functional groups with a prime symbol include protecting groups, as well as groups which may be converted to other desired functional groups rather than the protecting groups, such as nitro group (NO₂), bromine (Br) or iodine (I). In particular, nitro group can be considered as a precursor form of NH₂, NHR, or NH(C═O), etc. and Br or I can be considered as that of carboxylic acid derivative such as CO₂R, CONHR, or CN, etc.

In the above formula 1, the compounds having the following substituent definitions are preferable:

Ar is selected from the group consisting of benzene, pyridine, naphthalene and isoquinoline,

G is selected from the group consisting of R, F, Cl, Br, I, CN, and OR; where R represents H or a linear, branched, cyclic or branched cyclic alkyl group having 1 to 10 of carbon atoms,

A is selected from the group consisting of A1, A2, A3 and A4 below:

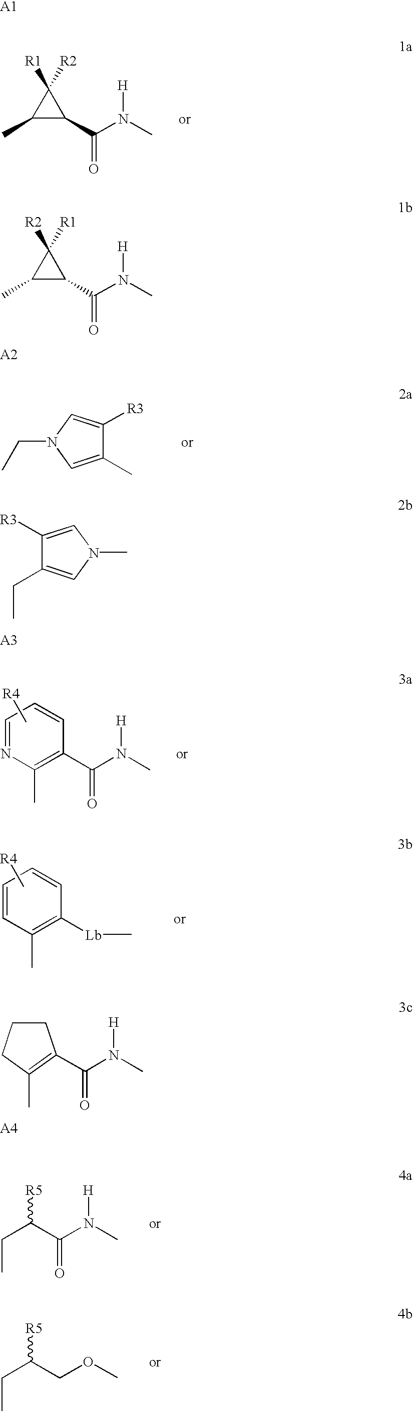

where

R1 and R2 are each independently selected from the group consisting of R, CH₂OR, CH₂OCOR, CO₂R, CONR₂, CON(CH₂)ₘ_{¹} (m¹=2, 3, 4, 5, 6, 7), CO-morpholine (N—), CO-piperazine-(N4—R), and CO-piperazine-(N4—COR),

R3 is selected from the group consisting of R, CH₂OCOR, CO₂R, CONR₂, CON(CH₂)ₘ_{²} (m²=2, 3, 4, 5, 6, 7), CO-morpholine (N—), CO-piperazine-(N4—R_, CO-piperazine-(4—COR), CONH-(amino acid), CONH-amino acid ester), and CONH-amino acid amide),

R4 is selected from the group consisting of F, Cl, OR, and R,

R5 is selected from the group consisting of NR₂, NR(COR), NR(CH₂)ₘ_{³}CO₂R (where m³=0,1,2,3), NR(CH₂)ₘ_{³}CONR (where m³=0,1,2,3), NRCONR₂, N(R)SO₂R, and N(SO₂R)₂; or selected from one of the groups below

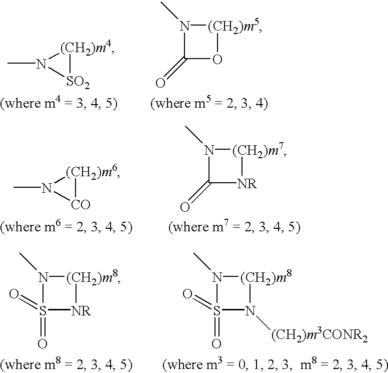

R6 is selected from the group consisting of CO₂R, CONR₂, and CH₂OR,

Lb is selected from the group consisting of CONH, CONHCH₂, CH₂NHCO, NHCONH, CH₂OCH₂, NHCOCH₂, NHCO, and CH₂CONH,

D represents —NH₂, or —CH₂NH₂; or is selected from one of the groups below:

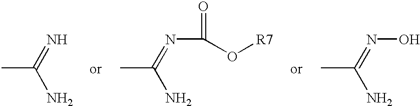

where

R7 is selected from the group consisting of a linear, branched, cyclic or branched cyclic alkyl group having 1 to 10 of carbon atoms, a phenyl group and a benzyl group

L is a simple linker, and represents —(CH₂)ₘ—(m=0,1),

P is selected from the group consisting of phenyl, pyridine, pyrrole, thiophene, thiazole, and pyrimidine,

X is selected from the group consisting of R, F, Cl, CN, OR, CO₂R, COR, CONR₂, CF₃, OCF₃, SO₂NR₂, SO₂R, imidazole, thiazole, pyrimidine, 1,2,3-triazole, 1,2,4-triazole, tetrazole, 1,3,5-triazine, (1,2)-imidazoline-2-yl, N-methyl-(1,2)-imidazoline-2-yl, and —NHC(═NR)R,

n represents a number of 0, 1, or 2,

Q represents hydrogen or is selected from the group consisting of phenyl, pyridine, pyrrole, furan, thiophene, oxazole, isoxazole, imidazole, 1,2-diazole, thiazole, isothiazole, and pyrimidine, provided that when Q is hydrogen, the substituents Y and Z are meant to be directly connected to P,

Y and Z are each independently selected from the group consisting of R, F, Cl, Br, I, CN, OR, CO₂R, COR, CONR₂, CF₃, OCF₃, SO₂NR, SO₂R imidazole, 1,2-diazole, thiazole, isothiazole, pyrimidine, 1,2,3-triazole, 1,2,4-triazole, tetrazole and 1,3,5-triazine.

In the above formula 1, the compounds having the following substituent definitions are more preferable:

Ar is selected from the group consisting of benzene, pyridine, naphthalene and isoquinoline,

G is selected from the group consisting of R, F, Cl, Br, I, CN, OR; where R represents H or a linear, branched, cyclic or branched cyclic alkyl group having 1 to 10 of carbon atoms,

A is selected from the group consisting of A1, A2, A3 and A4 below:

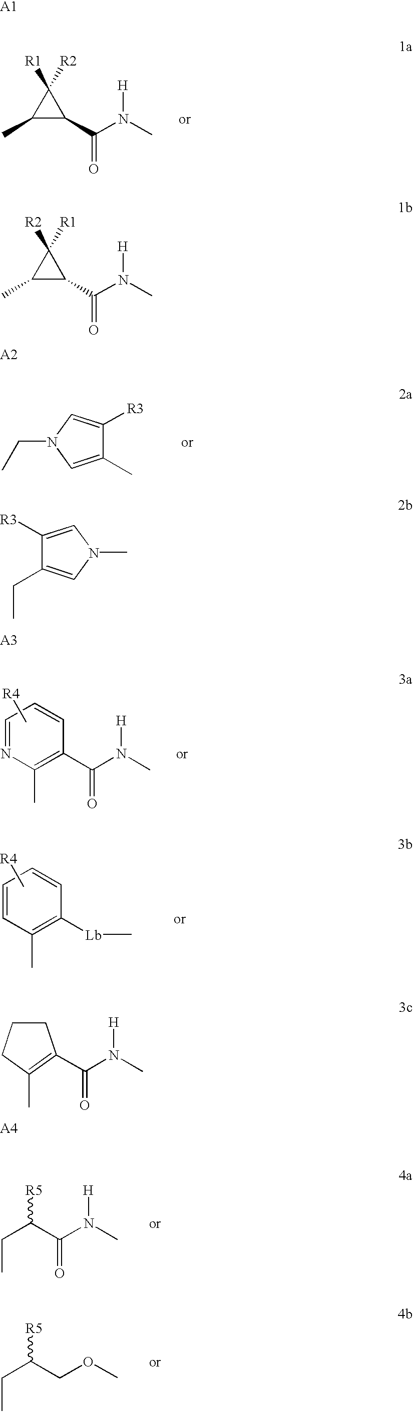

where

R1 and R2 are each independently selected from the group consisting of R, CH₂OR, CH₂OCOR, CO₂R, CONR₂, CON(CH₂)ₘ_{¹} (m¹=2, 3, 4, 5, 6, 7), CO-morpholine (N—), CO-piperazine-(N4—R), and CO-piperazine-(N4—COR),

R3 is selected from the group consisting of R, CO₂R, CONR₂, CON(CH₂)ₘ_{²} (m²=2, 3, 4, 5, 6, 7), CO-morpholine (N—), CO-piperazine-(N4—R), CO-piperazine-(N4—COR), CONH-(Amino acid), CONH-(amino acid ester), and CONH-(amino acid amide),

R4 is selected from the group consisting of F, Cl, OR, and R,

R5 is selected from the group consisting of NR₂, NR(COR), NR(CH₂)ₘ_{³}CO₂R (where m³=0,1,2,3), NR(CH₂)ₘ_{³}CONR (where m³=0,1,2,3), NRCONR₂, N(R)SO₂R, and N(SO₂R)₂, or selected from one of the groups below:

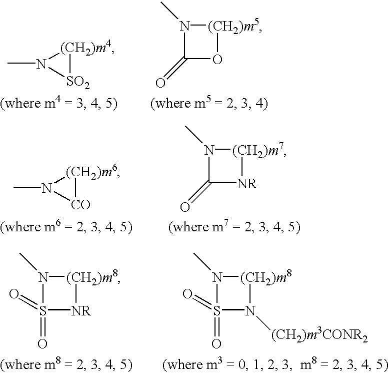

R6 is selected from the group consisting of CO₂R, CONR₂, and CH₂OR,

Lb is selected from the group consisting of CONH, CONHCH₂, CH₂NHCO, NHCONH, CH₂OCH₂, NHCOCH₂, NHCO, and CH₂CONH,

D represents NH₂, or —CH₂NH₂—; or is selected from one of the groups below:

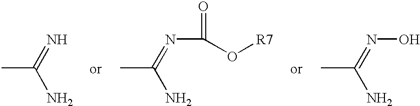

where

R7 is selected from the group consisting of a linear, branched, cyclic or branched cyclic alkyl group having 1 to 10 of carbon atoms, a phenyl group and a benzyl group

L is a simple linker, and represents —(CH₂)ₘ—(m=0,1),

P is selected from the group consisting of phenyl, pyridine, and pyrimidine,

X is selected from the group consisting of R, F, Cl, CN, OR, CF₃, OCF₃, SO₂NR₂, SO₂R, imidazole, thiazole, pyrimidine, 1,2,3-triazole, 1,2,4-triazole, tetrazole, (1,2)-imidazoline-2-yl, N-methyl-(1,2)-imidazoline-2-yl, and —NHC(═NR)R, where n is selected from 0,1,2,

Q is hydrogen or is selected from the group consisting of phenyl, pyridine, pyrrole, furan, thiophene, oxazole, isoxazole, imidazole, 1,2-diazole, thiazole, isothiazole, and pyrimidine, when Q is hydrogen, the substituents Y and Z are meant to be directly connected to P,

Y and Z are each independently selected from the group consisting of R, F, Cl, Br, I, CN, OR, CO₂R, COR, CONR₂, CF₃, OCF₃, SO₂NR₂, SO₂R, and imidazole.

The representative reactions used in the present invention include the following: deprotection of amino protecting group (Boc, Cbz, Alloc), deprotection of ester or ether (ester to acid, O-tBu or benzyl type protected alcohol to free —OH group), deprotection of amide protecting group (N-PMB, N-tBu of sulfonamide), alkylation (acid to ester, sulfonamide to N-alkyl sulfonamide, amide to N-alkylamide, amine to N-alkylamine, alcohol to ether), amidination and related reactions (nitrile to thioamide, alkylthioimidate to amidine, nitrile to amidoxime), prodrug formation reaction (amidine to alkoxycarbonylamidine or to alkoxycarbonyloxyamidine, carboxylic acid to ester, amine to amide or to carbamate, alcohol to ester), hydrolysis (ester and amide to acid, nitrile to amide, ester or acid), aromatic halide or triflate to trialkyltin, to nitrile, to alkoxycarbonyl and derivatives thereof, special functional group transformation (carboxylic acid to alkoxycarbonylamine [degradation], N-dealkylation [von Braun type degradation]), functionalization of hydrogen to electrophile (directed ortho metallation followed by quenching with electrophile, e.g., I₂, Br₂, B(OR)₃, NBS, NCS, NIS, CBr₄, CO₂), derivatizations (carboxylic acid to amide, ester and alcohol to ester or ether, amine to amide, carbamate, sulfonamide, N-alkylation), etc.

General processes for synthesizing compounds of formula A1a or A1b are depicted in the following reaction schemes 1, 2 and 3:

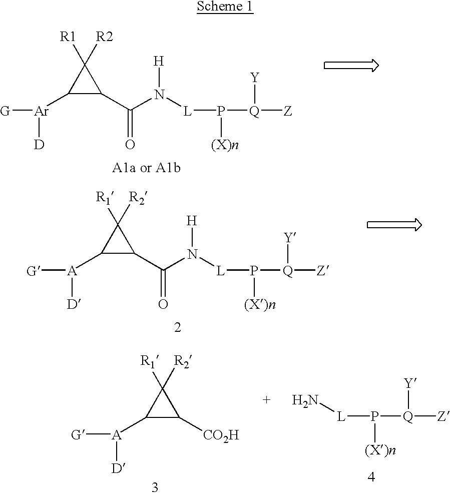

A compound of formula A1a or A1b is synthesized from a precursor compound (2). At this time, a unit reaction such as alkylation, deprotection, amidination, prodrug formation and the like, as mentioned above may be performed. Compound 2 can be obtained by coupling cyclopropane carboxylic acid (3) and an amine (4). An amide coupling method which can be used in the present invention includes a method of using a carbodiimide such as carbonyl dimidazole or N, N′-dicyclohexyl carbodiimide and the like, and a usual amide coupling method such as EDC/HOBt, HATU method and the like.

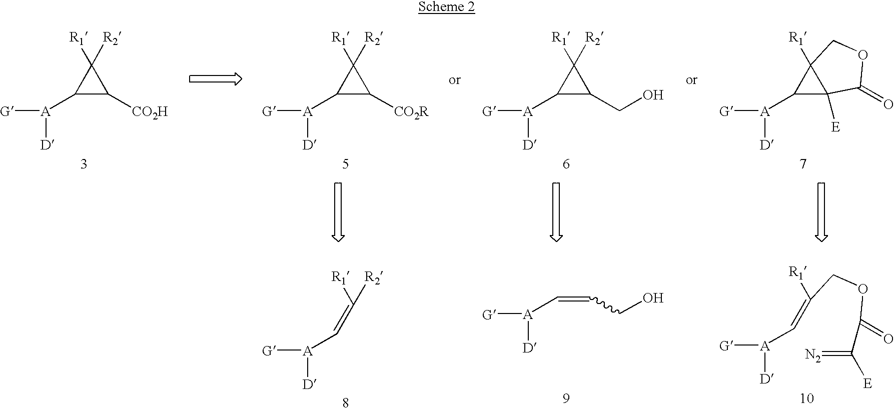

wherein, E is —CO₂R (where R is an akyl group such as methyl or ethyl).

Cyclopropane carboxylic acid (3) is obtained by hydrolysis of an ester (5), oxidation of an alcohol derivative (6), or some chemical reaction steps of a bicyclic compound (7). Compound (5) is obtained by cyclopropanation of an olefin compound (8). An alcohol compound (6) is also obtained by cyclopropanation of an allylic alcohol (9). A bicyclic lactone (7) may be obtained by intramolecular cyclopropanation of a diazo malonate derivative (10). A method of synthesizing intermediates (8), (9) and (10) will be specifically explained in examples below.

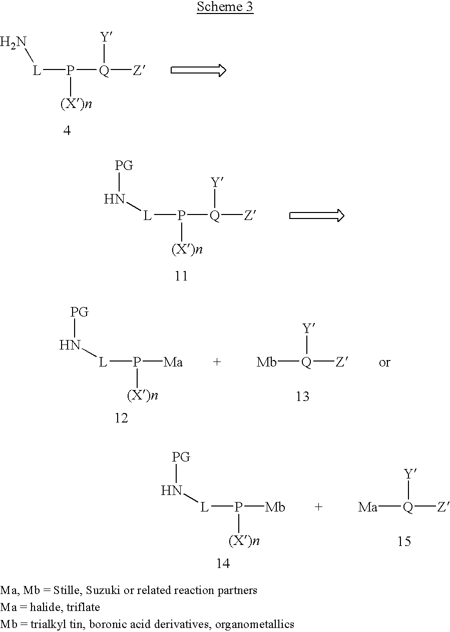

The reaction depicted in reaction scheme 3 is a method of synthesizing an amine compound (4) wherein P is an aryl group and Q is also an aryl group. When the amino group is not protected, the amino group is also represented in PG group of a protected group form. Compound (4) may be obtained by deprotection of compound (11). Compound (11) may be obtained by Stille coupling or Suzuki coupling compounds (12) and (13) or compounds (14) and (15). Stille coupling or Suzuki coupling may be carried out in a modified reaction, which is included in the present invention. That is, the present invention includes the coupling reaction using an organometallic species rather than a trialkyltin boronic acid derivative. At this time, an organometallic species which may be used in the reaction is representative of, but not limited to, a Grignard reagent, an organo lithium, an organozinc reagent, an organocopper, an organomecury compound and the like. Intermediates (12), (13), (14) and (15) are commercially available, or may be directly synthesized. Intermediates, which may be directly synthesized, are specifically described in examples below.

General processes for synthesizing a compound of formula A2a or A2b are depicted in the following reaction schemes 4, 5 and 6.

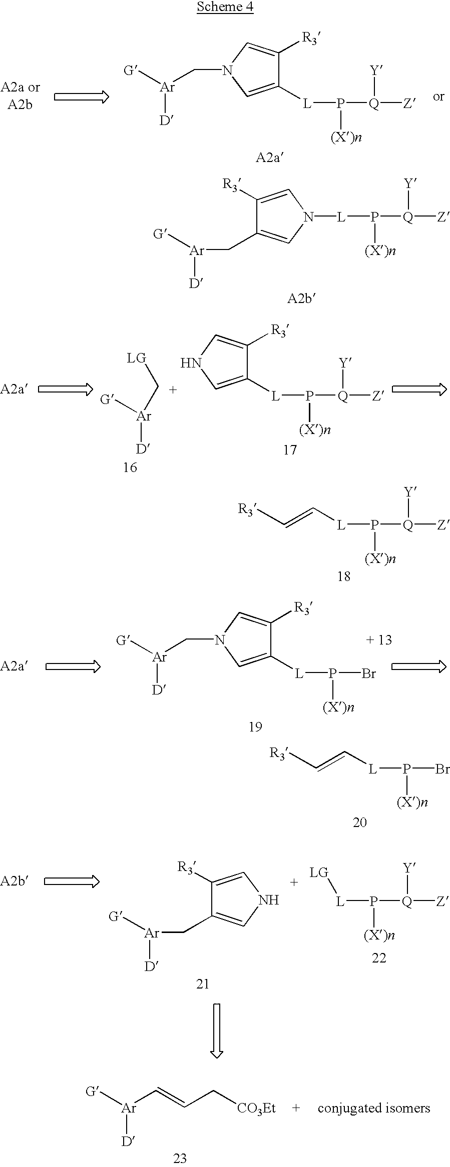

In the above reaction scheme 4, a synthesis of compound of formula A2a or A2b is depicted in a retrosynthetic method. A compound of formula A2a or A2b may be synthesized from compound A2a′ or A2b′ of a precursor through several steps of chemical reactions and isolation-purification processes. Compound of formula A2′ may be obtained by alkylation reaction of compound (16) having a leaving group with a pyrrole derivative (17). A pyrrole derivative (17) may also be obtained by reaction of an olefin derivative (18) with TOSMIC (p-toluenesulfonylmethylisocyanide). Alternatively, compound of formula A2′ can be obtained by coupling a pyrrole derivative (19) obtained in a similar method as above and compound (13). The pyrrole derivative (19) is obtained by reacting an olefin derivative (20) with TOSMIC to produce a pyrrole, the structure of which is not shown, and alkylating it with compound (16).

Compound of formula A2b′ may be obtained by reacting a pyrrole compound (21) with a compound (22) having a leaving group (LG). Compound (22), wherein L is CH₂, is almost used. Their intermediates are also commercially available, or are easily synthesized, for example by halogenation of a benzyl type alcohol or NBS bromination of the corresponding methyl compound. A pyrrole intermediate (21) is synthesized by reacting an olefinic ester (23) (+conjugated isomers) with TOSMIC.

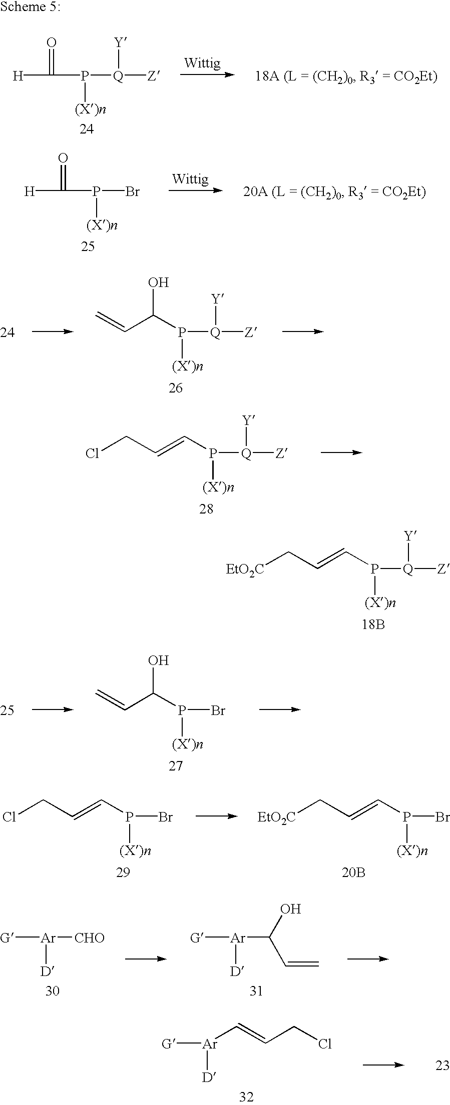

In the above reaction scheme 5, a method of synthesizing compounds (18), (20) and (23) is depicted. Specific examples (R3′═CO₂Et) of compounds (18A), (18B), (20A) and (20B) are described in the reaction scheme 5. However, all compounds with another substituent definitions can be used in the present invention without restricting to the above compound. When L is (CH₂)₀, an olefin compound (18A) or (20A) may be synthesized by simply subjecting an aldehyde compound (24) or (25) to Wittig reaction. A pyrrole is obtained from a reaction of the olefin compound and TOSMIC. When L is CH₂, an allylic chloride (28) or (29) is obtained by reaction of an aldehyde compound (24) or (25) with a vinyl Grignard reagent to produce an allylic alcohol (26) or (27), and by rearrangement of the resultant allylic alcohol. The allylic chloride is subjected to alkoxylcarbonylation using palladium catalyst to synthesize an olefin compound (18B) or (20B). Alternatively, the compounds (18B) and (20B) can be synthesized by Stille or Suzuki type coupling ethyl 4-bromocrotonate. However, the resulting product is presented in a mixture, and its yield is not good. An embodiment of the process thereof is described in an example below. The compound (18B) or (20B) is incorporated with some of a conjugated isomer. The conjugated isomer participates in a subsequent pyrrole formation reaction. It is found that the compound (18B) or (20B) is converted to a conjugated isomer in the pyrrole formation reaction to produce a pyrrole. Identically an allylic chloride (32) is obtained by reaction of an aldehyde (30) and a vinyl Grignard reagent to produce an allylic alcohol (31), and by a rearrangement of the allylic alcohol. The allylic chloride (32) is subjected to alkoxycarbonylation to synthesize an olefin compound (23). The olefin compound is also incorporated with some conjugated isomer.

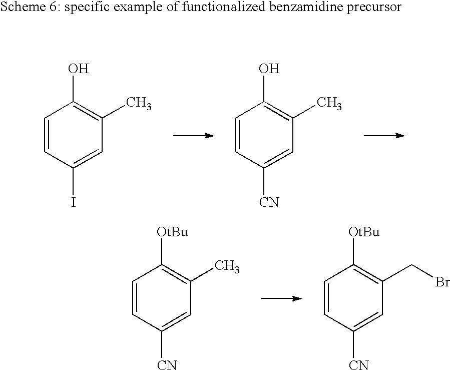

A reaction described in the above reaction scheme 6 shows an example for synthesizing a functionalized benzamidine. When the functionalized benzamidine is a hydroxylated benzamidine, 4-iodo-2-methylphenol is reacted with CuCN to synthesize 4cyano-2-methylphenol, an OH group of the synthesized product is protected by a t-butyl group, and then the protected product is subjected to a bromination to produce 2-t-butoxy-5-cyanobenzyl of the desired intermediate. The intermediate may be subjected to a reaction with nitrogen in a pyrrole.

General processes for synthesizing a compound of formula A3a, A3b or A3c are depicted in the following reaction scheme 7.

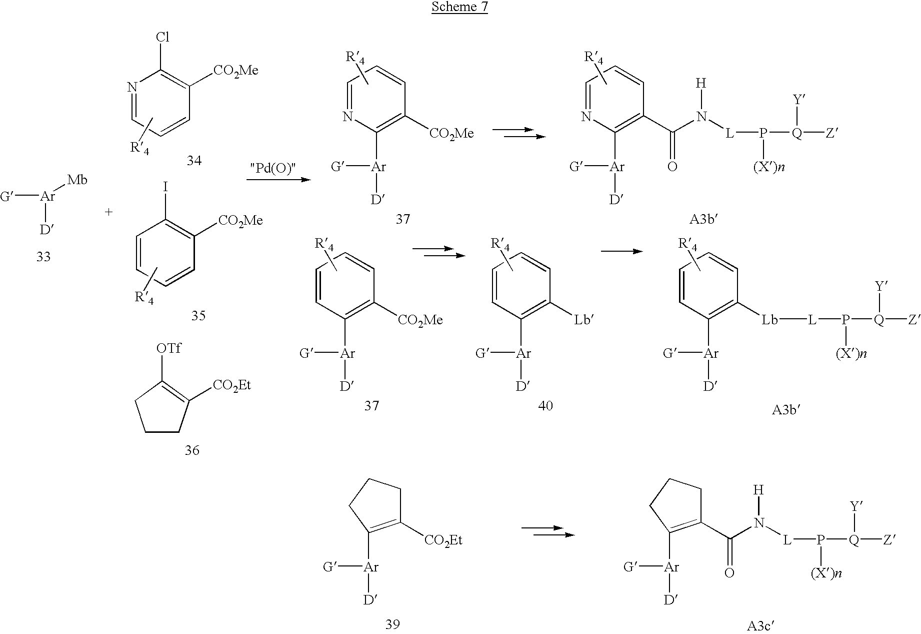

An intermediate compound (33) is reacted with compounds (34), (35) and (36) in the presence of a palladium catalyst to obtain compounds (37), (38) and (39), respectively. After hydrolysis of the obtained compound, a compound of formula A3′, A3b′ or A3c′ is obtained by coupling the hydrolyzed compound with an amine (4). Also, after hydrolysis of the compound (38) the hydrolyzed compound may be converted by degradation to an amine or an isocyanate, homologation to an acetic acid derivative, reduction to a benzyl alcohol, and reduction of the benzyl alcohol to a benzyl amine to synthesize a desired compound.

General processes for synthesizing a compound of formula A4a, A4b or A4c are depicted in the following reaction schemes 8 and 9.

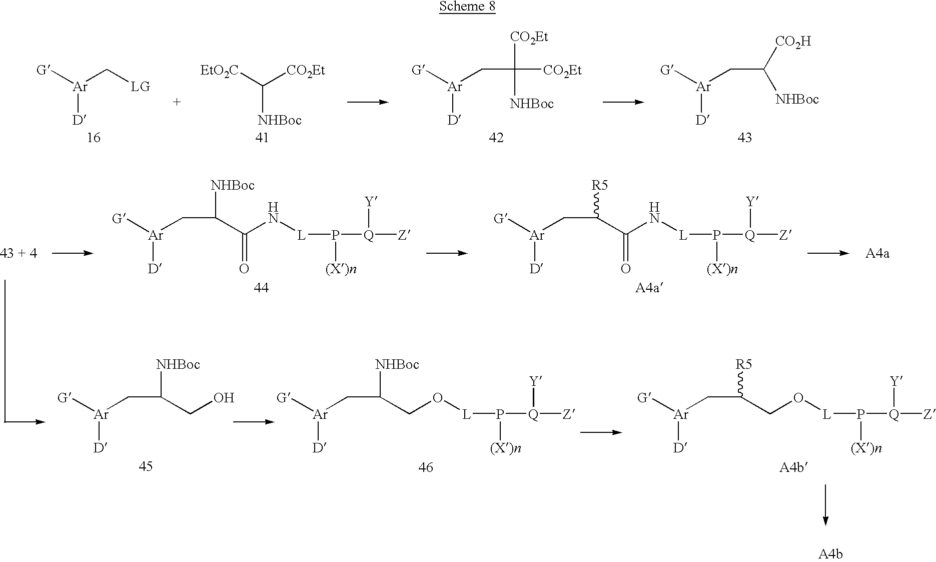

The above reaction scheme 8 relates to a synthesis of an amino acid derivative of formula A4a or A4b. A compound (16) with a leaving group is subjected to alkylation with an aminomalonate derivative (41) to produce a compound (42), the resultant compound is hydrolyzed, and then the hydrolyzed compound is decarboxylated to obtain a protected amino acid (43). An intermediate (44) is obtained by coupling the protected amino acid with an amine compound (4). A Boc protected amine part of the resultant intermediate is converted to obtain a compound (A4b′). The intermediate (A4′ and A4b′) is converted to obtain the desired compound (A4a and A4b).

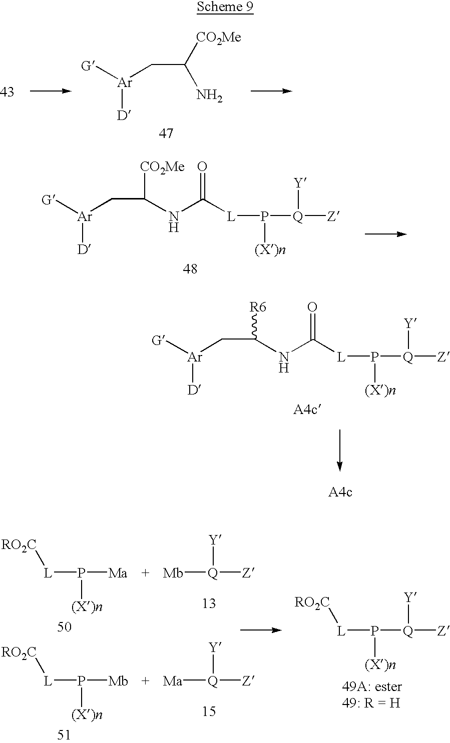

A compound (43) is converted to an amino ester (47) by another approach, and then the amino ester is subjected to coupling with a carboxylic acid (49) to obtain a compound (48). An ester part of the resultant compound is modified to obtain a compound (A4c′). The resultant compound is converted to a desired compound (A4c). A carboxylic acid (49) is prepared by coupling compound (50) with compound (13) or compound (51) with compound (15) to obtain an ester (49A), and hydrolyzing the ester.

A process for amidinating nitrite uses the following three methods:

first, a) thioamide formation with H₂S, Et₃N/pyridine, b) thioimidate formation with CH₃I, c) reaction with ammonium carbonate or ammonium acetate in hot alcoholic solvent; second, classical pinner type reaction, i.e., a) reaction of nitrite with ethanol in the presence of HCl to form ethyl imidate hydrochloride, and b) reaction with ammonium carbonate or ammonium acetate in hot alcoholic solvent; third, a) reaction of nitrile with hydroxylamine to form the amidoxime, and b) catalytic reduction of the aldoxime to amidine.

Amidine synthesized by the above three methods is mostly isolated and purified by reverse phase liquid chromatography (acetonitrile-water, with 0.1% trifluoroacetic acid), and then is lyophilized to obtain trifluoro acetic acid salt; in a form of white powder. In some cases, bis or tris trifluoroacetic acid salt; is obtained depending on the number of basic sites in the inhibitor molecules.

A process for synthesizing a prodrug is as follows:

An alkoxy carbonyl amidine is obtained from the resultant amidine by using alkoxycarbonyl chloride and trialkylamine base, or it is obtained by reacting directly nitrile and O-alkyl hydroxyamine or hydroxylamine to produce alkyl amidoxime or amidoxime and reacting the resultant amidoxime with alkoxycarbonyl chloride. In many cases, prodrug is also isolated and purified by HPLC, and lyophilized to obtain as a white solid.

The reaction schemes explained above are specifically described in examples below. However, the synthesis method, number of derivatization, prodrug form, salt; form and the like are not restricted to only detailed description explained herein.

The representative compounds of the above formula according to the present invention include compounds below. The compounds are described in order of A1, A2, A3 and A4 scaffolds.

(A1: Cyclopropyl Scaffold)

4-(2-aminosulfonylphenyl)-phenyl trans-2-(3-aminomethylphenyl)-cyclopropane-1-carboxamide mono trifluoroacetic acid salt;

4-(2-aminosulfonylphenyl)-phenyl cis-2-(3-aminoiminomethylphenyl)-cyclopropane-1-carboxamide mono trifluoroacetic acid salt;

4-(2-aminosulfonyl-5-methyl-phenyl)-phenyl trans-2-(3-aminoiminomethylphenyl)-cyclopropane-1-carboxamide mono trifluoroacetic acid salt (from less polar isomer);

4-(2-aminosulfonyl-5-methyl-phenyl)-phenyl cis-2-(3-aminoiminomethylphenyl)-cyclopropane-1-carboxamide mono trifluoroacetic acid salt (from more polar isomer);

4-(2-cyanophenyl)-phenyl cis-2-(3-aminoiminomethylphenyl)-cyclopropane-1-carboxamide mono trifluoroacetic acid salt;

4-(2-methansulfonylphenyl)-phenyl cis-2-(3-aminoiminomethylphenyl)-cyclopropane-1-carboxamide mono trifluoroacetic acid salt;

4-(2-cyanophenyl)-phenyl [1,2]-cis, [2,3]-cis-2-(3-aminoiminomethylphenyl)-cyclopropane-1-carboxamide mono trifluoroacetic acid salt;

3-aminoiminomethylbenzyl trans-2-(3-aminoiminomethylphenyl-cyclopropane-1-carboxamide bis trifluoroacetic acid salt;

3-aminoiminomethylbenzyl cis-2-(3-aminoiminomethylphenyl)-cyclopropane-1-carboxamide bis trifluoroacetic acid salt;

4-(1-imidazolyl)-phenyl cis-2(3-aminoiminomethylphenyl)-cyclopropane-1-carboxamide bis trifluoroacetic acid salt;

4-(2-aminosulfonyl-5-fluorophenyl)-phenyl cis-2-(3-aminoiminomethylphenyl)-cyclopropane-1-carboxamide trifluoroacetic acid salt;

5-(2-aminosulfonylphenyl)-pyridine-2-yl cis-2-(3-aminoiminomethylphenyl)-cyclopropane-1-carboxamide bis trifluoroacetic acid salt;

4-(2-cyanophenyl)-phenyl (1,2)-cis-(1,3)-cis-2-(3-aminoiminomethylphenyl)-3-carboxy-cyclopropane-1-carboxamide trifluoroacetic acid salt;

4-(2-fluorophenyl)-phenyl cis-2-(3-aminoiminomethylphenyl)-cyclopropane-1-carboxamide trifluoroacetic acid salt;

4-(2-chlorophenyl)-phenyl cis-2-(3-aminoiminomethylphenyl)-cyclopropane-1-carboxamide trifluoroacetic acid salt;

4-(2-trifluoromethylphenyl)-phenyl cis-2-(3-aminoiminomethylphenyl)-cyclopropane-1-carboxamide trifluoroacetic acid salt;

4-bromophenyl cis-2-(3-aminoiminomethylphenyl)-cyclopropane-1-carboxamide trifluoroacetic acid salt;

5-(2-methanesulfonylphenyl)-pyridine-2-yl cis-2-(3-aminoiminomethylphenyl)-cyclopropane-1-carboxamide bis trifluoroacetic acid salt;

4-(2-methanesulfonyl-[1,3,4]-triazole-1-yl)-phenyl cis-2-(3-aminoiminomethylphenyl)-cyclopropane-1-carboxamide bis trifluoroacetic acid salt;

4-(2-methylaminosulfonylphenyl)-phenyl cis-2-(3-aminoiminomethylphenyl)-cyclopropane-1-carboxamide trifluoroacetic acid salt;

4-(2-methanesulfonylimidazole-1-yl)-phenyl cis-2-(3-aminoiminomethylphenyl)-cyclopropane-1-carboxamide bis trifluoroacetic acid salt;

4-(2-cyano-thiophene-3-yl)-phenyl cis-2-(3-aminoiminomethylphenyl)-cyclopropane-1-carboxamide trifluoroacetic acid salt;

4-(2-aminosulfonyl-thiophene-3-yl)-phenyl cis-2-(3-aminoiminomethylphenyl)-cyclopropane-1-carboxamide trifluoroacetic acid salt;

4-(2-aminosulfonyl-5-methyl-thiophene-3-yl)-phenyl cis-2-(3-aminoiminomethylphenyl)-cyclopropane-1-carboxamide trifluoroacetic acid salt;

4-(4-cyano-thiophene-3-yl)-phenyl cis-2-(3-aminoiminomethylphenyl)-cyclopropane-1-carboxamide trifluoroacetic acid salt;

4-(2-cyanophenyl)-phenyl (1,2-cis)-2-(3-aminoiminomethylphenyl)-(1,3-trans)-3-carboxy-cyclopropane-1-carboxamide trifluoroacetic acid salt;

4-(2-methanesulfonylphenyl)-phenyl (1,2-cis)-2-(3-aminoiminomethylphenyl)-1,3-trans)-3-carboxy-cyclopropane-1-carboxamide trifluoroacetic acid salt; or

4-(2cyanophenyl)-phenyl (1,2-cis)-2-(3-aminoiminomethylphenyl)-1,3-trans)-3-ethoxycarbonyl-cyclopropane-1-carboxamide trifluoroacetic acid salt;

(A2: Pyrrole Scaffold)

Methyl 4-(3-aminoiminomethylbenzyl)-1-benzyl-pyrrole-3-carboxylate trifluoroacetic acid salt;

Ethyl 4-(3-aminoiminomethylbenzyl)-1-benzyl-pyrrole-3-carboxylate trifluoroacetic acid salt;

Ethyl 4-(4-aminoiminomethylbenzyl)-1-benzyl-pyrrole-3-carboxylate trifluoroacetic acid salt;

Ethyl 4-(4-methoxycarbonylbenzyl)-1-(3-aminoiminomethylbenzyl)-pyrrole-3-carboxylate trifluoroacetic acid salt;

Ethyl 4-(4-aminocarbonylbenzyl)-1-(3-aminoiminomethylbenzyl)-pyrrole-3-carboxylate trifluoroacetic acid salt;

Ethyl 4-(4-methylaminocarbonylbenzyl)-1-(3-aminoiminomethylbenzyl)-pyrrole-3-carboxylate trifluoroacetic acid salt;

Ethyl 4-(4-dimethylaminocarbonylbenzyl)-1-(3-aminoiminomethylbenzyl)-pyrrole-3-carboxylate trifluoroacetic acid salt;

Ethyl 4-(4-benzylaminocarbonylbenzyl)-1-(3-aminoiminomethylbenzyl)-pyrrole-3-carboxylate trifluoroacetic acid salt;

Ethyl 4-(4-phenylaminocarbonylbenzyl)-3-aminoiminomethylbenzyl)-pyrrole-3-carboxylate trifluoroacetic acid salt;

Ethyl 4-(4-acetylaminobenzyl)-1-(3-aminoiminomethylbenzyl)-pyrrole-3-carboxylate trifluoroacetic acid salt;

Ethyl 4-benzyl-1-(4-aminoiminomethylbenzyl)-pyrrole-3-carboxylate trifluoroacetic acid salt;

Ethyl 4-benzyl-1-(3-aminoiminomethylbenzyl)-pyrrole-3-carboxylate trifluoroacetic acid salt;

Ethyl 4-(3-aminoiminomethylphenyl)-1-(2-naphthylmethyl)-pyrrole-3-carboxylate trifluoroacetic acid salt;

Ethyl 4-(3-aminoiminomethylphenyl)-1-(1-naphthylmethyl)-pyrrole-3-carboxylate trifluoroacetic acid salt;

Ethyl 4-(3-aminoiminomethylbenzyl)-1-(1-naphthylmethyl)-pyrrole-3-carboxylate trifluoroacetic acid salt;

Ethyl 4-(3-aminoiminomethylbenzyl)-1-(2-naphthylmethyl)-pyrrole-3-carboxylate trifluoroacetic acid salt;

Ethyl 4-(3-aminoiminomethylbenzyl)-1-(3-phenoxybenzyl)-pyrrole-3-carboxylate trifluoroacetic acid salt;

Ethyl 4-(3-aminoiminomethylbenzyl)-1-(4-phenoxybenzyl)-pyrrole-3-carboxylate trifluoroacetic acid salt;

Ethyl 4-(3-aminoiminomethylbenzyl)-1-(4-biphenylmethyl)-pyrrole-3-carboxylate trifluoroacetic acid salt;

Methyl 4-(4-aminoiminomethylbenzyl)-1-(3-aminoiminomethylbenzyl)-pyrrole-3-carboxylate bistrifluoroacetic acid salt;

Ethyl 4-(4-aminoiminomethylbenzyl)-1-(3-aminoiminomethylbenzyl)-pyrrole-3-carboxylate bistrifluoroacetic acid salt;

Isopropyl 4-(4-aminoiminomethylbenzyl)-1-(3-aminoiminomethylbenzyl)-pyrrole-3-carboxylate bistrifluoroacetic acid salt;

n-propyl 4-(4-aminoiminomethylbenzyl)-1-(3-aminoiminomethylbenzyl)-pyrrole-3-carboxylate bistrifluoroacetic acid salt;

n-butyl 4-(aminoiminomethylbenzyl)-1-(3-aminoiminomethylbenzyl)-pyrrole-3-carboxylate bistrifluoroacetic acid salt;

i-butyl 4-(4-aminoiminomethylbenzyl)-1-(3-aminoiminomethylbenzyl)-pyrrole-3-carboxylate bistrifluoroacetic acid salt;

cyclopropylmethyl 4-(4-aminoiminomethylbenzyl)-1-(3-aminoiminomethylbenzyl)-pyrrole-3-carboxylate bistrifluoroacetic acid salt;

4-(4-aminoiminomethylbenzyl)-1-(3-aminoiminomethylbenzyl)-pyrrole-3-carboxylic acid bistrifluoroacetic acid salt;

4-(4-aminoiminomethylbenzyl)-1-(3-aminoiminomethylbenzyl)-pyrrole-3-carboxamide bistrifluoroacetic acid salt;

Ethyl 4-(4-aminoiminomethylbenzyl)-1-(3-aminoiminomethyl-6-hydroxy-benzyl)-pyrrole-3-carboxylate bistrifluoroacetic acid salt;

4-(4-aminoiminomethylbenzyl)-1-(3-aminoiminomethyl-6-hydroxy-benzyl)-pyrrole-3-carboxylic acid bistrifluoroacetic acid salt;

Methyl 4-(4-aminoiminomethylbenzyl)-1-(3-aminoiminomethylbenzyl)-pyrrole-3-carboxamide bistrifluoroacetic acid salt;

Ethyl 4-(4-aminoiminomethylbenzyl)-1-(3-aminoiminomethylbenzyl)-pyrrole-3-carboxamide bistrifluoroacetic acid salt;

Propyl 4-(4-aminoiminomethylbenzyl)-1-(3-aminoiminomethylbenzyl)-pyrrole-3-carboxamide bistrifluoroacetic acid salt;

Ethyl 2-[4-(4-aminoiminomethylbenzyl)-1-(3-aminoiminomethylbenzyl)-pyrrole-3-carbonyloxy]-acetate bistrifluoroacetic acid salt;

Ethyl 2-[4-(4-aminoiminomethylbenzyl)-1-(3-aminoiminomethylbenzyl)-pyrrole-3-carbonylamino]-acetate bistrifluoroacetic acid salt;

Methyl 4-(3-aminoiminomethylbenzyl)-1-(4-aminoiminomethylbenzyl)-pyrrole-3-carboxylate bistrifluoroacetic acid salt;

Ethyl 4-(3-aminoiminomethylbenzyl)-1-(4-aminoiminomethylbenzyl)-pyrrole-3-carboxylate bistrifluoroacetic acid salt;

Isopropyl 4-(3-aminoiminomethylbenzyl)-1-(4-aminoiminomethylbenzyl)-pyrrole-3-carboxylate bistrifluoroacetic acid salt;

Ethyl 2-[4-(3-aminoiminomethylbenzyl)-1-(4-aminoiminomethylbenzyl)-pyrrole-3-carbonylamino]-acetate bistrifluoroacetic acid salt;

4-(3-aminoiminomethylbenzyl)-1-(4-aminoiminomethylbenzyl)-pyrrole-3-carboxylic acid morphorline amide bistrifluoroacetic acid salt;

Ethyl 2-[4-(3-aminoiminomethylbenzyl)-1-(4-aminoiminomethylbenzyl)-pyrrole-3-carbonyloxy]-acetate bistrifluoroacetic acid salt;

Ethyl 4-(4-aminoiminomethylbenzyl)-1-(4-aminoiminomethylbenzyl)-pyrrole-3-carboxylate bistrifluoroacetic acid salt;

Ethyl 4-(3-aminoiminomethylbenzyl)-1-(3-aminoiminomethylbenzyl)-pyrrole-3-carboxylate bistrifluoroacetic acid salt;

Ethyl 4-(4-aminoiminomethylbenzyl)-1-(5-aminoiminomethylthiophen-2-yl-methyl)-pyrrole-3-carboxylate bistrifluoroacetic acid salt;

Ethyl 4-[4-(2-imidazoline-2-yl)-benzyl]-1-(3-aminoiminomethylbenzyl)-pyrrole-3-carboxylate bistrifluoroacetic acid salt;

Ethyl 4-(4-aminoiminomethylbenzyl)-1-(7-aminoiminomethylnaphthalene-2-yl-methyl)-pyrrole-3-carboxylate bistrifluoroacetic acid salt;

Ethyl 4-(4-bromophenyl)-1-(3-aminoiminomethylbenzyl)-pyrrole-3-carboxylate trifluoroacetic acid salt;

Ethyl 4-[4-(2-aminosulfonylphenyl)-phenyl]-1-(3-aminoiminomethylbenzyl)-pyrrole-3-carboxylate trifluoroacetic acid salt;

Ethyl 4-[4-(2-aminosulfonylphenyl)-phenyl]-1-(3-aminoiminomethylbenzyl)-pyrrole-3-carboxamide trifluoroacetic acid salt;

Ethyl 4-[4-(2-aminosulfonylphenyl)-phenyl]-1-(3-aminoiminomethyl&hydroxy-benzyl)-pyrrole-3-carboxylate trifluoroacetic acid salt;

Ethyl 4-(3-biphenyl)-1-(3-aminoiminomethylbenzyl)-pyrrole-3-carboxylate trifluoroacetic acid salt;

Ethyl 4-(4-biphenyl)-1-(3-aminoiminomethylbenzyl)-pyrrole-3-carboxylate trifluoroacetic acid salt;

Ethyl 4-[4-(2-aminosulfonyl-5-fluoro-phenyl)-phenyl]-1-(3-aminoiminomethylbenzyl)-pyrrole-3-carboxylate trifluoroacetic acid salt;

Ethyl 4-[4-(2-aminosulfonyl-5-methyl-phenyl)-phenyl]-1-(3-aminoiminomethylbenzyl)-pyrrole-3-carboxylate trifluoroacetic acid salt;

4-[4-(2-aminosulfonyl-5-methyl-phenyl)-phenyl]-1-(3-aminoiminomethylbenzyl)-pyrrole trifluoroacetic acid salt;

Ethyl 4-[4-(2-pyridyl)-phenyl]-1-(3-aminoiminomethylbenzyl)-pyrrole 3-carboxylate bistrifluoroacetic acid salt; or

Ethyl 4-[4-(3-pyridyl)-phenyl]-1-(3-aminoiminomethylbenzyl)-pyrrole 3-carboxylate bistrifluoroacetic acid salt;

(A3: Bicyclic Scaffold)

3-aminoiminomethylphenyl 2-(3-aminoiminomethylphenyl)-phenylacetamide bistrifluoroacetic acid salt;

4-aminoiminomethylphenyl 2-(4-aminoiminomethylphenyl)-phenylacetamide bistrifluoroacetic acid salt;

4-aminoiminomethylphenyl 2-(3-aminoiminomethylphenyl)-phenylacetamide bistrifluoroacetic acid salt;

3-aminoiminomethylbenzyl 2-(4-aminoiminomethylphenyl)-benzyl ether bistrifluoroacetic acid salt;

4-aminoiminomethylbenzyl 2-(4-aminoiminomethylphenyl)-benzyl ether bistrifluoroacetic acid salt;

4-aminoiminomethylbenzyl 2-(3-aminoiminomethylphenyl)-benzyl ether bistrifluoroacetic acid salt;

3-aminoiminomethylbenzyl 2-(3-aminoiminomethylphenyl)-benzyl ether bistrifluoroacetic acid salt;

N-(3-aminoiminomethylphenyl)-N′-[2-(4-aminoiminomethylphenyl)-phenyl]urea bistrifluoroacetic acid salt;

N-(4-aminoiminomethylphenyl)-N′-[2-(4-aminoiminomethylphenyl)-phenyl]urea bistrifluoroacetic acid salt;

N-(4-aminoiminomethylphenyl)-N′-[2-(3-aminoiminomethylphenyl)-phenyl]urea bistrifluoroacetic acid salt;

N-(3-aminoiminomethylphenyl)-N′-[2-(3-aminoiminomethylphenyl)-phenyl]urea bistrifluoroacetic acid salt;

3-aminoiminomethylbenzyl 2-(4-aminoiminomethylphenyl)-benzamide bistrifluoroacetic acid salt;

4-aminoiminomethylbenzyl 2-(4-aminoiminomethylphenyl)-benzamide bistrifluoroacetic acid salt;

4-aminoiminomethylbenzyl 2-(3-aminoiminomethylphenyl)-benzamide bistrifluoroacetic acid salt;

3-aminoiminomethylbenzyl 2-(3-aminoiminomethylphenyl)-benzamide bistrifluoroacetic acid salt;

2-(4-aminoiminomethylphenyl)-benzyl-4-aminoiminomethylbenzamide bistrifluoroacetic acid salt;

2-(4-aminoiminomethylphenyl)-benzyl-3-aminoiminomethylbenzamide bistrifluoroacetic acid salt;

2-(3-aminoiminomethylphenyl)-benzyl-4-aminoiminomethylbenzamide bistrifluoroacetic acid salt;

2-(3-aminoiminomethylphenyl)-benzyl-3-aminoiminomethylbenzamide bistrifluoroacetic acid salt;

2-(3-aminoiminomethylphenyl)-phenyl phenylacetamide trifluoroacetic acid salt;

2-(3-aminoiminomethylphenyl)-phenyl phenylmethylsulfonamide trifluoroacetic acid salt;

4-(2-aminosulfonylphenyl)-phenyl 2-(4-aminoiminomethylphenyl)-benzamide trifluoroacetic acid salt;

4-(2-aminosulfonylphenyl)-phenyl 2-(3-aminoiminomethylphenyl)-benzamide trifluoroacetic acid salt;

4-(2-aminosulfonylphenyl)-phenyl 2-(3-aminoiminomethylphenyl)-cyclopenetene-1-carboxamide trifluoroacetic acid salt;

5-(2-aminosulfonylphenyl)-pyridine-2-yl 2-(3-aminoiminomethylphenyl)-cyclopenetene-1-carboxamide trifluoroacetic acid salt;

4-(N-methylpyridinium-3-yl)-phenyl 2-(3-aminoiminomethylphenyl)-cyclopenetene-1-carboxamide trifluoroacetic acid salt;

4-(2-pyridyl)-phenyl 2-(3-aminoiminomethylphenyl)-cyclopenetene-1-carboxamide trifluoroacetic acid salt;

4-(2-aminosulfonylphenyl)-phenyl 2-(3-aminoiminomethylphenyl)-pyridine-3-carboxamide trifluoroacetic acid salt;

4-(2-aminosulfonyl-5-fluoro-phenyl)-phenyl 2-(3-aminoiminomethylphenyl)-pyridine-3-carboxamide trifluoroacetic acid salt;

4-(2-aminosulfonyl-5-methyl-phenyl)-phenyl 2-(3-aminoiminomethylphenyl)-pyridine-3-carboxamide trifluoroacetic acid salt;

4-(2-cyanophenyl)-phenyl 2-(3-aminoiminomethylphenyl)-pyridine-3-carboxamide bis trifluoroacetic acid salt;

4-(2-methanesulfonylphenyl)-phenyl 2-(3-aminoiminomethylphenyl)-pyridine-3-carboxamide bis trifluoroacetic acid salt;

4-(2-methanesulfonyl-imidazole-1-yl)-phenyl 2-(3-aminoiminomethylphenyl)-pyridine-3-carboxamide tris trifluoroacetic acid salt;

4-(2-methylaminosulfonylphenyl)-phenyl 2-(3-aminoiminomethylphenyl)-pyridine-3-carboxamide bis trifluoroacetic acid salt;

4-(2-cyano-thiophene-3-yl)-phenyl 2-(3-aminoiminomethylphenyl)-pyridine-3-carboxamide bis trifluoroacetic acid salt;

4-(2-aminosulfonyl-5-methyl-thiophene-3-yl)-phenyl 2-(3-aminoiminomethylphenyl)-pyridine-3-carboxamide bis trifluoroacetic acid salt;

4-(2-cyanophenyl)-phenyl 2-(3-aminoiminomethylphenyl)-methyl-pyridine-3-carboxamide bis trifluoroacetic acid salt; or

4-(2-methanesulfonylphenyl)-phenyl 2-(3-aminoiminomethylphenyl)-6-methyl-pyridine-3-carboxamide bis trifluoroacetic acid salt;

(A4: Cyanophenylalanine Scaffold)

4-(2-cyanophenyl)-phenyl N-methoxycarbonyl-3-(3-aminoiminomethylphenyl)alanine amide trifluoroacetic acid salt (racemic);

4-(2-aminosulfonyl-5-fluoro-phenyl)-phenyl N-methanesulfonyl-3-(3-aminoiminomethylphenyl)alanine amide trifluoroacetic acid salt (racemic);

4-(2-aminosulfonylphenyl)-phenyl N-methoxycarbonyl-3-(3-aminoiminomethyl-6-hydroxy-phenyl)alanine amide trifluoroacetic acid salt (racemic);

4-(2-aminocarbonylphenyl)-phenyl N-methanesulfonyl-3-(3-aminoiminomethylphenyl)alanine amide trifluoroacetic acid salt (racemic);

4-(2-cyanophenyl)-phenyl N-methanesulfonyl-3-(3-aminoiminomethylphenyl)alanine amide trifluoroacetic acid salt (racemic);

4-(2-aminosulfonylphenyl)-phenyl N-methanesulfonyl-3-(3-aminoiminomethylphenyl)alanine amide trifluoroacetic acid salt (racemic);

4-(2-aminosulfonyl-5-methyl-phenyl)-phenyl N-methanesulfonyl-3-(3-aminoiminomethylphenyl)alanine amide trifluoroacetic acid salt (racemic);

4-(2-aminosulfonylphenyl)-phenyl N-methoxycarbonyl-3-(3-aminoiminomethylphenyl)alanine amide trifluoroacetic acid salt (racemic);

5-(2-cyanophenyl)-pyridine-2-yl N-methanesulfonyl-3-(3-aminoiminomethylphenyl)alanine amide trifluoroacetic acid salt (optcally active);

4-(2-cyanophenyl)-phenyl N-(carboxymethyl)-3-(3-aminoiminomethylphenyl)alanine amide trifluoroacetic acid salt (racemic);

(S)-3-(3-aminoiminomethylphenyl-1-hydroxy-propane-2-yl 4-(2-aminosulfonyl-5-fluorophenyl)-benzamide trifluoroacetic acid salt (optcally active);

(S)-N-{4-(2-cyanophenyl)-benzoyl}-3-(3-aminoiminomethylphenyl)alanine methyl ester trifluoroacetic acid salt (optcally active);

(S)-N-{4-(2-cyanophenyl)-benzoyl}-3-(3-aminoiminomethylphenyl)alanine ethyl amide trifluoroacetic acid salt (optically active);

4-(2-cyanophenyl)-phenyl (S-N-acetyl-3-(3-aminoiminomethylphenyl)alanine amide trifluoroacetic acid salt (optically active);

(S)-N-{4-(2-cyano-5-fluoro-phenyl)-benzoyl}-3-(3-aminoiminomethylphenyl)alanine methyl ester trifluoroacetic acid salt (optically active);

(S)-N-{4-(2-aminosulfonyl-5-methyl-phenyl)-benzoyl}-3-(3-aminoiminomethylphenyl)alanine methyl ester trifluoroacetic acid salt (optcally active);

(S)-N-{4-(2-aminosulfonylphenyl)-benzoyl}-3-(3-aminoiminomethylphenyl)alanine trifluoroacetic acid salt (optcally active);

(S)-N-{4-(2-aminosulfonylphenyl)-benzoyl}-3-(3-aminoiminomethylphenyl)alanine methyl ester trifluoroacetic acid salt (optcally active);

(S)-N-{4-(2-aminosulfonylphenyl)-benzoyl}-3-(3-aminoiminomethylphenyl)alanine ethyl ester trifluoroacetic acid salt (optcally active);

4-(2-cyanophenyl)-phenyl N-methanesulfonyl-3-(3-aminoiminomethylphenyl)alanine amide trifluoroacetic acid salt (racemic);

1-[4-(2-aminosulfonylphenyl)-phenoxy]-2-methanesulfonylamino-3-(3-aminoiminomethylphenyl)propane trifluoroacetic acid salt (racemic);

4-(2-cyanophenyl)-phenyl N-(n-propanesulfonyl)-3-(3-aminoiminomethylphenyl)-alanine amide trifluoroacetic acid salt (racemic);

4-(2-cyanophenyl)-phenyl N-ethoxycarbonyl-3-(3-aminoiminomethylphenyl)-alanine amide trifluoroacetic acid salt (racemic);

4-(2-cyanophenyl)-phenyl N-ethylaminocarbonyl-3-(3-aminoiminomethylphenyl)-alanine amide trifluoroacetic acid salt (racemic);

4-(2-cyanophenyl)-phenyl N,N-bis-methanesulfonyl-3-(3-aminoiminomethylphenyl)-alanine amide trifluoroacetic acid salt (racemic);

4-(2-methanesulfonylphenyl)-phenyl N-methyl-N-methanesulfonyl-3-(3-aminoiminomethylphenyl)-alanine amide trifluoroacetic acid salt (racemic);

4-(2-methanesulfonylphenyl)-phenyl N-methanesulfonyl-3-(3-aminoiminomethylphenyl)-alanine amide trifluoroacetic acid salt (racemic);

4-(2-aminosulfonylphenyl)-phenyl N-methyl-N-methanesulfonyl-3-(3-aminoiminomethylphenyl)-alanine amide trifluoroacetic acid salt (racemic);

(S)-N-{4-(2-methanesulfonylphenyl)-benzoyl}-3-(3-aminoiminomethylphenyl)-alanine methyl ester trifluoroacetic acid salt (optcally active);

1-{4-(2-aminosulfonylphenyl)-phenylcarbonylamino}-1-(4-ethoxycarbonylthiazole-2-yl)-2-(3-aminoiminomethylphenyl)-ethane trifluoroacetic acid salt;

N-{4-(-(2-cyanophenyl)-benzoyl}-3-(2-aminoiminomethylpyridine-4-yl)-alanine methyl ester trifluoroacetic acid salt (racemic);

4-(2-methanesulfonylphenyl)-phenyl N-ethyl-N-methanesulfonyl-3-(3-aminoiminomethylphenyl)-alanine amide trifluoroacetic acid salt (racemic);

4-(2-cyanophenyl)-phenyl N-ethyl-N-methanesulfonyl-3-(3-aminoiminomethyl-phenyl)-alanine amide trifluoroacetic acid salt (racemic);

N-{4-(2-cyanophenyl)-benzoyl}-3-(2-aminoiminomethylpyridine-4-yl)-alanine N,N-dimethyl amide trifluoroacetic acid salt;

N-{4-(2-cyanophenyl)-benzoyl}-3-(2-aminoiminomethylpyridine-4-yl)-alanine ethyl ester trifluoroacetic acid salt;

4-(2-aminosulfonylphenyl)-phenyl N-ethyl-N-methanesulfonyl-3-(3-aminoiminomethylphenyl)-alanine amide trifluoroacetic acid salt (racemic);

4-(2-cyanophenyl)-phenyl N-ethyl-N-ethoxycarbonyl-3-(3-aminoiminomethyl-phenyl)-alanine amide trifluoroacetic acid salt (racemic);

4-(2-methanesulfonylphenyl)-phenyl 2-N-propanosultam)-3-(3-aminoiminomethyl-phenyl)-propanoic amide trifluoroacetic acid salt (racemic);

4-(2-methanesulfonylphenyl)-phenyl N-benzyl-N-methanesulfonyl-3-(3-aminoiminomethylphenyl)-alanine amide trifluoroacetic acid salt (racemic);

4-(2-cyanophenyl)-phenyl N-methyl-N-ethoxycarbonyl-3-(3-aminoiminomethyl-phenyl)-alanine amide trifluoroacetic acid salt (racemic);

4-(2-Cyanophenyl)-phenyl N-methyl-N-methanesulfonyl-3-(3-aminoiminomethylphenyl)-alanine amide trifluoroacetic acid salt (racemic);

4-(2-aminosulfonylphenyl)-2-chloro-phenyl N-methyl-N-methanesulfonyl-3-(3-aminoiminomethylphenyl)alanine amide trifluoroacetic acid salt (racemic);

4-(2-cyanophenyl)-phenyl 2-(N-propanosultam)-3-(3-aminoiminomethylphenyl)-propanoic amide trifluoroacetic acid salt (racemic);

4-(2-cyanophenyl)-phenyl N-methyl-N-acetyl-3-(3-aminoiminomethylphenyl)-alanine amide trifluoroacetic acid salt (racemic);

4-(2-cyanophenyl)-phenyl N-methyl-N-propanoyl-3-(3-aminoiminomethylphenyl)-alanine amide trifluoroacetic acid salt (racemic);

4-(2-methanesulfonylphenyl)-2-chloro-phenyl N-methyl-N-methanesulfonyl-3-(3-aminoiminomethylphenyl)-alanine amide trifluoroacetic acid salt (racemic);

4-(2-cyanophenyl)-phenyl N-ethyl-N-isopropyloxycarbonyl-3-(3-aminoiminomethylphenyl)-alanine amide trifluoroacetic acid salt (racemic);

4-(2-cyanophenyl)-phenyl N-ethyl-N-propanoyl-3-(3-aminoiminomethylphenyl)-alanine amide trifluoroacetic acid salt (racemic);

4-(2-cyano-3-fluoro-phenyl)-phenyl N-methyl-N-methanesulfonyl-3-(3-aminoiminomethylphenyl)-alanine amide trifluoroacetic acid salt (racemic);

4-(2-cyanochloro-phenyl)-phenyl N-methyl-N-methanesulfonyl-3-(3-aminoiminomethylphenyl)-alanine amide trifluoroacetic acid salt (racemic);

4-(2-cyanophenyl)-phenyl 2-(N-oxazolidin-2-one)-3-(3-aminoiminomethyl-phenyl)-propanoic amide trifluoroacetic acid salt (racemic);

4-(2-methanesulfonylphenyl)-phenyl 2-N-oxazolidin-2-one)-3-(3-aminoiminomethylphenyl)-propanoic amide trifluoroacetic acid salt (racemic);

4-(2-cyanophenyl)-phenyl 2-(N-butyrolactam)-3-(3-aminoiminomethylphenyl)-propanoic amide trifluoroacetic acid salt (racemic);

4-(2-methanesulfonylphenyl)-phenyl 2-(N-carboxymethyl-N-methanesulfonyl)amino-3-(3-aminoiminomethylphenyl)-propanoic amide trifluoroacetic acid salt (racemic);

4-(2-cyanophenyl)-2-chlorophenyl N-methyl-N-methanesulfonyl-3-(3-aminoiminomethylphenyl)-alanine amide trifluoroacetic acid salt (racemic);

4-(2-cyanophenyl)-phenyl 2-[N-(4,6-tetrahydro-1,3-oxazin-2-one)]-3-(3-aminoiminomethylphenyl)-propanoic amide trifluoroacetic acid salt (racemic);

4-(2-cyanophenyl)-phenyl 2-N-carboxymethyl-N-methanesulfonyl)amino-3-(3-aminoiminomethylphenyl)-propanoic amide trifluoroacetic acid salt (racemic);

4-(2-cyano-4-chlorophenyl)-phenyl N-methyl-N-methanesulfonyl-3-(3-aminoiminomethylphenyl)-alanine amide trifluoroacetic acid salt (racemic);

4-(2-cyano-5-fluorophenyl)-phenyl N-methyl-N-methanesulfonyl-3-(3-aminoiminomethylphenyl)-alanine amide trifluoroacetic acid salt (racemic);

4-(2-cyano-4-methylphenyl)-phenyl N-methyl-N-methanesulfonyl-3-(3-aminoiminomethylphenyl)-alanine amide trifluoroacetic acid salt (racemic);

4-(2-cyanophenyl)-phenyl 2-[N-1,3-oxazolidine-2-one)]-3-(1-aminoisoquinoline-7-yl)-propanoic amide trifluoroacetic acid salt (racemic);

4-(2-methanesulfonylphenyl)-phenyl 2-(N-propanosultam)-3-(1-aminoisoquinoline-7-yl)-propanoic amide trifluoroacetic acid salt (racemic);

4-(2-aminosulfonylphenyl)-phenyl 2-N-propanosultam)-3-(1-aminoisoquinoline-7-yl)-propanoic amide trifluoroacetic acid salt (racemic);

4-(2-cyanophenyl)-phenyl 2-[N-propanosultam]-3-(1-aminoisoquinoline-7-yl)-propanoic amide trifluoroacetic acid salt (racemic); or

4-(2-methanesulfonylphenyl)-phenyl N-carboxymethyl-N-methanesulfonyl-3-(1-aminoisoquinoline-7-yl)alanine amide trifluoroacetic acid salt (racemic);

(Prodrug)

4-(2-methanesulfonylphenyl)-phenyl cis-2-(3-amino[ethoxycarbonylimino]methylphenyl)-cyclopropane-1-carboxamide;

4-(2-methanesulfonylphenyl)-phenyl cis-2-(3-amino[hydroxyimino]methylphenyl)-cyclopropane-1-carboxamide;

4-(2-aminosulfonylphenyl)-phenyl cis-2-(3-amino[hydroxyimino]methylphenyl)-cyclopropane-1-carboxamide trifluoroacetic acid salt;

4-(2-aminosulfonyl-5-fluorophenyl)-phenyl cis-2-(3-amino[hydroxyimino]methylphenyl)-cyclopropane-1-carboxamide trifluoroacetic acid salt;

4-(2-aminosulfonyl-5-methylphenyl)-phenyl 2-(3-amino[hydroxyimino]methylphenyl)-pyridine-3-carboxamide bis trifluoroacetic acid salt;

4-(2-cyanophenyl)-phenyl 2-(3-amino[hydroxyimino]methylphenyl)-pyridine-3-carboxamide bis trifluoroacetic acid salt;

4-(2-methanesulfonylphenyl)-phenyl N-(methanesulfonyl)-N-methyl-3-(3-amino[hydroxyimino]methylphenyl)-alanine amide trifluoroacetic acid salt (racemic);

4-(2-cyanophenyl)-phenyl 2-(3-amino[ethoxycarbonyloxyimino]methylphenyl)-pyridine-3-carboxamide;

4-(2-methanesulfonyl-imidazol-1-yl)-phenyl cis-2-(3-amino[hydroxyimino]methylphenyl)-cyclopropane-1-carboxamide bistrifluoroacetic acid salt;

4-(2-methanesulfonylphenyl)-phenyl 2-(3-amino[hydroxyimino]methylphenyl)-pyridine-3-carboxamide bis trifluoroacetic acid salt;

4-(2-aminosulfonylphenyl)-phenyl 2-(3-amino[hydroxyimino]methylphenyl)-pyridine-3-carboxamide bis trifluoroacetic acid salt;

4-(2-methanesulfonyl-5-fluoro-phenyl)-phenyl 2-(3-amino[hydroxyimino]methylphenyl)-pyridine-3-carboxamide bis trifluoroacetic acid salt;

4-(2-aminosulfonylphenyl)-phenyl N-(methanesulfonyl)-N-methyl-3-(3-amino[hydroxyimino]methylphenyl)alanine amide trifluoroacetic acid salt (racemic);

4-(2-methylaminosulfonylphenyl)-phenyl 2-(3-amino[hydroxyimino]methylphenyl)-pyridine-3-carboxamide bis trifluoroacetic acid salt;

4-(2-methylaminosulfonylphenyl)-phenyl cis-2-(3-amino[hydroxyimino]methylphenyl)-cyclopropane-1-carboxamide trifluoroacetic acid salt;

4-(2-cyanophenyl)-phenyl cis-2-(3-amino[hydroxyimino]methylphenyl)-cyclopropane-1-carboxamide trifluoroacetic acid salt;

4-(2-methanesulfonyl-imidazole-1-yl)-phenyl 2-(3-amino[hydroxyimino]methylphenyl)-pyridine-3-carboxamide tris trifluoroacetic acid salt;

5-(2-aminosulfonylphenyl)-pyridine-2-yl cis-2-(3-amino[hydroxyimino]methylphenyl)-cyclopropane-1-carboxamide bis trifluoroacetic acid salt;

4-(2-methanesulfonylphenyl)-phenyl N-ethyl-N-methanesulfonyl-3-(3-amino[hydroxyimino]methylphenyl)-alanine amide trifluoroacetic acid salt (racemic);

4-(2-cyanophenyl)-phenyl cis-2-(3-amino[ethoxycarbonylimino]methylphenyl)-cyclopropane-1-carboxamide trifluoroacetic acid salt;

4-(2-cyanophenyl)-phenyl 2-(3-amino[hydroxyimino]methylphenyl)-6-methyl-pyridine-3-carboxamide bis trifluoroacetic acid salt;

4-(2-aminosulfonylphenyl)-phenyl N-ethyl-N-methanesulfonyl-3-(3-amino[hydroxyimino]methylphenyl)-alanine amide trifluoroacetic acid salt (racemic);

4-(2-cyanophenyl)-phenyl N-ethyl-N-methanesulfonyl-3-(3-amino[hydroxyimino]methylphenyl)-alanine amide trifluoroacetic acid salt (racemic);

4-(2-cyanophenyl)-phenyl N-ethyl-N-ethoxycarbonyl-3-(3-amino[hydroxyimino]methylphenyl)-alanine amide trifluoroacetic acid salt (racemic);

4-(2-methanesulfonylphenyl)-phenyl 2-N-propanosultam)-3-(3-amino[hydroxyimino]methylphenyl)-propanoic amide trifluoroacetic acid salt (racemic);

4-(2-cyanophenyl)-phenyl N-methyl-N-ethoxycarbonyl-3-(3-amino[hydroxyimino]methylphenyl)-alanine amide trifluoroacetic acid salt (racemic);

4-(2-aminosulfonylphenyl)-2-chloro-phenyl N-methyl-N-methanesulfonyl-3-(3-amino[hydroxyimino]methylphenyl)-alanine amide trifluoroacetic acid salt (racemic);

4-(4-cyano-thiophene-3-yl)-phenyl cis-2-(3-amino[hydroxyimino]methylphenyl)-cyclopropane-1-carboxamide trifluoroacetic acid salt;

4-(2-cyanophenyl)-phenyl (1,2-cis)-2-(3-amino[hydroxyimino]methylphenyl)-(1,3-trans)-3-carboxy-cyclopropane-1-carboxamide trifluoroacetic acid salt;

4-(2-cyanophenyl)-phenyl (1,2-cis)-2-(3-amino[hydroxyimino]methylphenyl)-(1,3-trans)-3-ethoxycarbonyl-cyclopropane-1-carboxamide trifluoroacetic acid salt;

4-(2-cyanophenyl)-phenyl 2-(N-propanosultam)-3-(3-amino[hydroxyimino]methylphenyl)-propanoic amide trifluoroacetic acid salt (racemic);

4-(2-cyanophenyl)-phenyl N-ethyl-N-isopropyloxycarbonyl-3-(3-amino[hydroxyimino]methylphenyl)-alanine amide trifluoroacetic acid salt (racemic);

4-(2-cyanophenyl)-phenyl N-ethyl-N-propanoyl-3-(3-amino[hydroxyimino]methylphenyl)-alanine amide trifluoroacetic acid salt (racemic);

4-(2-cyanophenyl)-phenyl 2-N-oxazolidin-2-one)-3-(3-amino[hydroxyimino]methylphenyl)-propanoic amide trifluoroacetic acid salt (racemic);

4-(2-methanesulfonylphenyl)-phenyl 2-(N-oxazolidin-2-one)-3-(3-amino[hydroxyimino]methylphenyl)-propanoic amide trifluoroacetic acid salt (racemic);

4-(2-cyano-phenyl)-2-chlorophenyl N-methyl-N-methanesulfonyl-3-(3-amino[hydroxyimino]methylphenyl)alanine amide trifluoroacetic acid salt (racemic);

4-(2-methanesulfonylphenyl)-phenyl 2-(N-carboxymethyl-N-methanesulfonyl)amino-3-(3-amino[hydroxyimino]methylphenyl)-propanoic amide trifluoroacetic acid salt (racemic);

4-(2-methanesulfonylphenyl)-phenyl 2-(N-ethoxycarbonylmethyl-N-methanesulfonyl)amino-3-(3-amino[hydroxyimino]methylphenyl)-propanoic amide trifluoroacetic acid salt (racemic);

4-(2-methanesulfonylphenyl)-phenyl 2-(3-amino[hydroxyimino]methylphenyl)-6-methyl-pyridine-3-carboxamide bis trifluoroacetic acid salt;

4-(2-methanesulfonylphenyl)-phenyl (1,2-cis)-2-(3-amino[hydroxyimino]methylphenyl)-(1,3-trans)-3-carboxy-cyclopropane-1-carboxamide trifluoroacetic acid salt (racemic);

4-(2-methanesulfonylphenyl)-phenyl (1,2-cis)-2-(3-amino[hydroxyimino]methylphenyl)-(1,3-trans=3-ethoxycarbonyl-cyclopropane-1-carboxamide trifluoroacetic acid salt (racemic);

4-(2-cyanophenyl)-phenyl 2-[N-(4,6-tetrahydro-1,3-oxazin-2-one)]-3-(3-amino[hydroxyimino]methylphenyl)-propanoic amide trifluoroacetic acid salt (racemic);

4-(2-cyanophenyl)-phenyl 2-(N-carboxymethyl-N-methanesulfonyl)amino-3-(3-amino[hydroxyimino]methylphenyl)-propanoic amide trifluoroacetic acid salt (racemic); or

4-(2-cyanophenyl)-phenyl 2-(N-ethoxycarbonylmethyl-N-methanesulfonyl)amino-3-(3-amino[hydroxyimino]methylphenyl)-propanoic amide trifluoroacetic acid salt (racemic).

The compound of formula 1 according to the present invention may be also formed as a pharmaceutically acceptable salt; thereof. The pharmaceutically acceptable salt; thereof includes an acid addition salt; formed by an acid, which contains a pharmaceutically acceptable anion and forms a non-toxic acid addition salt, as mentioned below:

inorganic acids (for example, hydrochloric acid, sulfuric acid, nitric acid, phosphoric acid, hydrobromic acid, or hydroiodic acid), organic carbonic acids (for example, tartaric acid, formic acid, citric acid, acetic acid, trichloroacetic acid or trifluoroacetic acid, gluconic acid, benzoic acid, lactic acid, fumaric acid, or maleic acid), and sulfonic acids (for example, methanesulfonic acid, benzenesulfonic acid, p-toluenesulfonic acid or naphtalenesulfonic acid).

The terms used in the present invention are described in abbreviation below:

AcCN or AN: acetonitrile

AIBN: 2,2′-azobisisobutyronitrile

Boc: t-butyloxycarbonyl

BOP-Cl: bis-2-oxo-3-oxazolidinyl)-phospinic acid chloride

(n-)Bu: (normal-) butyl

n-BuLi: normal butyl lithium

dba in Pd(dba)₂: 1,3-dibenzylidene acetone

DDC: dicylcohexylcarbodiimide

DEAD: diethyl azodicarboxylate

DIBAL: Diisobutylaluminum hydride

DIPEA: diisopropylethylamine

DME: dimethoxyethane

DMF: N,N-dimethylformamide

DMSO: dimethylsulfoxide

DPPA: diphenylphosphoryl azide

EA: ethyl acetate

EDC: 1-(3-dimethylaminopropyl)-3-ethylcarbodiimide hydrochloride

Eq. or equiv.: equivalent(s)

Et: ethyl

EtOH: ethanol

HATU: O-(7-azabenzotriazol-1-yl)-N,N,N′,N′-tetramethyluronium

hexafluorophosphate

Hex: hexanes

HOBT: hydroxybenzotriazole

LDA: Lithium diisopropylamide

Me: methyl

MeOH: methanol

NBS: N-bromosuccinimide

MNNG: 1-methyl-3-nitro-1-nitrosoguanidine

Ms: Methanesulfonyl

NMM: N-methylmorphorline

NMR or nmr: nuclear magnetic resonance (spectroscopy)

Ph: phenyl

PPh₃: triphenylphosphine

Pr: propyl

(Prep-)HPLC: (preparative) high performance liquid chromatography

Pyr: pyridine

TBS in Cu(TBS)₂;

TEA: triethylamine

TFA: trfluoroacetic acid

TBF: tetrahydrofuran

TOSMIC: tosylmethyl isocyamide

Known coupling agents for coupling reaction of amino group may be used in the present invention. These coupling agents include, but not limited to, dicyclohexylcarbodiimide (ICC), 1-(3-dimethylaminopropyl)-3-ethylcarbodiimide hydrochloride (EDC), bis-(2-oxo-3-oxazolidinyl)-phospinic acid chloride (BOP-Cl), diphenylphosporylazide (DPPA), isobutylchloroformate, and O-(7-azabenzotriazole-1-yl)-N,N,N′,N′-tetramethyluronium hexafluorphospate (HATU).

As mentioned above, compounds of formula 1 according to the present invention are FXa inhibitors, which have more excellent selectivity for thrombin over known compounds and are capable of being orally administrated. Thus, compounds of the present invention are useful in preventing blood coagulation and treating thrombosis.

The present invention also relates to a pharmaceutical composition for preventing blood coagulation and treating thrombosis, which comprises a compound of formula 1 or a pharmaceutically acceptible salt; thereof as an effective ingredient.

When the compound of the present invention is administrated for the clinical purpose, a preferred total daily dose, of which is administrated to host by single or divided dose, has a range of 0.001 mg to 10 mg per kg of body weight. However, specific dose level of specific patients may be varied depending on specific compounds to be used, body weight, sex, health status, diet, time of administration, method of administration, rate of excretion, drug combination, and severity of disease.

The compound of the present invention may be administrated as injection preparations and oral preparations.

Injection preparations, such as aqueous or oil suspensions for sterile injection may be prepared by using appropriate dispersing agents, wetting agents, or suspending agents in accordance with the known techniques. Solvents, which may be used, include water, Ringers solution and isotonic NaCl solution. Sterile fixing oil is usually used as a solvent or suspending medium. Non-irritant fixing oil, including mono-, or di-glyceride, may be used for this purpose. Also, a fatty acid such as oleic acid is used in injection preparations.

Solid dosage forms may be capsules, tablets, pills, powders and granules, and capsules or tablets are particularly useful. It is preferred that tablets and pills are prepared as enteric-coated preparations. Solid dosage forms may be prepared by mixing active compounds of formula 1 according to the present invention with carriers, such as one or more inert diluents, for example, sucrose, lactose, starch and the like; and lubricants, for example magnesium stearate; disintegrants; binders and the like.

The compound of formula 1 according to the present invention is characterized in that when the oral preparations comprising the compounds are administrated, the preparations show an effect of medicine. The above fact is proved by pharmacokinetic experiments using rats as test animal. That is, it is confirmed that when a pharmaceutical composition according to the present invention is orally administrated to rats, it maintains a concentration of drug in blood for a long time. Therefore, the compound of the present invention can be effectively used as an oral preparation and is more useful, in comparison with the conventional thrombin inhibitors.

In order to obtain the desired anti-coagulation effect and thrombolysis effect by clinical administration, an active compound of formula 1 according to the present invention and one or more ingredients selected from a thrombolytic agent and a platelet activity inhibitor may be administrated simultaneously. Thrombolytic agents which may be mixed with the present compound to be administrated include t-PA, urokinase, streptokinase and the like. Platelet activity inhibitors include aspirin, ticlopidin, clopidrogel 7E3 single antibody and the like.

However, preparations comprising the compound according to the present invention for treating and preventing thrombosis are not restricted to the above preparations, but include all preparations useful in treating and preventing thrombosis.

The following examples and experiments are provided to further illustrate the present invention, and are not intended as a limitation on the scope of the invention.

<Cyclopropyl Part>

### EXAMPLE 1

Synthesis of 3-vinylbenzonitrile

3-Bromobenzonitrile (1.0 g, 5.5 mmol) in DMF (5 mL) was treated with vinyltributyltin (1.75 g, 6.05 mmol) and (PPh₃)₄Pd (5 mol %), and heated to 80° C. for 16 h. The reaction was diluted with ether, washed with 1M Na₂CO₃, dried (MgSO₄), filtered and concentrated in vacuo. Flash chromatography gave 670 mg (95%) of the title compound.

¹H-NMR (500 MHz, CDCl₃) δ7.66 (s, 1H), 7.61 (d, J=7.8 Hz, 1H), 7.53 (d, J=7.8 Hz, 1H), 7.42 (t, J=7.8 Hz, 1H), 6.68 (dd, J=17.4, 11.0 Hz, 1H), 5.80 (d, J=16.0 Hz, 1H), 5.39 (d, J=11.0 Hz, 1H),

### EXAMPLE 2

Synthesis of ethyl cis- and trans-2-(3-cyanophenyl)-cyclopropane-1 carboxylate

3-vinylbenzonitrile (130 mg, 1.0 mmol) in ether (5 mL) was treated with Pd(OAc)₂ and cooled to 0° C. Ethyl diazoacetate (456 mg, 4 mmol) was added slowly to the solution. After stirring for 20 h at 0° C., the reaction was concentrated and chromatographed to give the title compound (74 mg, 34%) as mixes of diastereomer.

### EXAMPLE 3

Synthesis of 3-(3-cyanophenyl)-2-propyn-1-ol

A solution of 3-bromobenzonitrile (9.10 g, 50 mmol) and propargyl alcohol (2.80 g, 50 mmol) in DMF (50 mL) under N₂ was treated with (PPh₃)₄Pd (577 mg, 1 mol %), CuI (476 mg, 5 mol %) and TEA (13.94 mL, 2.0 equiv), and heated to 100-110° C. for 12 h. After concentration, the residue was dissolved in water, extracted with ethyl acetate (100 mL×3). The combined organic layer was washed with aqueous KI (100 mL×2), with 1N-HCl (100 mL), saturated NaHCO₃ (100 mL), dried (MgSO₄), filtered and concentrated in vacuo. Flash chromatography with ethyl actetate: hexanes (1:3) gave 5.15 g (65%) of the title compound.

¹H-NMR (500 MHz, CDCl₃) δ7.70 (s, 1H), 7.63 (m, 1H), 7.59 (m, 1H), 7.43 (t, J=7.8 Hz, 1H), 4.50 (d, J=5.5 Hz, 2H).

### EXAMPLE 4

Synthesis of cis-3-(3-cyanophenyl)-2-propen-1-ol (cis hydrogenation with Lindlar's catalyst)

A solution of 3-(3-cyanophenyl)-2-propyn-1-ol (5.14 g, 32.7 mmol) in toluene (70 mL) was treated with Lindlar's catalyst (1 g) and one drop of quinoline. The reaction was hydrogenated in Parr Hydrogenator at 45 psi H₂ atmosphere for 4.5 h to give the title compound.

¹H-NMR (500 MHz, CDCl₃) δ7.70 (s, 1H), 7.64 (d, J=7.8 Hz, 1H), 7.60 (d, J=7.8 Hz, 1H), 7.43 (t, J=7.8 Hz, 1H), 6.54 (d, J=12.0 Hz, 1H), 6.00 (m, 1H), 4.50 (d, J=5.4 Hz, 2H).

### EXAMPLE 5

Synthesis of cis-2-(3-cyanophenyl)-cyclopropane-1-methanol (cyclopropanation with Et₂Zn)

In a 3-neck round-bottomed flask was placed ethylene dichloride (77 mL), and cooled to −10° C. Diethylzinc (4.5 mL, 2.0 equiv) was added. Iodochloromethane (6.4 mL, 4.0 equiv) was added in 3 portions. After 10 minutes, a solution of cis-3-(3-cyanophenyl>2-propen-1-ol (3.5 g, 22.0 mmol) in ethylene dichloride (33 mL) added in 10 minute period. The reaction was stirred for 1.5 h at 0° C., then quenched with aqueous NH₄Cl. Conventional workup followed by flash chromatography with EA: Hex=2:1 gave 1.47 g (39%) of the title compound.

¹H-NMR (500 MHz, CDCl₃) δ7.54-7.49 (m, 3H), 7.38 (t, J=7.8 Hz, 1H), 3.45 (m, 1H), 3.22 (m, 1H), 2.30 (m, 1H), 1.55 (m, 1H), 1.13 (m, 1H), 0.86 (m, 1H).

### EXAMPLE 6

Synthesis of cis-2-(3-cyanophenyl)-cyclopropane-1-carboxylic acid (Sharpless oxidation)

A solution of cis-2-(3-cyanophenyl)-cyclopropane-1-methanol (283 mg, 1.63 mmol) in solvents (12.3 mL, CCl₄:CH₃CN:H₂O=2:2:3) was treated with RuCl₃H₂O (17 mg, 5 mol %), and NaIO₄ (1.05 g, 3 equiv), then stirred for 1 h at room temperature. After quenching with 1N-HCl (6 equiv), the reaction was extracted with CH₂Cl₂ (15 mL×3), then concentrated. The residue dissolved in ether was filtered through celite (to remove ruthenium impurities) and concentrated to give 231 mg (75.7%) of the title compound.

¹H-NMR (500 MHz, CDCl₃) δ7.53 (s, 1H), 7.49 (m, 2H), 7.36 (t, J=7.8 Hz, 1H), 2.63 (m, 1H), 2.11 (m, 1H), 1.68 (m, 1H), 1.46 (m, 1H).

### EXAMPLE 7

Synthesis of cis, cis-2-(3-cyanophenyl)-3-hydroxymethyl-cyclopropane-1-carboxylic acid lactone (intramolecular cyclopropanation)

To a solution of Cu (TBS)₂ (19 mg, 5 mol %) in refluxing toluene (20 mL) was added slowly a solution of cis-3-(3-cyanophenyl)-2-propen-1-yl diazoacetate (208 mg, 0.915 mmol) in toluene (20 mL), then refluxed for 12 h. Concentration followed by flash chromatography with EA: Hex=1:3 gave 98 mg (54%) of the title compound.

¹H-NMR (500 MHz, CDCl₃) δ7.60 (s, 1H), 7.59-7.55 (m, 2H), 7.45 (t, J=7.8 Hz, 1H), 4.40 (m, 1H), 3.99 (d, J=10.1 Hz, 1H), 2.76 (m, 1H), 2.66-2.63 (m, 2H).

### EXAMPLE 8

Preparation of Boronic Acids

Synthesis of 2-t-butylaminosulfonyl-benzeneboronic acid (J. Med. Chem. 1999, 42, 2752-2759)

To a solution of t-butylaminosulfonylbenzene (30 g, 0.14 mol) in dry THF (350 mL) at 0° C. was added n-BuLi (2.2 M in Hex, 130 mL) in 30 minutes, then the reaction was stirred for 30 minutes at 10° C. Triisopropylborate (36 g) was added while keeping the inner temperature below 35° C. After stirring for 1 h, the reaction was cooled with ice bath, treated with 1 N HCl (228 mL), then stirred for 1 day. The reaction was extracted with ether (200 mL×3), then the organic layer was reextacted with 1N NaOH (200 mL×3). Acidification of the aqueous exact with 6N HCl to pH 1, reextraction with ether (200 mL×3), drying with MgSO₄ followed by concentration gave 18 g (50%) of the title compound as white solid.

The following boronic acids were prepared similarly.

2-Methylthio-benzeneboronic acid

¹H-NMR (500 MHz, CDCl₃) δ8.01 (d, J=7.8 Hz, 1H), 7.51-7.26 (m, 3H), 6.53 (br, 2H), 2.50 (s, 3H).

2-t-Butylaminosulfonyl-5-fluoro-benzene boronic acid

¹H-NMR (500 MHz, CDCl₃) δ8.01 (dd, J=8.7, 5.1 Hz, 1H), 7.51 (dd, J=8.7, 2.8 Hz, 1H), 7.15 (m, 1H), 5.00 (s, 1H), 1.18 (s, 9H).

2-t-Butylaminosulfonyl-5-methyl-benzeneboronic acid

¹H-NMR (500 MHz, CDCl₃) δ7.92 (d, J=7.8 Hz, 1H), 7.68 (s, 1H), 7.31 (d, J=7.8 Hz, 1H), 5.86 (s, 2H), 4.71 (s, 1H), 2.42 (s, 3H), 1.18 (s, 9H).

### EXAMPLE 9

Preparation of Tin Compounds

Synthesis of 2-tributyltinbenzonitrile

To a solution of 2-bromobenzonitrile (5.0 g, 27.5 mmol) in dry THF (50 mL) and dry ether (5 mL) at −100° C. was added n-BuLi (1.75 M in Hex, 9.88 mL) in 5 minute period, then stirred for 5 min. Tributyltin chloride (9.13 g) was added, and the reaction was stirred for 30 minutes at room temperature. After quenching with water, the reaction was concentrated. Extraction with EA (40 mL×3), drying with MgSO₄ and concentration followed by flash chromatography (Hex: EA=50:1) gave 9.8 g (90%) of the title compound as a colorless oil.

¹H-NMR (500 MHz, CDCl₃) δ7.64 (d, J=7.8 Hz, 1H), 7.54 (d, J=7.4 Hz, 1H), 7.48 (m, 1H), 7.36 (m, 1H), 1.56 (m, 6H), 1.34 (m, 6H), 1.22 (m, 6H), 0.88 (m, 9H).

Synthesis of 3-tributyltin-benzonitrile

To a solution of 3-bromobenzonitrile (9.10 g, 50 mmol) in dry THF (60 mL) and dry ether (12 mL) under N₂ at −100° C. (liquid N₂/ether) was added slowly n-butyl lithium (2.2 M in Hex, 22.7 mL). After 5 minutes, tributyl chloride (14.24 mL, 1.05 equiv) was added and the reaction was stirred for 30 minutes at 0° C. Concentrated to ˜25 mL, the reaction was extracted with hexanes (200 mL), washed with water (100 mL×2), dried (MgSO₄) and concentrated. Flash chromatography with 2% EA in hexanes gave 17.67 g (90%) of the title compound as a yellowish oil.

¹H-NMR (500 MHz, CDCl₃) δ7.71 (dd, J=0.9, 1.0 Hz, 1H), 7.66 (m, 1H), 7.56 (m, 1H), 7.38 (t, J=7.4 Hz, 1H), 1.51 (m, 6H), 1.32 (m, 6H), 1.06 (m, 6H), 0.88 (t, J=7.4 Hz, 9H).

The following organotin intermediates were prepared similarly.

4-Tributyltinbenzonitrile

¹H-NMR (500 MHz, CDCl₃) δ7.56 (s, 4H), 1.51 (m, 6H), 1.31 (m, 6H), 1.08 (m, 6H), 0.88 (t, J=7.3 Hz, 9H).

4-t-Butyloxycarbonylaminophenyl tributylstannane

2-Tributyltin-pyridine

A mixture of 2-bromopyridine (0.57 mL, 6.0 mmol), Mg (360 mg, 15 mmol), 1,2-dibromoethane (0.57 mL, 6.6 mmol), bistributyltin oxide (3.06 g, 6.0 mmol) in dry THF (20 mL) under N₂ was sonicated for 1.5 h at 45° C. Quenching (with water), extraction with EA, drying and concentration followed by flash chromatography gave 1.1 g (50%) of the title compound.

¹H-NMR (500 MHz, CDCl₃) δ8.73 (d, J=5.1 Hz, 1H), 7.48 (td, J=7.3, 1.9 Hz, 1H), 7.39 (dd, J=8.7, 1.4 Hz, 1H), 7.10 (m, 1H), 1.49-1.28 (m, 12H), 0.92-0.86 (m, 15H).

The following organotin intermediates were prepared similarly.

3-Tributyltin-pyridine (yield 92%)

¹H-NMR (500 MHz, CDCl₃) δ8.59 (s, 1H), 8.50 (dd, J=5.1, 2.3 Hz, 1H), 7.73 (m, 1H), 7.21 (m, 1H), 1.53 (m, 6H), 1.33 (m, 6H), 1.10 (m, 6H), 0.88 (t, J=6.9 Hz, 9H).

4-Tributyltin-pyridine (yield 40%)

¹H-NMR (500 MHz, CDCl₃) δ8.47 (d, J=6.0 Hz, 2H), 7.35 (d, J=5.5 Hz, 2H), 1.40-1.30 (m, 12H), 0.95-0.86 (m, 15H).

### EXAMPLE 10

Suzuki Reaction

Synthesis of methyl 4-(2-t-butylaminosulfonylphenyl)-benzoate

A solution of 2-t-butylaminosulfonyl-benzeneboronic acid (250 mg, 0.965 mmol) and methyl 4-bromobenzoate (172 mg, 0.8 mmol) in degassed DME (5 mL) and 2M Na₂CO₃ (1.5 mL) under N₂ was treated with Pd(Ph₃P)₄ (46 mg, 5 mol %), and heated to reflux for 1.5 h. Conventional workup followed by flash chromatography gave the title compound in a quantitative yield.

¹H-NMR (500 MHz, CDCl₃) δ8.18 (d, J=7.8 Hz, 1H), 8.11 (d, J=8.3 Hz, 2H), 7.59-7.50 (m, 4H), 7.29 (d, J=7.3 Hz, 1H), 3.95 (s, 3H), 3.48 (s, 1H), 1.02 (s, 9H).

The following biaryl compounds were prepared similarly.

N-(t-Butyloxycarbonyl)-4-(2-methylthiophenyl)-aniline

¹H-NMR (500 MHz, CDCl₃) δ7.42-7.18 (m, 8H), 6.54 (s, 1H), 2.35 (s, 3H), 1.52 (s, 9H).

4-(2-t-Butylaminosulfonyl-phenyl)-aniline

¹H-NMR (500 MHz, CDCl₃) δ8.14 (dd, J=7.8, 1.4 Hz, 1H), 7.51 (m, 1H), 7.42 (m, 1H), 7.32 (d, J=8.9 Hz, 2H), 7.29 (m, 1H), 6.74 (d, J=8.7 Hz, 2H), 3.81 (br s, 2H), 3.70 (s, 1H), 0.98 (s, 9H).

2-Amino-5-(2-t-butylaminosulfonyl-phenyl)-pyridine

¹H-NMR (500 MHz, CDCl₃) δ8.16 (d, J=7.8 Hz, 1H), 8.07 (d, J=2.3 Hz, 1H), 7.70 (dd, J =8.3, 2.3 Hz, 1H), 7.56 (t, J=7.3 Hz, 1H), 7.47 (t, J=7.8 Hz, 1H), 7.28 (d, J=7.4 Hz, 1H), 6.56 (d, J=8.2 Hz, 1H), 4.56 (br s, 2H), 3.74 (s, 1H), 1.04 (s, 9H).

4-(2-t-Butylaminosulfonyl-5-methyl-phenyl)-aniline

¹H-NMR (500 MHz, CDCl₃) δ8.01 (d, J=7.8 Hz, 1H), 7.31 (d, J=8.3 Hz, 2H), 7.21 (d, J=9.6 Hz, 1H), 7.09 (s, 1H), 6.74 (d, J=8.3 Hz, 2H), 3.79 (br s, 2H), 3.66 (s, 1H), 2.40 (s, 3H), 0.98 (s, 9H).

4-(2-t-Butylaminosulfonyl-5-fluoro-phenyl)-aniline

¹H-NMR (500 Mz, CDCl₃) δ8.14 (dd, J=9.2, 6.0 Hz, 1H), 7.31 (d, J=8.3 Hz, 2H), 7.08 (m, 1H), 6.99 (dd, J=9.2, 2.8 Hz, 1H), 6.74 (d, J=8.7 Hz, 2H), 3.85 (br s, 2H), 3.68 (s, 1H), 0.98 (s, 9H).

Methyl 4-(2-t-butylaminosulfonyl-5-methyl-phenyl)-benzoate

¹H-NMR (500 MHz, CDCl₃) δ8.10 (d, J=8.3 Hz, 2H), 8.05 (d, J=8.3 Hz, 1H), 7.58 (d, J =8.7 Hz, 2H), 7.28 (m, 1H), 7.09 (s, 1H), 3.95 (s, 3H), 3.45 (s, 1H), 2.43 (s, 3H), 1.00 (s, 9H).

Methyl 4-(2-t-butylaminosulfonyl-5-fluoro-phenyl)-benzoate

¹H-NMR (500 MHz, CDCl₃) δ8.19 (dd, J=9.2, 5.5 Hz, 1H), 8.12 (d, J=8.3 Hz, 2H), 7.58 (d, J=8.3 Hz, 2H), 7.16 (m, 1H), 7.01 (dd, J=8.7, 2.3 Hz, 1H), 3.95 (s, 3H), 3.48 (s, 1H), 1.02 (s, 9H).

### EXAMPLE 11

Stille Reaction

Synthesis of 2-(4-t-butoxycarbonylaminophenyl)-benzonitrile

A mixture of 2-tributyltinbenzonitrile (392 mg, 1 mmol), N-(t-butyloxycarbonylamino)-4-bromobenzene (272 mg, 1 mmol), A₂O (231 mg, 1 mmol) and Pd(PPh₃)₄ (58 mg, 5 mol %) in DMF (2 mL) was stirred for 3 h at room temperature. The reaction was filtered through celite, then concentrated. The residue was taken up with EA, washed with water, dried (MgSO₄) and concentrated. Flash chromatography with Hex: EA=1:9 afforded 175 mg (60%) of the title compound.

¹H-NMR (500 MHz, CDCl₃) δ7.74 (d, J=7.8 Hz, 1H), 7.61 (m, 1H), 7.49-7.47 (m, 5H), 7.40 (m, 1H), 6.61 (s, 1H), 1.53 (s, 9H).

The following compounds were prepared similarly.

2-amino-5-(2-cyanophenyl)-pyridine

¹H-NMR (500 MHz, CDCl₃) δ8.24 (s, 1H), 7.75-7.40 (m, 5H), 6.61 (m, 1H), 4.65 (s, 2H).

3-(4-t-Butyloxycarbonylaminophenyl)-pyridine

¹H-NMR (500 MHz, CDCl₃) δ8.81 (d, J=1.8 Hz, 1H), 8.55 (dd, J=4.6, 1.4 Hz, 1H), 7.83 (dt, J=8.3, 1.8 Hz, 1H), 7.52 (d, J=8.7 Hz, 2H), 7.47 (d, J=8.7 Hz, 2H), 7.33 (dd, J=7.8, 5.1 Hz, 1H), 6.58 (s, 1H), 1.53 (s, 9H).

N-(t-butyloxycarbonyl)-4-(2-methanesulfonylphenyl)-aniline

¹H-NMR (500 MHz, DMSO-d₆) δ9.53 (s, 1H), 8.08 (d, J=7.8 Hz, 1H), 7.64 (t, J=7.8 Hz, 1H), 7.53 (d, J=8.7 Hz, 2H), 7.38 (d, J=7.4 Hz, 1H), 7.30 (d, J=8.2 Hz, 2H), 2.78 (s, 3H), 1.50 (s, 9H).

Methyl 4-(2-cyanophenyl)-benzoate

¹H-NMR (500 MHz, CDCl₃) δ8.16 (d, J=8.3 Hz, 2H), 7.79 (d, J=7.8 Hz, 1H), 7.67 (m, 1H), 7.63 (d, J=8.7 Hz, 2H), 7.53 (d, J=7.3 Hz, 1H), 7.49 (m, 1H), 3.95 (s, 3H).

N-t-butoxycarbonyl 4-(2-cyanophenyl)-aniline

¹H-NMR (500 MHz, CDCl₃) δ7.74 (d, J=7.8 Hz, 1H), 7.61 (m, 1H), 7.49-7.47 (m, 5H), 7.40 (m, 1H), 6.61 (s, 1H), 1.53 (s, 9H).

### EXAMPLE 12

Transformations after Biarycoupling (Hydrolysis, Removal of Boc Group and t-butyl Group)

a) Hydrolysis:

The following carboxylic acids were prepared by conventional hydrolysis of the corresponding ester.

4-(2-t-Butylaminosulfonyl-5-methyl-phenyl)-benzoic acid

¹H-NMR (500 MHz, CDCl₃) δ8.08 (d, J=8.3 Hz, 1H), 7.99 (d, J=8.3 Hz, 2H), 7.47 (d, J =8.3 Hz, 2H), 7.30 (d, J=8.3 Hz, 1H), 7.05 (s, 1H), 5.86 (s, 1H), 2.43 (s, 3H), 1.17 (s, 9H).

4-(2-t-Butylaminosulfonylphenyl)-benzoic acid

¹H-NMR (500 MHz, CDCl₃) δ8.21 (1H), 8.00 (2H), 7.60-7.35 (m, 5H), 5.92 (1H), 1.17 (s, 9H).

4-(2-t-Butylaminosulfonyl-5-fluoro-phenyl)-benzoic acid

¹H-NMR (500 MHz, CDCl₃) δ8.23 (dd, J=9.2 Hz, 5.5 Hz, 1H), 7.99 (d, J=8.3 Hz, 2H), 7.45 (d, J=8.3 Hz, 2H), 7.19 (m, 1H), 6.97 (dd, J=8.7, 2.8 Hz, 1H), 6.25 (s, 1H), 1.21 (s, 9H).

4-(2-Cyanophenyl)-benzoic acid

¹H-NMR (500 MHz, DMSO-d₆) δ8.08 (d, J=8.3 Hz, 2H), 7.99 (d, J=7.8 Hz, 1H), 7.82 (m, 1H), 7.71 (d, J=8.3 Hz, 2H), 7.68 (d, J=7.8 Hz, 1H), 7.63 (m, 1H).

b) Removal of Boc Group

4-(2-Cyanophenyl)-aniline

The above compound was obtained by treating N-t-butoxycarbonyl 4-(2-cyanophenyl)-aniline with TFA/CH₂Cl₂.

¹H-NMR (500 MHz, CDCl₃) δ7.70 (d, J=7.8 Hz, 1H), 7.58 (m, 1H), 7.46 (d, J=7.8, 1H), 7.38 (d, J=8.3 Hz, 2H), 7.34 (t, J=7.4 Hz, 1H), 6.76 (d, J=8.7 Hz, 2H), 3.47 (br s, 2H).

c) Removal of N-t-butyl group in Sulfonamide.

t-Butyl groups in t-butylaminosulfonyl moieties were removed with treatment of 100% trifluoroacetic acid for 20 h.

Not only the simple biaryl type t-butylaminosulfonyl groups but also more complex, advanced intermediates having the same groups could be treated similarly. In most cases the deprotected compounds were not characterized, being used directly in the next steps.

The following compounds were prepared similarly.

4-(2-aminosulfonylphenyl)-benzoic acid

¹H-NMR (500 MHz, DMSO-d₆) δ8.05 (d, J=7.4 Hz, 1H), 7.95 (d, J=8.3 Hz, 2H), 7.67-7.60 (m, 3H), 7.49 (d, J=8.3 Hz, 2H), 7.34-7.31 (m, 3H).

4-(2-aminosulfonyl-5-methyl-phenyl)-benzoic acid

¹H-NMR (500 MHz, DMSO-d₆) δ7.93 (m, 3H), 7.48 (d, J=8.3 Hz, 2H), 7.41 (d, J=8.3 Hz, 1H), 7.21 (s, 2H), 7.14 (s, 1H), 2.39 (s, 3H).

### EXAMPLE 13

Transformations after Biarylcoupling (mCPBA Oxidation to Sulfone, Degradation, etc.)

a) mCPBA Oxidation

The following sulfones were prepared by standard mCPBA oxidation of the corresponding sulfides.

4-[2-methanesulfonyl-(1,3,4)-triazole-1-yl]-phenyl cis-2-(3-cyanophenyl)-cyclopropane-1-carboxamide

¹H-NMR (500 MHz, DMSO-d₆) δ10.54 (s, 1H), 9.01 (s, 1H), 7.70 (s, 1H), 7.61 (m, 4H), 7.49-7.42 (m, 3H), 3.14 (s, 3H), 2.69 (m, 1H), 2.34 (m, 1H), 1.72 (m, 1H), 1.41 (m, 1H).

N-(t-butyloxycarbonyl)-4-(2-methanesulfonylphenyl)-aniline

The title compound were prepared by known method. (WO 98/28282)

b) Degradation

2-(3-cyanophenyl)-aniline

The above compound was obtained from Curtius reaction of 2-(3-cyanophenyl)-benzoic acid followed by hydrolysis.

¹H-NMR (500 MHz, CDCl₃) δ7.77 (t, J=1.4 Hz, 1H), 7.72 (m, 1H), 7.63 (m, 1H), 7.54 (dd, J=7.8, 7.4 Hz, 1H), 7.20 (m, 1H), 7.07 (m, 1H), 6.84 (m, 1H), 6.78 (d, J=7.8 Hz, 1H), 3.69 (br, 2H).

### EXAMPLE 14

Synthesis of 1-(4-aminophenyl)-2-methylthio-1,3,4)-triazole dihydrochloride

a) Synthesis of 4-acetylaminophenylthiocyanate

A solution of 4-acetylaminoaniline (20 g, 0.133 mol) in dry THF (400 mL) at 0° C. was treated with Et₃N (42.5 mL, 2.3 equiv), then with CS₂ (9.6 mL, 1.2 equiv) dropwise. After stirring for 2 days at room temperature, the reaction was recooled to 0° C., then treated ClCO₂Et (xx mL, xx equiv) dropwise. The mixture was stirred for 4 h at room temperature, then concentrated. Conventional workup followed by trituration in THF-ether gave 21.7 g (84.3%) of the title compound.

b) Synthesis of 1-(4acetylaminophenyl)-2-mercapto-1,3,4)-triazole

A solution of 4-acetylaminophenylthiocyarate (4.93 g, 25.6 mmol) and formhydrazide (1.61 g, 1.05 equiv) in THF (50 mL) was refluxed for 1 h (TLC analysis), then concentrated. To the residue were added water (80 mL) and KOH (2.2 g, 1.3 equiv), then heated to 90-100° C. for 1 h. After cooling to 0° C., the mixture was treated slowly with 1N-HCl (35 mL), then stirred for 30 minutes at 0° C. Filtration of the solid followed by drying under N₂ stream gave 5.63 g (93.6%) of the title compound.

¹H-NMR (500 MHz, DMSO-d₆) δ10.19 (s, 1H), 8.66 (s, 1H), 7.71 (d, J=9.2 Hz, 2H), 7.54 (d, J=9.2 Hz, 2H), 2.08 (s, 3H).

c) Synthesis of 1-(4-acetylaminophenyl)-2-methylthio-(1,3,4)-triazole

A solution of 1-(4-acetylaminophenyl)-2-mercapto-1,3,4)-triazole (4.66 g, 20.0 mmol) in DMF (30 mL) was treated slowly with CH₃I (1.36 mL, 1.1 equiv), and stirred for 1 h. After concentration, the residue was neutralized with 1N-NaOH. Filtration followed by drying gave 4.05 g (81.6%) of the title compound.

¹H-NMR (500 MHz, DMSO-d₆) δ10.23 (s, 1H), 8.79 (s, 1H), 7.74 (d, J=8.7 Hz, 2H), 7.41 (d, J=8.7 Hz, 2H), 2.60 (s, 3H), 2.08 (s, 3H).

d) Synthesis of 1-(4-aminophenyl)-2-methylthio-(1,3,4)-triazole dihydrochloride

A mixture of of 1-(4-acetylaminophenyl)-2-methylthio-1,3,4)-triazole (3.62 g, 14.6 mmol) in 2N-HCl (100 mL) was refluxed for 15 h, then concentrated. Trituration of the residue in THF-ether gave 3.66 g (13.1 mmol, 90%) of the title compound.

¹H-NMR (500 MHz, DMSO-d₆) δ9.08 (s, 1H), 7.46 (m, 2H), 7.26 (m, 2H), 2.64 (s, 3H).

### EXAMPLE 15

Synthesis of 1-(4-aminophenyl)-2-methylthio-imidazole dihydrochloride

a) Synthesis of N1-(2,2-methylethyl)-N3-(4-acethylaminophenyl)-thiourea and 1-(4-aminophenyl)-2-mercapto-imidazole

A solution of 4-acetylaminophenylthiocyanate (1.92 g, 10 mmol) and 2,2-dimethoxyethylamine (1.2 mL, 1.1 equiv) in THF (30 mL) was refluxed for 1 h, then concentrated (NMR A). The residue in 3N-HCl (120 mL) was refluxed for 1.5 h. After concentration, the residue was triturated in dry ether to give 2.16 g (95%) of the desired imidazole (NMR B).

¹H-NMR of A (500 MHz, DMSO-d₆) δ9.92 (s, 1H), 9.54 (br s, 1H), 7.51 (m, 3H), 7.30 (d, J=9.2 Hz, 2H), 4.55 (m, 1H), 3.60 (m, 1H), 3.31 (s, 6H), 2.02 (s, 3H).

¹H-NMR of B (500 MHz, DMSO-d₆) δ12.45 (br s, 1H), 7.71 (d, J=8.2 Hz, 2H), 7.43 (d, J =8.7 Hz, 2H), 7.31 (s, 1H), 7.10 (s, 1H).

b) Synthesis of 1-(4-aminophenyl)-2-methylthio-imidazole

A solution of 1-(4-aminophenyl)-2-mercapto-imidazole dihydrochloride (2.16 g, 9.5 mmol) in DMF (20 mL) was treated slowly with CH3I (0.95 mL, 1.2 equiv). After stirring for 1 h at room temperature, the reaction was neutralized with Et₃N, the concentrated. Flash chromatography gave 1.17 g (5.7 mmol, 60%) of the title compound.

¹H-NMR (500 MHz, DMSO-d₆) δ7.95 (d, J=2.3 Hz, 1H), 7.88 (d, J=1.9 Hz, 1H), 7.50 (d, J=8.7 Hz, 2H), 7.25 (d, J=8.3 Hz, 2H), 2.75 (s, 3H).

### EXAMPLE 16

Coupling of Diastereomeric Cyclopropanecarboxylic Acid with Amine

Synthesis of 3-cyanobenzyl cis-2-(3-cyanophenylcyclopropane-1-carboxamide (more polar isomer) and 3-cyanobenzyl trans-2-(3-cyanophenylcyclopropane-1-carboxamide (less polar isomer)

A solution of diastereomeric 2-(3-cyanophenyl)-cyclopropane-1-carboxylic acid (284 mg, 1.52 mmol) in DMF (3 mL) at 0° C. was treated sequentially with diisopropylethylamine (0.8 mL, 4.56 mmol), HOBt (307 mg, 2.28 mmol) and EDC (436 mg, 2.28 mmol). After 10 min at 0° C., 3-cyanobenzylamine hydrochloride (280 mg, 2.28 mmol) was added and the mixture was stirred for 15 h at room temperature. The volatiles were removed in high-vacuum rotary evaporator and the residue was worked up as usual. Column chromatography afforded trans compound (170 mg, 0.503 mmol) and cis compound (170 mg, 0.503 mmol) (total yield=70%)

cis isomer: ¹H-NMR (500 MHz, CDCl₃) δ7.51-7.25 (m, 8H), 6.08 (m, 1H), 4.41 (m, 1H), 4.18 (m, 1H), 2.50 (m, 1H), 1.99 (m, 1H), 1.82 (m, 1H), 1.38 (m, 1H).

trans isomer: ¹H-NMR (500 MHz, CDCl₃) δ7.58-7.33 (m, 8H), 6.06 (m, 1H), 4.58-4.46 (m, 2H), 2.58 (m, 1H), 1.74-1.64 (m, 2H), 1.30 (m, 1H).

### EXAMPLE 17

Synthesis of 4-(2-t-butylaminosulfonylphenyl)-phenyl trans-2-(3-cyanophenyl)-cyclopropane-1-carboxamide and 4-(2-t-butylaminosulfonylphenyl)-phenyl cis-2-(3-cyanophenyl)-cyclopropane-1-carboxamide

A solution of 2-(3-cyanophenyl)-cyclopropane-1-carboxylic acid (150 mg, 0.801 mmol) in ethylene dichloride (10 mL) was treated with thionyl chloride (0.59 mL, 10 eq) and heated to reflux for 3 h, then concentrated. The crude acid chloride dissolved in dry CH₂Cl₂ was reacted with 4-(2-t-butylaminiosulfonylphenyl) aniline (256 mg, 1.05 eq) in the presence of diisopropylethylamine (0.70 mL, 5 eq). Conventional workup followed by flash chromatography (Hex: EA=3:1) gave 168 mg (44%) of cis product and 178 mg (47%) of the trans product.

trans isomer: ¹H-NMR (500 MHz, CDCl₃) δ8.15 (d, J=8.3 Hz, 1H), 8.06 (s, 1H), 7.65 (d, J =7.8 Hz, 2H), 7.56 (m, 1H), 7.50-7.45 (m, 4H), 7.39 (m, 3H), 7.30 (d, J=7.8 Hz, 1H), 3.62 (s, 1H), 2.63 (m, 1H), 1.96 (m, 1H), 1.77 (m, 1H), 1.33 (m, 1H), 1.00 (s, 9H).

cis isomer: ¹H-NMR (500 MHz, CDCl₃) δ8.15 (d, J=7.8 Hz, 1H), 7.97 (s, 1H), 7 56-7.32 (m, 10H), 7.27 (d, J=7.8 Hz, 1H), 3.61 (s, 1H), 2.54 (m, 1H), 2.19 (m, 1H), 1.83 (m, 1H), 1.43 (m, 1H), 0.98 (s, 9H).

The following intermediates were synthesized similarly.

4-(2-t-butylaminosulfonyl-5-methyl-phenyl)-phenyl trans-2-(3cyanophenyl)-cyclopropane-1-carboxamide (less polar isomer)

¹H-NMR (500 MHz, CDCl₃) δ8.02 (d, J=7.8 Hz, 1H), 7.97 (s, 1H), 7.63 (d, J=8.7 Hz, 2H), 7.51 (m, 1H), 7.46 (d, J=8.7 Hz, 2H), 7.40 (m, 3H), 7.26 (m, 1H), 7.10 (s, 1H), 3.59 (s, 1H), 2.63 (m, 1H), 2.42 (s, 3H), 1.93 (m, 1H), 1.77 (m, 1H), 1.34 (m, 1H), 1.00 (s, 9H).

4-(2-t-butylaminosulfonyl-5-methyl-phenyl)-phenyl cis-2-(3-cyanophenyl)-cyclopropane-1-carboxamide (more polar isomer)

¹H-NMR (500 MHz, CDCl₃) δ8.01 (d, J=7.8 Hz, 1H), 7.87 (br s, 1H), 7.56 (s, 1H), 7.51 (d, J=8.3 Hz, 1H), 7.47-7.43 (m, 3H), 7.37-7.33 (m, 3H), 7.24 (m, 1H), 7.07 (s, 1H), 3.58 (s, 1H), 2.56 (m, 1H), 2.40 (s, 3H), 2.17 (m, 1H), 1.85 (m, 1H), 1.43 (m, 1H), 0.98 (s, 9H).

4-(2-cyanophenyl)-phenyl cis-2-(3-cyanophenyl)-cyclopropane-1-carboxamide

¹H-NMR (500 MHz, CDCl₃) δ7.73 (d, J=7.8 Hz, 1H), 7.72 (m, 3H), 7.53-7.34 (m, 9H), 2.57 (m, 1H), 2.12 (m, 1H), 1.86 (m, 1H), 1.45 (m, 1H).

4-(2-methanesulfonylphenyl)-phenyl cis-2-(3-cyanophenyl)-cyclopropane-1-carboxamide

¹H-NMR (500 MHz, CDCl₃) δ8.21 (dd, J=8.3, 1.4 Hz, 1H), 7.84 (s, 11), 7.63 (m, 1H), 7.56-7.51 (m, 3H), 7.48-7.42 (m, 3H), 7.37-7.32 (m, 4H), 2.65 (s, 3H), 2.56 (m, 1H), 2.14 (m, 1H), 1.85 (m, 1H), 1.45 (m, 1H).

4-[2-methylthio-(1,3,4)-triazole-1-yl]-phenyl cis-2-(3-cyanophenyl)-cyclopropane-1-carboxamide

¹H-NMR (500 MHz, DMSO-d₆) δ10.49 (s, 1H), 8.73 (s, 1H), 7.69 (s, 1H), 7.62-7.57 (m, 4H), 7.43 (t, J=7.8 Hz, 1H), 7.33 (d, J=7.8 Hz, 2H), 2.65 (m, 1H), 2.58 (s, 3H), 2.32 (m, 1H), 1.71 (m, 1H), 1.40 (m, 1H).

### EXAMPLE 18

Synthesis of 4-(2-aminosulfonylphenyl)-phenyl cis-2-(3-cyanophenyl)-cyclopropane-1-carboxamide (TFA treatment)

4-(2-t-butylaminosulfonylphenyl)-phenyl cis-2-(3-cyanophenyl)-cyclopropane-1-carboxamide (100 mg) was treated with 100% TFA (7 ml) for ˜6 h to give the title compound.

¹H-NMR (500 MHz, CDCl₃) δ8.13 (d, J=7.8 Hz, 1H), 7.80 (s, 1H), 7.59-7.26 (m, 11H), 4.36 (br, 2H), 2.65 (m, 1H), 2.19 (m 1H), 1.88 (m, 1H), 1.51 (m, 1H).

### EXAMPLE 19

Lactone Opening with Amine

4-(2-cyanophenyl)-phenyl [1,2]-cis-[2,3]-cis-2-(3-cyanophenyl)-3-hydroxymethyl-cyclopropane-1-carboxamide

To a solution of diisopropylamine (62 mg, 1.25 eq) in dry THF (5 mL) at −78° C. was added n-BuLi (2.31 M, 0.255 mL) and stirred for 5 minutes. A solution of 4-(2-cyanophenyl)-aniline (105 mg, 1.1 eq) in dry THF (4 mL) was added to the LDA solution. To the reaction was added slowly a solution of cis, cis-2-(3-cyanophenyl)-3-hydroxymethyl-cyclopropane-1-carboxylic acid lactone (98 mg, 0.492 mmol) in dry THF (5 mL), the resulting solution was stirred for 30 minutes at −78° C. Saturated ammonium chloride (1 mL) was added, and the reaction was allowed to warm up to room temperature. Additional saturated ammonium chloride (10 mL) was added. Conventional workup (extraction with EA, 10 mL×3) followed by flash chromatography (Hex: EA=1:1) gave 109 mg (56.5%) of the title compound.

¹H-NMR (500 MHz, CDCl₃) δ8.33 (s, 1H), 7.75 (d, J=7.8 Hz, 1H), 7.65-7.58 (m, 4H), 7.52-7.48 (m, 5H), 7.44-7.37 (m, 2H), 4.13 (m, 1H), 3.84 (m, 1H), 2.77 (m, 1H), 2.23 (m, 1H), 2.03 (m, 1H).

<Pyrrole Part>

### EXAMPLE 20

Ethyl 4-(3-cyanophenyl)-2-butenoate and its 3-butenoate isomer

A catalyst solution was prepared by stirring Pd (dba)₂ (267 mg, 3 mol %) and triphenylphosphine (243 mg, 6 mol %) in dry THF (25 mL) under N₂ for 5 min at room temperature. To the catalyst solution was added ethyl 4-bromocrotonate (2.14 mL, 15.5 mmol) and 3-cyanophenyltributyltin (6.10 g, 1.0 eq) in dry THF (25 mL). After refluxing for 48 h, the reaction was concentrated. The residue was dissolved in ether (60 mL) and water (60 mL), treated with KF (20 g), stirred for 30 min. After filtering of the solid formed, the filterate was worked up as usual. Flash chromatography 2→4→6% ethyl acetate in hexanes gave 2.140 g (62%) of the title compounds as mixture.

¹H-NMR (500 MHz, CDCl₃) of Ethyl 4-(3-cyanophenyl)-2-butenoate δ7.54 (m, 1H), 7.46-7.41 (m, 3H), 7.02 (dt, J=15.6, 6.9 Hz, 1H), 5.80 (dt, J=15.6, 1.9 Hz, 1H), 4.20 (q, J=6.9 Hz, 2H), 3.55 (dd, J=6.9, 1.9 Hz, 2H), 1.28 (t, J=6.9 Hz, 3H).

¹H-NMR (500 MHz, CDCl₃) of Ethyl 4-(3-cyanophenyl)-3-butenoate δ7.52-7.46 (m, 3H), 7.39 (t, J=7.8 Hz, 1H), 6.27 (dt, J=7.8, 11.0 Hz, 1H), 5.91 (dt, J=11.5, 1.9 Hz, 1H), 4.21 (q, J=7.4 Hz, 2H), 4.05 (dd, J=7.8, 1.4 Hz, 2H), 1.31 (t, J=7.3 Hz, 3H).

The following compounds were prepared similarly.

Ethyl 4-(4-cyanophenyl)-2-butenoate and its 3-butenoate isomer.

### EXAMPLE 21

Ethyl 3-(3-cyanophenyl) acrylate

Conventional Wittig reaction of 3-cyanobenzaldehyde and triethylphosphonoacetate (NaH, THF, LiCl, RT) afforded the title compound (>90%).

¹H-NMR (500 MHz, CDCl₃) δ7.78 (s, 1H), 7.73 (d, J=7.8 Hz, 1H), 7.66-7.62 (m, 2H), 7.51 (t, J=7.8 Hz, 1H), 6.48 (d, J=16.1 Hz, 1H), 4.28 (q, J=6.9 Hz, 2H), 1.34 (t, J=6.9 Hz, 3H).

The following compound was prepared similarly.

Ethyl 3-(4-cyanophenyl) acrylate

¹H-NMR (500 MHz, CDCl₃) δ7.78 (s, 1H), 7.73 (d, J=7.8 Hz, 1H), 7.65 (m, 1H), 7.63 (d, J=16.0 Hz, 1H), 7.50 (t, J=7.8 Hz, 1H), 6.48 (d, J=16.1 Hz, 1H), 4.27 (q, J=6.9 Hz, 2H), 1.33 (t, J=6.9 Hz, 3H).

### EXAMPLE 22

Ethyl 4-[3-cyanobenzyl]-pyrrole-3-carboxylate

A solution of ethyl 4-(3-cyanophenyl)-2-butenoate and ethyl 4-(3-cyanophenyl)-3-butenoate mixture (2.13 g, 9.90 mmol) and TOSMIC (2.15 g, 10 mmol) in dry THF (50 mL) under N₂ was treated with NaH (440 mg, 11 mmol, 60% dispersion in mineral oil). After stirring for 1 h at room temperature, the reaction was concentrated. Usual workup followed by flash chromatography (25% ethyl acetate in hexanes) gave the title compound (1.80 g, 62%).

¹H-NMR (500 MHz, CDCl₃) δ8.44 (br, 1H), 7.49-7.42 (m, 4H), 7.34 (m, 1H), 6.45 (d, J =2.3 Hz, 1H), 4.20 (q, J=6.9 Hz, 2H), 4.12 (s, 2H), 1.25 (t, J=6.9 Hz, 3H).

The following pyrrole intermediates were prepared similarly.

Ethyl 4-[4-cyanobenzyl]-pyrrole-3-carboxylate

¹H-NMR (500 MHz, CDCl₃) δ8.36 (br, 1H), 7.54 (d, J=8.3 Hz, 2H), 7.43 (m, 1H), 7.32 (d, J=8.3 Hz, 2H), 6.45 (s, 1H), 4.20 (q, J=6.9 Hz, 2H), 4.15 (s, 2H), 1.24 (t, J=6.9 Hz, 3H).

Ethyl 4-benzyl-pyrrole-3-carboxylate

¹H-NMR (500 MHz, CDCl₃) δ8.28 (br s, 1H), 7.41 (s, 1H), 7.25-7.17 (m, 5H), 6.32 (s, 1H), 4.23 (q, J=6.9 Hz, 2H), 4.10 (s, 2H), 1.27 (t, J=6.9 Hz, 3H).

Ethyl 4-[4-methoxycarbonylbenzyl]-pyrrole-3-carboxylate

¹H-NMR (500 MHz, CDCl₃) δ8.31 (br, 1H), 7.93 (d, J=8.3 Hz, 2H), 7.42 (m, 1H), 7.29 (d, J=8.3 Hz, 2H), 6.38 (s, 1H), 4.21 (q, J=6.9 Hz, 2H), 4.15 (s, 2H), 3.89 (s, 3H), 1.26 (t, J=6.9 Hz, 3H).

Ethyl 4-[4-bromophenyl]-pyrrole-3-carboxylate

¹H-NMR (500 MHz, CDCl₃) δ8.62 (br, 1H), 7.47-7.44 (m, 3H), 7.36 (d, J=8.7 Hz, 2H), 6.74 (pseudo t, J=2.8, 2.3 Hz, 1H), 4.22 (q, J=6.9 Hz, 2H), 1.26 (t, J=6.9 Hz, 3H).

Ethyl 4-[3-bromophenyl]-pyrrole-3-carboxylate

¹H-NMR (500 MHz, CDCl₃) δ8.64 (br, 1H), 7.63 (t, J=1.8 Hz, 3H), 7.49 (m, 1H), 7.43-7.38 (m, 2H), 7.20 (pseudo t, J=8.3, 7.8 Hz, 1H), 6.77 (pseudo t, J=2.8, 2.3 Hz, 1H), 4.22 (q, J=6.9 Hz, 2H), 1.26 (t, J=6.9 Hz, 3H).

Ethyl 4-[4-(2-imidazoline-2-yl)-benzyl]-pyrrole-3-carboxylate

¹H-NMR (500 MHz, DMSO-d₆) δ11.24 (br, 1H), 7.68 (d, J=7.8 Hz, 2M), 7.35 (s, 1H), 7.21 (d, J=7.8 Hz, 2H), 6.54 (s, 1H), 4.10 (q, J=6.9 Hz, 2H), 4.00 (s, 2H), 3.57 (s, 4H), 1.16 (t, J=6.9 Hz, 3H).

### EXAMPLE 23

1-(4-cyanophenyl)-2-propen-1-ol

To a solution of 4-cyanobenzaldehyde (10.5 g, 80 mmol) in dry THF (120 mL) under N₂ at −78° C. was added vinyl magnesium bromide (100 mL, 1.0M in THF, 1.25 eq) slowly. After addition, the reaction was stirred for ˜1 h at −50° C.˜−60° C. The reaction was quenched by addition of 6N HCl (25 mL), then concentrated. Usual workup followed by column chromatography with (Hex: EA=8:1-4:1) gave the title compound (10.2 g, 80%).

¹H-NMR (500 MHz, CDCl₃) δ7.63 (d, J=8.7 Hz, 2H), 7.48 (d, J=8.7 Hz, 2H), 5.96 (m, 1H), 5.37 (d, J=17.0 Hz, 1H), 5.27-5.22 (m, 2H).

The following compounds were similarly prepared.

1-(4methoxycarbonylphenyl)-2-propen-1-ol

¹H-NMR (500 MHz, CDCl₃) δ8.01 (d, J=8.3 Hz, 2H), 7.44 (d, J=8.3 Hz, 2H), 6.01 (m, 1H), 5.36 (d. J=17.0 Hz, 1H), 5.26-5.21 (m, 2H), 3.90 (s, 3H).

1-(3-Cyanophenyl)-2-propen-1-ol

### EXAMPLE 24

3-(4-cyanophenyl)-1-chloro-2-propene

A solution of 1-(4-cyanophenyl)-2-propen-1-ol (10.2 g, 64 mmol) in ethylene dichloride (70 mL) was treated with SOCl₂ (22.8 g, 3.0 eq), and the mixture was heated to 85° C. for 2 h. After concentration, usual workup (extraction with 10:1 hexanes/ethyl acetate) followed by flash chromatography (Hex: EA=10 1) gave the title compound (10.6 g, 93%).

¹H-NMR (500 MHz, CDCl₃) δ7.61 (d, J=8.3 Hz, 2H), 7.47 (d, J=8.3 Hz, 2H), 6.67 (d, J =15.6 Hz, 1H), 6.43 (dt, J=15.6, 6.9 Hz, 1H), 4.24 (d, J=6.9 Hz, 2H).

The following intermediates were prepared similarly.

3-(4-methoxycarbonylphenyl)-1-chloro-2-propene

¹H-NMR (500 MHz, CDCl₃) δ8.01 (d, J=8.3 Hz, 2H), 7.44 (d, J=8.3 Hz, 2H), 6.68 (d, J =15.6 Hz, 1H), 6.42 (m, 1H), 4.24 (d, J=6.9 Hz, 2H), 3.91 (s, 3H).

3-(3-Cyanophenyl)-1-chloro-2-propene

### EXAMPLE 25

Ethyl 4-(4-cyanophenyl)-3-butenoate

A solution of 3-(4-cyanophenyl)-1-chloro-2-propene (10.6 g, 60 mmol), Pd (OAc)₂(134 mg, 1 mol %) and K₂CO₃ (14.4 g, 3.0 eq) in EtOH (65 mL) was prepared. CO (g) was slowly bubbled into the solution for 3 h. After filtration (celite), concentration followed by flash chromatography (Hex: EA=8:1) gave the title compound (10.9 g, 85%).

¹H-NMR (500 MHz, CDCl₃) δ7.59 (d, J=8.3 Hz, 2H), 7.44 (d, J=8.3 Hz, 2H), 6.50 (d, J =16.1 Hz, 1H), 6.44 (dt, J=16.1, 6.4 Hz, 1H), 4.18 (q, J=6.9 Hz, 2H), 3.27 (d, J=6.0 Hz, 2H), 1.28 (t, J=6.9 Hz, 3H).

The following intermediates were prepared similarly.

Ethyl 4-(4-methoxycarbonylphenyl)-3-butenoate

¹H-NMR (500 MHz, CDCl₃) δ7.97 (d, J=8.3 Hz, 2H), 7.42 (d, J=8.3 Hz, 2H), 6.52 (d, J =16.1 Hz, 1H), 6.42 (dt, J=16.1, 6.9 Hz, 1H), 4.18 (q, J=6.9 Hz, 2H), 3.89 (s, 3H), 3.26 (dd, J=7.4, 1.4 Hz, 2H), 1.28 (t, J=6.9 Hz, 3H).

Ethyl 4-(3-cyanophenyl)-3-butenoate

### EXAMPLE 26

Synthesis of 3-bromomethyl-4-t-butyloxy-benzonitrile

a) 3-methyl-4-hydroxy-benzonitrile

A mixture of 4-iodo-2-methylphenol (10.0 g, 42.7 mmol) and CuCN (4.2 g, 1.1 eq) in degased DMF (50 mL) was refluxed for 2 h. After cooling, the mixture was filtered through celite and the filtrate was concentrated. Extractive workup with ethyl acetate gave 5.6 g (98%) of the title compound as a brownish solid, which was used directly in next step.

¹H-NMR (500 MHz, CDCl₃) δ7.42 (d, J=1.0 Hz, 1H), 7.39 (d, J=8.3 Hz, 1H), 7.04 (d, J =8.3 Hz, 1H), 2.20 (s, 3H).

b) 3-methyl-4-t-butyloxy-benzonitrile

A solution of 3-methylhydroxy-benzonitrile (1.44 g, 10.8 mmol) in solvent (CH₂Cl₂: cyclohexane 1:2, 60 mL) was treated with t-butyl trichloroimmidate (8.65 g, 4.0 eq) (Ref: Tetrahedron Letter, 29, 2483, 1988). To the solution was added BF₃OEt₂ (200 uL) and the resulting solution was stirred overnight. Conventional workup followed by flash chromatography gave 0.96 g of 3-methyl-4-hydroxy-benzonitrile and 0.64 g (31%) of the title compound.

¹H-NMR (500 MHz, CDCl₃) δ7.43 (s, 1H0, 7.39 (d, J=8.7 Hz, 1H), 7.04 (d, J=8.3 Hz, 1H), 2.20 (s, 3H), 1.45 (s, 9H).

c) 3-bromomethyl-4-t-butyloxy-benzonitrile

A solution of 3-methyl-4-t-butyloxy-benzonitrile (4.44 g, 23.5 mmol), AIBN (30 mg) and NBS (4.18 g, 1.0 eq) in CCl₄ (200 mL) was refluxed for 3 h. Filtering off the resulting succinimide, concentration of the filterate followed by flash chromatography gave 2.9 g (46%) of the title compound.

¹H-NMR (500 MHz, CDCl₃) δ7.63 (d, J=1.9 Hz, 1H), 7.50 (dd, J=8.3, 1.9 Hz, 1H), 7.10 (d, J=8.3 Hz, 1H), 4.44 (s, 2H), 1.54 (s, 9H).

### EXAMPLE 27

N-Alkylation of Pyrrole

Ethyl 4-benzyl-1-(4-cyanobenzyl)-pyrrole-3-carboxylate

A solution of ethyl 4-benzyl-pyrrole-3-carboxylate (119 mg, 0.524 mmol) in dry THF (3 mL) under N₂ at 0° C. was treated with NaH (24 mg, 0.60 mmol). After 10 min, a solution of 4-cyanobenzylbromide (113 mg, 0.576 mmol) in dry THF (1 mL) was added slowly therein and the solution was stirred for 3 h at 0° C. Extractive workup followed by flash chromatography gave 173 mg (96%) of the title compound.

¹H-NMR (500 MHz, CDCl₃) δ7.61 (d, J=8.3 Hz, 2H), 7.29-7.13 (m, 8H), 6.28 (d, J=2.3 Hz, 1H), 5.01 (s, 2H), 4.23 (q, J=6.9 Hz, 2H), 4.08 (s, 2H), 1.27 (t, J=6.9 Hz, 3H).

The following compounds were prepared similarly.

Ethyl 4-benzyl-1-(3-cyanobenzyl)-pyrrole-3-carboxylate

¹H-NMR (500 MHz, CDCl₃) δ7.59 (d, 1H), 7.44 (m, 1H), 7.35-7.18 (m, 8H), 6.17 (d, J=2.3 Hz, 1H), 4.98 (s, 2H), 4.23 (q, J=6.9 Hz, 2H), 4.08 (s, 2H), 1.28 (t, J=6.9 Hz, 3H).

Ethyl 4-(3-cyanobenzyl)-1-benzyl-pyrrole-3-carboxylate

¹H-NMR (500 MHz, CDCl₃) δ7.47-7.43 (m, 3H), 7.37-7.29 (m, 5H), 7.13 (d, J=7.8 Hz, 2H), 6.33 (d, J=2.3 Hz, 1H), 4.99 (s, 2H), 4.17 (q, J=6.9 Hz, 2H), 4.08 (s, 2H), 1.24 (t, J=6.9 Hz, 3H).

Ethyl 4-(4-cyanobenzyl)-1-benzyl-pyrrole-3-carboxylate

¹H-NMR (500 MHz, CDCl₃) δ7.53 (d, J=8.3 Hz, 2H), 7.36-7.29 (m, 6H), 7.12 (d, J=8.3 Hz, 2H), 6.32 (d, J=2.3 Hz, 1H), 4.98 (s, 2H), 4.18 (q, J=6.9 Hz, 2H), 4.11 (s, 2H), 1.23 (t, J =6.9 Hz, 3H).

Ethyl 4-(4-acetylamino-benzyl)-1-(3-cyanobenzyl)-pyrrole-3-carboxylate

¹H-NMR (500 MHz, CDCl₃) δ7.58 (d, J=7.8 Hz, 1H), 7.44 (m, 1H), 7.37 (d, J=8.3 Hz, 2H), 7.33 (s, 1H), 7.30 (d, J=7.8 Hz, 1H), 7.27 (d, J=2.3 Hz, 1H), 7.18-7.16 (m, 3H), 6.16 (s, 1H), 4.98 (s, 2H), 4.23 (q, J=6.9 Hz, 2H), 4.03 (s, 2H), 2.14 (s, 3H), 1.28 (t, J=6.9 Hz, 3H).

Ethyl 4-(4-methoxycarbonyl-benzyl)-1-(3-cyanobenzyl)-pyrrole-3-carboxylate

¹H-NMR (500 MHz, CDCl₃) δ7.93 (d, J=8.3 Hz, 2H), 7.59 (d, J=7.4 Hz, 1H), 7.45 (m, 1H), 7.36 (s, 1H), 7.30-7.27 (m, 3H), 6.21 (s, 1H), 5.00 (s, 2H), 4.21 (q, J=6.9 Hz, 2H), 4.13 (s, 2H), 3.88 (s, 3H), 1.25 (t, J=6.9 Hz, 3H).

Ethyl 4-(3-cyanobenzyl)-1-(1-naphthylmethyl)-pyrrole-3-carboxylate

¹H-NMR (500 MHz, CDCl₃) δ7.91-7.83 (m, 3H), 7.56-7.52 (m, 2H), 7.46-7.43 (m, 4H), 7.33 (m, 2H), 7.16 (d, J=6.9 Hz, 1H), 6.38 (d, J=2.3 Hz, 1H), 5.47 (s, 2H), 4.17 (q, J=6.9 Hz, 2H), 4.08 (s, 2H), 1.22 (t, J=6.9 Hz, 3H).

Ethyl 4-(3-cyanobenzyl)-1-(2-naphthylmethyl)-pyrrole-3-carboxylate

¹H-NMR (500 MHz, CDCl₃) δ7.84-7.80 (m, 4H), 7.59 (s, 1H), 7.52-7.43 (m, 5H), 7.37-7.32 (m, 2H), 7.25 (m, 1H), 6.37 (d, J=2.3 Hz, 1H), 5.15 (s, 2H), 4.19 (q, J=6.9 Hz, 2H), 4.10 (s, 2H), 1.24 (t, J=6.9 Hz, 3H).

Ethyl 4-(3-cyanophenyl)-1-(1-naphthylmethyl)-pyrrole-3-carboxylate

¹H-NMR (500 MHz, CDCl₃) δ7.93-7.88 (m, 3H), 7.73-7.69 (m, 2H), 7.56-7.45 (m, 5H), 7.39 (m, 1H), 7.26 (d, 1H), 6.70 (d, J=2.3 Hz, 1H), 5.54 (s, 2H), 4.19 (q, J=6.9 Hz, 2H), 1.22 (t, J =6.9 Hz, 3H).

Ethyl 4-(3-cyanophenyl)-1-(2-naphthylmethyl)-pyrrole-3-carboxylate

¹H-NMR (500 MHz, CDCl₃) δ7.86-7.82 (t, 3H), 7.76-7.71 (m, 2H), 7.67 (s, 1H), 8.52-7.46 (m, 4H), 7.40 (m, 1H), 7.31 (dd, J=8.7, 1.8 Hz, 1H), 6.73 (d, J=2.3 Hz, 1H), 5.23 (s, 2H), 4.21 (q, J=6.9 Hz, 2M), 1.24 (t, J=6.9 Hz, 3H).

Ethyl 4-(3-cyanobenzyl)-1-(4-biphenylmethyl)-pyrrole-3-carboxylate

¹H-NMR (500 MHz, CDCl₃) δ7.58-7.55 (m, 4H), 7.49-7.42 (m, 5H), 7.37-7.33 (m, 3H), 7.21 (d, J=8.3 Hz, 2H), 6.36 (d, J=2.3 Hz, 1H), 5.04 (s, 2H), 4.19 (q, J=6.9 Hz, 2H), 4.10 (s, 2H), 1.24 (t, J=6.9 Hz, 3H).

Ethyl 4-(4-cyanobenzyl)-1-(3-cyanobenzyl)-pyrrole-3-carboxylate

¹H-NMR (500 MHz, CDCl₃) δ7.61 (d, J=7.8 Hz, 1H), 7.54 (d, J=7.8 Hz, 2H), 7.47 (m, 1H), 7.36-7.30 (m, 5H), 6.28 (s, 1H), 5.03 (s, 2H), 4.19 (q, J=6.9 Hz, 2H), 4.13 (s, 2H), 1.23 (t, J=6.9 Hz, 3H).

Ethyl 4-(3-cyanobenzyl)-1-(4-cyanobenzyl)-pyrrole-3-carboxylate

¹H-NMR (500 MHz, CDCl₃) δ7.64 (m, 2H), 7.46 (m, 3H), 7.37-7.31 (m, 2H), 7.19 (d, 2H), 6.29 (d, J=2.3 Hz, 1H), 5.06 (s, 2H), 4.19 (q, J=6.9 Hz, 2H), 4.10 (s, 2H), 1.25 (t, J=6.9 Hz, 3H).

Ethyl 4-(3-cyanobenzyl)-1-(3-cyanobenzyl)-pyrrole-3-carboxylate

¹H-NMR (500 MHz, CDCl₃) δ7.61 (d, 1H), 7.47 (m, 4H), 7.38-7.30 (m, 4H), 6.29 (d, J=2.3 Hz, 1H), 5.04 (s, 2H), 4.21 (q, J=6.9 Hz, 2H), 4.10 (s, 2H), 1.26 (t, J=6.9 Hz, 3H).

Ethyl 4-(4-cyanobenzyl)-4-cyanobenzyl)-pyrrole-3-carboxylate

¹H-NMR (500 MHz, CDCl₃) δ7.64 (d, J=8.3 Hz, 2H), 7.54 (d, J=8.3 Hz, 2H), 7.30 (m, 3H), 7.18 (d, J=8.3 Hz, 2H), 6.28 (d, J=2.3 Hz, 1H), 5.05 (s, 2H), 4.19 (q, J=6.9 Hz, 2H), 4.12 (s, 2H), 1.24 (t, J=6.9 Hz, 3H).

Ethyl 4-(4-cyanobenzyl)-1-(3-cyano-6-methoxy-benzyl)-pyrrole-3-carboxylate

¹H-NMR (500 MHz, CDCl₃) δ7.61 (m, 1H), 7.54 (d, J=8.3 Hz, 2H), 7.33-7.29 (m, 3H), 7.06 (s, 1H), 7.94 (d, J=8.3 Hz, 1H), 6.28 (d, J=2.8 Hz, 1H), 4.97 (s, 2H), 4.20 (q, J=6.9 Hz, 2H), 4.13 (s, 2H), 1.24 (t, J=6.9 Hz, 3H).

Ethyl 4-(4-cyanobenzyl)-1-(5-cyanothiophene-2-methyl)-pyrrole-3-carboxylate

¹H-NMR (500 MHz, CDCl₃) δ7.55 (d, J=8.3 Hz, 2H), 7.50 (d, J=4.1 Hz, 1H), 7.34 (d, J=2.8 Hz, 1H), 7.30 (d, J=7.8 Hz, 2H), 6.92 (d, J=3.7 Hz, 1H), 6.32 (d, J=2.3 Hz, 1H), 5.17 (s, 2H), 4.19 (q, J=6.9 Hz, 2H), 4.11 (s, 2H), 1.24 (t, J=6.9 Hz, 3H).

Ethyl 4-[4-(2-imidazoline-2-yl)-benzyl]-1-(3-cyanobenzyl)-pyrrole-3-carboxylate

¹H-NMR (500 MHz, DMSO-d₆) δ7.78 (m, 1H), 7.73 (s, 1H), 7.68 (d, J=8.3 Hz, 2H), 7.59-7.55 (m, 3H), 7.20 (d, J=8.3 Hz, 2H), 6.65 (d, J=2.3 Hz, 1H), 5.15 (s, 2H), 4.09 (q, J=6.9 Hz, 2H), 3.98 (s, 2H), 3.56-3.33 (m, 4H), 1.17 (t J=6.9 Hz, 3H).

Ethyl 4-(3-bromophenyl)-1-(3-cyanobenzyl)-pyrrole-3-carboxylate

¹H-NMR (500 MHz, CDCl₃) δ7.63-7.60 (m, 2H), 7.50-7.46 (m, 2H), 7.41-7.37 (m, 4H), 7.19 (m, 1H), 6.65 (d, J=2.3 Hz, 1H), 5.10 (s, 2H), 4.20 (q, J=6.9 Hz, 2H), 1.24 (t, J=6.9 Hz, 3H).

Ethyl (4-bromophenyl)-1-(3-cyanobenzyl)-pyrrole-3-carboxylate

¹H-NMR (500 MHz, CDCl₃) δ7.63 (d, J=7.8 Hz, 1H), 7.50-7.43 (m, 4H), 7.40-7.38 (m, 2H), 7.34 (d, J=8.3 Hz, 2H), 6.64 (d, J=2.3 Hz, 1H), 5.10 (s, 2H), 4.20 (q, J=6.9 Hz, 2H), 1.24 (t, J=6.9 Hz, 3H).

Ethyl 4-(4-bromophenyl)-1-(3-cyano-6-t-butyloxy-benzyl)-pyrrole-3-carboxylate

¹H-NMR (500 MHz, CDCl₃) δ7.54 (dd, J=8.7, 1.9 Hz, 1H), 7.44 (d, J=8.3 Hz, 2H), 7.36 (d, J=2.3 Hz, 1H), 7.34 (d, J=8.3 Hz, 2H), 7.27 (d, J=2.3 Hz, 1H), 7.14 (d, J=8.7 Hz, 1H), 6.62 (d, J=2.3 Hz, 1H), 5.00 (s, 2H), 4.20 (q, J=6.9 Hz, 2H), 1.51 (s, 9H), 1.25 (t, J=6.9 Hz, 3H).

### EXAMPLE 28

Elogation of Aromatic Group in Pyrrole Scaffold

Ethyl 4-[4-(2-t-butylaminosulfonylphenyl)-phenyl]-1-(3-cyanobenzyl)-pyrrole-3-carboxylate

A solution of ethyl 4-(4-bromophenyl)-1-(3-cyanobenzyl)-pyrrole-3-carboxylate (1.39 g, 3.4 mmol), 2-t-butylaminosulfonyl-benzeneboronic acid (874 mg, 3.40 mmol), Pd(Ph₃P)₄ (196 mg, 5 mol %), n-Bu₄NBr (55 mg, 5 mol %) and 2M NaCO₃(3.4 mL) in benzene (30 mL) was refluxed for 5 h. The reaction was diluted with ethyl acetate, washed with water, dried and concentrated. The oily residue was flash-chromatographed to give 480 mg (52%) of the title compound.

¹H-NMR (500 MHz, CDCl₃) δ8.17 (d, J=7.8 Hz, 1H), 7.64 (d, J=7.8 Hz, 1H), 7.58 (d, J=8.3 Hz, 2H), 7.55-7.48 (m, 5H), 7.47-7.41 (m, 3H), 7.35 (d, J=7.3 Hz, 1H), 6.72 (d, J=2.3 Hz, 1H), 5.14 (s, 2H), 4.23 (q, J=6.9 Hz, 2H), 3.66 (s, 1H), 1.28 (t, J=6.9 Hz, 3H), 1.00 (s, 9H).

The following intermediates were prepared similarly.

Ethyl 4-[4-(2-t-butylaminosulfonyl-5-methyl-phenyl)-phenyl]-1-(3-cyanobenzyl)-pyrrole-3-carboxylate

¹H-NMR (500 MHz, CDCl₃) δ8.03 (d, J=8.2 Hz, 1H), 7.64 (d, J=7.8 Hz, 1H), 7.56 (d, J=8.3 Hz, 2H), 7.53-7.47 (m, 4H), 7.44-7.40 (m, 2H), 7.25 (m, 1H), 7.16 (s, 1H), 6.71 (d, J=2.3 Hz, 1H), 5.13 (s, 2H), 4.23 (q, J=6.9 Hz, 2H), 3.67 (s, 1H), 2.42 (s, 3H), 1.28 (t, J=6.9 Hz, 3H), 1.00 (s, 9H).

Ethyl 4-[4-(2-butylaminosulfonyl-5-fluoro-phenyl)-phenyl]-1-(3-cyanobenzyl)-pyrrole-3-carboxylate

¹H-NMR (500 MHz, CDCl₃) δ8.17 (dd, J=9.2, 6.0 Hz, 1H), 7.65 (d, J=7.8 Hz, 1H), 7.58 (d, J=8.3 Hz, 2H), 7.53-7.47 (m, 4H), 7.44-7.41 (m, 2H), 7.14 (m, 1H), 7.06 (dd, J=9.2, 2.8 Hz, 1H), 6.72 (d, J=2.3 Hz, 1H), 5.14 (s, 2H), 4.23 (q, J=6.9 Hz, 2H), 3.69 (s, 1H), 1.28 (t, J=6.9 Hz, 3H), 1.00 (s, 9H).

Ethyl 4-[4-(2-t-butylaminosulfonylphenyl)-phenyl]-1-(3-cyano-6-t-butyloxybenzyl)-pyrrole-3-carboxylate

¹H-NMR (500 MHz, CDCl₃) δ8.17 (d, J=8.3 Hz, 1H), 7.59-7.53 (m, 4H), 7.49 (d, J=8.3 Hz, 2H), 7.46 (m, 1H), 7.39 (d, J=2.3 Hz, 1H), 7.36 (d, J=7.4 Hz, 1H), 7.30 (s, 1H), 7.16 (d, J=8.7 Hz, 1H), 6.70 (d, J=2.3 Hz, 1H), 5.03 (s, 2H), 4.22 (q, J=6.9 Hz, 2H), 3.67 (s, 1H), 1.28 (t, J=6.9 Hz, 3H), 1.00 (s, 9H).

Ethyl 4-(4-biphenyl)-1-(3-cyanobenzyl)-pyrrole-3-carboxylate

¹H-NMR (500 MHz, CDCl₃) δ7.63-7.55 (m, 7H), 7.50-7.47 (m, 2H), 7.45-7.40 (m, 4H), 7.33 (m, 1H), 6.70 (d, J=2.3 Hz, 1H), 5.12 (s, 2H), 4.23 (q, J=6.9 Hz, 2H), 1.26 (t, J=6.9 Hz, 3H).

Ethyl 4-(3-biphenyl)-1-(3-cyanobenzyl)-pyrrole-3-carboxylate

¹H-NMR (500 MHz, CDCl₃) δ7.69 (m, 1H), 7.63-7.61 (m, 3H), 7.50-7.46 (m, 4H), 7.43-7.39 (m, 5H), 7.32 (m, 1H), 6.70 (d, J=2.3 Hz, 1H), 5.12 (s, 2H), 4.21 (q, J=6.9 Hz, 2H), 1.21 (t, J=6.9 Hz, 3H).

Ethyl 4-[4-(2-pyridyl)-phenyl]-1-(3-cyanobenzyl)-pyrrole-3-carboxylate

¹H-NMR (500 MHz, CDCl₃) δ8.69 (d, J=4.6 Hz, 1H), 7.98 (d, J=8.3 Hz, 2H), 7.74 (m, 2H), 7.63 (d, J=7.8 Hz, 1H), 7.59 (d, J=8.7 Hz, 2H), 7.50 (m, 1H), 7.41 (m, 2H), 7.21 (m, 1H), 6.72 (d, J=2.8 Hz, 1H), 5.12 (s, 2H), 4.23 (q, J=6.9 Hz, 2H), 1.25 (t, J=6.9 Hz, 3H).

Ethyl 4-[4-(3-pyridyl)-phenyl]-1-(3-cyanobenzyl)-pyrrole-3-carboxylate

¹H-NMR (500 MHz, CDCl₃) δ8.87 (d, J=1.4 Hz, 1H), 8.57 (dd, J=5.1, 1.9 Hz, 1H), 7.89 (m, 1H), 7.69-7.41 (m, 9H), 7.36 (m, 1H), 6.71 (d, J=2.8 Hz, 1H), 5.13 (s, 2H), 4.24 (q, J=6.9 Hz, 2H), 1.26 (t, J=6.9 Hz, 3H).

### EXAMPLE 29

Hydrolysis of Pyrrole Intermediates

a) BBr₃ method: Synthesis of 4-(4-cyanobenzyl)-1-(3-cyanobenzyl)-pyrrole-3-carboxylic acid

A solution of ethyl 4-(4-cyanobenzyl)-1-(3-cyanobenzyl)-pyrrole-3-carboxylate (1.50 g, 4.07 mmol) in CH₂Cl₂ (15 mL) was treated with BBr₃ (1.15 mL, 12.2 mmol) at −15° C., and the solution was stirred for 3.5 h while slowly warming up to room temperature. The reaction was cooled to −78° C., then quenched with water. Extractive workup gave 1.18 g (85%) of the title compound.

¹H-NMR (500 MHz, CDCl₃) δ7.61 (d, 1H), 7.55 (d, J=8.2 Hz, 2H), 7.47 (m, 1H), 7.38-7.31 (m, 5H), 6.27 (d, J=2.3 Hz, 1H), 5.03 (s, 2H), 4.13 (s, 2H).

b) n-Bu₄NOH method: Ethyl 4-(4-carboxybenzyl)-1-(3-cyanobenzyl)-pyrrole-3-carboxylate

A solution of ethyl 4-(4-methoxycarbonyl-benzyl)-1-(3-cyanobenzyl)-pyrrole-3-carboxylate (2.8 g, 0.96 mmol) in THF (30 mL) was treated with n-Bu₄NOH (55-60% in H₂O, 4.66 mL, 1.0 eq), and stirred for 7 h. After neutralization with 1N HCl, the reaction was concentrated. Extractive workup with ethyl acetate gave 2.55 g (95%) of the title compound.

¹H-NMR (500 MHz, CDCl₃) δ8.00 (d, J=8.3 Hz, 2H), 7.60 (d, J=7.8 Hz, 1H), 7.46 (m, 1H), 7.37 (s, 1H), 7.31 (m, 3H), 6.24 (s, 1H), 5.01 (s, 2H), 4.22 (q, J=6.9 Hz, 2H), 4.15 (s, 2H), 1.26 (t, J=6.9 Hz, 3H).

The following compound was prepared according to Method b).

Ethyl 4-(4-carboxyphenyl)-1-(3-cyanobenzyl)-pyrrole-3-carboxylate

¹H-NMR (500 MHz, CDCl₃) δ8.05 (d, J=8.7 Hz, 2H), 7.62 (d, J=7.8 Hz, 1H), 7.56 (d, J=8.3 Hz, 2H), 7.50-7.39 (m, 4H), 6.72 (d, J=2.8 Hz, 1H), 5.11 (s, 2H), 4.21 (q, J=6.9 Hz, 2H), 1.24 (t, J=6.9 Hz, 3H).

### EXAMPLE 30

Preparation of Esters and Amides

a) Esters: Isopropyl 4-(4-cyanobenzyl)-1-(3-cyanobenzyl)-pyrrole-3-carboxylate

A solution of 4-(4-cyanobenzyl)-1-(3-cyanobenzyl)-pyrrole-3-carboxylic acid (100 mg, 0.29 mmol) in benzene (10 mL) was treated with SOCl₂ (0.21 mL, 2.93 mmol), and the mixture was refluxed for 1 h. After concentration, the residue was dissolved in isopropanol (10 mL), then heated to reflux for 30 min. Concentration gave 112 mg (100%) of the title compound.

¹H-NMR (500 MHz, CDCl₃) δ7.62-7.45 (m, 4H), 7.37-7.29 (m, 5H), 6.28 (d, J=2.3 Hz, 1H), 5.08 (m, 1H), 5.02 (s, 2H), 4.12 (s, 2H), 1.21 (d, J=6.5 Hz, 6H).

The following esters were prepared similarly.

n-Propyl 4-(4-cyanobenzyl)-1-(3-cyanobenzyl)-pyrrole-3-carboxylate

¹H-NMR (500 MHz, CDCl₃) δ7.63-7.46 (m, 4H), 7.37-7.30 (m, 5H), 6.27 (s, 1H), 5.03 (s, 2H), 4.12 (m, 4H), 1.64 (m, 2H), 0.92 (t, J=7.3 Hz, 3H).

Isobutyl 4-(4-cyanobenzyl)-1-(3-cyanobenzyl)-pyrrole-3-carboxylate

¹H-NMR (500 MHz, CDCl₃) δ7.61 (d, J=7.3 Hz, 1H), 7.54 (d, J=8.3 Hz, 2H), 7.47 (m, 1H), 7.36-7.31 (m, 5H), 6.26 (d, J=2.3 Hz, 1H), 5.03 (s, 2H), 4.14 (s, 2H), 3.94 (d, J=6.4 Hz, 2H), 1.93 (m, 1H), 0.92 (d, J=6.9 Hz, 6H).

Cyclopropylmethyl 4-(4-cyanobenzyl)-1-(3-cyanobenzyl)-pyrrole-3-carboxylate

¹H-NMR (500 MHz, CDCl₃) δ7.61 (d, J=7.8 Hz, 1H), 7.54 (d, J=8.2 Hz, 2H), 7.46 (m, 1H), 7.37-7.31 (m, 5H), 6.29 (d, J=1.9 Hz, 1H), 5.03 (s, 2H), 4.14 (s, 2H), 3.98 (d, J=7.4 Hz, 2H), 1.10 (m, 1H), 0.52 (m, 2H), 0.26 (m, 2M).

n-Butyl 4-(4-cyanobenzyl)-1-(3-cyanobenzyl)-pyrrole-3-carboxylate

¹H-NMR (500 MHz, CDCl₃) δ7.61-7.46 (m, 4H), 7.36-7.30 (m, 5H), 6.27 (s, 1H), 5.03 (s, 2H), 4.13 (m, 4H), 1.60 (m, 2H), 1.36 (m, 2H), 0.92 (t, J=7.3 Hz, 3H).

Ethyl 2-[4-(4-cyanobenyzl)-1-(3-cyanobenzyl)-pyrrole-3-carbonyloxy]-acetate

¹H-NMR (500 MHz, CDCl₃) δ7.61 (d, J=7.4 Hz, 1H), 7.54 (d, J=8.3 Hz, 2H), 7.47 (m, 1H), 7.39-7.31 (m, 5H), 6.29 (s, 1H), 5.02 (s, 2H), 4.67 (s, 2H), 4.21 (q, J=6.9 Hz, 2H), 4.14 (s, 2H), 1.26 (t, J=6.9 Hz, 3H).

Methyl 4-(3-cyanobenzyl)-1-(4-cyanobenzyl)-pyrrole-3-carboxylate

¹H-NMR (500 MHz, CDCl₃) δ7.64 (d, J=8.3 Hz, 2H), 7.48-7.44 (m, 3H), 7.37-7.33 (m, 1H), 7.29 (d, J=2.3 Hz, 1H), 7.18 (d, J=8.3 Hz, 2H), 6.30 (d, J=2.3 Hz, 1H), 5.06 (s, 2H), 4.09 (s, 2H), 3.72 (s, 3J).

Isopropyl 4-(3-cyanobenzyl)-1-(4-cyanobenzyl)-pyrrole-3-carboxylate

¹H-NMR (500 MHz, CDCl₃) δ7.63 (d, J=8.3 Hz, 2H), 7.44 (m, 3H), 7.36-7.31 (m, 2H), 7.19 (d, J=8.3 Hz, 2H), 6.29 (d, J=2.3 Hz, 1H), 5.09 (m, 1H), 5.06 (s, 2H), 4.09 (s, 2H), 1.19 (d, J=6.0 Hz, 6H).

Ethyl 2-[4-(3-cyanobenzyl)-pyrrole-3-carbonyloxy]-acetate

¹H-NMR (500 MHz, CDCl₃) δ7.65 (d, J=8.3 Hz, 2H), 7.48-7.35 (m, 5H), 7.19 (d, J=7.8 Hz, 2H), 6.28 (d, J=2.3 Hz, 1H), 5.06 (s, 2H), 4.67 (s, 2H), 4.22 (q, J=6.9 Hz, 2H), 4.11 (s, 2H), 1.27 (t, J=6.9 Hz, 3H).

Ethyl 4-(4-ethoxycarbonylphenyl)-1-(3-cyanobenzyl)-pyrrole-3-carboxylate

¹H-NMR (500 MHz, CDCl₃) δ8.00 (d, J=8.3 Hz, 2H), 7.63 (d, J=7.8 Hz, 1H), 7.53 (d, J=8.3 Hz, 2H), 7.51-7.47 (m, 2H), 7.40 (m, 2H), 6.70 (d, J=2.3 Hz, 1H), 5.11 (s, 2H), 4.37 (q, J=6.9 Hz, 2H), 4.21 (q, J=6.9 Hz, 2H), 1.38 (t, J=6.9 Hz, 3H), 1.25 (t, J=6.9 Hz, 3H).

b) Amides: Ethyl 4-(4-methylaminocarbonyl-benzyl)-1-(3-cyanobenzyl)-pyrrole-3-carboxylate

A solution of ethyl 4-(4-carboxybenzyl)-1-(3-cyanobenzyl)-pyrrole-3-carboxylate (80 mg) in CH₂Cl₂ (2 mL) was treated with SOCl₂ (118 mg, 5.0 eq), then heated to reflux for 1 h. After concentration, the residue was dissolved in CH₂Cl₂ (2 mL), then treated with MeNH₂(1 mL, 10 eq), stirred for 2 h at room temperature. Extractive workup followed by flash chromatography gave 83 mg (80%) of the title compound.

¹H-NMR (500 MHz, CDCl₃) δ7.65 (d, J=7.8 Hz, 2H), 7.59 (d, J=7.4 Hz, 1H), 7.45 (m, 1H), 7.32-7.27 (m, 5H), 6.20 (s, 1H), 6.10 (br, 1H), 5.00 (s, 2H), 4.22 (q, J=6.9 Hz, 2H), 4.11 (s, 2H), 2.99 (d, J=5.1 Hz, 3H), 1.27 (t, J=6.9 Hz, 3H).

The following amides were prepared similarly.

Ethyl 4-(4-aminocarbonylbenzyl)-1-(3-cyanobenzyl)-pyrrole-3-carboxylate

¹H-NMR (500 MHz, CDCl₃) δ7.71 (d, J=8.3 Hz, 2H), 7.59 (d, J=7.8 Hz, 1H), 7.45 (m, 1H), 7.30 (m, 5H), 6.22 (d, J=2.3 Hz, 1H), 6.08 (br, 1H), 5.55 (br, 1H), 5.01 (s, 2H), 4.22 (q, J=6.9 Hz, 2H), 4.13 (s, 2H), 1.26 (t, J=6.9 Hz, 3H).

Ethyl 4-(4-dimethylaminocarbonylbenzyl)-1-(3-cyanobenzyl)-pyrrole-3-carboxylate

¹H-NMR (500 MHz, CDCl₃) δ7.59 (dJ, J=7.8 Hz, 2H), 7.45 9m, 1H), 7.34-7.24 (m, 7H), 6.16 (d, J=2.3 Hz, 1H), 4.98 (s, 2H), 4.23 (q, J=6.9 Hz, 2H), 4.10 (s, 2H), 3.09 (s, 3H), 2.98 (s, 3H), 1.26 (t, J=6.9 Hz, 3H).

Ethyl 4-(4-phenylaminocarbonybenzyl)-1-(3-cyanobenzyl)-pyrrole-3-carboxylate

¹H-NMR (500 MHz, CDCl₃) δ7.83 (br, 1H), 7.78 (d, J=8.3 Hz, 2H), 7.63 (d, J=7.3 Hz, 2H), 7.59 (d, J=7.8 Hz, 1H), 7.46 (m, 1H), 7.37-7.33 (m, 5H), 7.30 (d, J=2.8 Hz, 1H), 7.27 (s, 1H), 7.13 (m, 1H), 6.26 (d, J=2.3 Hz, 1H), 5.02 (s, 2H), 4.23 (q, J=6.9 Hz, 2H), 4.15 (s, 2H), 1.28 (t, J=6.9 Hz, 3H).

Ethyl 4-(4-benzylaminocarbonylbenzyl)-1-(3-cyanobenzyl)-pyrrole-3-carboxylate

¹H-NMR (500 MHz, CDCl₃) δ7.69 (d, J=8.3 Hz, 2H), 7.59 (d, J=7.8 Hz, 1H), 7.45 (m, 1H), 7.35-7.27 (m, 10H), 6.36 (br, 1H), 6.19 (d, J=2.3 Hz, 1H), 4.99 (s, 2H), 4.63 (d, J=5.5 Hz, 2H), 4.22 (q, J=6.9 Hz, 2H), 4.12 (s, 2H), 1.27 (t, J=6.9 Hz, 3H).

4-(4-Cyanobenzyl)-1-(3-cyanobenzyl)-pyrrole-3-carboxamide

¹H-NMR (500 MHz, CDCl₃) δ7.60-7.44 (m, 4H), 7.36-7.31 (m, 4H), 7.09 (d, J=2.3 Hz, 1H), 6.31 (d, J=2.3 Hz, 1H), 5.46 (br, 2H), 5.01 (s, 2H), 4.14 (s, 2H).

Methyl 4-(4-cyanobenzyl)-1-(3-cyanobenzyl)-pyrrole-3-carboxamide

¹H-NMR (500 MHz, CDCl₃) δ7.61-7.44 (m, 4H), 7.36-7.29 (m, 4H), 6.97 (d, J=2.3 Hz, 1H), 6.30 (d, J=2.3 Hz, 1H), 5.54 (br, 1H), 5.01 (s, 2H), 4.14 (s, 2H), 2.85 (d, J=4.6 Hz, 3H).

Ethyl 4-(4-cyanobenzyl)-1-(3-cyanobenzyl)-pyrrole-3-carboxamide

¹H-NMR (500 MHz, CDCl₃) δ7.61-7.44 (m, 4H), 7.36-7.30 (m, 4H), 7.00 (s, 1H), 6.31 (s, 1H), 5.48 (br, 1H), 5.01 (s, 2H), 4.14 (s, 2H), 3.34 (m, 2H), 1.10 (t, J=6.9 Hz, 3H).

Diethyl 4-(4-(cyanobenzyl)-1-(3-cyanobenzyl)-pyrrole-3-carboxamide

¹H-NMR (500 MHz, CDCl₃) δ7.60-7.43 (m, 4H), 7.36-7.29 (m, 4H), 6.68 (d, J=2.3 Hz, 1H), 6.37 (d, J=2.3 Hz, 1H), 5.01 (s, 2H), 3.95 (s, 2H), 3.32 (m, 4H), 1.03 (m, 6H).

4-(4-Cyanobenzyl)-1-(3-cyanobenzyl)-pyrrole-3-carboxylic acid morpholine amide

¹H-NMR (500 MHz, CDCl₃) δ7.63 (d, J=8.7 Hz, 2H), 7.46 (m, 3H), 7.35 (m, 1H), 7.17 (d, J=8.7 Hz, 2H), 6.69 (d, J=2.3 Hz, 1H), 6.40 (d, J=2.3 Hz, 1H), 5.05 (s, 2H), 3.94 (s, 2H), 3.55-3.49 (m, 8H).

Ethyl 2-[4-(4-cyanobenzyl)-1-(3-cyanobenzyl)-pyrrole-3-carbonylamino]-acetate

¹H-NMR (500 MHz, CDCl₃) δ7.59-7.43 (m, 4H), 7.35-7.32 (m, 4H), 7.11 (d, J=2.3 Hz, 1H), 6.30 (d, J=2.3 Hz, 1H), 6.17 (br, 1H), 5.00 (s, 2H), 4.19 (m, 2H), 4.16 (d, 2H), 4.10 (s, 2H), 1.26 (t, J=6.9 Hz, 3H).

Ethyl 2-[4-(3-cyanobenzyl)-1-(4-cyanobenzyl)-pyrrole-3-carbonylamino]-acetate

¹H-NMR (500 MHz, CDCl₃) δ7.64 (d, J=8.3 Hz, 2H), 7.50-7.44 (m, 3H), 7.35 (m, 1H), 7.18 (d, J=8.3 Hz, 2H), 7.09 (d, J=2.3 Hz, 1H), 6.30 (d, J=2.3 Hz, 1H), 6.08 (br, 1H), 5.05 (s, 2H), 4.19 (q, J=6.9 Hz, 2H), 4.12 (s, 2H), 1.25 (t, J=6.9 Hz, 3H).

Ethyl 4-(4-phenylaminocarbonylphenyl)-1-(3-cyanobenzyl)-pyrrole-3-carboxylate

¹H-NMR (500 MHz, CDCl₃) δ7.89 (s, 1H), 7.83 (d, J=8.3 Hz, 2H), 7.65-7.63 (m, 3H), 7.59 (d, J=8.3 Hz, 2H), 7.52-7.48 (m, 2H), 7.43-7.35 (m, 4H), 7.14 (m, 1H), 6.72 (d, J=2.8 Hz, 1H), 5.12 (s, 2H), 4.22 (q, J=6.9 Hz, 2H), 1.28 (t, J=6.9 Hz, 3H).

c) Synthesis of ethyl 4-(4-benzyloxycarbonylaminobenzyl)-1-(3-cyanobenzyl)-pyrrole-3-carboxylate (Carbamate)

Ethyl 4-(4-carboxybenzyl)-1-(3-cyanobenzyl)-pyrrole-3-carboxylate was reacted with diphenylphosphoryl azide, triethylamine and benzyl alcohol by conventional Curtius rearrangement under heating to give the title compound.

¹H-NMR (500 MHz, CDCl₃) δ7.58 (d, J=7.4 Hz, 1H), 7.46-7.26 (m, 1H), 7.17 (d, J=8.3 Hz, 2H), 6.61 (br, 1H), 6.15 (s, 1H), 5.18 (s, 2H), 4.97 (s, 2H), 4.23 (q, J=6.9 Hz, 2H), 4.03 (s, 2H), 1.28 (t, J=6.9 Hz, 3H).

### EXAMPLE 31

Derivatization (Removal of t-butyl Group: O-t-Bu+N-t-Bu)

a) Synthesis of Ethyl 4-(4-cyanobenzyl)-1-(3-cyano-6-hydroxy-benzyl)-pyrrole-3 carboxylate (Removal of O-t-Bu group)

Ethyl 4-(4-cyanobenzyl)-1-(3-cyano-t-butyloxybenzyl)-pyrrole-3-carboxylate in CH₂Cl₂ was treated with trifluoroacetic acid to give the title compound (100%).

¹H-NMR (500 MHz, CDCl₃) δ7.53 (d, J=8.3 Hz, 2H), 7.47 (dd, J=8.3, 2.3 Hz, 1H), 7.43 (d, J=2.3 Hz, 1H), 7.29 (d, J=8.2 Hz, 2H), 7.22 (d, J=1.9 Hz, 1H), 6.93 (d, J=8.7 Hz, 1H), 6.36 (d, J=2.8 Hz, 1H), 4.99 (s, 2H), 4.20 (q, J=6.9 Hz, 2H), 4.10 (s, 2H), 1.21 (t, J=6.9 Hz 3H).

b) Removal of N-t-butyl group in sulfonamide

N-t-butylsulfonamide was treated with 100% trifluoroacetic acid for ˜20 h to give the desired product quantitatively.

<Biphenyl Part>

### EXAMPLE 32

Methyl 2-(4-cyanophenyl)-benzoate

To a solution of 4-bromobenzonitrile (4.16 g, 1.2 eq) in dry THF (25 mL)-dry ether (5 mL) under N₂ at −100° C. was added n-BuLi/hexane solution (10.9 mL, 2.2 M, 1.05 eq) in 2 minutes through the inner surface of the flask (orange-yellow). After 3 minutes, this solution was transferred into a solution of anhydrous ZnBr₂ (5.15 g, 1.2 eq, freshly vacuum-dried with flame) in dry THF (30 mL), then stirred for 15 minutes (yellowish-transparent solution, Solution A). Meanwhile, a catalyst solution was prepared by stirring Pd (dba)₂ (329 mg, 3 mol %) and triphenylphosphine (300 mg, 6 mol %) in dry THF (10 mL) under N₂ for 20 min. A solution of methyl 2-iodobenzoate (5.0 g, 19.1 mmol, 1 eq) in dry THF (15 mL) was added to the catalyst solution (Solution B). To Solution B was added Solution A via double-tipped needle, then stirred for 2 h at ambient temperature, and finally heated to reflux for 40 minutes. After concentration, the residue was dissolved in EA-Hexanes (1:1, 200 mL), washed with 1N-HCl (100 mL×2), with water (100 mL), dried (Na₂SO₄) and concentrated. Flash chromatography (7-8% EA in hexanes) gave partially purified material, which was extracted several times with hexanes. Concentration of hexane solution gave 4.18 g (92%) of the title compound.

¹H-NMR (500 MHz, CDCl₃) δ7.93 (dd, J=7.3, 1.4 Hz, 1H), 7.68 (d, J=8.3 Hz, 2H), 7.57 (dt, J=7.8, 1.4 Hz, 1H), 7.48 (dt, J=7.3, 1.4 Hz, 1H), 7.40 (d, J=8.7 Hz, 2H), 7.31 (dd, J=7.8, 1.0 Hz, 1H), 3.67 (s, 3H).

The following compound was prepared similarly.

Methyl 2-(3-cyanophenyl)-benzoate (yield=90%)

¹H-NMR (500 MHz, CDCl₃) δ7.93 (dd, J=7.8, 1.4 Hz, 1H), 7.64-7.45 (m, 6H), 7.30 (dd, J=7.8, 1.0 Hz, 1H), 3.68 (s, 3H).

### EXAMPLE 33

Hydrolysis

Synthesis of 2-(4-cyanophenyl)-benzoic acid

A solution of methyl 2-(4-cyanophenyl)-benzoate (4.16 g) in THF (50 mL)-methanol (25 mL) was treated with 1N-NaOH (40 mL). After 5 h, additional 1N-NaOH (10 mL) was added and the solution was heated to 45° C. until the reaction was completed. Neutralization, concentration followed by conventional extractive workup gave solid, which was triturated twice with CH₂Cl₂-hexanes (1:9) to give 3.498 g of the title compound as a white powder.

¹H-NMR (500 MHz, CDCl₃) δ8.04 (dd, J=7.8, 1.0 Hz, 1H), 7.67 (d, J=7.8 Hz, 2H), 7.61 (dt, J=7.8, 1.4 Hz, 1H), 7.50 (dt, J=7.8, 1.4 Hz, 1H), 7.41 (d, J=7.8 Hz, 2H), 7.31 (d, J=7.8 Hz, 1H).

The following compound was prepared similarly.

2-(3-Cyanophenyl)-benzoic acid

¹H-NMR (500 MHz, CDCl₃) δ8.05 (dd, J=7.8, 0.9 Hz, 1H), 7.65-7.47 (m, 6H), 7.30 (d, J=7.8 Hz, 1H).

### EXAMPLE 34

2-trifluoromethylsulfonyloxy-1-cyclopentene-1-carboxylic acid ethyl ester

A solution of ethyl 2-oxo-cyclopentanecarboxylate (2.18 g, 1.0 eq) in dry THF (20 mL) was treated with NaH (560 mg, 1.0 eq). In 20 minutes, solid was formed, but the solid could not be stirred. Thus additional THF (20 mL) and N-phenyltriflic imide (5.0 g) were added thereto. After 1.5 h, the reaction was concentrated and the residue was worked up as usual. Flash chromatography with 5% EA in hexanes gave 3.638 g (90%) of the title compound as clear liquid.

¹H-NMR (500 MHz, CDCl₃) δ4.25 (q, J=6.9 Hz, 2H), 2.78-2.66 (m, 4H), 2.01 (m, 2H), 1.31 (t, J=6.9 Hz, 3H).

### EXAMPLE 35

2-(4-cyanophenyl)-1-cyclopentene-1-carboxylic acid ethyl ester

A solution of ethyl 2-trifluoromethylsulfonyloxy-1-cyclopentene-1-carboxylate (747 mg, 1.0 eq), 4-tributyltinbenzonitrile (1.27 g, assumed to be 80% purity), LiCl (329 mg, 3.0 eq) and Pd (PPh₃)₄ (90 mg, 3 mol %) in dioxane (8 mL) under N₂ was heated to reflux for 24 h. Conventional workup followed by flash chromatography with 5% EA in hexanes afforded 515 mg (82%) of title compound as clear liquid.

¹H-NMR (500 MHz, CDCl₃) δ7.61 (d, J=8.3 Hz, 2H), 7.40 (d, J=8.3 Hz, 2H), 4.08 (q, J=7.4 Hz, 2H), 2.84 (m, 4H), 2.01 (m, 2H), 1.11 (t, J=7.4 Hz, 3H).

The following intermediate was prepared similarly.

2-(3-Cyanophenyl)-1-cyclopentene-1-carboxylic acid ethyl ester

### EXAMPLE 36

Methyl 2-(3-cyanophenyl)-pyridine-3-carboxylate

A solution of methyl 2-chloronicotinate (1.16 g, 6.73 mmol), LiCl (856 mg, 3 eq) and Pd(PPh₃)₄ (233 mg, 3 mol %) in dioxane (20 mL) under N₂ was treated with 3-tributyltinbenzonitrile (2.64 g, 1.0 eq), and heated to reflux for 12 h. After dilution with saturated NaHCO₃ (30 mL), and the reaction was extracted with EA (30 mL×3), dried and concentrated. Flash chromatography with Hex: EA=4:1 gave 1.51 g (94%) of the title compound.

¹H-NMR (500 MHz, CDCl₃) δ8.82 (dd, J=5.0, 1.8 Hz, 1H), 8.21 (dd, J=7.8, 1.4 Hz, 1H), 7.85 (s, 1H), 7.74-7.69 (m, 2H), 7.54 (m, 1H), 7.42 (m, 1H), 3.75 (s, 3H).

Methyl 2-chloronicotinate [¹H-NMR (500 MHz, CDCl₃) δ8.49 (dd, J=5.0, 1.9 Hz, 1H), 8.14 (dd, J=7.4, 1.9 Hz, 1H), 7.30 (dd, J=7.8, 4.6 Hz, 1H), 3.94 (s, 3H)]

### EXAMPLE 37

2-(4-cyanophenyl-1-cyclopentene-1-carboxylic acid

A solution of ethyl 2-(4-cyanophenyl)-1-cyclopentene-1-carboxylate (993 mg, 4.12 mmol) in THF (16 mL)-methanol (8 mL) was treated with 1N-NaOH (8 mL). After stirring overnight, conventional extractive workup followed by trituration in hexanes gave 818 mg of the title compound as a yellowish powder.

¹H-NMR (500 MHz, DMSO-d₆) δ7.79 (d, J=8.3 Hz, 2H), 7.52 (d, J=8.3 Hz, 2H), 2.84 (m, 2H), 2.74 (m, 2H), 1.93 (m, 2H).

The following compounds were prepared similarly.

2-(3-Cyanophenyl)-1-cyclopentene-1-carboxylic acid

¹H-NMR (500 MHz, DMSO-d₆) δ12.35 (br, 1H), 7.81 (s, 1H), 7.75 (d, J=7.8 Hz, 1H), 7.68 (dd, J=8.3, 1.4 Hz, 1H), 7.54 (t, J=7.8 Hz, 1H), 2.85 (m, 2H), 2.74 (m, 2H), 1.92 (m, 2H).

2-(3-Cyanophenyl)-pyridine-3-carboxylic acid

¹H-NMR (500 MHz, DMSO-d₆) δ8.80 (dd, J=5.1, 1.9 Hz, 1H), 8.23 (dd, J=8.3, 1.9 Hz, 1H), 7.96 (s, 1H), 7.91 (m, 1H), 7.86 (m, 1H), 7.66 (t, J=7.8 Hz, 1H), 7.57 (dd, J=7.8, 4.6 Hz, 1H).

### EXAMPLE 38

2-(3-cyanophenyl)-benzyl alcohol

A solution of 2-(3-cyanophenyl)-benzoic acid (351 mg, 1.57 mmol) in CH₂Cl₂ (6 mL) was treated with SOCl₂ (0.45 mL), then refluxed for 3 h. After concentration, the residue was dissolved in dry TBF (10 mL), then added to a solution of NaBH₄ (75 mg) in methanol (7 mL) at −78° C. The reaction was allowed to warm up to room temperature and stirred for 1 h at this temperature. Neutralization with 1N HCl, extraction with EA, drying (MgSO₄) followed by concentration gave 314 mg (95%) of the title compound.

¹H-NMR (500 MHz, CDCl₃) δ7.70 (pseudo t, J=1.8 Hz, 1.4 Hz, 1H), 7.67-7.64 (m, 2H), 7.57-7.52 (m, 2H), 7.46-7.37 (m, 2H), 7.24 (dd, J=7.8, 0.9 Hz, 1H), 4.56 (s, 2H),

The following compound was prepared similarly.

2-4-(cyanophenyl)-benzyl alcohol

¹H-NMR (500 MHz, CDCl₃) δ7.72 (d, J=8.3 Hz, 2H), 7.58-7.39 (m, 5H), 7.26 (m, 2H), 4.57 (s, 2H).

### EXAMPLE 39

2-(4-cyanophenyl)-benzylamine

A Mitzunobu reaction of 2-(4-cyanophenyl)-benzyl alcohol with phthalimide gave N-2-(4-cyanophenyl)-benzyl phthalimide {¹H-NMR (500 MHz, CDCl₃) δ7.81 (m, 2H), 7.73-7.69 (m, 4H), 7.56 (d, J=8.7 Hz, 2H), 7.35-7.30 (m, 3H), 7.18 (m, 1H), 4.78 (s, 2H)}, which was deprotected to give 2-(4-cyanophenyl)-benzylamine. The amine was used directly without further purification in the next step. Similarly, 2-(3-cyanophenyl)-benzylamine was prepared.

### EXAMPLE 40

2-(4-cyanophenyl)-benzyl chloride

2-(4-Cyanophenyl)-benzyl alcohol was heated with SOCl₂/LiCl to give 2-(4-cyanophenyl)-benzyl chloride, which was used directly without further purification in the next step. Similarly, 2-(3-cyanophenyl)-benzyl chloride was prepared.

### EXAMPLE 41

Methyl 2-(3-cyanophenyl)-phenylacetate

A solution of 2-(3-cyanophenyl)-benzoic acid (400 mg, 1.79 mmol) in CH₂Cl₂ (5 mL) was treated with SOCl₂ (1 mL), then heated to reflux for 3 h. The concentrated residue was reacted with CH₂N₂ in ether to give 2-(3-cyanophenyl)-benzoyldiazomethane. The intermediate in methanol was treated with TEA (5 mL) and silver benzoate (61 mg, 15 mol %), then stirred for 1 h at room temperature. After filtration through celite and concentration, the residue was dissolved in EA, washed with 0.5N HCl, dried and concentrated. Flash chromatography with Hex: EA=3:1 afforded 338 mg (75%) of the title compound.

¹H-NMR (500 MHz, CDCl₃) δ7.66 (m, 1H), 7.61 (m, 1H), 7.58-7.51 (m, 2H), 7.40-7.34 (m, 3H), 7.20 (d, 1H), 3.63 (s, 3H).

Similarly, methyl 2-(4-cyanophenyl)-phenylacetate was prepared.

### EXAMPLE 42

2-(3-cyanophenyl)-phenylacetic acid

A solution of methyl 2-(3-cyanophenyl)-phenylacetate (obtained as above) in THF (8 mL) was treated with 1.0 N NaOH (2.7 mL, 2.0 eq), then stirred for 2 h at room temperature. Neutralization with 1.0 N HCl and extractive workup gave 291 mg (93%) of the title compound.

¹H-NMR (500 MHz, CDCl₃) δ7.66 (m, 1H), 7.62 (s, 1H), 7.58-7.50 (m, 2H), 7.41-7.35 (m, 3H), 7.23 (d, J=7.4 Hz, 1H), 3.57 (s, 2H).

The following compound was prepared similarly.

2-(4-Cyanophenyl)-phenylacetic acid

¹H-NMR (500 MHz, CDCl₃) δ7.70 (d, J=7.8 Hz, 2H), 7.44 (d, J=8.3 Hz, 2H), 7.41-7.36 (m, 3H), 7.24 (d, J=7.4 Hz, 1H), 3.58 (s, 2H).

### EXAMPLE 43

Urea Formation (Curtius Rearrangement Followed by Amine Treatment)

N-{2-(4-cyanophenyl)-phenyl}-N′-(4-cyanophenyl) urea

A solution of 2-(4-cyanophenyl)-benzoic acid (223 mg, 1.0 mmol) in benzene (30 mL) was azeotropically dried (Dean-Stark trap), and 15 mL portion of benzene was drained off from the Dean-Stark trap. After cooling to room temperature, diphenylphorylazide (226 μL, 1.05 eq) and triethylamine (167 μL, 1.2 eq) were added therein and heated to reflux for 1 h. The cooled reaction mixture was treated with 4-aminobenzonitrile (142 mg, 1.2 eq), then heated to reflux overnight. Extractive workup followed by trituration in CHCl₃ gave 259 mg (77%) of the title compound as white powder.

¹H-NMR (500 MHz, DMSO-d₆) δ9.39 (s, 1H), 7.95 (d, J=7.8 Hz, 2H), 7.84 (m, 1H), 7.70 (d, J=8.3 Hz, 2H), 7.62 (d, J=7.8 Hz, 2H), 7.55 (d, J=8.7 Hz, 2H), 7.42 (m, 1H), 7.30-7.22 (m, 2H).

The following ureas were prepared similarly.

N-{2-(3-cyanophenyl)-phenyl}-N′-(3-cyanophenyl) urea

¹H-NMR (500 MHz, CDCl₃) δ7.93 (d, J=8.3 Hz, 1H), 7.67 (m, 1H), 7.60 (m, 5H), 7.42 (m, 1H), 7.33 (m, 1H), 7.29-7.20 (m, 4H), 6.65 (s, 1H).

N-{2-(3-cyanophenyl)-phenyl}-N′-(4-cyanophenyl) urea

MS: 399 [M+H]

N-{2-(4-cyanophenyl)-phenyl}-N′-(3-cyanophenyl) urea

¹H-NMR (500 MHz, DMSO-d₆) δ9.20 (d, J=4.6 Hz, 1H), 7.97 (br s, 1H), 7.95 (d, J=7.8 Hz, 2H), 7.92 (s, 1H), 7.85 (t, J=7.3 Hz, 1H), 7.62 (d, J=8.3 Hz, 2H), 7.55 (m, 1H), 7.47-7.39 (m, 3H), 7.30-7.21 (m, 2H).

### EXAMPLE 44

4-cyanobenzyl 2-(4-cyanophenyl)-benzamide

A solution of 2-(4-cyanophenyl)-benzoic acid (200 mg, 0.896 mmol), 4-aminomethylbenzonitrile HCl (166 mg, 1.1 eq), EDC (238 mg, 1.3 eq) and HOBT (157 mg, 1.3 eq) in DMF (5 mL) at 0° C. was treated with DIPEA (0.47 mL, 3.0 eq), then stirred for 5 h at room temperature. After concentration, extractive workup followed by flash chromatography with Hex: EA=1:1 afforded 267 mg (88%) of the title compound.

¹H-NMR (500 MHz, CDCl₃) δ7.64 (d, J=8.3 Hz, 3H), 7.58-7.46 (m, 6H), 7.36 (d, J=7.4 Hz, 1H), 7.16 (d, J=7.8 Hz, 2H), 5.75 (m, 1H), 4.43 (d, J=6.0 Hz, 2H).

The following compounds were prepared similarly.

3-cyanobenzyl 2-(4-cyanophenyl)-benzamide

¹H-NMR (500 MHz, CDCl₃) δ7.69 (d, J=8.3 Hz, 2H), 7.63-7.33 (m, 9H), 7.24 (m, 1H), 5.85 (m, 1H), 4.41 (d, J=6.0 Hz, 2H).

3-cyanobenzyl 2-(3-cyanophenyl)-benzamide

¹H-NMR (500 MHz, CDCl₃) δ7.67-7.59 (m, 4H), 7.56-7.52 (m, 2H), 7.48 (pseudo t, J=7.8, 7.4 Hz, 2H), 7.41 (t, J=7.8 Hz, 1H), 7.33 (dd, J=7.8, 1.4 Hz, 2H), 7.26 (s, 1H), 5.78 (m, 1H), 4.43 (d, J=6.4 Hz, 2H).

4-cyanobenzyl 2-(3-cyanophenyl)-benzamide

¹H-NMR (500 MHz, CDCl₃) δ7.67-7.42 (m, 9H), 7.34 (dd, J=7.8, 1.0 Hz, 1H), 7.17 (d, J=7.8 Hz, 2H), 5.81 (m, 1H), 4.46 (d, J=6.4 Hz, 2H).

3-cyanophenyl 2-(3-cyanophenyl)-phenylacetamide

¹H-NMR (500 MHz, CDCl₃) δ7.76 (s, 1H), 7.67 (d, J=6.9 Hz, 1H), 7.60 (s, 1H), 7.56-7.51 (m, 3H), 7.49-7.38 (m, 5H), 7.29 (m, 1H), 7.02 (br s, 1H), 3.67 (s, 2H).

4-cyanophenyl 2-(4-cyanophenyl)-phenylacetamide

¹H-NMR (500 MHz, CDCl₃) δ7.70 (d, J=8.3 Hz, 2H), 7.58 (d, J=8.7 Hz, 2H), 7.50 (d, J=8.7 Hz, 2H), 7.48-7.40 (m, 5H), 7.30 (d, J=7.8 Hz, 1H), 7.13 (br s, 1H), 3.68 (s, 2H).

3-cyanophenyl 2-(4-cyanophenyl)-phenylacetamide

4-Cyanophenyl 2-(3-cyanophenyl)-phenylacetamide

2-(4-Cyanophenyl)-benzyl 4-cyanobenzamide

¹H-NMR (500 MHz, CDCl₃) δ7.77-7.70 (m, 6H), 7.49-7.39 9m, 5H), 7.26 (m, 1H), 6.21 (br, 1H), 4.60 (d, J=6.0 Hz, 2H).

2-(4-Cyanophenyl)-benzyl 3-cyanobenzamide

¹H-NMR (500 MHz, CDCl₃) δ7.94 (s, 1H), 7.90 (m, 1H), 7.78 (m, 1H), 7.72 (d, J=8.7 Hz, 2H), 7.56 (t, J=7.8 Hz, 1H), 7.50-7.39 (m, 5H), 7.27 (m, 1H), 6.20 (br, 1H), 4.60 (d, J=5.5 Hz, 2H).

2-(3-cyanophenyl)-benzyl 3-cyanobenzamide

¹H-NMR (500 MHz, CDCl₃) δ7.96 (s, 1H), 7.90 (d, J=7.8 Hz, 1H), 7.77 (d, J=7.8 Hz, 1H), 7.67 (d, J=7.4 Hz, 1H), 7.62 (s, 1H), 7.61 -7.54 (m, 3H), 7.49-7.38 (m, 3H), 7.26 (m, 1H), 6.21 (br, 1H), 4.58 (d, J=5.5 Hz, 2H).

2-(3-Cyanophenyl)-benzyl 4-cyanobenzamide

¹H-NMR (500 MHz, CDCl₃) δ7.76 (d, J=8.7 Hz, 2H), 7.71 (d, J=8.3 Hz, 2H), 7.66 (d, J=7.4 Hz, 1H), 7.62 (s, 1H), 7.60-7.53 (m, 2H), 7.49-7.38 (m, 3H), 7.25 (m, 1H), 6.22 (br, 1H), 4.58 (d, J=5.5 Hz, 2H).

### EXAMPLE 45

4-cyanobenzyl 2-(4-cyanophenyl)-benzyl ether

A solution of 2-(4-(cyanophenyl)-benzyl alcohol (130 mg, 0.624 mmol) and 4-cyanobenzyl chloride (100 mg, 1.05 eq) in DMF (5 mL) at 0° C. was treated with NaH (60% dispersed in Mineral oil, 40 mg, 1.5 eq) and stirred for 1 h. After concentration, extractive workup followed by flash chromatography with Hex.: EA=5:1 gave 186 mg (92%) of the title compound.

¹H-NMR (500 MHz, CDCl₃) δ7.70 (d, J=8.3 Hz, 2H), 7.62 (d, J=8.3 Hz, 2H), 7.55 (m, 1H), 7.49 (d, J=8.3 Hz, 2H), 7.46-7.40 (m, 2H), 7.38 (d, J=8.7 Hz, 2H), 7.27 (m, 1H), 4.51 (s, 2H), 4.43 (s, 2H).

The following ethers were prepared similarly.

3-Cyanobenzyl 2-(4-cyanophenyl)-benzyl ether

¹H-NMR (500 MHz, CDCl₃) δ7.69 (d, J=8.3 Hz, 2H), 7.58-7.54 (m, 3H), 7.49-7.41 (m, 6H), 7.27 (m, 1H), 4.48 (s, 2H), 4.42 (s, 2H).

4-Cyanobenzyl 2-(3-cyanophenyl)-benzyl ether

¹H-NMR (500 MHz, CDCl₃) δ7.71-7.38 9m, 11H), 7.26 (m, 1H), 4.52 (s, 2H), 4.40 (s, 2H).

3-Cyanobenzyl 2-(3-cyanophenyl)-benzyl ether

¹H-NMR (500 MHz, CDCl₃) δ7.68-7.42 (m, 11H), 7.27 (d, J=7.8 Hz, 1H), 4.49 (s, 2H), 4.41 (s, 2H).

### EXAMPLE 46

4-(2-pyridyl)-phenyl 2-(3-cyanophenyl)-cyclopentene-1-carboxamide

A solution of 2-(3-cyanophenyl)-cyclopentene-1-carboxylic acid (80 mg, 0.375 mmol) in 1,2-ethylene dichloride (4 mL) was treated with SOCl₂ (0.28 mL, 10 eq), then refluxed for 2.5 h. After concentration, the residue dissolved in CH₂Cl₂ (10 mL) at 0° C. was treated with DIPEA (0.65 mL, 10 eq) and 4-(2-pyridyl)aniline (53 mg, 0.314 mmol), and stirred for 12 h. Concentration, extractive workup followed by flash chromatography with Hex: EA=3:1 afforded 59 mg (51%) of the title compound.

¹H-NMR (500 MHz, CDCl₃) δ8.64 (m, 1H), 7.91 (d, J=8.3 Hz, 2H), 7.74-7.63 (m, 4H), 7.59 (d, J=7.8 Hz, 1H), 7.46-7.41 (m, 3H), 7.19 (m, 1H), 7.07 (br s, 1H), 2.97 (m, 2H), 2.91 (m, 2H), 2.11 (m, 2H).

The following compounds were prepared similarly.

4-(3-Pyridyl)-phenyl 2-(3-cyanophenyl)-cyclopentene-1-carboxamide

¹H-NMR (500 MHz, CDCl₃) δ8.78 (d, J=1.9 Hz, 1H), 8.55 (dd, J=5.0, 1.4 Hz, 1H), 7.82 (m, 1H), 7.65 (m, 2H), 7.60 (d, J=7.8 Hz, 1H), 7.50-7.42 (m, 5H), 7.33 (m, 1H), 7.13 (br s, 1H), 2.97 (m, 2H), 2.90 (m, 2H), 2.11 (m, 2H).

4-(2-t-Butylaminosulfonylphenyl)-phenyl 2-(3-cyanophenylcyclopentene-1-carboxamide

¹H-NMR (500 MHz, CDCl₃) δ8.14 (dd, J=7.8, 1.4 Hz, 1H), 7.67 (s, 1H), 7.64 (d, J=7.8 Hz, 1H), 7.60 (m, 1H), 7.55-7.51 (m, 1H), 7.48-7.44 (m, 2H), 7.41 (s, 4H), 7.27 (dd, J=7.4, 1.4 Hz, 1H), 7.11 (br s, 1H), 3.57 (s, 1H), 2.97 (m, 2H), 2.91 (m, 2H), 2.11 (m, 2H), 1.00 (s, 9H).

5-(2-t-Butylaminosulfonylphenyl)-pyridine-2-yl 2-(3-cyanophenyl)-cyclopentene-1-carboxamide

¹H-NMR (500 MHz, CDCl₃) δ8.47 (d, J=2.3 Hz, 1H), 8.14 (d, J=7.8 Hz, 1H), 7.79-7.54 (m, 6H), 7.44 (m, 2H), 7.32 (m, 1H), 6.76 (d, J=8.3 Hz, 1H), 3.78 (s, 1H), 2.73 (m, 2H), 2.48 (m, 2H), 1.93 (m, 2H), 1.12 (s, 9H).

4-(2-t-Butylaminosulfonylphenyl)-phenyl 2-(4-cyanophenyl)-benzamide

¹H-NMR (500 MHz, CDCl₃) δ8.14 (d, J=7.8 Hz, 1H), 7.78 (d, J=7.4 Hz, 1H), 7.70 (d, J=8.3 Hz, 2H), 7.61-7.59 (m, 3H), 7.56-7.53 (m, 2H), 7.48-7.39 (m, 6H), 7.28 (d, J=7.3 Hz, 1H), 7.18 (s, 1H), 3.54 (s, 1H), 1.01 (s, 9H).

4-(2-t-Butylaminosulfonylphenyl)-phenyl 2-(3-cyanophenyl)-benzamide

¹H-NMR (500 MHz, CDCl₃) δ8.13 (dd, J=7.8, 1.4 Hz, 1H), 7.78 (m, 2H), 7.72 (d, J=7.8 Hz, 1H), 7.65 (d, J=7.8 Hz, 1H), 7.61-7.50 (m, 4H), 7.47-7.39 (m, 6H), 7.28 (dd, J=7.3, 0.9 Hz, 1H), 7.22 (s, 1H), 3.56 (s, 1H), 1.00 (s, 9H).

4-(2-t-Butylaminosulfonyl-phenyl)-phenyl 2-(3-cyanophenyl)-pyridine-3-carboxamide

¹H-NMR (500 MHz, CDCl₃) δ8.82 (dd, J=4.6, 1.4 Hz, 1H), 8.11-8.06 (m, 3H), 7.96 (d, J =8.3 Hz, 1H), 7.69 (d, J=7.8 Hz, 1H), 7.58-7.42 (m, 9H), 7.28 (d, J=7.8 Hz, 1H), 3.59 (s, 1H), 1.00 (s, 9H).

4-(2-t-Butylaminosulfonyl-5-methylphenyl)-phenyl-2-(3-cyanophenyl)-pyridine-3-carboxamide

¹H-NMR (500 MHz, CDCl₃) δ8.83 (dd, J=5.0, 1.8 Hz, 1H), 8.08 (dd, J=7.8, 1.9 Hz, 1H), 8.06 (s, 1H), 7.97 (d, J=8.3 Hz, 2H), 7.69 (d, J=7.8 Hz, 1H), 7.55-7.51 (m, 2H), 7.48-7.40 (m, 5H), 7.25 (m, 1H), 7.08 (s, 1H), 3.57 (s, 1H), 2.41 (s, 3H), 1.00 (s, 9H).

4-(2-t-butylaminosulfonyl-5-fluorophenyl)-phenyl 2-(3-cyanophenyl)-pyridine-3-carboxamide

¹H-NMR (500 MHz, CDCl₃) δ8.84 (dd, J=4.6, 1.4 Hz, 1H), 8.14 (dd, J=8.7, 5.5 Hz, 1H), 8.09 (m, 2H), 7.99 (d, J=7.8 Hz, 1H), 7.71 (d, J=7.8 Hz, 1H), 7.55 (m, 1H), 7.48 (dd, J=7.8, 5.1 Hz, 1H), 7.44 (s, 4H), 7.38 (s, 1H), 7.15 (m, 1H), 7.00 (dd, J=8.7, 2.3 Hz, 1H), 3.60 (s, 1H), 1.01 (s, 9H).

2-(3-Cyanophenyl)-phenyl phenylacetamide

¹H-NMR (500 MHz, CDCl₃) δ8.28 (d, J=8.3 Hz, 1H), 7.57 (dd, J=7.8, 1.4 Hz, 1H), 7.40-7.05 (m, 11H), 6.89 (br s, 1H), 3.63 (s, 2H).

### EXAMPLE 47

Removal of N-t-butyl Group from Sulfonamide (General Procedure)

Synthesis of 4-(2-aminosulfonylphenyl)-phenyl 2-(4-cyanophenyl)-benzamide 4-(2-t-butylaminosulfonylphenyl)-phenyl 2-(4-cyanophenyl)-benzamide was treated with 100% trifluoroacetic acid overnight at room temperature to give the title compound in a quantitative yield.

¹H-NMR (500 MHz, CDCl₃) δ8.73 (s, 1H), 8.08 (d, J=8.3 Hz, 1H), 7.68 (d, J=7.3 Hz, 1H), 7.65 (d, J=8.3 Hz, 2H), 7.56 (d, J=8.3 Hz, 2H), 7.53-7.34 (m, 9H), 7.26 (d, J=7.3 Hz, 1H), 4.89 (s, 2H).

Similar treatment of all the t-butylsulfonamides prepared afforded corresponding sulfonamide without event.

<Cyanophenylalanine Part>

### EXAMPLE 48

Diethyl 2-t-butoxycarbonylamino malonate

A solution of diethyl 2-aminomalonate (5 g, 23.6 mmol) and (Boc)₂O (5.65 g, 25.96 mmol) in CH₂Cl₂ (50 mL) was treated slowly with Et₃N (2.43 g, 24 mmol) for 10 minutes. After stirring 3 h at room temperature, the reaction was washed twice with water, dried and concentrated to give 6.16 g (95%) of the title compound.

¹H-NMR (500 MHz, CDCl₃) δ5.54 (d, J=7.3 Hz, 1H), 4.93 (d, J=7.8 Hz, 1H), 4.26 (m, 4H), 1.44 (s, 9H), 1.29 (t, J=6.9 Hz, 6H).

### EXAMPLE 49

Diethyl 2-t-butoxycarbonylamino-2-(3-cyanophenyl)methyl malonate

NaOEt was prepared by dissolving Na (440 mg) in absolute ethanol (30 mL) under N₂ at ambient temperature. To the NaOEt solution at 0° C. was added dropwise diethyl 2-t-butoxycarbonylamino malonate (4 g, 14.5 mmol). After 10 minutes, a solution of 3-bromomethylbenzonitrile (3.13 g, 15.13 mmol) in dry THF (7 mL) was added dropwise, and the solution was stirred for 2 h at 0° C. After concentration, the residue was taken up with EA, washed with the saturated NH₂Cl and then brine, dried and concentrated to give 5.38 g (95%) of the title compound.

The following compounds were prepared similarly.

Diethyl 2-t-butoxycarbonylamino-2-(3-cyano-6-t-butyloxy-phenyl)methyl malonate

¹H-NMR (500 MHz, CDCl₃) δ7.44 (dd, J=8.7, 2.3 Hz, 1H), 7.35 (s, 1H), 7.06 (d, J=8.3 Hz, 1H), 5.67 (s, 1H), 4.32 (m, 2H), 4.15 (m, 2H), 3.62 (s, 2H), 1.47 (s, 9H), 1.41 (s, 9H), 1.25 (m, 6H).

Diethyl 2-t-butoxycarbonylamino-2-(2-cyano-pyridine-4-yl-methyl) malonate

### EXAMPLE 50

N-t-butoxycarbonyl-3-(3-cyanophenyl)alanine

To a refluxing solution of diethyl 2-t-butoxycarbonylamino-2-(3-cyanophenyl) malonate (5.38 g, 13.8 mmol) in EtOH (40 mL) was added dropwise 1.5 N NaOH (20 mL). After refluxing for 3 h, volatiles were removed in vacuo. The residue at 0° C. was neutralized with 1N HCl, extracted with CH₂Cl₂. The organic extract was dried (MgSO₄) and concentrated to give 3.5 g (12 mmol, 87%) of the title compound.

¹H-NMR (500 MHz, CDCl₃) δ7.55 (d, J=7.3 Hz, 1H), 7.48 (s, 1H), 7.45-7.40 (m, 2H), 5.02 (d, J=6.0 Hz, 1H), 4.61 (m, 1H), 3.27 (m, 1H), 3.09 (m, 1H), 1.41 (s, 9H).

The following compounds were prepared similarly.

N-t-butoxycarbonyl-3-(3-cyano-6-t-butoxy-phenyl)alanine

N-t-butoxycarbonyl-3-(2-cyanopyridine-4-yl)alanine

### EXAMPLE 51

(S)-N-t-butoxycarbonyl-3-(3-cyanophenyl)alanine methyl ester

To a flask containing 6N NaOH (1 mL) and Et₂O (3 mL) at 0° C. was added MNNG (588 mg, 4 mmol) cautiously (generating gas). If gas was not generated, then the organic layer was dried with KOH pellets. To an another flask containing (S)N-t-butoxycarbonyl-3-(3-cyanophenyl)alanine (610 mg, 2.1 mmol) in dry THF at 0° C. was added the diazomethane. After 10 minutes, acetic acid was added slowly to the solution to remove excess diazomethane. The reaction was washed twice with brine, dried (MgSO₄) and concentrated to give 609 mg (2 mmol, 95%) of the title compound.

¹H-NMR (500 MHz, CDCl₃) δ7.53-7.39 (m, 4H), 5.03 (m, 1H), 4.55 (m, 1H), 4.18 (q, J=6.9 Hz, 2H), 3.18 (m, 1H), 3.06 (m, 1H), 1.42 (s, 9H), 1.24 (t, J=6.9 Hz, 3H).

### EXAMPLE 52

2-(t-butoxycarbonylamino)-3-(3-cyanophenyl)-propan-1-ol (racemic)

To a solution of 5.0 g of 2-(t-butoxycarbonylamino)-3-(3-cyanophenyl)-propanoic acid and 2.1 mL (1.10 eq) of NMM in 50 mL of dry THF was added 2.3 mL (1.05 eq) of i-Butyl chloroformate under N2 at 0° C. After 30 min, the slurry was added via a glass filter to a solution of 1.3 g (1.0 eq) of NaBH₄ in 20 mL of MeOH/80 mL of TBF at −78° C. and the whole mixture was stirred at −78° C. for 3 hr. The reaction was quenched with 3.9 mL of AcOH and concentrated under reduced pressure. The resulting slurry was dissolved in Ethyl acetate and water. satd NaHCO₃ and brine. The organic layer was washed with satd NaHCO₃ and brine, and dried over anhydrous Na₂SO₄. Short filtration through Si gel gave 3.67 g (77%) of 2-(t-butoxycarbonylamino)-3-(3-cyanophenyl)-propan-1-ol

¹H-NMR (500 MHz, CDCl₃) δ7.53-7.39 (m, 4H), 4.77 (m, 1H), 3.85 (m, 1H), 3.67 (m, 1H), 3.56 (m, 1H), 2.89 (m, 2H), 1.40 (s, 9H).

### EXAMPLE 53

1-(4-iodophenoxy)-2-t-butoxycarbonylamino-3-(3-cyanophenyl)-propane (racemic)

To a solution of 192 mg of 2-(t-butoxycarbonylamino)-3-(3-cyanophenyl)-propan-1-ol, 202 mg of PPh₃ and 168 mg (1.1 eq) of 4-iodophenol in 5 mL of THF was added 0.12 mL (1.1 eq) of DEAD under N₂ at 0° C. After stirring for 6 h by conventional work-up and purification 165 mg (49%) of 1-(4-iodophenoxy)-2-t-butoxycarbonylamino-3-(3-cyanophenyl)-propane was obtained.

¹H-NMR (500 MHz, CDCl₃) δ7.65 (s, 1H), 7.58-7.38 (m, 5H), 6.66 (d, 2H), 4.90 (m, 1H), 4.16 (m, 1H), 3.92-3.83 (m, 2H), 2.88 (dd, J=14.7, 4.6 Hz, 1H), 2.76 (dd, J=14.7, 6.9 Hz, 1H), 1.40 (s, 9H).

### EXAMPLE 54

(S)-N-{4-(2-t-butylaminosulfonylphenyl)-benzoyl}-3-(3-cyanophenyl)alanine methyl ester

To a solution of (S)-N-t-butoxycarbonyl-3-(3-cyanophenyl)alanine methyl ester (639 mg, 2.2 mmol) in methanol (5 mL) at 0° C. was added acetyl chloride (1 mL) slowly. After stirring for 2 h at 0° C., the reaction was concentrated in vacuo. Ether was added to the residue which was solidified to give (s)-3-(3-cyanophenyl)alanine methyl ester hydrochloride (430 mg, 1.79 mmol).

To a solution of 4-(2-t-butylaminosulfonylphenyl)-benzoic acid (195 mg, 0.7 mmol) and (S)-3-(3-cyanophenyl)alanine methyl ester hydrochloride (202 mg, 0.84 mmol) in DMF (10 mL) at 0° C. was added HOBT (123 mg, 0.91 mmol), EDC (174 mg, 0.91 mmol) and finally Et₃N (0.29 mL, 2.1 mmol). After stirring at 0° C. for 15 h, DMF was removed in high-vacuum rotary evaporator. The residue was taken up with EA, washed with water, dried (MgSO₄), filtered and concentrated. Flash chromatography afforded 218 mg (0.468 mmol, 67%) of the title compound.

¹H-NMR (500 MHz, CDCl₃) δ8.18 (d, J=8.3 Hz, 1H), 7.82 (d, J=8.3 Hz, 2H), 7.60-7.40 (m, 8H), 7.28 (m, 1H), 6.74 (d, J=7.3 Hz, 1H), 5.07 (m, 1H), 4.25 (q, J=7.4 Hz, 2H), 3.57 (s, 1H), 3.37 (m, 1H), 3.28 (m, 1H), 1.30 (t, J=7.4 Hz, 3H), 1.02 (s, 9H).

The following intermeidates were prepared similarly.

(S)-N-[4-(2-aminosulfonyl-5-methyl-phenyl)-benzoyl]-3-(3-cyanophenyl)alanine methyl ester

¹H-NMR (500 MHz, CDCl₃) δ8.04 (d, J=8.3 Hz, 1H), 7.79 (d, J=8.3 Hz, 2H), 7.55 (m, 3H), 7.44 (m, 3H), 7.32 9d, J=7.8 Hz, 1H), 7.12 (s, 1H), 6.77 (1NH), 5.09 (m, 1H), 4.28 (s, 2H), 3.80 (s, 3H), 3.39 (dd, J=14.2, 5.5 Hz, 1H), 3.24 (dd, J=14.2, 6.0 Hz, 1H), 2.44 (s, 3H).

(S)-N-[4-(2-aminosulfonylphenyl)-benzoyl]-3-(3-cyanophenyl)alanine ethyl ester

¹H-NMR (500 MHz, CDCl₃) δ8.16 (d, J=8.3 Hz, 1H), 7.77 (d, J=8.3 Hz, 2H), 7.63-7.44 (m, 8H), 7.33 (d, J=7.4 Hz, 1H), 7.00 (d, J=6.9 Hz, 1H), 5.08 (m, 1H), 4.45 (br, 2H), 4.27 (m, 2H), 3.38 (dd, J=14.2, 6.4 Hz, 1H), 3.28 (dd, J=14.2, 6.0 Hz, 1H), 1.31 (t, J=7.3 Hz, 3H).

(S)-N-[4-(2-aminosulfonylphenyl)-benzoyl]-3-(3-cyanophenyl)alanine methyl ester

¹H-NMR (500 MHz, CDCl₃) δ8.17 (d, J=8.3 Hz, 1H), 7.79 (d, J=8.3 Hz, 2H), 7.63-7.42 (m, 8H), 7.32 (d, J=7.4 Hz, 1H), 6.78 (d, J=7.3 Hz, 1H), 5.10 (m, 1H), 4.34 (s, 2H), 3.80 (s, 3H), 3.41-3.22 (m, 2H).

(S)-N-[4-(2-aminosulfonylphenyl)-benzoyl]3-(3-cyanophenyl)alanine

(S)-N-[4-(2-cyanophenyl)-benzoyl]-3-(3-cyanophenyl)alanine methyl ester

¹H-NMR (500 MHz, CDCl₃) δ7.85 (d, J=8.3 Hz, 2H), 7.79 (d, J=7.4 Hz, 1H), 7.69-7.63 (m, 3H), 7.57-7.47 (m, 3H), 7.45-7.41 (m, 3H), 6.73 (d, J=6.9 Hz, 1H), 5.11 (m, 1H), 3.80 (s, 3H), 3.38 (dd, J=14.3, 6.0 Hz, 1H), 3.25 (dd, J=14.3, 5.5 Hz, 1H).

(S)-N-[4-(2-t-butylaminosulfonyl-5-fluoro-phenyl)-benzoyl]-3-(3-cyanophenyl)alanine methyl ester

¹H-NMR (500MHz, CDCl₃) δ8.19 (dd, J=9.3, 6.0 Hz, 1H), 7.82 (d, J=7.8 Hz, 2H), 7.57 (m, 3H), 7.43 (m, 3H), 7.18 (m, 1H), 7.00 (dd, J=8.7, 2.8 Hz, 1H), 6.72 (d, J=6.9 Hz, 1H), 5.11 (m, 1H), 3.81 (s, 3H), 3.58 (s, 1H), 3.39 (dd, J=14.2, 6.0 Hz, 1H), 3.26 (dd, J=14.2, 5.5 Hz, 1H), 1.04 (s, 9H).

### EXAMPLE 55

4-(2-aminocarbonylphenyl)-phenyl N-t-butoxycarbonyl-3-3-cyanophenyl) alanine amide

A solution of N-t-butoxycarbonyl-3-(3-cyanophenyl)alanine (190 mg), 4-(2-aminocarbonylphenyl)alanine (127 mg) and HATU (297 mg) in DMF (4 mL) was treated with DIPEA (232 mg), and stirred for 10 h. After removing DMF, the residue was taken up with EA, washed with saturated NaHCO₃, dried (MgSO₄), filtered and concentrated. Flash chromatography with Hex: EA=1:1 gave 278 mg (95%) of the title compound.

¹H-NMR (500 MHz, DMSO-d₆) δ10.11 (s, 1H), 7.79 (s, 1H), 7.68 (m, 2H), 7.60-7.35 (m, 10H), 7.25 (s, 1H), 7.19 (d, J=9.2 Hz, 1H), 4.37 (m, 1H), 3.09 (m, 1H), 2.90 (m, 1H), 1.31 (s, 9H).

The following intermediates were prepared similarly.

4-(2-t-Butylaminosulfonyl-5-fluoro-phenyl)-phenyl N-t-butoxycarbonyl-3-(3-cyanophenyl)alanine amide (racemic)

¹H-NMR (500 MHz, CDCl₃) δ8.41 (br, 1H), 8.18 (dd, J=8.7, 5.5 Hz, 1H), 7.56-7.40 (m, 8H), 7.14 (m, 1H), 6.99 (dd, J=9.2, 2.8 Hz, 1H), 5.15 (d, J=7.8 Hz, 1H), 4.51 (m, 1H), 3.68 (s, 1H), 3.30 (dd, J=14.2, 6.4 Hz, 1H), 3.08 (dd, J=14.2, 7.8 Hz, 1H), 2.80 (s, 3H), 1.42 (s, 9H), 1.01 (s, 9H).

4-(2-t-Butylaminosulfonylphenyl)-phenyl N-methoxycarbonyl-3-(3-cyanophenyl)alanine amide (racemic)

¹H-NMR (500 MHz, CDCl₃) δ8.16 (d, J=7.8 Hz, 1H), 8.12 (br, 1H), 7.56-7.40 (m, 10H), 7.28 (d, J=7.8 Hz, 1H), 5.33 (br d, 1H), 4.56 (m, 1H), 3.70 (s, 3H), 3.69 (br, 1H), 3.30-3.12 (m, 2H), 1.05 (s, 9H).

4-(2-Cyanophenyl)-phenyl N-t-butoxycarbonyl-3-(3-cyanophenyl)alanine amide (racemic)

¹H-NMR (500 MHz, CDCl₃) δ8.23 (br, 1H), 7.75 (d, 1H), 7.64-7.42 (m, 11H), 5.07 (m, 1H), 4.50 (m, 1H), 3.31 (m, 1H), 3.09 (m, 1H), 1.41 (s, 9H).

4-(2-Aminosulfonylphenyl)-phenyl N-t-butoxycarbonyl-3-(3-cyano-6-t-butoxy-phenyl)alanine amide (racemic)

¹H-NMR (500 MHz, CDCl₃) δ8.46 (br, 1H), 8.14 (d, J=8.3 Hz, 1H), 7.58-7.42 (m, 8H), 7.32 (d, J=7.8 Hz, 1H), 7.13 (d, J=8.7 Hz, 1H), 5.65 (d, J=6.9 Hz, 1H), 5.45 (m, 1H), 4.30 (s, 2H), 3.21 (m, 1H), 3.09 (m, 1H), 1.56 (s, 9H), 1.41 (s, 9H).

### EXAMPLE 56

(S)-3-(3-cyanophenyl)-1-hydroxy-propane-2-yl 4-(2-aminosulfonyl-5-fluorophenyl)-benzamide

A solution of (S)-N-{4-(2-aminosulfonyl-5-fluoro-phenyl)-benzoyl}-3-(3-cyanophenyl)alanine (obtained from hydrolysis of the corresponding methyl ester) (108 mg, 0.23 mmol) and N-methylmorpholine (50 uL, 2.0 eq) in THF at −40° C. was treated with isobutyl chloroformate (31 uL, 1.05 eq), and the suspension was stirred for 30 minutes. The suspension was added via a glass filter to a solution of NaBH₄ (17 mg, 2.0 eq) in MeOH (5 mL) at −78° C. The solution was stirred for 2 h while allowing to be warmed up to room temperature. After concentration, the residue was worked up as usual. Flash chromatography gave 33 mg (32%) of the title compound.

¹H-NMR (500 MHz, CDCl₃) δ8.15 (dd, J=8.7, 5.5 Hz, 1H), 7.76 (dJ, J=8.0 Hz, 2H), 7.56-7.40 (m, 6H), 7.19 (m, 1H), 7.01 (dd, J=8.3, 2.3 Hz, 1H), 6.79 (d, J=8.3 Hz, 1H), 4.60 (s, 2H), 3.78 (m, 1H), 3.67 (m, 1H), 3.04 (d, J=7.4 Hz, 2H).

### EXAMPLE 57

4-(2-t-butylaminosulfonylphenyl)-phenyl N-methanesulfonyl-3-(3-cyanophenyl)alanine amide

A solution of 4-(2-t-butylaminosulfonylphenyl)-phenyl N-t-butoxycarbonyl-3-(3-cyanophenyl)alanine amide (163 mg, 0.28 mmol) in CH₂Cl₂ (5 mL) was treated with TFA (2.5 mL). After stirring for 3 h at room temperature, the reaction was concentrated. The residue was dissolved in dry CH₂Cl₂, and cooled to −20° C. To the solution was added TEA (78 uL, 0.56 mmol) and methanesulfonyl chloride (26 uL, 0.33 mmol) dropwise. After stirring for 30 minutes at −20° C., the reaction was diluted with EA, washed with water, dried (MgSO₄), filtered and concentrated. Flash chromatography gave 70 mg (0.119 mmol, 43%) of the title compound.

The following compounds were prepared similarly.

1-(4-Iodophenoxy)-2-methanesulfonylino-3-(3-cyanophenyl)-propane (racemic)

¹H-NMR (500 MHz, CDCl₃) δ7.60-7.42 (m, 6H), 6.65 (d, J=9.2 Hz, 2H), 4.67 (d, J=9.2 Hz, 1H), 4.00-3.89 (m, 3H), 3.06 (m, 2H), 2.74 (s, 3H).

4-(2-Aminocarbonylphenyl)-phenyl N-methanesulfonyl-3-(3-cyanophenyl)alanine amide (racemic)

¹H-NMR (500 MHz, DMSO-d₆) δ10.22 (s, 1H), 7.84-7.80 (m, 2H), 7.72 (d, J=7.4 Hz, 1H), 7.66 (d, J=7.8 Hz, 1H), 7.58-7.35 (m, 10H), 7.25 (s, 1H), 4.28 (m, 1H), 3.12 (m, 1H), 2.94 (m, 1H), 2.68 (s, 3H).

4-(2-Cyanophenyl)-phenyl N-methanesulfonyl-3-(3-cyanophenyl)alanine amide (racemic)

¹H-NMR (500 MHz, DMSO-d₆) δ10.36 (s, 1H), 7.93 (d, J=6.8 Hz, 1H), 7.86 (m, 1H), 7.80-7.76 (m, 2H), 7.72 (m, 3H), 7.67 (d, J=7.8 Hz, 1H), 7.61 (d, J=7.4 Hz, 1H), 7.58-7.53 (m, 4H), 4.30 (m, 1H), 3.13 (dd, J=13.8, 5.5 Hz, 1H), 2.95 (dd, J=13.8, 10.1 Hz, 1H), 2.68 (s, 3H).

4-(2-t-Butylaminosulfonyl-5-fluoro-phenyl)-phenyl N-methanesulfonyl-3-(3-cyanophenyl)alanine amide (racemic)

¹H-NMR (500 MHz, CDCl₃) δ8.44 (s, 1H), 8.19 (dd, J=8.7, 5.5 Hz, 1H), 7.62-7.43 (m, 8H), 7.17 (m, 1H), 7.00 (m, 1H), 5.46 (d, J=8.7 Hz, 1H), 4.32 (m, 1H), 3.92 (s, 1H), 3.30 (m, 1H), 3.09 (m, 1H), 2.68 (s, 3H), 1.04 (s, 9H).

4-(2-Aminosulfonylphenyl)-phenyl N-methoxycarbonyl-3-(3-cyano-6-t-butoxy-phenyl)alanine amide

¹H-NMR (500 MHz, CDCl₃) δ8.31 (br, 1H), 8.14 (d, J=7.8 Hz, 1H), 7.59-7.42 (m, 8H), 7.32 (d, J=7.4 Hz, 1H), 7.14 (d, J=8.7 Hz, 1H), 5.90 (d, J=6.9 Hz, 4H), 4.48 (m, 1H), 4.32 (s, 2H), 3.67 (s, 3H), 3.15 (m, 2H), 1.55 (s, 9H).

4-(2-Cyanophenyl)-phenyl N-(t-butoxycarbonylmethyl)-3-(3-cyanophenyl)alanine amide

¹H-NMR (500 MHz, CDCl₃) δ9.44 (s, 1H), 7.75 (dd, J=7.8, 0.9 Hz, 1H), 7.71 (d, J=8.7 Hz, 2H), 7.63 (m, 1H), 7.58-7.50 (m, 6H), 7.46-7.41 (m, 2H), 3.49 (dd, J=8.3, 4.6 Hz, 1H), 3.34-3.23 (m, 3H), 3.04 (dd, J=13.7, 7.8 Hz, 1H), 1.44 (s, 9H).

### EXAMPLE 58

4-(2-aminosulfonylphenyl)-phenyl N-methanesulfonyl-3-(3-cyanophenyl)alanine amide

4-(2-t-butylaminosulfonylphenyl)-phenyl N-methanesulfonyl-3-(3-cyanophenyl)alanine amide (70 mg, 0.119 mmol) was treated with TFA (5 mL) and stirred for 20 h at room temperature. Concentration gave 63 mg of the title compound.

t-Butyl in t-butylaminosulfonyl group was removed by similar treatment.

### EXAMPLE 59

4-Iodophenyl (S)-N-t-butoxycarbonyl-3-(3-cyanophenyl)alanine amide

A solution of N-t-butoxycarbonyl-3-(3-cyanophenyl)alanine (890 mg, 2.89 mmol), 4-iodoaniline (831 mg, 1.1 eq) and HATU (1.70 g, 1.3 eq) in DMF (10 mL) at 0° C. was treated with TEA (1.45 mL, 3.0 eq), and stirred for 24 h at room temperature. After removal of DMF, conventional workup followed by flash chromatography gave 1.07 g (75%) of the title compound as white powder.

¹H-NMR (500 MHz, CDCl₃) δ8.28 (br, 1H), 7.61-7.19 (m, 8H), 5.14 (br, 1H), 4.47 (m, 1H), 3.26 (dd, J=13.8, 6.4 Hz, 1H), 3.04 (dd, J=13.8, 8.3 Hz, 1H), 1.41 (s, 9H).

The following compounds were prepared similarly.

5-Bromo-pyridine-2-yl (S)-N-t-butoxycarbonyl-3-(3-cyanophenyl)alanine amide

¹H-NMR (500 MHz, CDCl₃) δ8.77 (br, 1H), 8.30 (d, J=2.3 Hz, 1H), 8.11 (d, J=8.7 Hz, 1H), 7.81 (dd, J=8.7, 2.3 Hz, 1H), 7.53-7.37 (m, 4H), 5.34 (br, 1H), 4.59 (m, 1H), 3.29 (dd, J =14.2, 6.6 Hz, 1H), 3.04 (dd, J=14.2, 8.3 Hz, 1H), 1.40 (s, 9H).

4-Iodophenyl (S)-N-methanesulfonyl-3-(3-cyanophenyl)alanine amide

¹H-NMR (500 MHz, DMSO-d₆) δ10.22 (s, 1H), 7.83 (d, J=8.7 Hz, 1H), 7.78 (s, 1H), 7.71-7.38 (m, 7H), 4.23 (m, 1H), 3.08 (dd, J=13.8, 5.5 Hz, 1H), 2.91 (dd, J=13.8, 9.2 Hz, 1H), 2.65 (s, 3H).

### EXAMPLE 60

N-(4-bromobenzoyl)-3-(3-cyanophenyl)alanine methyl ester

A solution of 3-(3-aminophenyl)alanine methyl ester (489 mg, 2.39 mmol), 4-bromobenzoic acid (528 mg, 1.1 eq), EDC (593 mg, 1.3 eq) and HOBT (419 mg, 1.3 eq) in DMF at 0° C. was treated with TEA (1.0 mL, 3.0 eq ), and the resulting solution was stirred for 24 h at room temperature. Conventional workup followed by flash chromatography gave 835 mg (90%) of the title compound as white powder.

### EXAMPLE 61

4-(2-pyridyl)-phenyl (S)-N-methanesulfonyl-3-(3-cyanophenyl)alanine amide

A solution of 4-Iodophenyl (S)-N-methanesulfonyl-3-(3-cyanophenyl)alanine amide (234 mg, 0.50 mmol), Pd(PPh₃)₄ (29 mg, 5 mol %), LiCl (64 mg, 3.0 eq) and CuBr (14 mg, 0.2 eq) in dioxane (5 mL) under N₂ at room temperature was treated slowly with 2-tributyltinpyridine (203 mg, 1.1 eq), and the resulting mixture was refluxed for 1 day. Conventional workup followed by flash chromatography gave 118 mg (58%) of the title compound as an oil.

The following intermediates were prepared similarly.

4-(2-t-butylaminosulfonyl-5-fluoro-phenyl)-phenyl N-t-butoxycarbonyl-3-(3-cyanophenyl)alanine amide

¹H-NMR (500 MHz, CDCl₃) δ8.31 (br, 1H), 8.17 (dd, J=8.7, 5.5 Hz, 1H), 7.56-7.51 (m, 5H), 7.47-7.41 (m, 3H), 7.14 (m, 1H), 7.00 (dd, J=9.2, 2.8 Hz, 1H), 5.08 (br, 1H), 4.50 (m, 1H), 3.65 (s, 1H), 3.31 (dd, J=14.2, 6.5 Hz, 1H), 3.09 (dd, J=14.2, 7.8 Hz, 1H), 1.43 (s, 9H), 1.01 (s, 9H).

4-(2-cyanophenyl)-phenyl N-methoxycarbonyl-3-(3-cyanophenyl)alanine amide

¹H-NMR (500 MHz, CDCl₃) δ8.11 (br, 1H), 7.75 (d, J=7.8 Hz, 1H), 7.63 (m, 1H), 7.59-7.48 (m, 8H), 7.43 (m, 2H), 5.30 (br, 1H), 4.54 (m, 1H), 3.71 (s, 3H), 3.28 (m, 1H), 3.13 (m, 1H).

4-(2-cyanophenyl)-phenyl N-methanesulfonyl-3-(3-cyanophenyl)alanine amide

¹H-NMR (500 MHz, CDCl₃) δ8.33 (s, 1H), 7.75 (d, J=7.8 Hz, 1H), 7.65-7.43 (m, 11H), 5.30 (d, J=9.2 Hz, 1H), 4.31 (m, 1H), 3.26 (m, 1H), 3.11 (m, 1H), 2.88 (m, 1H), 2.81 (m, 1H), 1.23 (m, 3H).

Final Amidinations and Prodrug Formations

<Cyclopropyl Scaffold>

### EXAMPLE 62a

Cyclopropyl Scaffold (H₂S Method)

4-(2-aminosulfonylphenyl)-phenyl trans-2-(3-aminoiminomethylphenyl)-cyclopropane-1-carboxamide mono trifluoroacetic acid salt (Compound No. A1-1)

4-(2-aminosulfonylphenyl)-phenyl trans-2-(3-cyanophenyl)-cyclopropane-1-carboxamide (128 mg, 0.344 mmol) was dissolved in saturated H₂S/pyridine-THA (3:1) (5 mL), and the solution was stirred for 12 h at room temperature. After concentration, the residue was treated with 0.5N-HCl (10 mL), then extracted with EA (10 mL×3), dried, filtered and concentrated. The crude intermediate was dissolved in acetonitrile (7 mL), treated with methyl iodide (0.5 mL×3), refluxed for 3 h, then concentrated in vacuo. The crude methylthio imidate salt; was dissolved in MeOH (8 mL), treated with ammonium acetate (106 mg, 4 eq, freshly dried with warming), and then refluxed for 12 h. After concentration, the reaction was isolated and purified with prep HPLC (reverse phase) using acetonitrile/0.1% trifluoroacetic acid in water. Collected fractions were concentrated until most of acetonitrile was removed, then lyophilized to give 89 mg (47%) of the title compound as a trifluoroacetic acid salt;.

¹H-NMR (500 MHz, DMSO-d₆) δ10.37 (s, 1H), 9.30 (s, 2H), 9.10 (s, 2H), 8.02 (dd, J=7.8, 1.4 Hz, 1H), 7.67-7.53 (m, 8H), 7.33 (d, J=8.8 Hz, 2H), 7.30 (d, J=7.8 Hz, 1H), 7.19 (s, 2H), ˜2.50 (m, 1H), 2.20 (m, 1H), 1.57 (m, 2H).

The following inhibitors were prepared similarly.

4-(2-aminosulfonylphenyl)-phenyl cis-2-(3-aminoiminomethylphenyl)-cyclopropane-1-carboxamide mono trifluoroacetic acid salt (Compound No. A1-2)

¹H-NMR (500 MHz, DMSO-d₆) δ10.30 (s, 1H), 9.30 (s, 2H), 9.09 (s, 2H), 7.99 (d, J=7.8 Hz, 1H), 7.73 (s, 1H), 7.64-7.43 (m, 7H), 7.24 (m, 3H), 7.19 (s, 2H), 2.65 (m, 1H), 2.36 (m, 1H), 1.76 (m, 1H), 1.42 (m, 1H).

4-(2-aminosulfonyl-5-methyl-phenyl)-phenyl trans 2-(3-aminoiminomethylphenyl-cyclopropane-1-carboxamide mono trifluoroacetic acid salt (Compound No. A1-3, from less polar isomer)

¹H-NMR (500 MHz, DMSO-d₆) δ10.34 (s, 1H), 9.29 (s, 2H), 9.06 (s, 2H), 7.89 (d, J=8.3 Hz, 1H), 7.66-7.55 (m, 6H), 7.35-7.31 (m, 3H), 7.11 (s, 1H), 7.07 (s, 2H), 2.50 (m, 1H), 2.38 (s, 3H), 2.20 (m, 1H), 1.59 (m, 2H).

4-(2-aminosulfonyl-5-methyl-phenyl)-phenyl cis-2-(3-aminoiminomethylphenyl)-cyclopropane-1-carboxamide mono trfluoroacetic acid salt (Compound No. A1-4, from more polar isomer)

¹H-NMR (500 MHz, DMSO-d₆) δ10.26 (s, 1H), 9.29 (s, 2H), 8.94 (s, 2H), 7.87 (d, J=7.8 Hz, 1H), 7.72 (s, 1H), 7.63 (d, J=7.8 Hz, 1H), 7.58 (d, J=6.9 Hz, 1H), 7.48 (m, 1H), 7.42 (d, J=8.2 Hz, 2H), 7.32 (d, J=7.8 Hz, 1H), 7.22 (d, J=7.8 Hz, 2H), 7.07 (s, 2H), 7.05 (s, 1H), 2.65 (m, 1H), 2.35 (m+s, 4H), 1.76 (m, 1H), 1.42 (m, 1H).

4-(2-cyanophenyl)-phenyl cis-2-(3-aminoiminomethylphenyl)-cyclopropane-1-carboxamide mono trifluoroacetic acid salt (Compound No. A1-5)

¹H-NMR (500 MHz, DMSO-d₆) δ10.42 (s, 1H), 9.29 (s, 2H), 8.91 (s, 2H), 7.90 (d, J=7.8 Hz, 1H), 7.76-7.73 (m, 2H), 7.64-7.43 (m, 9H), 2.66 (m, 1H), 2.37 (m, 1H), 1.76 (m, 1H), 1.44 (m, 1H).

4-(2-methanesulfonylphenyl)-phenyl cis-2-(3-aminoiminomethylphenyl)-cyclopropane-1-carboxamide mono trifluoroacetic acid salt (Compound No. A1-6)

¹H-NMR (500 MHz, DMSO-d₆) δ10.38 (s, 1H), 9.30 (s, 2H), 9.05 (s, 2H), 8.05 (d, J=7.8 Hz, 1H), 7.74-7.71 (m, 2H), 7.65-7.59 (m, 3H), 7.49-7.46 (m, 3H), 7.33 (d, J=7.8 Hz, 1H), 7.25 (d, J=8.7 Hz, 2H), 2.77 (s, 3H), 2.66 (m, 1H), 2.36 (m, 1H), 1.76 (m, 1H), 1.44 (m, 1H).

4-(2-cyanophenyl)-phenyl [1,2]-cis, [2,3]-cis-2-(3-aminoiminomethylphenyl)cyclopropane-1-carboxamide mono trifluoroacetic acid salt (Compound No. A1-7)

¹H-NMR (500 MHz, DMSO-d₆) δ10.49 (s, 1H), 9.27 (s, 2H), 8.89 (s, 2H), 7.92 (d, J=6.9 Hz, 1H), 7.78-7.74 (m, 2H), 7.65-7.58 (m, 5H), 7.56-7.48 (m, 1H), 3.90 (m, 1H), 3.73 (m, 1H), 2.81 (m, 4H), 2.34 (m, 1H), 1.91 (m, 1H).

3-aminoiminomethylbenzyl trans-2-(3-aminoiminomethylphenyl)-cyclopropane-1-carboxamide bis trifluoroacetic acid salt (Compound No. A1-8)

¹H-NMR (500 MHz, DMSO-d₆) δ9.28 (br, 8H), 8.6 (t, J=6.0 Hz, 1H), 7.72 (s, 1H), 7.63-7.55 (m, 4H), 7.47-7.42 (m, 2H), 7.25 (d, J=7.8 Hz, 1H), 4.19 (m, 2H), 2.54 (m, 1H), 2.18 (m, 1H), 1.65 (m, 1H), 1.31 (m, 1H).

3-aminoiminomethylbenzyl cis-2-(3-aminoiminomethylphenyl)-cyclopropane-1-carboxamide bis trifluoroacetic acid salt (Compound No. A1-9)

¹H-NMR (500 MHz, DMSO-d₆) δ9.32 (s, 2H), 9.28 (s, 2H), 9.15 (br s, 4H), 8.75 (m, 1H), 7.70-7.49 (m, 8H), 4.47-4.33 (m, 2H), 2.41 (m, 1H), 2.04 (m, 1H), 1.46 (m, 1H), 1.40 (m, 1H).

4-(1-imidazolyl)-phenyl cis-2-(3-aminoiminomethylphenyl)-cyclopropane-1-carboxamide bis trifluoroacetic acid salt (Compound No. A1-10)

¹H-NMR (500 MHz, DMSO-d₆) δ10.59 (s, 1H), 9.48 (s, 1H), 9.30 (s, 2H), 9.21 (s, 2H), 8.14 (s, 1H), 7.84 (s, 1H), 7.74 (s, 1H), 7.63 (s, 4H), 7.61 (d, J=7.8 Hz, 2H), 7.47 (t, J=7.8 Hz, 1H), 2.68 (m, 1H), 2.35 (m, 1H), 1.74 (m, 1H), 1.44 (m, 1H).

4-(2-aminosulfonyl-5-fluorophenyl)-phenyl cis-2-(3-aminoiminomethylphenyl)-cyclopropane-1-carboxamide trifluoroacetic acid salt (Compound No. A1-11)

¹H-NMR (500 MHz, DMSO-d₆) δ10.32 (s, 1H), 9.30 (s, 2H), 8.97 (s, 2H), 8.04 (dd, J=8.7, 5.5 Hz, 1H), 7.72 (s, 1H), 7.63 (d, J=7.8 Hz, 1H), 7.58 (d, J=7.8 Hz, 1H), 7.50-7.38 (m, 4H), 7.29 (s, 2H), 7.26 (d, J=8.3 Hz, 2H), 7.11 (m, 1H), 2.67 (m, 1H), 2.35 (m, 1H), 1.75 (m, 1H), 1.43 (m, 1H).

5-(2-aminosulfonylphenyl)-pyridine-2-yl cis-2-(3-aminoiminomethylphenyl)cyclopropane-1-carboxamide bis trifluoroacetic acid salt; (Compound No. A1-12)

¹H-NMR (500 MHz, DMSO-d₆) δ10.85 (s, 1H), 9.30 (s, 3H), 8.90 (s, 2H), 8.23 (s, 1H), 8.01 (d, J=7.4 Hz, 1H), 7.79 (d, J=9.6 Hz, 1H), 7.70 (s, 1H), 7.66-7.57 (m, 5H), 7.48 (m, 1H), 7.39 (s, 2H), 7.32 (d, J=7.3 Hz, 1H), 2.69 (m, 1H), 2.55 (m, 1H), 1.77 (m, 1H), 1.45 (m, 1H).

4-(2-cyanophenyl)-phenyl (1,2)-cis-(1,3-cis-2-(3-aminoiminomethylphenyl)-3-carboxycyclopropane-1-carboxamide trifluoroacetic acid salt; (Compound No. A1-13)

¹H-NMR (500 MHz, DMSO-d₆) δ10.64 (s, 1H), 9.29 (s, 2H), 8.89 (s, 2H), 7.92 (d, J=7.8 Hz, 1H), 7.90 (s, 1H), 7.77 (m, 1H), 7.71 (d, J=8.7 Hz, 1H), 7.64-7.47 (m, 8H), 2.97 (m, 1H), 2.69 (m, 1H), 2.61 (m, 1H).

4-(2-fluorophenyl)-phenyl cis-2-(3-aminoiminomethylphenyl)-cyclopropane-1-carboxamide trifluoroacetic acid salt (Compound No. A1-14)

¹H-NMR (500 MHz, DMSO-d₆) δ10.35 (s, 1H), 9.29 (s, 2H), 8.96 (s, 2H), 7.73 (s, 1H), 7.63-7.58 (m, 2H), 7.52-7.34 (m, 7H), 7.28-7.24 (m, 2H), 2.65 (m, 1H), 2.34 (m, 1H), 1.73 (m, 1H), 1.42 (m, 1H).

4-(2-chlorophenyl)-phenyl cis-2-(3-aminoiminomethylphenyl)-cyclopropane-1-carboxamide trifluoroacetic acid salt (Compound No. A1-15)

¹H-NMR (500 MHz, DMSO-d₆) δ10.36 (s, 1H), 9.29 (s, 2H), 9.12 (s, 2H), 7.74 (s, 1H), 7.63-7.59 (m, 2H), 7.53-7.46 (m, 4H), 7.40-7.33 (m, 3H), 7.28 (d, J=8.3 Hz, 2H), 2.65 (m, 1H), 2.35 (m, 1H), 1.75 (m, 1H), 1.42 (m, 1H).

4-(2-trifluoromethylphenyl)-phenyl cis-2-(3-aminoiminomethylphenyl)-cyclopropane-1-carboxamide trifluoroacetic acid salt (Compound No. A1-16)

¹H-NMR (500 MHz, DMSO-d₆) δ10.36 (s, 1H), 9.29 (s, 2H), 9.11 (s, 2H), 7.79 (d, J=8.3 Hz, 1H), 7.74 (s, 1H), 7.69-7.55 (m, 4H), 7.50-7.46 (m, 3H), 7.33 (d, J=7.8 Hz, 1H), 7.16 (d, J=8.7 Hz, 2H), 2.66 (m, 1H), 2.35 (m, 1H), 1.75 (m, 1H), 1.43 (m, 1H).

4-bromophenyl cis-2-(3-aminoiminomethylphenyl)-cyclopropane-1-carboxamide trifluoroacetic acid salt (Compound No. A1-17)

¹H-NMR (500 MHz, DMSO-d₆) δ10.33 (s, 1H), 9.27 (s, 2H), 8.93 (s, 2H), 7.71 (s, 1H), 7.59 (m, 2H), 7.46 (t, J=7.8 Hz, 1H), 7.38 (s, 4H), 2.65 (m, 1H), 2.30 (m, 1H), 1.71 (m, 1H), 1.41 (m, 1H).

5-(2-methanesulfonylphenyl)-pyridine-2-yl cis-2-(3-aminoiminomethylphenyl)-cyclopropane-1-carboxamide bis trifluoroacetic acid salt (Compound No. A1-18)

¹H-NMR (500 MHz, DMSO-d₆) δ10.92 (s, 1H), 9.29 (s, 2H), 8.97 (s, 2H), 8.26 (d, J=2.3 Hz, 1H), 8.09 (d, J=7.8 Hz, 1H), 7.83 (d, J=8.3 Hz, 1H), 7.78-7.67 (m, 4H), 7.63 (d, J=8.3 Hz, 1H), 7.60 (d, J=7.8 Hz, 1H), 7.48 (m, 1H), 7.40 (d, J=7.8 Hz, 1H), 2.69 (m, 1H), 2.55 (m, 1H), 1.77 (m, 1H), 1.46 (m, 1H).

4-(2-methanesulfonyl-[1,3,4]-triazole-1-yl)-phenyl cis-2-(3-aminoiminomethylphenyl)-cyclopropane-1-carboxamide bis trifluoroacetic acid salt (Compound No. A1-19)

¹H-NMR (500 MHz, DMSO-d₆) δ10.54 (s, 1H), 9.29 (s, 2H), 9.08 (s, 2H), 8.75 (s, 1H), 7.73 (s, 1H), 7.62-7.57 (m, 4H), 7.47 (t, J=7.8 Hz, 1H), 7.33 (d, J=8.7 Hz, 2H), 2.68 (m, 1H), 2.35 (m, 1H), 1.75 (m, 1H), 1.43 (m, 1H).

4-(2-methylaminosulfonylphenyl)-phenyl cis-2-(3-aminoiminomethylphenyl)-cyclopropane-1-carboxamide trifluoroacetic acid salt (Compound No. A1-20)

¹H-NMR (500 MHz, DMSO-d₆) δ10.34 (s, 1H), 9.31 (s, 2H), 9.21 (s, 2H), 7.86 (d, J=7.8 Hz, 1H), 7.74 (s, 1H), 7.63-7.53 (m, 4H), 7.49-7.44 (m, 3H), 7.28 (d, J=7.4 Hz, 1H), 7.22 (d, J=8.7 Hz, 2H), 7.09 (q, J=4.6 Hz, 1H), 2.66 (m, 1H), 2.35 (m, 4H), 1.76 (m, 1H), 1.42 (m, 1H).

4-(2-methanesulfonylimidazole-1-yl)-phenyl cis-2-(3-aminoiminomethylphenyl)-cyclopropane-1-carboxamide bis trifluoroacetic acid salt (Compound No. A1-21)

¹H-NMR (500 MHz, DMSO-d₆) δ10.49 (s, 1H), 9.29 (s, 2H), 8.96 (s, 2H), 7.72 (s, 1H), 7.62-7.57 (m, 3H), 7.53 (d, J=9.2 Hz, 2H), 7.48 (m, 1H), 7.35 (d, J=9.2 Hz, 2H), 7.26 (s, 1H), 2.68 (m, 1H), 2.35 (m, 1H), 1.76 (m, 1H), 1.44 (m, 1H).

4-(2-cyano-thiophene-3-yl)-phenyl cis-2-(3-aminoiminomethylphenyl)-cyclopropane-1-carboxamide trifluoroacetic acid salt (Compound No. A1-22)

¹H-NMR (500 MHz, DMSO-d₆) δ10.47 (s, 1H), 9.29 (s, 2H), 9.04 (s, 2H), 8.09 (d, J=5.1 Hz, 1H), 7.73 (s, 1H), 7.62-7.55 (m, 6H), 7.49-7.45 (m, 2H), 2.67 (m, 1H), 2.35 (m, 1H), 1.75 (m, 1H), 1.43 (m, 1H).

4-(2-aminosulfonyl-5-methyl-thiophene-3-yl)-phenyl cis-2-(3-aminoiminomethylphenyl) cyclopropane-1-carboxamide trifluoroacetic acid salt ((Compound No. A1-23)

¹H-NMR (500 MHz, DMSO-d₆) δ10.32 (s, 1H), 9.29 (s, 2H), 8.94 (s, 2H), 7.72 (s, 1H), 7.62-7.55 (m, 4H), 7.49-7.41 (m, 5H), 6.84 (s, 1H), 2.66 (m, 1H), 2.44 (s, 3H), 2.34 (m, 1H), 1.75 (m, 1H), 1.42 (m, 1H).

4-(4-cyanothiophene-3-yl)-phenyl cis-2-(3-aminoiminomethylphenyl)-cyclopropane-1-carboxamide trifluoroacetic acid salt (Compound No. A1-24)

¹H-NMR (500 MHz, DMSO-d₆) δ10.38 (s, 1H), 9.28 (s, 2H), 8.91 (s, 2H), 7.79 (d, J=3.2 Hz, 1H), 7.72 (s, 1H0, 7.62 (d, J=7.4 Hz, 1H), 7.59 (d, J=7.8 Hz, 1H), 7.53-7.46 (m, 5H), 2.66 (m, 1H), 2.35 (m, 1H), 1.75 (m, 1H), 1.43 (m, 1H).

4-(2 cyanophenyl)-phenyl (1,2-cis)-2-(3-aminoiminomethylphenyl)-(1,3-trans)-3-carboxy-cyclopropane-1-carboxamide trifluoroacetic acid salt (Compound No. A1-25)

¹H-NMR (500 MHz, DMSO-d₆) δ10.60 (s, 1H), 9.32 (s, 2H), 8.90 (s, 2H), 7.91 (d, J=8.7 Hz, 1H), 7.79 (s, 1H), 7.75 (m, 1H), 7.68-7.63 (m, 2H), 7.58-7.46 (m, 7H), 3.08 (m, 1H), 2.83 (m, 2H).

<Pyrrole Scaffold>

### EXAMPLE 62b

Pyrrole Scaffold (H₂S Method)

Ethyl 4-(4-aminoiminomethylbenzyl)-benzyl-pyrrole-3-carboxylate trifluoroacetic acid salt (Compound No. A2-1)

A solution of ethyl 4-(4-cyanobenzyl)-1-benzyl-pyrrole-3-carboxylate (115 mg, 0.334 mmol) in saturated H₂S in pyridine:TEA=4:1 (5 mL) was stirred for 10 h at room temperature, then concentrated. The residue was taken up with EA, washed 0.5N HCl, dried (MgSO₄) and concentrated. The crude thioamide in acetonitrile (10 mL) was treated with CH₃I (0.5 mL), refluxed for 1 h, then concentrated. The crude methylthioimidate salt; was dissolved EtOH (10 mL), treated with anhydrous NH₄OAc (77 mg, 3 eq), then refluxed for 1 h. After concentration, the crude product was purified with RP-HPLC (Microsorb C18, 232 nm, 15 mL/min, 35% AcCN in H₂O containing 0.1% TFA), and lyophilized to give 108 mg (68%) of the title compound.

¹H-NMR (500 MHz, DMSO-d₆) δ9.21 (s, 2H), 9.18 (s, 2H), 7.69 (d, J=8.3 Hz, 2H), 7.51 (d, J=2.3 Hz, 1H), 7.39 (d, J=8.2 Hz, 2H), 7.35 (m, 2H), 7.30 (d, J=7.4 Hz, 1H), 7.23 (d, J =6.9 Hz, 2H), 6.71 (d, J=2.3 Hz, 1H), 5.10 (s, 2H), 4.08 (q, J=7.4 Hz, 2H), 4.06 (s, 2H), 1.18 (t, J=7.3 Hz, 3H).

MS: 362 [M+H]

The following inhibitors were prepared similarly.

Methyl 4-(3-aminoiminomethylbenzyl)-1-benzyl-pyrrole-3-carboxylate trifluoroacetic acid salt (Compound No. A2-2)

¹H-NMR (500 MHz, DMSO-d₆) δ9.26 (s, 2H), 9.12 (s, 2H), 7.65 (s, 1H), 7.59 (d, J=7.3 Hz, 1H), 7.52-7.47 (m, 3H), 7.34-7.28 (m, 3H), 7.22 (d, J=7.3 Hz, 2H), 6.66 (s, 1H), 5.09 (s, 2H), 4.05 (s, 2H), 3.63 (s, 3H).

MS: 348 [M+H]

Ethyl 4-(3-aminoiminomethylbenzyl)-1-benzyl-pyrrole-3-carboxylate trifluoroacetic acid salt (Compound No. A2-3)

¹H-NMR (500 MHz, DMSO-d₆) δ9.32 (s, 2H), 9.27 (s, 2H), 7.67 (s, 1H), 7.60 (d, J=7.3 Hz, 1H), 7.52-7.47 (m, 3H), 7.34 (m, 2H), 7.29 (d, J=7.3 Hz, 1H), 7.23 (d, J=7.4 Hz, 2H), 6.65 (d, J=1.4 Hz, 1H), 5.09 (s, 2H), 4.09 (q, J=7.4 Hz, 2H), 4.06 (s, 2H), 1.18 (t, J=7.4 Hz, 3H).

MS: 362 [M+H]

Ethyl 4-(4-methoxycarbonylbenzyl)-1-(3-aminoiminomethylbenzyl)-pyrrole-3-carboxylate trifluoroacetic acid salt (Compound No. A2-4)

¹H-NMR (500 MHz, DMSO-₆) δ9.34 (s, 2H), 9.25 (s, 2H), 7.84 (d, J=8.3 Hz, 2H), 7.75 (s, 1H), 7.73 (d, J=7.4 Hz, 1H), 7.62-7.55 (m, 3H), 7.30 (d, J=8.3 Hz, 2H), 6.71 (s, 1H), 5.18 (s, 2H), 4.08 (q, J=6.9 Hz, 2H), 4.03 (s, 2H), 3.82 (s, 3H), 1.15 (t, J=6.9 Hz, 3H).

MS: 420 [M+H]

Ethyl 4-(4-aminocarbonylbenzyl)-1-(3-aminoiminomethylbenzyl)-pyrrole-3-carboxylate trifluoroacetic acid salt (Compound No. A2-5)

¹H-NMR (500 MHz, DMSO-d₆) δ9.33 (s, 2H), 9.10 (s, 2H), 7.85 (br s, 1H), 7.75-7.71 (m, 4H), 7.62-7.54 (m, 3H), 7.25 (br s, 1H), 7.23 (d, J=8.3 Hz, 2H), 6.66 (d, J=2.3 Hz, 1H), 5.17 (s, 2H), 4.10 (q, J=6.9 Hz, 2H), 4.00 (s, 2H), 1.17 (t, J=6.9 Hz, 3H).

MS: 405 [M+H]

Ethyl 4-(4-methylaminocarbonylbenzyl)-1-(3-aminoiminomethylbenzyl)-pyrrole-3-carboxylate trifluoroacetic acid salt (Compound No. A2-6)

¹H-NMR (500 MHz, DMSO-d₆) δ9.34 (s, 2H), 9.23 (s, 2H), 7.74-7.71 (m, 2H), 7.62-7.54 (m, 3H), 7.27 (d, J=8.3 Hz, 2H), 7.22 (d, J=8.3 Hz, 2H), 6.69 (d, J=2.3 Hz, 1H), 5.18 (s, 2H), 4.10 (q, J=6.9 Hz, 2H), 3.99 (s, 2H), 2.95 (s, 3H), 2.89 (s, 3H), 1.17 (t, J=6.9 Hz, 3H).

MS: 419 [M+H]

Ethyl 4-(4-methylaminocarbonylbenzyl)-1-(3-aminoiminomethylbenzyl)-pyrrole-3-carboxylate trifluoroacetic acid salt (Compound No. A2-7)

¹H-NMR (500 MHz, DMSO-d₆) δ9.34 (s, 2H), 9.23 (s, 2H), 7.74-7.71 (m, 2H), 7.62-7.54 (m, 3H), 7.27 (d, J=8.3 Hz, 2H), 7.22 (d, J=8.3 Hz, 2H), 6.69 (d, J=2.3 Hz, 1H), 5.18 (s, 2H), 4.10 (q, J=6.9 Hz, 2H), 3.99 (s, 2H), 2.95 (s, 3H), 2.89 (s, 3H), 1.17 (t, J=6.9 Hz, 3H).

MS: 433 [M+]

Ethyl 4-(4-benzylaminocarbonylbenzyl)-1-(3-aminoiminomethylbenzyl)-pyrrole-3-carboxylate trifluoroacetic acid salt (Compound No. A2-8)

¹H-NMR (500 MHz, DMSO-d₆) δ9.33 (s, 2H), 9.12 (s, 2H), 8.93 (t, J=6.0 Hz, 1H), 7.78 (d, J=8.3 Hz, 2H), 7.74 (s, 1H), 7.72 (d, J=7.8 Hz, 1H), 7.62-7.54 (m, 3H), 7.33-7.21 (m, 7H), 6.67 (d, J=2.3 Hz, 1H), 5.17 (s, 2H), 4.46 (d, J=6.0 Hz, 2H), 4.10 (q, J=6.9 Hz, 2H), 4.01 (s, 2H), 1.18 (t, J=6.9 Hz, 3H).

MS: 495 [M+H]

Ethyl 4-(4-phenylaminocarbonylbenzyl)-1-(3-aminoiminomethylbenzyl)-pyrrole-3-carboxylate trifluoroacetic acid salt (Compound No. A2-9)

¹H-NMR (500 MHz, DMSO-d₆) δ10.14 (s, 1H), 9.35 (s, 2H), 9.30 (s, 2H), 7.84 (d, J=8.2 Hz, 2H), 7.77-7.72 (m, 4H), 7.62-7.56 (m, 3H), 7.35-7.30 (m, 4H), 7.08 (m, 1H), 6.71 (s, 1H), 5.19 (s, 2H), 4.11 (q, J=6.9 Hz, 2H), 4.04 (s, 2H), 1.19 (t, J=6.9 Hz, 3H).

MS: 481 [M+H]

Ethyl 4-(4-acetylaminobenzyl)-1-(3-aminoiminomethylbenzyl)-pyrrole-3-carboxylate trifluoroacetic acid salt (Compound No. A2-10)

¹H-NMR (500 MHz, DMSO-d₆) δ9.81 (s, 1H), 9.32 (s, 2H), 9.04 (br s, 2H), 7.73 (s, 1H), 7.71 (d, J=8.3 Hz, 1H), 7.61-7.54 (m, 2H), 7.52 (d, J=2.8 Hz, 1H), 7.42 (d, J=8.3 Hz, 2H), 7.08 (d, J=8.3 Hz, 2H), 6.56 (d, J=2.3 Hz, 1H), 5.15 (s, 2H), 4.11 (q, J=6.9 Hz, 2H), 3.89 (s, 2H), 2.00 (s, 3H), 1.19 (t, J=6.9 Hz, 3H).

MS: 419 [M+H]

Ethyl 4-benzyl-1-(4-aminoiminomethylbenzyl)-pyrrole-3-carboxylate trifluoroacetic acid salt (Compound No. A2-11)

¹H-NMR (500 MHz, CD₃OD) δ7.76 (d, J=8.3 Hz, 2H), 7.43 (s, 1H), 7.37 (d, J=7.8 Hz, 2H), 7.22-7.11 (m, 5H), 6.42 (s, 1H), 5.19 (s, 2H), 4.17 (q, J=6.9 Hz, 2H), 4.01 (s, 2H), 1.23 (t, J=6.9 Hz, 3H).

Ethyl 4-benzyl-1-(3-aminoiminomethylbenzyl)-pyrrole-3-carboxylate trifluoroacetic acid salt (Compound No. A2-12)

¹H-NMR (500 MHz, CD₃OD) δ7.72-7.53 (m, 4H), 7.44 (d, J=2.8 Hz, 1H), 7.23-7.10 (m, 5H), 6.45 (d, J=2.3 Hz, 1H), 5.17 (s, 2H), 4.16 (q, J=6.9 Hz, 2H), 4.02 (s, 2H), 1.23 (t, J=6.9 Hz, 3H).

Ethyl 4-(3-aminoiminomethylphenyl)-1-(2-naphthylmethyl)-pyrrole-3-carboxylate trifluoroacetic acid salt (Compound No. A2-13)

¹H-NMR (500 MHz, DMSO-d₆) δ9.27 (s, 2H), 9.22 (s, 2H), 8.19 (d, J=8.3 Hz, 1H), 7.99 (d, J=7.8 Hz, 1H), 7.95 (d, J=8.2 Hz, 1H), 7.85 (s, 1H), 7.78 (m, 1H), 7.71-7.52 (m, 6H), 7.39 (d, J=7.4 Hz, 1H), 7.21 (d, J=2.3 Hz, 1H), 5.73 (s, 2H), 4.11 (q, J=6.9 Hz, 2H), 1.16 (t, J=6.9 Hz, 3H).

MS: 398 [M+H]

Ethyl 4-(3-aminoiminomethylphenyl)-1-(1-naphthylmethyl)-pyrrole-3-carboxylate trifluoroacetic acid salt (Compound No. A2-14)

¹H-NMR (500 MHz, DMSO-d₆) δ9.27 (s, 2H), 9.20 (s, 2H), 7.94-7.90 (m, 4H), 7.86 (s, 1H), 7.81 (d, J=7.8 Hz, 1H), 7.76 (d, J=2.3 Hz, 1H), 7.66 (c, J=7.8 Hz, 1H), 7.56-7.52 (m, 3H), 7.48 (d, J=8.3 Hz, 1H), 7.25 (d, J=2.3 Hz, 1H), 5.38 (s, 2H), 4.12 (q, J=6.9 Hz, 2H), 1.19 (t, J=6.9 Hz, 3H).

MS: 398 [M+H]

Ethyl 4-(3-aminoiminomethylbenzyl)-1-(1-naphthylmethyl)-pyrrole-3-carboxylate trifluoroacetic acid salt (Compound No. A2-15)

¹H-NMR (500 MHz, DMSO-d₆) δ9.24 (s, 2H), 9.09 (s, 2H), 8.08 (m, 1H), 7.97 (m, 1H), 7.92 (d, J=8.3 Hz, 1H), 7.65-7.46 (m, 8H), 7.24 (d, J=6.9 Hz, 1H), 6.72 (d, J=2.3 Hz, 1H), 5.62 (s, 2H), 4.09 (q, J=6.9 Hz, 2H), 4.06 (s, 2H), 1.16 (t, J=6.9 Hz, 3H).

MS: 412 [M+H]

Ethyl 4-(3-aminoiminomethylbenzyl)-1-(2-naphthylmethyl)-pyrrole-3-carboxylate trifluoroacetic acid salt (Compound No. A2-16)

¹H-NMR (500 MHz, DMSO-d₆) δ9.25 (s, 2H), 7.90 (d, J=8.3 Hz, 2H), 7.87 (d, J=8.7 Hz, 1H), 7.76 (s, 1H), 7.67 (s, 1H), 7.60-7.47 (m, 6H), 7.38 (d, J=8.3 Hz, 1H), 6.71 (s, 1H), 5.27 (s, 2H), 4.11 (q, J=6.9 Hz, 2H), 4.07 (s, 2H), 1.18 (t J=6.9 Hz, 3H).

MS: 412 [M+H]

Ethyl 4-(3-aminoiminomethylbenzyl)-1-(3-phenoxybenzyl)-pyrrole-3-carboxylate trifluoroacetic acid salt (Compound No. A2-17)

¹H-NMR (500 MHz, DMSO-d₆) δ9.25 (br s, 4H), 7.68 (s, 1H), 7.61 (d, J=6.3 Hz, 1H), 7.52-7.46 (m, 3H), 7.40-7.33 (m, 3H), 7.15 (m, 1H), 7.00 (m, 3H), 6.91 (m, 2H), 6.65 (s, 1H), 5.10 (s, 2H), 4.12 (q, J=6.9 Hz, 2H), 4.06 (s, 2H), 1.18 (t, J=6.9 Hz, 3H).

MS: 454 [M+H]

Ethyl 4-(3-aminoiminomethylbenzyl)-1-(4-phenoxybenzyl)-pyrrole-3-carboxylate trifluoroacetic acid salt (Compound No. A2-18)

¹H-NMR (500 MHz, DMSO-d₆) δ9.25 (s, 4H), 9.04 (s, 2H), 7.67 (s, 1H), 7.60 (d, J=7.4 Hz, 1H), 7.53-7.48 (m, 3H), 7.39 (pseudo t, J=7.8, 8.3 Hz, 2H), 7.28 (d, J=8.3 Hz, 2H), 7.15 (t, J=7.4 Hz, 1H), 7.00-6.97 (m, (4H), 6.67 (d, J=1.8 Hz, 1H), 5.08 (s, 2H), 4.11 (q, J=6.9 Hz, 2H), 4.07 (s, 2H), 1.19 (t, J=6.9 Hz, 3H).

MS: 454 [M+H]

Ethyl 4-(3-aminoiminomethylbenzyl)-1-(4-biphenylmethyl)-pyrrole-3-carboxylate trifluoroacetic acid salt (Compound No. A2-19)

¹H-NMR (500 MHz, DMSO-d₆) δ9.18 (br s, 4H), 7.68-7.45 (m, 1H), 7.38-7.32 (m, 3H), 6.70 (s, 1H), 5.15 (s, 2H), 4.12 (q, J=6.9 Hz, 2H), 4.08 (s, 2H), 1.19 (t, J=6.9 Hz, 3H).

MS: 438 [M+H]

Methyl 4-(4-aminoiminomethylbenzyl)-1-(3-aminoiminomethylbenzyl)-pyrrole-3-carboxylate bis trifluoroacetic acid salt (Compound No. A2-20)

¹H-NMR (500 MHz, CD₃OD) δ7.74-7.55 (m, 6H), 7.47 (d, J=2.3 Hz, 1H), 7.43 (d, J=8.3 Hz, 2H), 6.69 (d, J=2.3 Hz, 1H), 5.21 (s, 2H), 4.14 (s, 2H), 3.66 (s, 3H).

MS: 390 [M+H]

Ethyl 4-(4-aminoiminomethylbenzyl)-1-(3-aminoiminomethylbenzyl)-pyrrole-3-carboxylate bis trifluoroacetic acid salt (Compound No. A2-21)

¹H-NMR (500 MHz, DMSO-d₆) δ9.34 (s, 2H), 9.19 (s, 2H), 9.07 (s, 2H), 8.92 (s, 2H), 7.75 (s, 1H), 7.73 (d, J=7.8 Hz, 1H), 7.68 (d, J=8.3 Hz, 2H), 7.61 (m, 1H), 7.58 (s, 1H), 7.56 (d, J =2.3 Hz, 1H), 7.38 (d, J=8.3 Hz, 2H), 6.80 (d, J=2.3 Hz, 1H), 5.19 (s, 2H), 4.08 (q, J=7.4 Hz, 2H), 4.06 (s, 2H), 1.17 (t, J=7.3 Hz, 3H).

MS: 404 [M+H]

Isopropyl 4-(4-aminoiminomethylbenzyl)-1-(3-aminoiminomethylbenzyl)-pyrrole-3-carboxylate bis trifluoroacetic acid salt (Compound No. A2-22)

¹H-NMR (500 MHz, CD₃OD) δ7.76-7.68 (m, 4H), 7.62-7.54 (m, 2H), 7.47 (d, J=2.3 Hz, 1H), 7.42 (d, J=8.3 Hz, 2H), 6.71 (d, J=2.3 Hz, 1H), 5.23 (s, 2H), 5.00 (m, 1H), 4.15 (s, 2H), 1.17 (d, J=6.4 Hz, 6H).

MS: 418 [M+H]

n-Propyl 4-(4-aminoiminomethylbenzyl)-1-(3-aminoiminomethylbenzyl)-pyrrole-3-carboxylate bis trifluoroacetic acid salt (Compound No. A2-23)

¹H-NMR (500 MHz, DMSO-d₆) δ9.35 (s, 2H), 9.28 (s, 2H), 9.20 (s, 2H), 9.13 (s, 2H), 7.77-7.56 (m, 7H), 7.39 (d, J=8.3 Hz, 2H), 6.78 (s, 1H), 5.20 (s, 2H), 4.07 (s, 2H), 4 01 (t, J=6.9 Hz, 2H), 1.58 (m, 2H), 0.88 (m, 3H).

MS: 418 [M+H]

n-Butyl 4-(4-aminoiminomethylbenzyl)-1-(3-aminoiminomethylbenzyl)-pyrrole-3-carboxylate bis trifluoroacetic acid salt (Compound No. A2-24)

¹H-NMR (500 MHz, DMSO-d₆) δ9.34 (s, 2H), 9.19 (s, 2H), 9.16 (s, 2H), 9.00 (s, 2H), 7.76-7.69 (m, 4H), 7.63 -7.57 (m, 3H), 7.38 (d, J=7.8 Hz, 2H), 6.78 (d, J=2.3 Hz, 1H), 5.20 (s, 2H), 4.07 (s, 2H), 4.05 (t, J=6.5 Hz, 2H), 1.54 (m, 2H), 1.32 (m, 2H), 0.87 (t, J=7.4 Hz, 3H).

MS: 432 [M+H]

i-Butyl 4-(4-aminoiminomethylbenzyl)-1-(3-aminoiminomethylbenzyl)-pyrrole-3-carboxylate bis trifluoroacetic acid salt (Compound No. A2-25)

¹H-NMR (500 MHz, DMSO-d₆) δ9.35 (br, 2H), 9.19 (s, 4H), 9.00 (br, 2H), 7.76-7.69 (m, 4H), 7.63-7.56 (m, 3H), 7.39 (d, J=7.8 Hz, 2H), 6.77 (d, J=2.3 Hz, 1H), 5.20 (s, 2H), 4.08 (s, 2H), 3.85 (d, J=6.4 Hz, 2H), 1.88 (m, 1H), 0.88 (d, J=6.5 Hz, 6H).

MS: 432 [M+H]

Cyclopropylmethyl 4-(4-aminoiminomethylbenzyl)-1-(3-aminoiminomethylbenzyl)-pyrrole-3-carboxylate bis trifluoroacetic acid salt (Compound No. A2-26)

¹H-NMR (500 MHz, DMSO-d₆) δ9.35 (br, 2H), 9.19 (br, 4H), 9.00 (br, 2H), 7.77-7.69 (m, 4H), 7.63-7.58 (m, 3H), 7.40 (d, J=7.8 Hz, 2H), 6.80 (d, J=2.3 Hz, 1H), 5.20 (s, 2H), 4.08 (s, 2H), 3.90 (t, J=7.3 Hz, 2H), 1.08 (m, 1H), 0.50 (m, 2H), 0.25 (m, 2H).

MS: 430 [M+H]

4-(4-Aminoiminomethylbenzyl)-1-(3-aminoiminomethylbenzyl)-pyrrole-3-carboxylic acid bis trifluoroacetic acid salt (Compound No. A2-27)

MS: 376 [M+H]

4-(4-aminoiminomethylbenzyl)-1-(3-aminoiminomethylbenzyl)-pyrrole-3-carboxamide bis trifluoroacetic acid salt (Compound No. A2-28)

MS: 375 [M+H]

Ethyl 4-(4-aminoiminomethylbenzyl)-1-(3-aminoiminomethyl-6-hydroxy-benzyl)-pyrrole-3-carboxylate bis trifluoroacetic acid salt (Compound No. A2-29)

¹H-NMR (500 MHz, DMSO-d₆) δ9.20-8.80 (br m, 8H), 7.72-7.66 (m, 4H), 7.45-7.38 (m, 3H), 7.01 (d, J=8.3 Hz, 1H), 6.77 (s, 1H), 5.04 (s, 2H), 4.08 (q, J=7.4 Hz, 2H), 4.05 (s, 2H), 1.17 (t, J=7.3 Hz, 3H).

MS: 420 [M+H]

4-(4-Aminoiminomethylbenzyl)-1-(3-aminoiminomethylhydroxy-benzyl)-pyrrole-3-carboxylic acid bis trifluoroacetic acid salt (Compound No. A2-30)

¹H-NMR (500 MHz, DMSO-d₆) δ11.18 (br, 1H), 9.18 (s, 2H), 9.09 (s, 4H), 8.92 (s, 2H), 7.70 (m, 4H), 7.40 (m, 3H), 7.03 (m, 1H), 6.71 (s, 1H), 5.02 (s, 2H), 4.05 (s, 2H).

MS: 392 [M+H]

Methyl 4-(4-aminoiminomethylbenzyl)-1-(3-aminoiminomethylbenzyl)-pyrrole-3-carboxamide bis trifluoroacetic acid salt (Compound No. A2-31)

¹H-NMR (500 MHz, CD₃OD) δ7.79 (d, 1H), 7.70 (s, 1H), 7.66 (d, 2H), 7.44-7.37 ( 4H), 7.26 (d, J=2.3 Hz, 1H), 6.58 (d, J=2.3 Hz, 1H), 5.12 (s, 2H), 4.17 (s, 2H), 2.73 (s, 3H).

MS: 390 [M+H]

Ethyl 4-(4-aminoiminomethylbenzyl)-1-(3-aminoiminomethylbenzyl)-pyrrole-3-carboxamide bis trifluoroacetic acid salt (Compound No. A2-32)

¹H-NMR (500 MHz, CD₃OD) δ7.79-7.64 (m, 4H), 7.46-7.38 (m, 4H), 7.28 (d, J=2.3 Hz, 1H), 6.57 (d, J=2.3 Hz, 1H), 5.12 (s, 2H), 4.17 (s, 2H), 3.22 (q, J=7.4 Hz, 2H), 1.09 (t, J=7.4 Hz, 3H).

MS: 404 [M+H]

Propyl 4-(4-aminoiminomethylbenzyl)-1-(3-aminoiminomethylbenzyl)-pyrrole-3-carboxamide bis trifluoroacetic acid salt (Compound No. A2-33)

¹H-NMR (500 MHz, CD₃OD) δ7.74-7.53 (m, 6H), 7.43 (d, J=8.3 Hz, 2H), 7.30 (d, J=2.3 Hz, 1H), 6.64 (d, J=2.3 Hz, 1H), 5.18 (s, 2H), 4.17 (s, 2H), 3.15 (m, 2H), 1.49 (m, 2H), 0.87 (t, J=7.3 Hz, 3H).

MS: 417 [M+H]

Ethyl 2-[4-(4-aminoiminomethylbenzyl)-1-(3-aminoiminomethylbenzyl)-pyrrole-3-carbonyl oxy]-acetate bis trifluoroacetic acid salt (Compound No. A2-34)

¹H-NMR (500 MHz, CD₃OD) δ7.78 (d, J=8.3 Hz, 2H), 7.67 (s, 1H), 7.58-7.42 (m, 4H), 7.33 (d, J=8.8 Hz, 1H), 7.01 (d, J=8.8 Hz, 1H), 6.67 (s, 1H), 5.25 (s, 2H), 4.67 (s, 2H), 4.21-4.15 (m, 4H), 1.24 (t J=7.4 Hz, 3H).

MS: 462 [M+H]

Ethyl 2-[4-(4-aminoiminomethylbenzyl)-1-(3-aminoiminomethylbenzyl)-pyrrole-3-carbonyl amino]-acetate bis trifluoroacetic acid salt (Compound No. A2-35)

¹H-NMR (500 MHz, CD₃OD) δ7.74-7.55 (m, 6H), 7.44 (d, J=7.8 Hz, 2H), 7.37 (d, J=2.3 Hz, 1H), 6.64 (d, J=2.3 Hz, 1H), 5.20 (s, 2H), 4.17 (m, 4H), 3.94 (s, 2H), 1.24 (t, J=6.9 Hz, 3H).

MS: 461 [M+H]

Methyl 4-(3-aminoiminomethylbenzyl)-1-(4-aminoiminomethylbenzyl)-pyrrole-3-carboxylate bis trifluoroacetic acid salt (Compound No. A2-36)

¹H-NMR (500 MHz, CD₃OD) δ7.78 (d, J=8.7 Hz, 2H), 7.67 (s, 1H), 7.59-7.40 (m, 6H), 6.65 (s, 1M), 5.24 (s, 2H), 4.13 (s, 2H), 3.68 (s, 3H).

MS: 390 [M+H]

Ethyl 4-(3-aminoiminomethylbenzyl)-1-aminoiminomethylbenzyl)-pyrrole-3-carboxylate bis trifluoroacetic acid salt (Compound No. A2-37)

¹H-NMR (500 MHz, CD₃OD) δ7.78 (m, 3H), 7.61-7.40 (m, 5H), 6.64 (d, J=2.3 Hz, 1H), 5.24 (s, 2H), 4.15 (m, 4H), 1.22 (t, J=6.9 Hz, 3H).

MS: 404 [M+H]

Isopropyl 4-(3-aminoiminomethylbenzyl)-1-(4-aminoiminomethylbenzyl)-pyrrole-3-carboxylate bis trifluoroacetic acid salt (Compound No. A2-38)

¹H-NMR (500 MHz, CD₃OD) δ7.78 (d, J=8.7 Hz, 2H), 7.67 (s, 1H), 7.58-7.48 (m, 6H), 6.65 (s, 1H), 5.24 (s, 2H), 5.01 (m, 1H), 4.14 (s, 2H), 1.19 (d, J=6.4 Hz, 6H).

MS: 418 [M+H]

Ethyl 2-[4-(3-aminoiminomethylbenzyl)-1-(4-aminoiminomethylbenzyl)-pyrrole-3-carbonyl amino]-acetate bis trifluoroacetic acid salt (Compound No. A2-39)

¹H-NMR (500 MHz, CD₃OD) δ7.78 (d, J=8.3 Hz, 2H), 7.66 (s, 1H), 7.55 (m, 2H), 7.44-7.36 (m, (4H), 6.67 (s, 1H), 5.24 (s, 2H), 4.15 (m, 4H), 3.94 (s, 2H), 1.24 (t, J=7.4 Hz, 3H).

MS: 460 [M+H]

4-(3-Aminoiminomethylbenzyl)-1-(4-aminoiminomethylbenzyl)-pyrrole-3-carboxylic acid morphorline amide bis trifluoroacetic acid salt (Compound No. A2-40)

¹H-NMR (500 MHz, CD₃OD) δ7.77 (d, J=8.2 Hz, 2H), 7.61-7.48 (m, 4H), 7.40 (d, J=7.8 Hz, 2H), 7.01 (s, 1H), 6.76 (s, 1H), 5.23 (s, 2H), 3.98 (s, 2H), 3.51-3.45 (m, 8H).

MS: 445 [M+H]

Ethyl 2-[4-(3-aminoiminomethylbenzyl)-1-(4-aminoiminomethylbenzyl)-pyrrole-3-carbonyl oxy]-acetate bis trifluoroacetic acid salt (Compound No. A2-41)

¹H-NMR (500 MHz, DMSO-₆) δ9.26 (br, 4H), 9.00 (br, 4H), 7.77 (d, J=8.3 Hz, 2H), 7.68 9s, 1H), 7.64-7.59 (m, 2H), 7.52-7.46 (m, 4H), 6.74 (s, 1H), 5.24 (s, 2H), 4.70 (s, 2H), 4.13 (q, J=6.9 Hz, 2H), 4.07 (s, 2H), 1.19 (t, J=6.9 Hz, 3H).

MS: 462 [M+H]

Ethyl 4-(4-aminoiminomethylbenzyl)-4-aminoiminomethylbenzyl)-pyrrole-3-carboxylate bis trifluoroacetic acid salt (Compound No. A2-42)

¹H-NMR (500 MHz, DMSO-d₆) δ9.29 (s, 2H), 9.28 (s, 2H), 9.21 (s, 2H), 9.17 (s, 2H), 7.78 (d, J=8.3 Hz, 2H), 7.70 (d, J=2.3 Hz, 1H), 7.44 (d, J=8.3 Hz, 2H), 7.39 (d, J=8.3 Hz, 2H), 6.76 (d, J=2.3 Hz, 1H), 5.23 (s, 2H), 4.08 (q, J=6.9 Hz, 2H), 4.06 (s, 2H), 1.17 (t, J=7.3 Hz, 3H).

MS: 404 [M+H]

Ethyl 4-(3-aminoiminomethylbenzyl)-1-(3-aminoiminomethylbenzyl)-pyrrole-3-carboxylate bis trifluoroacetic acid salt (Compound No. A2-43)

¹H-NMR (500 MHz, CD₃OD) δ7.77-7.45 (m, 9H), 6.67 (s, 1H), 5.21 (s, 2H), 4.15 (m, 4H), 1.22 (t, J=6.9 Hz, 3H).

MS: 404 [M+H]

Ethyl 4-(4-aminoiminomethylbenzyl)-1-(5-aminoiminomethylthiophen-2-yl-methyl)-pyrrole-3-carboxylate bis trifluoroacetic acid salt (Compound No. A2-44)

¹H-NMR (500 MHz, DMSO-d₆) δ9.19 (br s, 4H), 8.95 (br s, 4H), 7.89 (d, J=4.2 Hz, 1H), 7.69 (d, J=8.3 Hz, 2H), 7.59 (d, J=2.3 Hz, 1H), 7.39 (d, J=8.3 Hz, 2H), 7.29 (d, J=3.7 Hz, 1H), 6.79 (d, J=2.3 Hz, 1H), 5.46 (s, 2H), 4.09 (q, J=6.9 Hz, 2H), 4.06 (s, 2H), 1.18 (t, J=6.9 Hz, 3H).

MS: 410 [M+H]

Ethyl 4-[4-(2-imidazoline-2-yl)-benzyl]-1-(3-aminoiminomethylbenzyl)-pyrrole-3-carboxylate bis trifluoroacetic acid salt (Compound No. A2-45)

¹H-NMR (500 MHz, CD₃OD) δ7.75-7.71 (m, 3H), 7.66 (s, 1H), 7.62-7.56 (m, 2H), 7.48 (d, J=2.3 Hz, 1H), 7.44 (d, J=8.7 Hz, 2H), 6.71 (d, J=2.3 Hz, 1H), 5.22 (s, 2H), 4.15 (s, 2H), 4.11 (q, J=6.9 Hz, 2H), 4.07 (s, 2H), 1.19 (t, J=6.9 Hz, 3H).

MS: 430 [M+H]

Ethyl 4-(4-aminoiminomethylbenzyl)-1-(7-aminoiminomethylnaphthalene-2-yl-methyl)-pyrrole-3-carboxylate bistrifluoroacetic acid salt (Compound No. A2-46)

¹H-NMR (500 MHz, DMSO-d₆) δ9.43 (s, 2H), 9.33 (s, 2H), 9.19 (s, 2H), 9.12 (s, 2H), 8.45 (s, 1H), 8.14 (d, J=8.3 Hz, 1H), 8.07 (d, J=8.7 Hz, 1H), 7.88 (s, 1H), 7.83 (d, J=8.7 Hz, 1H), 7.70 (d, J=8.3 Hz, 2H), 7.61 (m, 2H), 7.40 (d, J=8.3 Hz, 2H), 6.80 (d, J=2.3 Hz, 1H), 5.35 (s, 2H), 4.11-4.08 (m, 4H), 1.18 (t, J=7.3 Hz, 3H).

MS: 454 [M+H]

Ethyl 4-(4-bromophenyl)-1-(3-aminoiminomethylbenzyl)-pyrrole-3-carboxylate trifluoroacetic acid salt (Compound No. A2-47)

¹H-NMR (500 MHz, DMSO-d₆) δ9.33 (s, 2H), 9.04 (s, 2H), 7.83 (s, 1H), 7.75-7.70 (m, 2H) 7.68 (s, 1H), 7.63 (m, 1H), 7.49 (d, J=8.3 Hz, 2H), 7.37 (d, J=8.3 Hz, 2H), 7.14 (s, 1H), 5.25 (s, 2H), 4.11 (q, J=6.9 Hz, 2H), 1.18 (t, J=6.9 Hz, 3H).

MS: 426 [M+H]

Ethyl 4-[4-(2-aminosulfonylphenyl)-phenyl]-1-(3-aminoiminomethylbenzyl)-pyrrole-3-carboxylate trifluoroacetic acid salt (Compound No. A2-48)

¹H-NMR (500 MHz, DMSO-d₆) δ9.34 (s, 2H), 9.00 (s, 2H), 8.04 (d, J=8.3 Hz, 1H), 7.84 (s, 1H), 7.75-7.68 (m, 3H) 7.65-7.55 (m, 3H), 7.47 (d, J=8.3 Hz, 2H), 7.35-7.32 (m, 3H), 7.18 (m, 3H), 5.27 (s, 2H), 4.13 (q, J=6.9 Hz, 2H), 1.20 (t, J=6.9 Hz, 3H).

MS: 503 [M+H]

Ethyl 4-[4-(2-aminosulfonylphenyl)-phenyl]-1-(3-aminoiminomethylbenzyl)-pyrrole-3-carboxamide trifluoroacetic acid salt (Compound No. A2-49)

¹H-NMR (500 MHz, DMSO-d₆) δ9.35 (s, 2H), 9.10 (s, 2H), 8.04 (d, J=7.8 Hz, 1H), 7.82 (s, 1H), 7.75 (d, J=7.4 Hz, 1H), 7.70 (d, J=7.4 Hz, 1H), 7.65-7.61 (m, 2H), 7.58-7.55 (m, 2H), 7.47 (d, J=7.8 Hz, 2H), 7.35-7.32 (m, 4H), 7.18 (s, 1H), 7.14 (s, 2H), 5.22 (s, 2H), 3.17 (m, 2H), 1.05 ( J=6.9 Hz, 3H).

Ethyl 4-[4-(2-aminosulfonylphenyl)-phenyl]-1-(3-aminoiminomethyl-6-hydroxy-benzyl)-pyrrole-3-carboxylate trifluoroacetic acid salt (Compound No. A2-50)

¹H-NMR (500 MHz, DMSO-d₆) δ11.15 (s, 1H), 9.09 (s, 2H), 8.74 (s, 2H), 8.04 (d, J=7.8 Hz, 1H), 7.79 (s, 1H), 7.68-7.55 (m, 4H), 7.45 (d, J=8.3 Hz, 2H), 7.34-7.32 (m, 3H), 7.18 (s, 2H), 7.10 (d, J=2.3 Hz, 1H), 7.03 (d, J=8.7 Hz, 1H), 5.14 (s, 2H), 4.12 (q, J=6.9 Hz, 2H), 1.20 (t, J=6.9 Hz, 3H).

MS: 519 [M+H]

Ethyl 4-(3-biphenyl)-1-(3-aminoiminomethylbenzyl)-pyrrole-3-carboxylate trifluoroacetic acid salt (Compound No. A2-51)

¹H-NMR (500 MHz, DMSO-d₆) δ9.34 (s, 2H), 9.12 (s, 2H), 7.85 (s, 1H), 7.76-7.61 (m, 7H), 7.52-7.35 (m, 6H), 7.21 (d, J=2.3 Hz, 1H), 5.27 (m, 2H), 4.12 (q, J=6.9 Hz, 2H), 1.16 (t, J=6.9 Hz, 3H).

MS: 424 [M+H]

Ethyl 4-(4-biphenyl)-1-(3-aminoiminomethylbenzyl)-pyrrole-3-carboxylate trifluoroacetic acid salt (Compound No. A2-52)

¹H-NMR (500 MHz, DMSO-d₆) δ9.34 (s, 2H), 9.06 (s, 2H), 7.85 (s, 1H), 7.76-7.72 (m, 2H), 7.68-7.64 (m, 4H), 7.61 (d, J=8.3 Hz, 2H), 7.52 (d, J=8.2 Hz, 2H), 7.48-7.45 (m, 2H), 7.37-7.34 (m, 1H), 7.16 (d, J=2.3 Hz, 1H), 5.27 (s, 2H), 4.13 (q, J=6.9 Hz, 2H), 1.20 (t, J =6.9 Hz, 3H).

MS: 424 [M+H]

Ethyl 4-[4-(2-aminosulfonyl-5-fluoro-phenyl)-phenyl]-1-(3-aminoiminomethylbenzyl)-pyrrole-3-carboxylate trifluoroacetic acid salt (Compound No. A2-53)

¹H-NMR (500 MHz, DMSO-d₆) δ9.35 (s, 2H), 9.11 (s, 2H), 8.09 (dd,=8.7, 5.5 Hz, 1H), 7.84 (s, 1H), 7.76-7.72 (m, 2H), 7.69 (d, J=2.3 Hz, 1H), 7.65-7.62 (m, 1H), 7.48 (d, J=8.2 Hz, 2H), 7.46-7.42 (m, 1H), 7.38 (d, J=8.3 Hz, 2H), 7.25 (s, 2H), 7.19-7.17 (m, 2H), 5.27 (s, 2H), 4.13 (q, J=6.9 Hz, 2H), 1.21 (t, J=6.9 Hz, 3H).

MS: 521 [M+H]

Ethyl 4-[4-(2-aminosulfonyl-5-methyl-phenyl)-phenyl]-1-(3-aminoiminomethylbenzyl)-pyrrole-3-carboxylate trifluoroacetic acid salt (Compound No. A2-54)

¹H-NMR (500 MHz, DMSO-d₆) δ9.35 (s, 2H), 9.17 (s, 2H), 7.92 (d, J=7.8 Hz, 1H), 7.85 (s, 1H), 7.76-7.72 (m, 2H), 7.68 (d, J=2.3 Hz, 1H), 7.63 (m, 1H), 7.46 (d, J=7.8 Hz, 2H), 7.37-7.33 (m, 3H), 7.18 (d, J=2.3 Hz, 1H), 7.14 (s, 1H), 7.06 (s, 2H), 5.27 (s, 2H), 4.13 (q, J =6.9 Hz, 2H), 2.39 (s, 3H), 1.21 (t, J=6.9 Hz, 3H).

MS: 517 [M+H]

4-[4-(2-Aminosulfonyl-5-methyl-phenyl)-phenyl]-1-(3-aminoiminomethylbenzyl)-pyrrole trifluoroacetic acid salt (Compound No. A2-55)

¹H-NMR (500 MHz, DMSO-d₆) δ9.32 (s, 2H), 8.96 (s, 2H), 7.90 (d, J=8.3 Hz, 1H), 7.75 (s, 1H), 7.71 (m, 1H), 7.61 (m, 2H), 7.51 (d, J=8.3 Hz, 2H), 7.39 (m, 1H), 7.36-7.31 (m, 3H), 7.13 (s, 1H), 7.05 (s, 2H), 6.94 (m, 1H), 6.52 (m, 1H), 5.23 (s, 2H), 2.40 (s, 3H).

MS: 445 [M+H]

### EXAMPLE 62c

Pyrrole Scaffold (Pinner Method)

Ethyl 4-[4-(2-pyridyl)-phenyl]-1-(3-aminoiminomethylbenzyl)-pyrrole 3-carboxylate bistrifluoroacetic acid salt (Compound No. A2-56)

A solution of ethyl 4-[4-(2-pyridyl)-phenyl]-1-(3-cyanobenzyl)-pyrrole 3-carboxylate (180 mg, 0.44 mmol) in saturated ethanolic HCl (8 mL) was tightly sealed with septum stopper, stirred for 48 h at room temperature, and concentrated. The residue was dissolved in ethanol, treated with anhydrous ammonium carbonate (422 mg, 10 eq), and stirred for 24 h at room temperature. Purification with RP-HPLC followed by lyophilization afforded 142 mg (50%) of the title compound.

¹H-NMR (500 MHz, DMSO-d₆) δ9.36 (s, 2H), 9.13 (br, 2H), 8.68 (d, J=4.2 Hz, 1H), 8.06-7.99 (m, 3H), 7.93 (m, 1H), 7.86 (s, 1H), 7.76-7.67 (m, 3H), 7.64 (m, 1H), 7.56 (d, J=8.3 Hz, 2H), 7.39 (m, 1H), 7.21 (d, J=2.3 Hz, 1H), 5.27 (s, 2H), 4.14 (q, J=6.9 Hz, 2H), 1.20 (t, J=6.9 Hz, 3H).

The following inhibitor was prepared similarly.

Ethyl 4-[4-(3-pyridyl)-phenyl]-1-(3-aminoiminomethylbenzyl)-pyrrole 3-carboxylate bistrifluoroacetic acid salt (Compound No. A2-57)

¹H-NMR (500 MHz, DMSO-d₆) δ9.36 (s, 2H), 9.18 (s, 2H), 9.03 (s, 1H), 8.67 (s, 1H), 8.35 (d, J=6.9 Hz, 1H), 7.86 (s, 1H), 7.78-7.58 (m, 9H), 7.22 (d, J=1.9 Hz, 1H), 5.28 (s, 2H), 4.14 (q, J=6.9 Hz, 2H), 1.21 (t, J=6.9 Hz, 3H).

<Bicyclic Scaffolds>

### EXAMPLE 62d

Bicyclic Scaffold (H₂S Method)

3-aminoiminomethylphenyl 2-(3-aminoiminomethylphenyl)-phenylacetamide bistrifluoroacetic acid salt (Compound No. A3-1)

A solution of 3-cyanophenyl 2-(3-cyanophenyl)-phenylacetamide (146 mg, 0.433 mmol) in saturated H₂S (10 mL, in pyridine:TEA=4:1) was stirred for 10 h at room temperature. After concentration, the residue was taken up with EA, washed with 0.5N HCl, dried (MgSO₄), then concentrated. The crude thioamide in acetonitrile (15 mL) was treated with CH₃I (1.1 mL, 20 eq), refluxed for 1 h, then concentrated. The residue was dissolved in MeOH (10 mL), treated with anhydrous NH₄OAc (166 mg, 2.5 eq), refluxed for 1 h, then concentrated. The crude product was purified with RP-HPLC (Microsorb C18, 232 nm, 15 mL/min, 10% to 25% AcCN in H₂O containing 0.1% TFA), and lyophilized to give 81 mg (31%) of the title compound.

¹H-NMR (500 MHz, DMSO-d₆) δ10.48 (s, 1H), 9.34 (s, 2H), 9.28 (s, 2H), 9.25 (s, 2H), 9.16 (s, 2H), 8.10 (s, 1H), 7.87 (s, 1H), 7.82 (pseudo t, J=9.2, 8.8 Hz, 2H), 7.75 (d, J=8.3 Hz, 1H), 7.67 (t, J=7.8 Hz, 1H), 7.54 (t, J=7.8 Hz, 1H), 7.46-7.36 (m, 5H), 3.70 (s, 2H). 100/a to

The following inhibitors were prepared similarly.

4-aminoiminomethylphenyl 2-(4-aminoiminomethylphenyl)-phenylacetamide bistrifluoroacetic acid salt (Compound No. A3-2)

¹H-NMR (500 MHz, DMSO-d₆) δ10.59 (s, 1H), 9.33 (br s, 2H), 9.17 (br s, 3H), 8.97 (br s, 2H), 7.89 (d, J=8.3 Hz, 2H), 7.79-7.74 (Abq, J=8.7 Hz, 4H), 7.66 (d, J=8.3 Hz, 2H), 7.46-7.36 (m, 4H), 7.29 (d, J=6.9 Hz, 1H), 3.71 (s, 2H).

MS: 372 [m+H]

4-aminoiminomethylphenyl 2-(3-aminoiminomethylphenyl)-phenylacetamide bistrifluoroacetic acid salt (Compound No. A3-3)

¹H-NMR (500 MHz, DMSO-d₆) δ10.52 (s, 1H), 9.32 (s, 2H), 9.23 (s, 2H), 9.16 (s, 2H), 9.01 (s, 2H), 7.86 (s, 1H), 7.82-7.72 (m, 6H), 7.66 (t, J=7.8 Hz, 1H), 7.47-7.34 (m, 4H), 3.72 (s, 2H).

MS: 372 [m+H]

3-aminoiminomethylbenzyl 2-(4-aminoiminomethylphenyl)-benzyl ether bistrifluoroacetic acid salt (Compound No. A3-4)

¹H-NMR (500 MHz, DMSO-d₆) δ9.36 (s, 2H), 9.31 (s, 2H), 9.14 (s, 2H), 9.08 (s, 2H), 7.90 (d, J=8.3 Hz, 2H), 7.73-7.57 (m, 7H), 7.48 (m, 2H), 7.34 (m, 1H), 4.54 (s, 2H), 4.52 (s, 2H).

MS: 359 [m+H]

4-aminoiminomethylbenzyl 2-(4-aminoiminomethylphenyl)-benzyl ether bistrifluoroacetic acid salt (Compound No. A3-5)

¹H-NMR (500 MHz, DMSO-d₆) δ9.36 (br s, 2H), 9.28 (br s, 2H), 9.17 (br s, 2H), 9.07 (br s, 2H), 7.90 (d, J=8.7 Hz, 2H), 7.78 (d, J=8.3 Hz, 2H), 7.67 (d, J=8.3 Hz, 2H), 7.61 (m, 1H), 7.51 (d, J=8.3 Hz, 2H), 7.47 (m, 2H), 7.73 (m, 1H), 4.57 (s, 2H), 4.52 (s, 2H).

4-aminoiminomethylbenzyl 2-(3-aminoiminomethylphenyl)-benzyl ether bistrifluoroacetic acid salt (Compound No. A3-6)

¹H-NMR (500 MHz, DMSO-d₆) δ9.36 (s, 4H), 9.29 (s, 2H), 9.27 (s, 2H), 7.86-7.84 (m, 2H), 7.78 (m, 3H), 7.68 (m, 1H), 7.61 (m, 1H), 7.51-7.46 (m, 4H), 7.42 (m, 1H), 4.57 (s, 2H), 4.50 (s, 2H).

3-aminoiminomethylbenzyl 2-(3-aminoiminomethylphenyl)-benzyl ether bistrifluoroacetic acid salt (Compound No. A3-7)

¹H-NMR (500 MHz, DMSO-d₆) δ9.36 (s, 2H), 9.34 (s, 2H), 9.29 (s, 2H), 9.26 (s, 2H), 7.84 (m, 2H), 7.79 (d, J=8.3 Hz, 1H), 7.80 (m, 2H), 7.68-7.56 (m, 4H), 7.47 (m, 2H), 7.41 (m, 1H), 4.53 (s, 2H), 4.50 (s, 2H).

MS: 359 [m+H]

N-3-aminoiminomethylphenyl)-N′-[2-(4-aminoiminomethylphenyl)-phenyl]urea bistrifluoroacetic acid salt (Compound No. A3-8)

¹H-NMR (500 MHz, DMSO-d₆) δ9.35 (s, 2H), 9.33 (s, 1H), 9.26 (s, 2H), 9.15 (s, 2H), 9.02 (s, 2H), 8.12 (s, 1H), 7.95 (d, J=8.3 Hz, 2H), 7.90 (s, 1H), 7.81 (d, J=7.8 Hz, 1H), 7.68 (d, J =8.3 Hz, 2H), 7.60 (d, J=8.8 Hz, 1H), 7.48 (m, 1H), 7.33-7.24 (m, 3H).

MS: 373 [m+H]

N-4-aminoiminomethylphenyl)-N′-[2-(4-aminoiminomethylphenyl)-phenyl]urea bistrifluoroacetic acid salt (Compound No. A3-9)

¹H-NMR (500 MHz, DMSO-d₆) δ9.57 (s, 1H0, 9.35 (s, 2H), 9.20 (s 2H), 9.11 (s, 2H), 8.88 (s, 2H), 8.27 (s, 1H), 7.94 (d, J=8.3 Hz, 2H), 7.79 (d, J=8.3 Hz, 1H), 7.75 (d, J=8.7 Hz, 2H), 7.69 (d, J=8.3 Hz, 2H), 7.59 (d, J=8.7 Hz, 2H0, 7.43 (m, 1H), 7.32-7.26 (m, 2H).

MS: 373 [m+H]

N-4-aminoiminomethylphenyl)-N′-[2-(3-aminoiminomethylphenyl)-phenyl]urea bistrifluoroacetic acid salt (Compound No. A3-10)

¹H-NMR (500 MHz, DMSO-d₆) δ9.63 (s, 1H), 9.35 (s, (4H), 9.11 (s, 2H), 9.01 (s, 2H), 8.27 (s, 1H), 7.93 (s, 1H), 7.88-7.68 (m, 6H), 7.59 (d, J=8.8 Hz, 2H), 7.45-7.38 (m, 2H), 7.26 (m, 1H).

N-3-aminoiminomethylphenyl)-N′-[2-(3-aminoiminomethylphenyl)-phenyl]urea bistrifluoroacetic acid salt (Compound No. A3-11)

¹H-NMR (500 MHz, DMSO-d₆) δ9.42 (s, 1H), 9.37 (s, 4H), 9.27 (s, 2H), 9.20 (s, 2H), 8.16 (s, 1H), 7.92 (s, 1H), 7.89-7.84 (m, 3H), 7.79 (d, J=7.8 Hz, 1H), 7.73-7.66 (m, 2H), 7.49 (pseudo t, J=7.8, 8.3 Hz, 1H), 7.43-7.37 (m, 2H), 7.33 (d, J=7.8 Hz, 1H), 7.25 (pseudo t, J =7.8, 7.3 Hz, 1H).

MS: 373 [M+H]

3-aminoiminomethylbenzyl 2-(4-aminoiminomethylphenyl)-benzamide bistrifluoroacetic acid salt (Compound No. A3-12)

¹H-NMR (500 MHz, DMSO-d₆) δ9.34 (br s, 2H), 9.31 (br s, 2H), 9.12 (br s, 2H), 9.10 (br s, 2H), 9.01 (t, J=6.0 Hz, 1H), 7.81 (d, J=8.2 Hz, 2H), 7.68 (m, 2H), 7.63-7.58 (m, 4H), 7.53 (m, 2H), 7.45 (d, J=7.4 Hz, 2H), 4.40 (d, J=6.0 Hz, 2H).

MS: 372 [m+H]

4-aminoiminomethylbenzyl 2-(4-aminoiminomethylphenyl)-benzamide bistrifluoroacetic acid salt (Compound No. A3-13)

¹H-NMR (500 MHz, DMSO-d₆) δ9.34 (s, 2H), 9.27 (s, 2H), 9.19 (s, 2H), 9.14 (s, 2H), 9.07 (t, J=6.0 Hz, 1H), 7.83 (d, J=8.3 Hz, 2H), 7.75 (d, J=8.3 Hz, 2H), 7.59-7.51 (m, 5H), 7.45 (d, J=7.8 Hz, 2H), 4.40 (d, J=6.0 Hz, 2H).

MS: 372 [m+H]

4-aminoiminomethylbenzyl 2-(3-aminoiminomethylphenyl)-benzamide bistrifluoroacetic acid salt (Compound No. A3-14)

¹H-NMR (500 MHz, DMSO-d₆) δ9.36 (s, 2H), 9.26 (s, 22H), 9.12 (s, 2H), 9.07 (s, 2H), 9.02 (t, J=6.0 Hz, 1H), 7.87 (s, 1H), 7.79 (d, J=7.8 Hz, 1H), 7.75 (d, J=8.3 Hz, 2H), 7.65-7.51 (m, 6H), 7.41 (d, J=8.3 Hz, 2H), 4.39 (d, J=6.0 Hz, 2H).

MS: 372 [m+H]

3-aminoiminomethylbenzyl 2-(3-aminoiminomethylphenyl)-benzamide bistrifluoroacetic acid salt (Compound No. A3-15)

¹H-NMR (500 MHz, DMSO-d₆) δ9.35 (s, 2H), 9.32 (s, 2H), 9.27 (s, 2H), 9.22 (s, 2H), 8.98 (t, J=6.0 Hz, 1H), 7.85 (s, 1H), 7.77 (d, J=7.4 Hz, 1H), 7.68 (m, 2H), 7.63-7.48 (m, 7H), 7.44 (d, J=7.4 Hz, 1H), 4.38 (d, J=6.0 Hz, 2H).

MS: 372 [m+H]

2-(4-aminoiminomethylphenyl)-benzyl 4-aminoiminomethylbenzamide bistrifluoroacetic acid salt (Compound No. A3-16)

¹H-NMR (500 MHz, DMSO-d₆) δ9.49 (s, 2H), 9.43 (s, 4H), 9.39 (s, 2H), 9.28 (t, J=5.5 Hz, 1H), 8.04 (d, J=8.3 Hz, 1H), 7.94-7.90 (m, 4H), 7.71 (d, J=8.3 Hz, 2H), 7.51 (d, J=7.3 Hz, 1H), 7.46-7.38 (m, 2H), 7.29 (d, J=7.8 Hz, 1H), 4.46 (d, J=5.5 Hz, 2H).

MS: 372 [m+H]

2-(4-aminoiminomethylphenyl)-benzyl 3-aminoiminomethylbenzamide bistrifluoroacetic acid salt (Compound No. A3-17)

¹H-NMR (500 MHz, DMSO-d₆) δ9.43 (s, 2H), 9.40 (s, 2H), 9.38 (s, 2H), 9.37 (s, 2H), 9.19 (t, J=5.5 Hz, 1H), 8.29 (s, 1H), 8.18 (d, J=7.8 Hz, 1H), 7.96-7.92 (m, 3H), 7.74-7.71 (m, 3H), 7.52 (d, J=7.4 Hz, 1H), 7.44-7.39 (m, 2H), 7.29 (dd, J=7.8 Hz, 1.4 Hz, 1H), 4.46 (d, J=5.5 Hz, 1H).

MS: 372 [m+H]

2-(3-aminoiminomethylphenyl)-benzyl 4-aminoiminomethylbenzamide bistrifluoroacetic acid salt (Compound No. A3-18)

¹H-NMR (500 MHz, DMSO-d₆) δ9.43 (s, 2H), 9.42 (s, 2H), 9.38 (s, 2H), 9.37 (s, 2H), 9.24 (t, J=5.5 Hz, 1H), 8.02 (d, J=8.3 Hz, 2H), 7.91-7.81 (m, 5H), 7.70 (pseudo t, J=7.4, 7.8 Hz, 1H), 7.50 (d, J=7.8 Hz, 1H), 7.45-7.39 (m, 2H), 7.35 (d, J=7.4 Hz, 1H), 4.49 (d, J=5.5 Hz, 2H).

MS: 372 [m+H]

2-(3-aminoiminomethylphenyl)-benzyl 3-aminoiminomethylbenzamide bistrifluoroacetic acid salt (Compound No. A3-19)

¹H-NMR (500 MHz, DMSO-d₆) δ9.51 (s, 2H), 9.47 (s, 2H), 9.41 (s, 2H), 9.39 (s, 2H), 9.17 (t, J=5.5 Hz, 1H), 8.27 (s, 1H), 8.15 (d, J=7.3 Hz, 1H), 7.95 (d, J=6.9 Hz, 1H), 7.88-7.82 (m, 3H), 7.73-7.70 (m, 2H), 7.52 (d, J=7.3 Hz, 1H), 7.44-7.34 (m, 3H), 4.49 (d, J=5.5 Hz, 2H).

MS: 372 [m+H]

2-(3-aminoiminomethylphenyl)-phenyl phenylacetamide trifluoroacetic acid salt (Compound No. A3-20)

¹H-NMR (500 MHz, DMSO-d₆) δ9.55 (s, 1H), 9.33 (s, 2H), 9.22 (s, 2H), 7.81 (m, 2H), 7.64 (d, J=7.8 Hz, 1H), 7.55 (pseudo t, J=7.8, 8.3 Hz, 1H), 7.51 (d, J=7.8 Hz, 1H), 7.45-7.40 (m, 2H), 7.34 (m, 1H), 7.28 (m, 2H), 7.23 (m, 1H), 7.15 (d, J=7.3 Hz, 2H), 3.49 (s, 2H).

MS: 330 [m+H]

2-3-aminoiminomethylphenyl)-phenyl phenylmethylsulfonamide trifluoroacetic acid salt (Compound No. A3-21)

¹H-NMR (500 MHz, DMSO-d₆) δ9.31 (s, 2H), 9.18 (s, 2H), 9.11 (s, 1H), 7.89 (s, 1H), 7.82 (d, J=7.4 Hz, 2H), 7.68 (m, 1H), 7.45-7.03 (m, 9H), 4.22 (s, 2H).

MS: 366 [m+H]

4-(2-aminosulfonylphenyl)-phenyl 2-(4-aminoiminomethylphenyl)-benzamide trifluoroacetic acid salt (Compound No. A3-22)

¹H-NMR (500 MHz, DMSO-d₆) δ10.63 (s, 1H), 9.34 (s, 2H), 9.01 (s, 2H), 8.02 (d, J=6.9 Hz, 1H), 7.86 (d, J=8.3 Hz, 2H), 7.70-7.51 (m, 9H), 7.33 (d, J=8.7 Hz, 2H), 7.29 (m, 2H).

MS: 471 [m+H]

4-(2-aminosulfonylphenyl)-phenyl 2-(3-aminoiminomethylphenyl)-benzamide trifluoroacetic acid salt (Compound No. A3-23)

¹H-NMR (500 MHz, DMSO-d₆) δ10.48 (s, 1H), 9.39 (s, 2H), 9.08 (s, 2H), 8.02 (d, J=8.3 Hz, 1H), 7.92 (s, 1H), 7.79-7.75 (m, 2H), 7.69-7.55 (m, 9H), 7.32-7.27 (m, 5H).

MS: 471 [m+H]

4-(2-aminosulfonylphenyl)-phenyl 2-(3-aminoiminomethylphenyl)-cyclopentene-1-carboxamide trifluoroacetic acid salt (Compound No. A3-24)

¹H-NMR (500 MHz, DMSO-d₆) δ10.00 (s, 1H), 9.33 (s, 2H), 9.01 (s, 2H), 8.02 (d, J=7.8 Hz, 1H), 7.80 (s, 1H), 7.77 (d, J=7.4 Hz, 1H), 7.68 (d, J=7.8 Hz, 1H), 7.62-7.53 (m, 5H), 7.32-7.24 (m, 5H), 2.92 (m, 4H), 2.06 (m, 2H).

MS 461 [m+H]

5-(2-aminosulfonylphenyl)-pyridine-2-yl 2-(3-aminoiminomethylphenyl)-cyclopentene-1-carboxamide trifluoroacetic acid salt (Compound No. A3-25)

¹H-NMR (500 MHz, DMSO-d₆) δ10.41 (s, 1H), 9.33 (s, 2H0, 9.07 (s, 2H), 8.26 (d, J=2.3 Hz, 1H0, 8.05 (m, 2H), 7.80-7.74 (m, 3H), 7.70-7.56 (m, 4H), 7.39 (s, 2H), 7.35 (d, J=7.4 Hz, 1H), 2.92 (m, 4H), 2.03 (m, 2H).

MS: 462 [m+H]

4-(N-methylpyridinium-3-yl)-phenyl 2-(3-aminoiminomethylphenyl)-cyclopenetene-1-carboxamide trifluoroacetic acid salt (Compound No. A3-26)

¹H-NMR (500 MHz, DMSO-₆) δ10.17 (s, 1H), 9.35 (s, 1H), 9.32 (s, 2H), 9.23 (s, 2H), 8.91 (d, J=6.0 Hz, 1H), 8.83 (d, J=8.7 Hz, 1H), 8.16 (m, 1H), 7.85-7.68 (m, 7H), 7.54 (m, 1H), 4.39 (s, 3H), 2.92 (m, 4H), 2.05 (m, 2H).

MS: 383 [m+H]

4-(2-pyridyl)-phenyl 2-(3-aminoiminomethylphenyl)-cyclopentene-1-carboxamide trifluoroacetic acid salt (Compound No. A3-27)

¹H-NMR (500 MHz, DMSO-d₆) δ10.05 (s, 1H), 9.31 (s, 2H), 8.99 (s, 2H), 8.64 (d, J=4.6 Hz, 1H), 8.02 (d, J=8.8 Hz, 2H), 7.90 (m, 2H), 7.79 (s, 1H), 7.75-7.66 (m, 4H), 7.56 (m, 1H), 7.34 (m, 1H), 2.93 (m, 4H), 2.05 (m, 2H).

MS: 397 [m+H]

4-(2-aminosulfonylphenyl)-phenyl 2-(3-aminoiminomethylphenyl)-pyridine-3-carboxamide trifluoroacetic acid salt (Compound No. A3-28)

¹H-NMR (500 MHz, DMSO-d₆) δ10.65 (s, 1H), 9.40 (s, 2H), 9.04 (s, 2H), 8.84 (m, 1H), 8.16 (d, J=1.4 Hz, 1H), 8.12 (d, J=7.8 Hz, 1H), 8.03 (d, J=8.3 Hz, 1H), 7.99 (d, J=7.8 Hz, 1H), 7.82 (d, J=7.8 Hz, 1H), 7.70 (m, 1H), 7.64-7.54 (m, 5H), 7.34 (m, 2H), 7.29 (d, J=7.4 Hz, 1H), 7.25 (s, 2H).

MS: 472 [m+H]

4-(2-aminosulfonyl-5-fluoro-phenyl)-phenyl 2-(3-aminoiminomethylphenyl)-pyridine-3-carboxamide trifluoroacetic acid salt (Compound No. A3-29)

¹H-NMR (500 MHz, DMSO-d₆) δ10.67 (s, 1H), 9.40 (s, 2H), 9.09 (s, 2H), 8.84 (m, 1H), 8.16 (s, 1H), 8.12 (dd, J=7.4, 1.4 Hz, 1H), 8.07 (m, 1H), 7.98 (d, J=7.8 Hz, 1H), 7.82 (d, J=7.8 Hz, 1H), 7.69 (t, J=7.8 Hz, 1H), 7.62 (m, 1H), 7.58 (d, J=8.3 Hz, 2H), 7.42 (m, 1H), 7.37 (d, J=8.3 Hz, 2H), 7.32 (s, 2H), 7.15 (m, 1H).

MS: 490 [m+H]

4-(2-aminosulfonyl-5-methyl-phenyl)-phenyl 2-(3-aminoiminomethylphenyl)-pyridine-3-carboxamide trifluoroacetic acid salt (Compound No. A3-30)

¹H-NMR (500 MHz, DMSO-d₆) δ10.63 (s, 1H), 9.40 (s, 2H), 9.05 (s, 2H), 8.84 (d, J=5.1 Hz, 1H), 8.16 (s, 1H), 8.12 (d, J=7.8 Hz, 1H), 7.99 (d, J=7.8 Hz, 1H), 7.90 (d, J=8.3 Hz, 1H), 7.82 (d, J=7.4 Hz, 1H), 7.69 (t, J=7.8 Hz, 1H), 7.62 (m, 1H), 7.55 (d, J=8.3 Hz, 2H), 7.34 (m, 3H), 7.14 (s, 2H), 7.10 (s, 1H), 2.38 (s, 3H).

MS: 486 [m+H]

4-(2-cyanophenyl)-phenyl 2-(3-aminoiminomethylphenyl)-pyridine-3-carboxamide bis trifluoroacetic acid salt (Compound No. A3-31)

¹H-NMR (500 MHz, DMSO-d₆) δ10.81 (s, 1H), 9.41 (s, 2H), 9.11 (s, 2H), 8.85 (d, J=3.7 Hz, 1H), 8.15 (m, 1H), 7.98-7.93 (m, 2H), 7.82-7.77 (m, 2H), 7.71-7.54 (m, 8H),

4-(2-methanesulfonylphenyl)-phenyl 2-(3-aminoiminomethylphenyl)-pyridine-3-carboxamide bistrifluoroacetic acid salt (Compound No. A3-32)

¹H-NMR (500 MHz, DMSO-d₆) δ10.74 (s, 1H), 9.40 (s, 2H), 8.96 (s, 2H), 8.85 (d, J=4.6 Hz, 1H), 8.15 (m, 2H), 8.09 (d, J=7.8 Hz, 1H), 8.00 (d, J=7.8 Hz, 1H), 7.81 (d, J=7.4 Hz, 1H), 7.78-7.61 (m, 6H), 7.39-7.36 (m, 3H), 2.83 (s, 3H).

4-(2-methanesulfonyl-imidazole-1-yl)-phenyl 2-(3-aminoiminomethylphenyl)-pyridine-3-carboxamide tris trifluoroacetic acid salt (Compound No. A3-33)

¹H-NMR (500 MHz, DMSO-d₆) δ10.84 (s, 1H), 9.40 (s, 2H), 8.98 (br s, 2H), 8.86 (d, J=3.7 Hz, 1H), 8.15 (m, 2H), 7.98 (d, J=6.9 Hz, 1H), 7.82 (d, J=6.4 Hz, 1H), 7.71-7.61 (m, 6H), 7.48 (d, J=8.7 Hz, 2H), 7.30 (s, 1H), 3.38 (s, 3H).

4-(2-cyano-thiophene-3-yl)-phenyl 2-(3-aminoiminomethylphenyl)-pyridine-3-carboxamide bistrifluoroacetic acid salt (Compound No. A3-34)

¹H-NMR (500 MHz, DMSO-d₆) δ10.81 (s, 1H), 9.39 (s, 2H), 9.00 (s, 2H), 8.85 (dd, J=4.6, 1.4 Hz, 1H), 8.15-8.12 (m, 3H), 7.97 (d, J=8.3 Hz, 1H), 7.80 (d, J=8.7 Hz, 1H), 7.73-7.61 (m, 6H), 7.54 (d, J=5.0 Hz, 1H).

4-(2-aminosulfonyl-5-methyl-thiophene-3-yl)-phenyl 2-(3-aminoiminomethylphenyl)-pyridine-3-carboxamide bistrifluoroacetic acid salt (Compound No. A3-35)

¹H-NMR (500 MHz, DMSO-d₆) δ10.69 (s, 1H), 9.40 (s, 2H), 9.04 (s, 2H), 8.84 (dd, J=5.1, 1.9 Hz, 1H), 8.15 (s, 1H), 8.11 (dd, J=7.3, 1.9 Hz, 1H), 7.97 (d, J=7.8 Hz, 1H), 7.81 (d, J=8.7 Hz, 1H), 7.70-7.52 (m, 8H), 6.89 (s, 1H), 2.47 (s, 3H).

4-(2-cyanophenyl)-phenyl 2-(3-aminoiminomethylphenyl)-6-methyl-pyridine-3-carboxamide bistrifluoroacetic acid salt (Compound No. A3-36)

¹H-NMR (500 MHz, DMSO-d₆) δ10.70 (s, 1H), 9.40 (s, 2H), 9.17 (s, 2H), 8.10 (s, 1H), 8.03 (d, J=8.3 Hz, 1H), 7.94 (m, 2H), 7.81-7.76 (m, 2H), 7.71-7.65 (m, 3H), 7.61-7.53 (m, 4H), 7.48 (d, J=7.8 Hz, 1H), 2.63 (s, 3H).

<Cyanophenylalanine Scaffolds>

### EXAMPLE 62e

Cyanophenylalanine Scaffold (H₂S Method)

4-(2-cyanophenyl)-phenyl N-methoxycarbonyl-3-(3-aminoiminomethylphenyl)alanine amide trifluoroacetic acid salt; (racemic, Compound No. A4-1)

A solution of 4-(2-cyanophenyl)-phenyl N-methoxycarbonyl-3-(3-cyanophenyl)alanine amide (61 mg, 0.14 mmol) in saturated H₂S (3 mL, in pyridine:TEA=4:1) was stirred for 10 h at room temperature. After concentration, the residue was taken up with EA, washed with 0.5N HCl, dried (MgSO₄) and concentrated. The crude thioamide was dissolved in acetonitrile (5 mL), treated with CH₃I (0.18 mL, 20 eq), then refluxed for 1 h. After concentration, the residue was dissolved in MeOH (5 mL), treated with anhydrous NH₄OAc (33 mg, 3 eq), refluxed for 1 h, then concentrated. The crude product was purified with RP-HPLC (Microsorb C18, 232 nm, 15 mL/min, 20% to 40% AcCN in H₂O containing 0.1% TFA), and lyophilized to give 49 mg (61%) of the title compound.

¹H-NMR (500 MHz, DMSO-d₆) δ10.27 (s, 1H), 9.28 (s, 2H), 9.02 (s, 2H), 7.93 (d, J=7.8 Hz, 1H), 7.80-7.54 (m, 12H), 4.48 (m, 1H), 3.50 (s, 3H), 3.16 (m, 1H), 2.98 (m, 1H).

The following compounds were prepared similarly.

4-(2-aminosulfonyl-5-fluoro-phenyl)-phenyl N-methanesulfonyl-3-(3-aminoiminomethylphenyl)alanine amide trifluoroacetic acid salt (racemic, Compound No. A4-2)

¹H-NMR (500 MHz, DMSO-d₆) δ10.23 (s, 1H), 9.30 (s, 2H), 8.97 (s, 2H), 8.08 (dd, J=8.7, 6.0 Hz, 1H), 7.83 (d, J=8.7 Hz, 1H), 7.77 (s, 1H), 7.69 (d, J=7.8 Hz, 1H), 7.66 (d, J=7.8 Hz, 1H), 7.59-7.56 (m, 3H), 7.43 (m, 1H), 7.38 (d, J=8.7 Hz, 2H), 7.30 (s, 2H), 7.16 (m, 1H), 4.34 (m, 1H), 3.16 (m, 1H), 2.99 9m, 1H), 2.69 (s, 3H).

MS: 534 [m+H]

4-(2-aminosulfonylphenyl)-phenyl N-methoxycarbonyl-3-(3-aminoiminomethyl-6-hydroxy-phenyl)alanine amide trifluoroacetic acid salt (racemic, Compound No. A4-3)

¹H-NMR (500 MHz, DMSO-d₆) δ10.83 (s, 1H), 9.99 (s, 1H), 8.99 (s, 2H), 8.78 (s, 2H), 8.03 (d, J=7.8 Hz, 1H), 7.70 (s, 1H), 7.62-7.54 (m, 5H), 7.36-7.29 (m, 4H), 7.18 (s, 2H), 6.97 (d, J=8.7 Hz, 1H), 4.49 (m, 1H), 3.50 (s, 3H), 3.12 (m, 1H), 2.90 (m, 3H).

MS: 512 [M+H]

4-(2-aminocarbonylphenyl)-phenyl N-methanesulfonyl-3-(3-aminoiminomethylphenyl)alanine amide trifluoroacetic acid salt (racemic, Compound No. A4-4)

¹H-NMR (500 MHz, DMSO-d₆) δ10.21 (s, 1H), 9.30 (s, 2H), 9.15 (s, 2H), 7.82 (d, J=9.2 Hz, 1H), 7.78 (s, 1H), 7.68-7.63 (m, 3H), 7.58-7.54 (m, 3H), 7.48-7.34 (m, 6H), 7.26 (s, 1H), 4.33 (m, 1H), 3.15 (dd, J=13.8, 6.0 Hz, 1H), 3.00 (dd, J=13.8, 8.7 Hz, 1H), 2.69 (s, 3H).

MS: 480 [M+H]

4-(2-cyanophenyl)-phenyl N-methanesulfonyl-3-(3-aminoiminomethylphenyl)alanine amide trifluoroacetic acid salt (racemic, Compound No. A4-5)

¹H-NMR (500 MHz, DMSO-d₆) δ10.32 (s, 1H), 9.29 (s, 2H), 8.95 (s, 2H), 7.94 (d, J=7.8 Hz, 1H), 7.84 (d, J=8.7 Hz, 1H), 7.80-7.77 (m, 2H), 7.71-7.65 (m, 4H), 7.61-7.55 (m, 5H), 4.34 (m, 1H), 3.17 (dd, J=13.3, 6.0 Hz, 1H), 3.00 (dd, J=13.3, 8.8 Hz, 1H), 2.71 (s, 3H).

MS: 462 M+H]

4-(2-aminosulfonylphenyl)-phenyl N-methanesulfonyl-3-(3-aminoiminomethylphenyl)alanine amide trifluoroacetic acid salt (racemic, Compound No. A4-6)

¹H-NMR (500 MHz, CD₃OD) δ8.10 (d, J=7.8 Hz, 1H), 7.73-7.51 (m, 8H), 7.38 (d, J=8.7 Hz, 2H), 7.30 (dd, J=7.3, 2.4 Hz, 1H), 4.38 (m, 1H), 3.28 (m, 1H), 3.14 (m, 1H), 2.84 (s, 3H).

4-(2-aminosulfonyl-5-methyl-phenyl)-phenyl N-methanesulfonyl-3-(3-aminoiminomethylphenyl)alanine amide trifluoroacetic acid salt (racemic, Compound No. A4-7)

¹H-NMR (500 MHz, CD₃OD) δ7.97 (d, J=8.3 Hz, 1H), 7.74-7.66 (m, 3H), 7.57 (m, 1H), 7.51 (d, J=8.2 Hz, 2H), 7.37 (d, J=8.7 Hz, 2H), 7.33 (d, J=6.9 Hz, 1H), 7.12 (s, 1H), 4.38 (m, 1H), 3.29 (m, 1H), 3.16 (m, 1H), 2.84 (s, 3H), 2.42 (s, 3H).

4-(2-aminosulfonylphenyl)-phenyl N-methoxycarbonyl-3-(3-aminoiminomethylphenyl)alanine amide trifluoroacetic acid salt (racemic, Compound No. A4-8)

¹H-NMR (500 MHz, DMSO-d₆) δ10.17 (s, 1H), 9.20 (br, 4H), 8.03 (d, J=7.8 Hz, 1H), 7.79 (s, 1H) 7.70 (d, J=7.3 Hz, 1H), 7.65-7.54 (m, 9H), 7.34 (d, J=8.3 Hz, 2H), 7.30 (d, J=7.8 Hz, 1H), 4.48 (m, 1H), 3.49 (s, 3H), 3.15 (m, 1H), 2.98 (m, 1H).

5-(2-cyanophenyl)-pyridine-2-yl N-methanesulfonyl-3-(3-aminoiminomethylphenyl)alanine amide trifluoroacetic acid salt (optcally active, Compound No. A4-9)

¹H-NMR (500 MHz, DMSO-d₆) δ10.89 (s, 1H), 9.30 (s, 12H), 9.05 (s, 2H), 8.57 (d, J=2.3 Hz, 1H), 8.23 (d, J=8.8 Hz, 1H), 8.08 (dd, J=8.8, 2.3 Hz, 1H), 7.99 (d, J=7.4 Hz, 1H), 7.89-7.81 (m, 3H), 7.74-7.55 (m, 5H), 4.48 (m, 1H), 3.23 (m, 3H), 2.94 (m, 1H), 2.60 (s, 1H).

MS: 463 [M+H]

4-(2-cyanophenyl)-phenyl N-carboxymethyl)-3-(3-aminoiminomethylphenyl)alanine amide trifluoroacetic acid salt (racemic, Compound No. A4-10)

¹H-NMR (500 MHz, DMSO-d₆) δ10.40 (s, 1H), 9.27 (s, 2H), 9.08 (s, 2H), 7.94 (d, J=7.8 Hz, 1H), 7.80-7.76 (m, 2H), 7.68 (d, J=7.8 Hz, 1H), 7.62-7.54 (m, 8H), 4.15 (m, 1H), 3.72 (br, 2H), 3.21 (m, 1H).

(S)-3-(3-aminoiminomethylphenyl)-1-hydroxy-propane-2-yl 4-(2-aminosulfonyl-5-fluorophenyl)-benzamide trifluoroacetic acid salt (optcally active, Compound No. A4-11)

¹H-NMR (500 MHz, DMSO-d₆) δ9.28 (s, 2H), 9.04 (s, 2H), 8.30 (d, J=8.3 Hz, 1H), 8.09 (dd, J=9.2, 6.0 Hz, 1H), 7.80 (d, J=8.7 Hz, 2H), 7.74 (s, 1H), 7.67 (d, J=7.8 Hz, 1H), 7.61 (d, J=7.8 Hz, 1H), 7.54-7.45 (m, 4H), 7.37 (s, 2H), 7.18 (dd, J=9.2, 2.8 Hz, 1H), 4.29 (m, 1H), 3.53 (m, 2H), 3.08 (dd, J=13.8, 5.1 Hz, 1H), 2.92 (dd, J=13.8, 9.2 Hz, 1H).

MS: 471 [M+H]

(S)-N-{4-(2-cyanophenyl)-benzoyl}-3-(3-aminoiminomethylphenyl)alanine methyl ester trifluoroacetic acid salt (optically active, Compound No. A4-12)

¹H-NMR (500 MHz, DMSO-d₆) 9.31 (s, 2H), 9.23 (s, 2H), 9.07 (d, J=7.8 Hz, 1H), 7.98 (d, J =7.9 Hz, 1H), 7.93 (d, J=8.3 Hz, 2H), 7.82 (m, 2H), 7.72-7.61 (m, 6H), 7.54 (m, 1H), 4.82 (m, 1H), 3.69 (s, 3H), 3.31 (m, 1H), 3.21 (m, 1H).

MS: 427 [M+H]

(S)-N-{4-(2-cyanophenyl)-benzoyl}-3-(3-aminoiminomethylphenyl)alanine ethyl amide trifluoroacetic acid salt (optically active, Compound No. A4-13)

MS: 440 [M+H]

4-(2-cyanophenyl)-phenyl (S)-N-acetyl-3-(3-aminoiminomethylphenyl)alanine amide trifluoroacetic acid salt (optically active, Compound No. A4-14)

MS: 426 [M+H]

(S)-N-{4-(2-cyano-5-fluoro-phenyl)-benzoyl}-3-(3-aminoiminomethylphenyl)alanine methyl ester trifluoroacetic acid salt (optically active, Compound No. A4-15)

MS: 499 [m+H]

(S)-N-{4-(2-aminosulfonyl-5-methyl-phenyl)-benzoyl}-3-(3-aminoiminomethylphenyl)alanine methyl ester trifluoroacetic acid salt (optcally active, Compound No. A4-16)

¹H-NMR (500 MHz, CD₃OD) 7.98 (d, J=8.3 Hz, 1H), 7.74 (m, 3H), 7.67 (m, 2H), 7.54 (m, 1H), 7.47 (d, J=8.7 Hz, 2H), 7.38 (m, 1H), 7.13 (s, 1H), 4.50 (m, 1H), 3.77 (s, 3H), 3.47 (m, 1H), 3.30 (m, 1H), 2.43 (s, 3H).

(S)-N-{4-(2-aminosulfonylphenyl)-benzoyl}-3-(3-aminoiminomethylphenyl)alanine trifluoroacetic acid salt (optcally active, Compound No. A4-17)

¹H-NMR (500 MHz, DMSO-d₆) δ9.26 (br, 4H), 8.75 (br, 2H), 8.05 (d, J=7.8 Hz, 1H), 7.80 (m, 3H), 7.71 (d, J=6.9 Hz, 1H), 7.66-7.59 (m, 3H), 7.54 (m, H), 7.45 (d, J=8.3 Hz, 2H), 7.31 (m, 3H), 4.74 (m, 1H), ˜3.30 (1H, buried underwater peak), 3.20 (m, 1H).

(S)-N-{4-(2-aminosulfonylphenyl)-benzoyl}-3-(3-aminoiminomethylphenyl)alanine methyl ester trifluoroacetic acid salt (optcally active, Compound No. A4-18)

¹H-NMR (500 MHz, DMSO-d₆) δ9.29 (s, 2H), 9.04 (s, 2H), 8.97 (d, J=8.3 Hz, 1H), 8.05 (d, J=7.4 Hz, 1H), 7.80 (m, 3H), 7.73 (d, J=7.8 Hz, 1H), 7.65-7.59 (m, 3H), 7.56 (m, 1H), 7.46 (d, J=8.3 Hz, 2H), 7.31 (m, 3H), 4.82 (m, 1H), 3.69 (s, 3H), 3.34 (m, 1H), 3.21 (m, 1H).

(S)-N-{4-(2-aminosulfonylphenyl)-benzoyl}-3-(3-aminoiminomethylphenyl)alanine ethyl ester trifluoroacetic acid salt (optcally active, Compound No. A4-19)

¹H-NMR (500 MHz, CD₃OD) 8.11 (d, J=7.8 Hz, 1H), 7.75 (m, 3H), 7.68-7.61 (m, 3H), 7.58-7.52 (m, 2H), 7.49 (d, J=7.4 Hz, 2H), 7.31 (d, J=7.3 Hz, 1H), 4.97 (m, 1H), 4.23 (q, J=6.9 Hz, 2H), 3.46 (m, 1H), 3.22 (m, 1H), 1.27 (t, J=6.9 Hz, 3H).

4-(2-cyanophenyl)-phenyl N-methanesulfonyl-3-(3-aminoiminomethylphenyl)alanine amide trifluoroacetic acid salt (racemic, Compound No. A4-20)

¹H-NMR (500 MHz, DMSO-d₆) δ10.31 (s, 1H), 9.29 (s, 2H), 8.93 (s, 2H), 7.94 (d, J=6.9 Hz, 1H), 7.82-7.77 (m, 3H), 7.70-7.65 (m, 4H), 7.61-7.55 (m, 5H), 4.31 (m, 1H), 3.16 (m, 1H), 2.99 (m, 1H), 2.78 (m, 2H), 1.04 (m, 3H).

1-[4-(2-aminosulfonylphenyl)-phenoxy]-2-methanesulfonylamino-3-(3-aminoiminomethylphenyl)-propane trifluoroacetic acid salt (racemic, Compound No. A4-21)

¹H-NMR (500 MHz, DMSO-d₆) δ9.29 (br, 2H), 8.94 (br, 2H), 8.02 (d, J=7.8 Hz, 1H), 7.79 (s, 1H), 7.71 (d, J=7.8 Hz, 1H), 7.67 (d, J=7.8 Hz, 1H), 7.62-7.52 (m, 4H), 7.34 (d, J=8.7 Hz, 2H), 7.29 (d, J=6.9 Hz, 1H), 7.16 (s, 1H), 6.97 (d, J=8.7 Hz, 2H), 4.03-3.92 (m, 3H), 3.11 (m, 1H), 2.90 (m, 1H) 2.62 (s, 3H).

4-(2-cyanophenyl)-phenyl N-(n-propanesulfonyl)-3-(3-aminoiminomethylphenyl)-alanine amide trifluoroacetic acid salt (racemic, Compound No. A4-22)

1H-NMR (500 MHz, DMSO-d₆) 10.32 (s, 1H), 9.30 (s, 2H), 9.02 (s, 2H), 7.94 (d, J=7.4 Hz, 1H), 7.83-7.77 (m, 3H), 7.71-7.66 (m, 4H), 7.62-7.55 (m, 5H), 4.31 (m, 1H), 3.16 (dd, J=13.3, 6.0 Hz, 1H), 2.99 (dd, J=13.3, 9.2 Hz, 1H), 2.75 (m, 2H), 1.55 (m, 1H), 1.45 (m, 1H), 0.81 (t, J=7.3 Hz, 3H).

4-(2-Cyanophenyl)-phenyl N-ethoxycarbonyl-3-(3-aminomethylphenyl)-alanine amide trifluoroacetic acid salt (racemic, Compound No. A4-23)

¹H-NMR (500 MHz, DMSO-d₆) 10.28 (s, 1H), 9.17 (br s, 4H), 7.94 (d, J=7.8 Hz, 1H), 7.80 (s, 1H), 7.77 (d, J=7.8 Hz, 1H), 7.72-7.69 (m, 3H), 7.65-7.54 (m, 7H), 4.46 (m, 1H), 3.93 (m, 2H), 3.15 (m, 1H), 2.98 (m, 1H), 1.12 (t, J=6.9 Hz, 3H).

4-(2-Cyanophenyl)-phenyl N-ethylaminocarbonyl-3-(3-aminoiminomethylphenyl)-alanine amide trifluoroacetic acid salt (racemic, Compound No. A4-24)

¹H-NMR (500 MHz, DMSO-d₆) 10.27 (s, 1H), 9.27 (s, 2H), 9.05 (s, 2H), 7.93 (d, J=7.4 Hz, 1H), 7.78 (m, 1H), 7.71-7.67 (m, 3H), 7.64-7.51 (m, 7H), 6.33 (d, J=8.3 Hz, 1H), 6.06 (t, J=5.5 Hz, 1H), 4.65 (m, 1H), 3.10 (dd, J=13.8, 6.0 Hz, 1H), 3.00-2.93 (m, 3H), 0.95 (t, J=7.3 Hz, 3H).

4-(2-Cyanophenyl)-phenyl N,N-bis-methanesulfonyl-3-(3-aminoiminomethylphenyl)-alanine amide trifluoroacetic acid salt (racemic, Compound No. A4-25)

¹H-NMR (500 MHz, DMSO-d₆) 10.22 (s, 1H), 9.35 (s, 2H), 9.10 (s, 2H), 8.10 (dd, J=8.3, 1.4 Hz, 1H), 7.88 (m, 2H), 7.79-7.66 (m, 6H), 7.41 (m, 3H), 5.44 (m, 1H), 3.77 (m, 1H), 3.61 (m, 1H), 3.10 (s, 6H), 2.85 (s, 3H).

4-(2-Methanesulfonylphenyl)-phenyl N-methyl-N-methanesulfonyl-3-(3-aminoiminomethylphenyl)alanine amide trifluoroacetic acid salt (racemic, Compound No. A4-26)

¹H-NMR (500 MHz, DMSO-d₆) 10.34 (s, 1H), 9.32 (s, 2H), 9.16 (s, 2H), 8.09 (d, J=7.3 Hz, 1H), 7.79-7.59 (m, 8H), 7.36 (m, 3H), 4.87 (m, 1H), 3.34 (m, 1H), 3.20 (m, 1H), 3.02 (s, 3H), 2.83 (s, 3H), 2.78 (s, 3H).

4-(2-Methanesulfonylphenyl) N-methanesulfonyl-3-(3-aminoiminomethylphenyl)-alanine amide trifluoroacetic acid salt (racemic, Compound No. A4-27)

¹H-NMR (500 MHz, DMSO-d₆) 10.31 (s, 1H), 9.31 (s, 2H), 9.13 (s, 2H), 8.10 (d, J=7.3 Hz, 1H), 7.88-7.56 (m, 8H), 7.38 (m, 4H), 4.32 (m, 1H), 3.16 (m, 1H), 2.99 (m, 1H), 2.83 (s, 3H), 2.68 (s, 3H).

4-(2-Aminosulfonylphenyl)-phenyl N-methyl-N-methanesulfonyl-3-(3-aminoiminomethylphenyl)alanine amide trifluoroacetic acid salt (racemic, Compound No. A4-28)

¹H-NMR (500 MHz, DMSO-d₆) 10.26 (s, 1H), 9.31 (s, 2H), 9.02 (s, 2H), 8.02 (d, J=7.8 Hz, 1H), 7.78 (s, 1H), 7.72 (d, J=7.8 Hz, 1H), 7.67 (d, J=7.8 Hz, 1H), 7.62-7.54 (m, 6H), 7.34 (d, J=8.3 Hz, 2H), 7.29 (d, J=7.8 Hz, 1H), 7.25 (s, 2H), 4.86 (m, 1H), ˜3.32 (m, 1H), 3.16 (m, 1H), 3.02 (s, 3H), 2.80 (s, 3H).

(S)-N-{4-(2-methanesulfonylphenyl)-benzoyl}-3-(3-aminoiminomethylphenyl)-alanine methyl ester trifluoroacetic acid salt (optcally active, Compound No. A4-29)

¹H-NMR (500 MHz, DMSO-d₆) 9.30 (s, 2H), 9.04 (d, J=7.8 Hz, 1H), 8.95 (s, 1H), 8.11 (d, J=8.3 Hz, 1H), 7.85-7.64 (m, 7H), 7.55 (m, 1H), 7.49 (d, J=7.8 Hz, 2H), 7.39 (d, J=7.4 Hz, 1H), 4.82 (m, 1H), 3.69 (s, 3H), ˜3.32 (m, 1H), 3.21 (m, 1H), 2.90 (s, 3H).

1-{4-(2-aminosulfonylphenyl)-phenylcarbonylamino}-1-(4-ethoxycarbonylthiazole-2-yl)-2-(3-aminoiminethylphenyl)ethane trifluoroacetic acid salt (Compound No. A4-30)

¹H-NMR (500 MHz, DMSO-d₆) 9.41 (d, J=8.3 Hz, 1H), 9.30 (s, 2H), 8.98 (br, 2H), 8.48 (s, 1H), 8.04 (d, J=7.3 Hz, 1H), 7.94 (s, 1H), 7.82-7.78 (m, 3H), 7.65-7.54 (m, 4H), 7.47 (d, J =8.3 Hz, 2H), 7.34 (s, 2H), 7.31 (d, J=6.9 Hz, 1H), 5.71 (m, 1H), 4.33 (m, 2H), 3.57 (m, 1H), ˜3.4 (m, 1H, buried under solvent peaks), 1.32 (t, J=7.3 Hz, 3H).

4-(2-Methanesulfonylphenyl)-phenyl N-ethyl-N-methanesulfonyl-3-(3-aminoiminomethylphenyl)alanine amide trifluoroacetic acid salt; (racemic, Compound No. A4-31)

¹H-NMR (500 MHz, DMSO-d₆) 10.21 (s, 1H), 9.28 (s, 2H), 8.96 (s, 2H), 8.07 (d, J=7.8 Hz, 1H), 7.76-7.73 (m, 2H), 7.69-7.64 (m, 3H), 7.59-7.54 (m, 3H), 7.37-7.32 (m, 3H), 4.78 (m, 1H), 3.65-3.30 (m, 3H, buried under solvent peaks), 3.14 (m, 1H), 2.94 (s, 3H), 2.82 (s, 3H), 1.13 (t, J=6.9 Hz, 3H).

4-(2-Cyanophenyl)-phenyl N-ethyl-N-methanesulfonyl-3-(3-aminoiminomethylphenyl)-alanine amide trifluoroacetic acid salt; (racemic, Compound No. A4-32)

¹H-NMR (500 MHz, DMSO-d₆) 10.30 (s, 1H), 9.30 (s, 2H), 9.15 (s, 2H), 7.92 (d, J=7.8 Hz, 1H), 7,78-7.75 (m, 2H), 7.68-7.63 (m, 4H), 7.59-7.51 (m, 5H), 4.79 (m, 1H), 3.63-3.35 (m, 3H, buried under solvent peaks), 3.15 (dd, J=13.7, 6.9 Hz, 1H), 2.94 (s, 3H), 1.13 (t, J=7.4 Hz. 3H).

N-{4-(2-cyanophenyl)-benzoyl}-3-(2-aminoiminomethylpyridine-4-yl)-alanine N,N-dimethyl amide trifluoroacetic acid salt (Compound No. A4-33)

¹H-NMR (500 MHz, DMSO-d₆) 9.31 (s, 2H), 9.16 (s, 2H), 8.97 (d, J=7.8 Hz, 1H), 7.99-7.94 (m, 5H), 7.84-7.81 (m, 2H), 7.73 (d, J=7.4 Hz, 1H), 7.67-7.61 (m, 5H), 7.53 (m, 1H), 5.19 (m, 1H), 3.18-3.06 (m, 2H), 3.05 (s, 3H), 2.85 (s, 3H).

N-{4-(2-cyanophenyl)-benzoyl}-3-(2-aminoiminomethylpyridine-4-yl)-alanine ethyl ester trifluoroacetic acid salt (Compound No. A4-34)

¹H-NMR (500 MHz, DMSO-₆) 9.30 (s, 2H), 9.11 (d, J=7.8 Hz, 1H), 7.99 (d, J=7.3 Hz, 1H), 7.93 (d, J=6.9 Hz, 2H), 7.82 (m, 2H), 7.73-7.61 (m, 6H), 7.55 (m, 1H), 4.80 (m, 1H), 4.15 (m, 2H), 3.31-3.19 (m, 2H), 1.18 (m, 3H).

4-(2-Aminosulfonylphenyl)-phenyl N-ethyl-N-methanesulfonyl-3-(3-aminoiminomethylphenyl)-alanine amide trifluoroacetic acid salt; (racemic, Compound No. A4-35)

¹H-NMR (500 MHz, DMSO-d₆) 10.17 (s, 1H), 9.30 (s, 2H), 9.02 (d, J=7.8 Hz, 1H), 8.01 (dd, J=7.8, 1.4 Hz, 1H), 7.76 (s, 1H0, 7.68-7.49 (m, 7H), 7.32-7.26 (m, 5H), 4.78 (m, 1H), 3.64˜3.33 (m, 3H, buried under solvent peaks), 3.13 (m, 1H), 2.96 (s, 3H), 1.13 (t, J=6.9 Hz, 3H).

4-(2-Cyanophenyl)-phenyl N-ethyl-N-ethoxycarbonyl-3-(3-aminoiminomethylphenyl)-alanine amide trifluoroacetic acid salt; (racemic, Compound No. A4-36)

¹H-NMR (500 MHz, DMSO-d₆) [mixture of rotamers]δ10.20 (s, 1H), 9.30 (s, 2H), 9.11 (s, 2H), 7.93 (d, J=7.8 Hz, 1H), 7.79-7.53 (m, 11H), 5.02 & 4.91 (two br s, 1H), 4,05 & 3.96 (two br s, 2H), 3.38 (dd, J=13.8, 6.9 Hz, 1H), 3.31 (br s, 2H), 3.10 (dd, J=13.8, 8.3 Hz, 1H), 1.15-0.99 (m, 6H).

4-(2-Methanesulfonylphenyl)-phenyl 2-(N-propanosultam)-3-(3-aminoiminomethylphenyl-propanoic amide trifluoroacetic acid salt; (racemic, Compound No. A4-37)

¹H-NMR (500 MHz, DMSO-d₆) δ10.21 (s, 1H), 9.29 (s, 2H), 8.96 (s, 2H), 8.08 (dd, J=7.8, 1.4 Hz, 1H), 7.75 (m, 2H), 7.68-7.64 (m, 3H), 7.59-7.55 (m, 3H), 7.37-7.32 (m, 3H), 4.56 (m, 1H), 3.76 (m, 1H), 3.55-3.10 (m, 5H), 2.82 (s, 3H), 2.31 (m, 1H), 2.17 (m, 1H).

4-(2-Methanesulfonylphenyl)-phenyl N-benzyl-N-methanesulfonyl-3-(3-aminoiminomethylphenyl)alanine amide trifluoroacetic acid salt; (racemic, Compound No. A4-38)

¹H-NMR (500 MHz, DMSO-d₆) δ10.30 (s, 1H), 9.21 (s, 2H), 9.06 (s, 2H), 8.08 (d, J=7.8 Hz, 1H), 7.75 (m, 1H), 7.66 (m, 1H), 7.60 (d, J=7.4 Hz, 1H), 7.55-7.48 (m, 4H), 7.42 (s, 1H0, 7.38-7.32 (m, 5H), 7.27-7.19 (m, 3H), 4.90 (m, 1H), 4.85-4.69 (ABq, J=17.0 Hz, 2H), ˜3.4 (m, 1H, buried under solvent peaks), 3.25 (dd, J=13.7, 8.7 Hz, 1H), 2.99 (s, 3H), 2.83 (s, 3H).

4-(2-Cyanophenyl)-phenyl N-methyl-N-ethoxycarbonyl-3-(3-aminoiminomethylphenyl)-alanine amide trifluoroacetic acid salt; (racemic, Compound No. A4-39)

¹H-NMR (500 MHz, DMSO-d₆) [mixture of rotamers]δ10.23 & 10.17 (two s, 1H), 9.30 (s, 2H), 9.04 (s, 2H), 7.94 (d, J=7.8 Hz, 1H), 7.80-7.40 (m, 11H), 5.14 & 5.04 (two m, 1H), 3.99-3.89(m, 2H), ˜3.40 (m, 1H, buried under solvent peaks), 3.11 (m, 1H), 2.88 & 2.82 (two s, 3H), 1.13-1.01 (m, 3H).

4-(2-Cyanophenyl)-phenyl N-methyl-N-methanesulfonyl-3-(3-aminoiminomethylphenyl)-alanine amide trifluoroacetic acid salt; (racemic, Compound No. A4-40)

¹H-NMR (500 MHz, DMSO-d₆) δ10.39 (s, 1H), 9.31 (s, 2H), 9.12 (s, 2H), 7.94 (d, J=7.8 Hz, 1H), 7.79-7.76 (m, 2H), 7.72-7.70 (m, 3H), 7.67 (d, J=7.8 Hz, 1H), 7.61-7.54 (m, 5H), 4.87 (m, 1H), 3.33 (m, 1H), 3.02 (s, 3H), 2.78 (s, 3H).

4-(2-Aminosulfonylphenyl)-2-chloro-phenyl N-methyl-N-methanesulfonyl-3-(3-aminoiminomethylphenyl)-alanine amide trifluoroacetic acid salt; (racemic, Compound No. A4-41)

4-(2-Cyanophenyl)-phenyl 2-(N-propanosultam)-3-(3-aminoiminomethylphenyl)-propanoic amide trifluoroacetic acid salt; (racemic, Compound No. A4-49)

¹H-NMR (500 MHz, DMSO-d₆) δ10.24 (s, 1H), 9.28 (s, 2H), 8.97 (s, 2H), 7.93 (d, J=8.3 Hz, 1H), 7.79-7.76 (m, 2H), 7.67-7.63 (m, 4H), 7.60-7.51 (m, 5H), 4.57 (m, 1H), 3.76 (m, 1H), 3.6-3.3 (m, 2H, buried under solvent peaks), 3.22-3.11 (m, 3H), 2.32 (m, 1H), 2.19 (m, 1H).

4-(2-Cyanophenyl)-phenyl N-methyl-N-acetyl-3-(3-aminoiminomethylphenyl)alanine amide trifluoroacetic acid salt; (racemic, Compound No. A4-43)

¹H-NMR (500 MHz, DMSO-d₆) [mixture of rotamers]δ10.17 & 10.07 (two s, 1H), 9.28 (s, 2H), 8.96 (s, 2H), 7.94 (m, 1H), 7.81-7.52 (m, 11H), 5.45 & 4.89 (two m, 1H), ˜3.40 (m, 1H, buried under solvent peaks), 3.07 (m, 1H), 3.00 & 2.84 (two s, 3H), 1.96 & 1.73 (two s, 3H).

4-(2-Cyanophenyl)-phenyl N-methyl-N-propanoyl-3-(3-aminoiminomethylphenyl)-alanine amide trifluoroacetic acid salt; (racemic, Compound No. A4-44)

¹H-NMR (500 MHz, DMSO-d₆) [mixture of rotamers]δ10.15 & 10.06 (s, 1H), 9.27 (s, 2H), 8.93 (s, 2H), 7.93 (m, 1H), 7.80-7.52 (m, 11H), 5.48 & 4.95 (two m, 1H), ˜3.40 (m, 1H, buried under solvent peaks), 3.07 (m, 1H), 2.97 & 2.86 (two s, 3H), 2.26 (m, 2H), 0.90 & 0.79 (two t, 3H).

4-2Cyanophenyl)-phenyl N-ethyl-N-isopropyloxycarbonyl-3-(3-aminoiminomethylphenyl)-alanine amide trifluoroacetic acid salt; (racemic, Compound No. A4-45)

1H-NMR (500 MHz, DMSO-d₆) [mixture of rotamers]δ10.18 & 10.00 (s, 1H), 9.28 (s, 2H), 9.13 & 9.04 (s, 2H), 7.93 (d, J=7.8 Hz, 1H), 7.79-7.53 (m, 11H), 5.02 & 4.77 (two br s, 2H), ˜3.50 (m, 3H, buried under solvent peaks), 3.11 (dd, J=13.3, 8.3 Hz, 1H), 1.28-0.98 (m, 3H).

4-(2-Cyanophenyl)-phenyl N-ethyl-N-propanoyl-3-(3-aminoiminomethylphenyl)-alanine amide trifluoroacetic acid salt; (racemic, Compound No. A4-46)

¹H-NMR (500 MHz, DMSO-d₆) [mixture of rotamers]δ10.26 & 10.01 (s, 1H), 9.28 (s, 2H), 9.19 (s, 2H), 7.92 (d, J=7.4 Hz, 1H), 7.78-7.50 (m, 11H), 5.23 & 4.84 (two m, H), ˜3.40 (m, 3H, buried under solvent peaks), 3.04 (m, 1H), 2.55-1.91 (m, 2H), 1.05-0.82 (m, 6H).

4-(2-Cyanophenyl)-phenyl 2-(N-oxazolidin-2-one)-3-(3-aminoiminomethylphenyl)-propanoic amide trifluoroacetic acid salt; (racemic, Compound No. A4-47)

¹H-NMR (500 MHz, DMSO-d₆) δ10.40 (s, 1H), 9.30(s, 2H), 8.99 (s, 2H), 7.94 (d, J=8.2 Hz, 1H), 7.80-7.71 (m, 5H), 7.67 (d, J=8.3 Hz, 1H), 7.62-7.54 (m, 5H), 4.87 (m, 1H), 4.33 (m, 1H), 4.19 (m, 1H), 3.85 (m, 1H), 3.74 (m, 1H), 3.32 (m, 1H), 3.16 (m, 1H).

4-(2-Methanesulfonylphenyl)-phenyl 2-(N-oxazolidin-2-one)-3-(3-aminoiminomethylphenyl)-propanoic amide trifluoroacetic acid salt; (racemic, Compound No. A4-48)

¹H-NMR (500 MHz, DMSO-d₆) δ10.35 (s, 1H), 9.30 (s, 2H), 8.97 (s, 2H), 8.09 (d, J=7.8 Hz, 1H), 7.79-7.57 (m, 8H), 7.39-7.35 (m, 3H), 4.86 (m, 1H), 4.34 (m, 1H), 4.19 (m, 1H), 3.85 (m, 1H), 3.75 (m, 1H), 3.33 (m, 1H), 3.17 (m, 1H), 2.82 (s, 3H).

4-(2-Cyanophenyl)-phenyl 2-[N-propanosultam]-3-1-aminoisoquinoline-7-yl)-propanoic amide trifluoroacetic acid salt; (racemic, Compound No. A4-49)

¹H-NMR (500 MHz, DMSO-d₆) δ10.37 (s, 1H), 8.09 (s, 1H), 7.92 (m, 1H), 7.78-7.51 (m, 11H), 6.86 (d, J=6.0 Hz, 1H), 6.66 (m, 1H), 4.64 (m, 1H), 3.78 (m, 1H), 3.61 (m, 1H), 3.38 (m, 1H), 3.19-3.09 (m, 3H), 2.30 (m, 1H), 2.17 (m, 1H).

<Prodrug Formations>

### EXAMPLE 63

4-(2-methanesulfonylphenyl)-phenyl 2-(N-oxazolidin-2-one)-3-(3-amino-[hydroxyimino]methylphenyl)-propanoic amide trifluoroacetic acid salt (racemic)

To a solution of 141 mg (0.287 mmol) of 4-(2-methanesulfonylphenyl)-phenyl 2-(N-oxazolidin-2-one)-3-(3-cyanophenyl)-propanoic amide in 5 ml of a mixed solvent (EtOH:H₂O=4:1) was added Na₂CO₃ 52 mg (1.7 eq) of and 80 mg (4.0 eq) of NH₂OH.HCl. After refluxing for 2 hrs, the reaction mixture was concentrated in vacuo and isolated with prep-HPLC. The reaction was lyophilized to obtain white solid as TFA salt (66 mg, 36%).

¹H-NMR (500 MHz, DMSO-d₆) δ11.0 (br, 1H), 10.37 (s, 1H), 8.80 (br, 2H), 8.08 (dd, J=8.3, 0.9 Hz, 1H), 7.76 (m, 1H), 7.70 (s, 1H), 7.68-7.64 (m, 4H), 7.58-7.52 (m, 2H), 7.39-7.35 (m, 3H), 4.85 (m, 1H), 4.33 (m, 1H), 4.17 (m, 1H), 3.86 (m, 1H), 3.73 (m, 1H), 3.33 (m, 1H), 3.15 (m, 1H), 2.82 (s, 3H).

4-(2-methanesulfonylphenyl)-phenyl cis-2-(3-amino[ethoxycarbonylimino]methylphenyl)-cyclopropane-1-carboxamide

¹H-NMR (500 MHz, CDCl₃) δ8.17 (d, J=7.8 Hz, 1H), 7.93 (br s, 1H), 7.80 (s, 1H), 7.64-7.59 (m, 2H), 7.52 (m, 1H), 7.47-7.41 (m, 3H), 7.33-7.28 (m, 4H), 4.21 (q, J=6.9 Hz, 2H), 2.58 (m, 1H+s, 3H), 2.21 (m, 1H), 1.89 (m, 1H), 1.42 (m, 1H), 1.33 (t, J=6.9 Hz, 3H).

4-(2-methanesulfonylphenyl)-phenyl cis-2-(3-amino[hydroxyimino]methylphenyl)-cyclopropane-1-carboxamide

¹H-NMR (500 MHz, DMSO-d₆) δ10.29 (s, 1H), 9.56 (s, 1H), 8.05 (d, J=8.3 Hz, 1H), 7.73-7.61 (m, 4H), 7.49 (d, J=8.7 Hz, 2H), 7.44 (d, J=7.3 Hz, 1H), 7.35 (d, J=7.4 Hz, 1H), 7.28-7.19 (m, 4H), 5.73 (s, 1H), 2.75 (s, 3H), 2.58 (m, 1H), 2.28 (m, 1H), 1.66 (m, 1H), 1.34 (m, 1H).

4-(2-aminosulfonylphenyl)-phenyl cis-2-(3-amino[hydroxyimino]methylphenyl)-cyclopropane-1-carboxamide trifluoroacetic acid salt;

1H-NMR (500 MHz, DMSO-d₆) δ11.0 (br, 1H), 10.30 (s, 1H), ˜8.9 (br, 1H), 7.99 (d, J=7.8 Hz, 1H), 7.62 (s, 1H), 7.59-7.51 (m, 3H), 7.49-7.42 (m, 4H), 7.26-7.21 (m, 5H), 2.64 (m, 1H), 2.34 (m, 1H), 1.73 (m, 1H), 1.42 (m, 1H).

4-(2-aminosulfonyl-5-fluorophenylphenyl cis-2-(3-amino[hydroxyimino]methylphenyl)-cyclopropane-1-carboxamide trifluoroacetic acid salt;

¹H-NMR (500 MHz, DMSO-d₆) δ11.09 (br s, 1H), 10.32 (s, 1H), 8.97 (br, 2H), 8.04 (dd, J =8.7, 5.5 Hz, 1H), 7.63 (s, 1H), 7.59 (d, J=7.3 Hz, 1H), 7.50-7.37 (m, 5H), 7.29 (s, 2H), 7.26 (d, J=8.7 Hz, 2H), 7.11 (dd, J=9.6, 2.8 Hz, 1H), 2.65 (m, 1H), 2.35 (m, 1H), 1.74 (m, 1H), 1.41 (m, 1H).

4-(2-aminosulfonyl-5-methylphenyl)-phenyl 2-(3-amino[hydroxyimino]methylphenyl)-pyridine-3-carboxamide bistrifluoroacetic acid salt;

¹H-NMR (500 MHz, DMSO-d₆) δ10.68 (s, 1H), 9.20 (br s, 1H), 8.83 (dd, J=4.6, 1.9 Hz, 1H), 8.12 (dd, J=7.8, 1.8 Hz, 1H), 8.07 (s, 1H), 7.97 (d, J=7.8 Hz, 1H), 7.90 (d, J=8.3 Hz, 1H), 7.75-7.67 (m, 2H), 7.62 (dd, J=7.8, 5.1 Hz, 1H), 7.56 (d, J=8.7 Hz, 2H), 7.37-7.33 (m, 3H), 7.21 (s, 2H), 7.10 (s, 1H), 2.38 (s, 3H).

4-(2-cyanophenyl)-phenyl 2-(3-amino[hydroxyimino]methylphenyl)-pyridine-3-carboxamide bistrifluoroacetic acid salt;

¹H-NMR (500 MHz, DMSO-d₆) δ10.82 (s, 1H), 9.14 (br s, 1H), 8.84 (dd, J=5.1 1.4 Hz, 1H), 8.14 (dd, J=7.8, 1.9 Hz, 1H), 8.07 (s, 1H), 7.96-7.93 (m, 2H), 7.80-7.55 (m, 10H).

4-(2-cyanophenyl)-phenyl 2-(3-amino[ethoxycarbonyloxyimino]methylphenyl)-pyridine-3-carboxamide

¹H-NMR (500 MHz, CDCl₃) δ8.73 (dd, J=4.6, 1.9 Hz, 1H), 8.07 (s, 1H), 8.02 (dd, J=7.8, 1.9 Hz, 1H), 7.80 (d, J=7.8 Hz, 1H), 7.77 (s, 1H), 7.74-7.70 (m, 2H), 7.62 (m, 1H), 7.47-7.37 (m, 8H), 5.12 (s, 2H), 4.27 (q, J=6.9 Hz, 2H), 1.33 (t, J=6.9 Hz, 3H).

4-(2-methanesulfonyl-imidazol-1-yl)-phenyl cis-2-(3-amino[hydroxyimino]methylphenyl)-cyclopropane-1-carboxamide bistrifluoroacetic acid salt;

¹H-NMR (500 MHz, DMSO-d₆) δ11.12 (br s, 1H), 11.50 (s, 1H), 9.20 (br s, 2H), 7.61 (m, 3H), 7.54 (m, 2H), 7.47 (m, 2H), 7.36 (d, J=7.8 Hz, 2H), 7.26 (s, 1H), 3.34 (s, 3H), 2.68 (m, 1H), 2.35 (m, 1H), 1.74 (m, 1H), 1.44 (m, 1H).

4-(2-methanesulfonylphenyl)-phenyl 2-(3-amino[hydroxyimino]methylphenyl)-pyridine-3-carboxamide bistrifluoroacetic acid salt;

¹H-NMR (500 MHz, DMSO-d₆) δ10.75 (s, 1H), 8.84 (d, J=5.1 Hz, 1H), 8.15 (d, J=7.8 Hz, 1H), 8.09 (d, J=7.8 Hz, 1H), 8.06 (s, 1H), 7.97 (m, 1H), 7.78-7.61 (m, 7H), 7.39-7.35 (m, 3H), 2.84 (s, 3H).

4-(2-methylaminosulfonylphenyl)-phenyl 2-(3-amino[hydroxyimino]methylphenyl)-pyridine-3-carboxamide bistrifluoroacetic acid salt;

¹H-NMR (500 MHz, DMSO-d₆) δ11.21 (br s, 1H), 10.69 (s, 1H), 9.11 (br s, 1H), 8.84 (m, 1H), 8.12 (d, J=7.8 Hz, 1H), 8.06 (d, J=1.8 Hz, 1H), 7.96 (d, J=7.4 Hz, 1H), 7.88 (d, J=7.8 Hz, 1H), 7.75-7.57 (m, 9H), 7.33 (m, 3H), 7.22 (m, 1H), 2.40 (d, J=5.1 Hz, 3H).

4-(2-methylaminosulfonylphenyl)-phenyl cis-2-(3-amino[hydroxyimino]methylphenyl)-cyclopropane-1-carboxamide trifluoroacetic acid salt;

¹H-NMR (500 MHz, DMSO-d₆) δ11.10 (br s, 1H), 10.31 (s, 1H), 9.02 (br s, 2H), 7.85 (d, J =7.8 Hz, 1H), 7.63-7.32 (m, 9H), 7.28 (d, J=7.4 Hz, 1H), 7.22 (d, J=8.3 Hz, 2H), 7.11 (m, 1H), 2.65 (m, 1H), 2.35 (m, 4H), 1.74 (m, 1H), 1.41 (m, 1H).

5-(2-aminosulfonylphenyl)-pyridine-2-yl cis-2-(3-amino[hydroxyimino]methylphenyl)-cyclopropane-1-carboxamide bistrifluoroacetic acid salt;

¹H-NMR (500 MHz, DMSO-d₆) 11.20 (br, 1H), 10.87 (s, 1H), 9.12 (br, 2H), 8.23 (d, J=2.3 Hz, 1H), 8.02 (dd, J=7.8, 1.4 Hz, 1H), 7.80 (d, J=8.7 Hz, 1H), 7.68-7.45 (m, 7H), 7.40 (s, 2H), 7.32 (dd, J=7.4, 1.4 Hz, 1H), 2.68 (m, 1H), 2.54 (m, 1H), 1.75 (m, 1H), 1.45 (m, 1H).

4-(2-methanesulfonylphenyl)-phenyl N-ethyl-N-methanesulfonyl-3-(3-amino[hydroxyimino]methylphenyl)alanine amide trifluoroacetic acid salt (racemic)

¹H-NMR (500 MHz, DMSO-d₆) δ11.05 (br, 1H), 10.24 (s, 1H), 8.75 (br, 2H), 8.07 (dd, J=7.8, 1.4 Hz, 1H), 7.76-7.50 (m, 8H), 7.37-7.33 (m, 3H), 4.79 (m, 1H), 3.75-3.35 (m, 3H), 3.12 (m, 1H), 2.91 (s, 3H), 2.82 (s, 3H), 1.12 (t, J=7.4 Hz, 3H).

4-(2-cyanophenyl)-phenyl cis-2-(3-amino[ethoxycarbonylimino]methylphenyl)-cyclopropane-1-carboxamide trifluoroacetic acid salt;

¹H-NMR (500 MHz, DMSO-d₆) δ10.43 (s, 1H), 7.90 (d, J=7.8 Hz, 1H), 7.76-7.73 (m, 2H), 7.61-7.51 (m, 6H), 7.48-7.43 (m, 3H), 4.29 (m, 2H), 2.66 (m, 1H), 2.35 (m, 1H), 1.75 (m, 1H), 1.43 (m, 1H), 1.29 (t, J=6.9 Hz, 3H).

4-(2-cyanophenyl)-phenyl 2-(3-amino[hydroxyimino]methylphenyl)-methyl-pyridine-3-carboxamide bistrifluoroacetic acid salt;

¹H-NMR (500 MHz, DMSO-d₆) δ11.2 (br s, 1H), 10.68 (s, 1H), 9.14 (br s, 1H), 8.02 (m, 2H), 7.92 (m, 2H), 7.78 (m, 1H), 7.72-7.63 (m, 4H), 7.61-7.53 (m, 4H), 7.47 (d, J=8.2 Hz, 1H), 2.62 (s, 3H).

4-(2-aminosulfonylphenyl)-phenyl N-ethyl-N-methanesulfonyl-3-(3-amino[hydroxyimino]methylphenyl)alanine amide trifluoroacetic acid salt (racemic)

¹H-NMR (500 MHz, DMSO-d₆) δ11.05 (br s, 1H), 10.18 (s, 1H), 8.90 (br, 1H), 8.01 (dd, J =7.8, 1.4 Hz, 1H), 7.67 (s, 1H), 7.61-7.51 (m, 7H), 7.33-7.27 (m, 5H), 4.78 (m, 1H), 3.61-3.36 (m, 3H), 3.10 (dd, J=13.8, 6.9 Hz, 1H), 2.93 (s, 3H), 1.13 (t, J=7.4 Hz, 3H).

4-(2-cyanophenyl)-phenyl N-ethyl-N-methanesulfonyl-3-(3-amino[hydroxyimino]methylphenyl)-alanine amide trifluoroacetic acid salt (racemic)

¹H-NMR (500 MHz, DMSO-d₆) δ10.28 (s, 1H), 7.93 (d, J=7.3 Hz, 1H), 7.77 (m, 1H), 7.68-7.64 (m, 3H), 7.60-7.52 (m, 7H), 4.78 (m, 1H), 3.62-3.10 (m, 4H), 2.91 (s, 3H), 1.12 (t, J =6.9 Hz, 3H).

4-(2-cyanophenyl)-phenyl N-ethyl-N-ethoxycarbonyl-3-(3-amino[hydroxyimino]methylphenyl)-alanine amide trifluoroacetic acid salt (racemic)

¹H-NMR (500 MHz, DMSO-d₆) [mixture of rotamers]δ11.0 (br, 1H), 10.21 & 10.14 (two s, 1H), 8.90 (br, 1H), 7.93 (d, J=8.3 Hz, 1H), 7.79-7.71 (m, 3H), 7.63-7.52 (m, 8H), 5.01 & 4.88 (two s, 1H), 4.05-3.05 (m, 6H), 1.19-0.98 (m, 6H).

4-(2-methanesulfonylphenyl)-phenyl 2-(N-propanosultam)-3-(3-amino[hydroxyimino]methylphenyl)-propanoic amide trifluoroacetic acid salt (racemic)

¹H-NMR (500 MHz, DMSO-d₆) δ11.05 (br, 1H), 10.24 (s, 1H), 8.80 (br, 2H), 8.08 (dd, J=7.8, 1.4 Hz, 1H), 7.75 (m, 1H), 7.68-7.64 (m, 2H), 7.62-7.50 (m, 5H), 7.38-7.33 (m, 3H), 4.56 (m, 1H), 3.76 (m, 1H), ˜3.45 (m, 1H, buried under solvent peaks), 3.30 (dd, J=14.2, 6.9 Hz, 1H), 3.22-3.08 (m, 3H), 2.82 (s, 3H), 2.32 (m, 1H), 2.16 (m, 1H).

4-(2-cyanophenyl)-phenyl N-methyl-N-ethoxycarbonyl-3-(3-amino[hydroxyimimo]methylphenyl)alanine amide trifluoroacetic acid salt (racemic)

¹H-NMR (500 MHz, DMSO-d₆) [mixture of rotamers]δ11.08 (br, 1H), 10.25 & 10.19 (two s, 1H), 8.80 (br, 2H), 7.93 (d, J=6.9 Hz, 1H), 7.80-7.72 (m, 3H), 7.66 (s, 1H), 7.62-7.51 (m, 7H), 5.12 & 5.02 (two m, 1H), 3.99 & 3.89 (two m, 2H), 3.36 (m, 1H), 3.10 (m, 1H), 2.88 & 2.82 (two s, 3H), 1.13-1.03 (m, 3H).

4-(4-cyanothiophene-3-yl)-phenyl cis-2-(3-amino[hydroxyimino]methylphenyl)-cyclopropane-1-carboxamide trifluoroacetic acid salt;

¹H-NMR (500 MHz, DMSO-d₆) δ11.02 (br, 1H), 10.38 (s, 1H), 8.80 (br, 2H), 8.65 (d, J=3.2 Hz, 1H), 7.79 (d, J=2.8 Hz, 1H), 7.62 (s, 1H), 7.57-7.42 (m, 7H), 2.64 (m, 1H)S, 2.34 (m, 1H), 1.72 (m, 1H), 1.42 (m, 1H).

4-(2-cyanophenyl)-phenyl (1,2-cis)-2-(3-amino[hydroxyimino]methylphenyl)-1,3-trans)-3-carboxycyclopropane-1-carboxamide trifluoroacetic acid salt;

¹H-NMR (500 MHz, DMSO-d₆) δ11.05 (br, 1H), 10.62 (s, 1H), 8.80 (br, 2H), 7.91 (d, J=7.8 Hz, 1H), 7.75 (m, 1H), 7.70 (s, 1H), 7.62-7.46 (m, 9H), 3.06 (m, 1H), 2.82-2.79 (m, 2H).

4-(2-cyanophenyl)-phenyl (1,2-cis)-2-(3-amino[hydroxyimino]methylphenyl)-1,3-trans)-3-ethoxycarbonyl-cyclopropane-1-carboxamide trifluoroacetic acid salt;

¹H-NMR (500 MHz, DMSO-₆) δ11.17 (br, 1H), 10.67 (s, 1H), 8.85 (br, 2H), 7.90 (dd, J=7.8, 0.9 Hz, 1H), 7.75 (m, 1H), 7.71 (s, 1H), 7.64-7.46 (m, 9H), 4.19 (m, 2H), 3.12 (m, 1H), 2.93 (m, 1H), 2.86 (m, 1H), 1.27 (m, 3H)

4-(2-cyanophenyl)-phenyl 2-(N-propanosultam)-3-(3-amino[hydroxyimino]methylphenyl)-propanoic amide trifluoroacetic acid salt (racemic)

¹H-NMR (500 MHz, DMSO-d₆) δ11.18 (br, 1H), 10.28 (s, 1H), 8.97 (br, 2H), 7.93 (d, J=7.8 Hz, 1H), 7.78 (m, 1H), 7.68-7.52 (m, 10H), 4.56 (m, 1H), 3.76 (m, 1H), ˜3.4 (m, 1H, buried under solvent peaks), 3.31 (dd, J=14.2, 7.8 Hz, 1H), 3.23-3.10 (m, 3H), 2.32 (m, 1H), 2.18 (m, 1H).

4-(2-cyanophenyl)-phenyl N-ethyl-N-isopropyloxycarbonyl-3-(3-amino[hydroxyimino]methylphenyl)alanine amide trifluoroacetic acid salt (racemic)

¹H-NMR (500 MHz, DMSO-d₆) [mixture of rotamers]δ11.20 (br, 1H), 10.19 & 10.04 (two s, 1H), 8.77 (br, 2H), 7.92 (d, J=7.8 Hz, 1H), 7.79-7.49 (m, 11H), 5.02 & 4.77 (two br s, 2H), 3.80-3.28 (m, 3H, buried under solvent peaks), 3.09 (dd, J=13.7, 8.2 Hz, 1H), 1.19-0.97 (m, 9H).

4-(2-cyanophenyl)-phenyl N-ethyl-N-propanoyl-3-(3-amino[hydroxyimino]methylphenyl)-alanine amide trifluoroacetic acid salt (racemic)

¹H-NMR (500 MHz, DMSO-d₆) [mixture of rotamers]δ11.10 (br, 1H), 10.23 & 10.01 (two s, 1H), 8.87 (br, 2H), 7.92 (d, J=7.8 Hz, 1H), 7.78-7.48 (m, 11H), 5.22 & 4.82 (two m, 1H), ˜3.4 (m, 3H, buried under solvent peaks), 3.02 (m, 1H), 2.55 & 2.35 & 1.91 (three m, 2H), 1.08-0.84 (m, 9H).

4-(2-cyanophenyl)-phenyl 2-(N-oxazolidin-2-one)-3-(3-amino[hydroxyimino]methylphenyl)-propanoic amide trifluoroacetic acid salt (racemic)

¹H-NMR (500 MHz, DMSO-d₆) δ11.05 (br, 1H), 10.42 (s, 1H), 8.80 (br, 2H), 7.93 (d, J=7.8 Hz, 1H), 7.80-7.71 (m, (4H), 7.66 (d, J=6.9 Hz, 1H), 7.62-7.53 (m, 6H), 4.86 (m, 1H), 4.32 (m, 1H), 4.17 (m, 1H), 3.86 (m, 1H), 3.73 (m, 1H), 3.33 (m, 1H), 3.15 (m, 1H).

Experiment 1

Biological Activity Analysis of FXa Inhibitor Preparations

The inhibition effect of the compound of formula 1 according to the present invention is measured by a value of dissociation coefficient Ki. The value is decided by using the equation below in accordance with a method described in a reference (see, Methods in Enzymology V.80 p341-361; Biochemistry 27 p2144-2151, 1988).

Ki=[E][I]/[EI]

[E]: concentration of enzyme not binding with inhibitor

[I]: concentration of inhibitor not binding with enzyme

[EI]: concentration of complex of enzyme and inhibitor

The dissociation coefficient Ki shows degree of which enzyme and Fxa inhibitor compound are dissociated. Thus, it is meant that the more the value of dissociation coefficient is low, the more the binding ability of inhibitor to enzyme is high. Thus, this high binding ability may be estimated to show the high inhibition activity. This dissociation coefficient may be obtained by reacting FXa with a substrate, which is hydrolyzed by action of FXa, to show a chromophoric activity, and measuring a degree of chromophoric activity as a function of time in accordance with spectrometry.

A chromophoric material used in the present invention is Chromozyme X (Nle-Gly-Arg-4-NA). Chromozyme X is hydrolyzed by FXa to produce yellow para-nitroaniline (p-NA). FXa inhibition activity of the compound according to the present invention may be obtained by measuring the amount of the resulting para-nitroaniline in variation of absorbency in accordance with time. That is, activity of enzyme may be measured from variation of absorbency, and the variation may be directly involved in ability of which FXa inhibits enzyme activity.

The FXa inhibiting selectivity of the compound according to the present invention to thrombin is measured as follows. The inhibition effect of the compound of formula 1 to thrombin is measured in Ki value by practicing the same method as the above measuring method of FXa inhibiting activity, and the rate of thrombin/FXa is obtained. At this time, the experimental method of thrombin is the same as that of FXa, except that Chromozyme TH (Tosyl-Gly-Pro-Arg-nitroanilide acetate) is used as the substrate.

The FXa inhibition selectivity of the compound according to the present invention to trypsin is measured as follows. The inhibition effect of the compound of formula 1 to trypsin is measured in Ki value by practicing the same method as the above measuring method of FXa inhibiting activity, and the rate of trypsin/FXa is obtained. At this time, the experimental method of thrombin is the same as that of FXa, except that N-benzoyl-Val-Gly-Arg-p-nitroanilide hydrochloride is used as the substrate.

1. Preparation of FXa

a) Materials and Methods

Citrated plasma was purchased from Local Red Cross Blood Center (Taejon, Korea). All reagents for isolation-purification were used in reagent grade.

b) Isolation-Purification of FXa

Isolation-purification of FXa: The usually known method was used for isolating-purifying Factor X (S. Paul Bajaj and Jens J. Birktoft: Methods in Enzymology, Vol 222, 100-107). This method was applied to isolate and purify factor IX. Some modified method was used for isolating-purifying factor X. Solution of the resulting Factor X in Russel's viper venom (1/40 w/w)-20 mM Tris-HCl (pH=7.5)-150 mM NaCl-10 mM CaCl₂ was gently shook at 37° C. for 30 minutes to activate FXa,. The reaction was completed by 1M EGTA to be 12.5 mM of the final concentration. The activated FXa was isolated and purified by p-aminobenzamidine-Sepharose chromatography. The isolated and purified FXa was kept in 80% ammonium sulfate-0.1% BSA suspension status at −70° C.

2. FXa Inhibition Assay

a) Material

Chromozyme X (Nle-Gly-Arg-4-NA) of chromogenic substrate for FXa assay was purchased from Boehringer Mannheim Company. The substrate was made in 10 mM DDW solution. At the time of using the solution, it was diluted with 150 mM NaCl-100 mM Tris-HCl (pH=7.8)-0.1% PEG 8000 solution to be 0.25 mM.

b) Inhibiting Activity of FXa Inhibitor

Inhibition ability of the present compound against Fxa activity was measured as follows:

In each well of 96-well plate, 0.1M tris buffer solution (pH 7.8) comprising 150 mM NaCl, and 0.1% PEG 8000 was placed by 90 uL. Chromozyme X was dissolved in dimethylsulfoxide (DMSO) to be 0.25 mM, and then diluted with the above buffer solution to be 0.1 mM to prepare the substrate solution. 70 uL of 0.25 mM substrate solution as prepared above was added to each well. A compound according to the present invention was dissolved in DMSO to be 10 mM, and then diluted with the above buffer solution to be 0.1 mM, 0.01 mM and 0.001 mM, respectively, to prepare an inhibitor solution. The inhibitor solution was taken in an amount from 0 to 20 uL, and supplemented with tris buffer solution up to 20 uL total volume of the solution to add to each well.

20 uL of FXa, which was dissolved in the above tris buffer solution to be 80 nM, was added to the well having the reaction solution at room temperature to begin enzyme hydrolysis. The amount of para-nitroanilide produced for 2 minutes after adding enzyme was monitored about variation of absorbency at 381 nm to depict continuous spectrum of reaction time to absorbency. The above experiment was repeated for various concentration of inhibitor to obtain consecutive spectrum.

The initial velocity Vi was calculated from gradient within 10 minutes of the reaction time in each spectrum. Graph was depicted for a reciprocal of the initial velocity to inhibitor concentration (1/Vi). A linear equation corresponding to points on the graph was obtained. Thereafter, Ki may be calculated by using enzyme reaction equation from x intercept. Km value used in this calculation was obtained by varying concentration of the substrate to 0.4 uM at a definite enzyme concentration.

3. Effect for Blood Coagulation

The effect for blood coagulation in accordance with the present invention was measured by the following experimental method:

a) Measurement of aPTT

Blood was gathered from an animal or human, and then diluted with 3.8% sodium citrate solution to isolate blood plasma. 5 uL of the solution of a compound (5 uM) according to the present invention and 50 uL of Platelin LS (Organon Teknika) were added to 45 uL of blood plasma, and then reacted at 37° C. for 5 minutes. 50 uL of 25 mM CaCl₂ was added to the blood plasma to measure a clotting time of blood plasma. The clotting time of blood plasma is a time wherein absorbency at 340 nm is 0.1.

b) Measurement of PT

5 uL of the solution according to the present invention was added to 45 uL of blood plasma, and then reacted at 37° C. for 3 minutes. 100 uL of Simplastin (Organon Teknika) was added to the blood plasma to measure a clotting time of blood plasma. The clotting time of blood plasma is a time wherein absorbency at 340 nm is 0.1.

c) Animal Model

Inhibition ability against thrombus formation was measured in animal model. Male white rats (Sprague Dawley) were grown at 20-22° C. and under light and darkness at 12 hour intervals by using the commercially available standard feed in a laboratory animal room of LG Chemical Co., Ltd. The rats weighing 250-300 g were used in 34 of rats per one experimental group.

Firstly, rats were anesthetized by intraperitoneal injection of urethane in 1.3 g per kg of body weight. With consecutive injection of the compounds in examples via left femoral vein, abdomen of rats were incised to open inferior vena cava, and blood vessels were isolated from ambient tissue on sites under left renal vein. After the blood vessels were loosely wound with para film (25×8 mm), intestines were returned to abdominal cavity and abdominal cavity incision was sealed temporarily by a hemostatic forceps. Inferior vena cava was opened again 15 minutes after the compounds in examples were consecutively injected, followed by winding para film, and a filter paper (diameter 6 mm) wetted with 35% FeCl₃ solution was quietly placed on the blood vessels wound with para film. Thereafter, the blood vessels and filter paper were again wound with para film. With consecutive injection of the compounds in examples, 15 minutes after the filter paper was applied, it was separated. The compounds in examples were injected for further 45 minutes. Thereafter, inferior vena cava was extracted to take the produced thrombus and measure their weight.

4. Absorption Effect on Oral Administration

The absorption effect of the compound according to the present invention was decided by measuring drug concentration in blood in accordance with the following experiment method. Male rats and dogs were fasted for 18 hours, respectively, and then the experiment was performed. 1% (10 mg/mL) solution of a compound in an example was prepared by using an appropriate solution aid, and then orally administrated. After taking blood at a definite interval, the blood was extracted with methylenechloride in liquid phase, and again reverse extracted to measure drug concentration in blood by high performance liquid chromatography (HPLC).

5. Selectivity Against Thrombin and Trypsin

a) Selectivity Against Thrombin

Inhibiting ability of a compound according to the present invention against thrombin activity was measured as follows.

In 1.5 mL cuvette, 0.1M tris buffer solution (pH 7.8) comprising 150 mM NaCl, and 0.1% PEG 8000 (molecular weight 8000) was placed by 1160 uL. Chromozyme X was dissolved in dimethylsulfoxide (DMSO) to be 0.1 mM, and diluted with the above buffer solution to be 0.1 mM to prepare the substrate solution. 225 uL of 0.1 mM substrate solution as prepared above was added to cuvette. The compound of the present invention was dissolved in DMSO to be 10 mM, and diluted with the above buffer solution to be 0.1 mM, 0.01 mM and 0.001 mM, respectively, to prepare an inhibitor solution. The inhibitor solution was taken in an amount from 0 to 20 uL, and supplemented with tris buffer solution up to 20 uL of total volume of the solution to add to the cuvette.

15 uL of human thrombin, which was dissolved in the above tris buffer solution to be 0.1 mg/mL, was added to the cuvette having the reaction solution at room temperature to begin enzyme hydrolysis. The amount of para-nitroanilide produced for 2 minutes after adding enzyme was monitored about variation of absorbency at 381 nm to depict continuous spectrum of reaction time to absorbency. The above experiment was repeated for various concentrations of inhibitor to obtain consecutive spectrum.

The initial velocity Vi was calculated from gradient within 30 sec of the reaction time in each spectrum. A graph was depicted for a reciprocal of the initial velocity to inhibitor concentration (1/Vi). A linear equation corresponding to points on the graph was obtained. Thereafter, Ki may be calculated by using enzyme reaction equation from x intercept. Km value used in this calculation was obtained by varying concentration of the substrate to 5.2 uM at a definite enzyme concentration.

Ks of velocity coefficient was obtained by the following experiment method, using the same solution and concentration as those used for obtaining Ki coefficient.

That is, 1160 uL of the buffer solution was placed in 1.5 mL cuvette, and then 15 uL of 0.1 mg/mL human thrombin solution and 100 uL of the inhibitor solution were placed herein to keep at room temperature for 15 minutes. Thereafter, with adding 225 uL of the substrate solution to the above solution., variation of absorbency was monitored in accordance with variation of time for 2 minutes. Gradient was measured about parts showing straight line from the resulting consecutive spectrum to represent Vs. This experiment was repeated for various concentrations of inhibitor to obtain Vs values and depict a graph of 1/Vs against inhibitor concentration. A linear equation corresponding to points on the graph was obtained. Thereafter, Ks was calculated by using enzyme reaction equation from x intercept

b) Selectivity Against Trypsin

Inhibition activity of a compound according to the present invention was measured by performing the experiment as explained above concerning FXa.

20 uM solution of N-benzoyl-Val-Gly-Arg-p-nitroanilide hydrochloride was used as a substrate. An inhibitor solution with various concentrations in the range of 0 to 120 uM was used. Trypsin was dissolved in 0.1N HCl, and supplemented with the above tris buffer solution to be 45 ug/mL. Thereafter, 40 uL of the trypsin solution was used. The remaining procedure and the used amounts of materials (for example, 0.2 mL of total volume of the reaction solution) and the like were the same as those of the experiment for thrombin. Also, Km was decided in the same method as used in Ki calculation. Value of Km was 20.2 uM.

In accordance with the method mentioned above, each enzyme activity of the compound according to the present invention against FXa, thrombin and trypsin was represented by Ki value, and the selectivity of the compound against FXa represented by thrombin/FXa and trypsin/FXa. The results are shown in table 1 below.

TABLE 1
Inhibition ability of inhibitor against FXa, thrombin and trypsin
(A1: cyclopropyl scaffold)

| | Inhibition | Inhibition | Inhibition | | |
|---|---|---|---|---|---|
| | ability against | bility against | ability against | | |
| Compound | FXa | thrombin | trypsin | Selectivity | Selectivity |
| Nos.(A1) | Ki(nM) | Ki(nM) | Ki(nM) | (thrombin/FXa) | (trypsin/FXa) |
| 1 | 270 | 1600 | 180 | 6 | 0.67 |
| 2 | 0.5 | 2900 | 40 | 5800 | 80 |
| 3 | 113 | 520 | 120 | 5 | 0.94 |
| 4 | 3.0 | 380 | 510 | 127 | 42 |
| 5 | 1.0 | 3000 | 100 | 3000 | 100 |
| 6 | 0.3 | 1200 | 36 | 4000 | 120 |
| 7 | 5.0 | 2000 | 200 | 400 | 40 |
| 8 | 230 | 7000 | | 30 | |
| 9 | 320 | 12000 | | 38 | |

(A2: pyrrole scaffold)

| | Inhibition | Inhibition ability | Inhibition | | |
|---|---|---|---|---|---|
| | ability against | gainst | ability against | | |
| Compound | FXa | thrombin | trypsin | Selectivity | Selectivity |
| Nos.(A2) | Ki(nM) | Ki(nM) | Ki(nM) | (thrombin/FXa) | (trypsin/FXa) |
| 1 | 7.5 | 0.75 | | 0.1 | |
| 2 | 23 | 13 | | 0.56 | |
| 3 | 2.0 | 6.3 | | 3.2 | |
| 4 | 5.0 | 12 | | 2.4 | |
| 5 | 8.3 | 10.4 | | 1.3 | |
| 6 | 6.0 | 17 | | 2.8 | |
| 7 | 10.5 | 12 | | 1.1 | |
| 8 | 5.4 | 7.5 | | 1.4 | |
| 9 | 6.0 | 6.0 | | 1.0 | |
| 10 | 6.3 | 20 | | 3.2 | |
| 11 | 12.6 | 0.99 | | 0.08 | |
| 12 | 4.6 | 8.4 | | 1.8 | |
| 13 | 90 | 0.56 | | 6.2 | |
| 14 | 0.92 | 0.69 | | 0.8 | |
| 15 | 1.4 | 2.8 | | 2.0 | |
| 16 | 1.8 | 2.4 | | 1.3 | |
| 17 | 0.65 | 9.2 | | 14.2 | |
| 18 | 2.4 | 1.7 | | 0.7 | |
| 19 | 4.4 | 1.9 | | 0.4 | |
| 20 | 0.34 | 1.8 | | 5.3 | |
| 21 | 68 | 1.2 | | 18 | |
| 22 | 84 | 0.76 | | 9.0 | |
| 23 | 54 | 1.0 | | 19 | |
| 24 | 44 | 0.73 | | 17 | |
| 25 | 60 | 0.55 | | 9.2 | |
| 26 | 77 | 0.58 | | 7.5 | |
| 27 | 0.41 | 18 | | 44 | |
| 28 | 0.19 | 7.6 | | 40 | |
| 29 | 32 | 9.0 | | 280 | |
| 30 | 0.46 | 86 | | 190 | |
| 31 | 3.4 | 2.0 | | 0.6 | |
| 32 | 1.5 | 0.8 | | 0.53 | |
| 33 | 0.12 | 2.1 | | 18 | |
| 34 | 47 | 0.51 | | 11 | |
| 35 | 0.2 | 2.4 | | 12 | |
| 36 | 0.25 | 1.4 | | 5.6 | |
| 37 | 0.20 | 1.4 | | 7.0 | |
| 38 | 0.20 | 0.63 | | 3.2 | |
| 39 | 0.30 | 1.3 | | 4.3 | |
| 40 | 1.0 | 14.3 | | 14 | |
| 41 | 0.25 | 1.4 | | 5.6 | |
| 42 | 0.43 | 2.0 | | 4.7 | |
| 43 | 0.20 | 10 | | 50 | |
| 44 | 1.2 | 1.4 | | 1.2 | |
| 45 | 2.0 | 18 | | 9.0 | |
| 46 | 88 | 0.67 | | 7.6 | |
| 47 | 2.6 | 1.6 | | 0.62 | |
| 48 | 13 | 2.2 | | 169 | |
| 49 | 12 | 3.0 | | 250 | |
| 50 | 0.4 | 1.3 | 0.14 | 3250 | 350 |
| 51 | 5.2 | 0.42 | | 0.08 | |
| 52 | 0.47 | 1.2 | | 2.6 | |
| 53 | 7.3 | 0.75 | | 103 | |
| 54 | 15 | 0.35 | | 23 | |
| 55 | 0.11 | 2.4 | | 22 | |
| 56 | 0.25 | 0.9 | | 3.6 | |
| 57 | 0.77 | 2.8 | | 3.6 | |

(A3: bicyclic scaffold)

| | Inhibition | Inhibition | Inhibition | | |
|---|---|---|---|---|---|
| | ability | ility against | ability against | | |
| Compound | FXa | thrombin | trypsin | Selectivity | Selectivity |
| Nos.(A3) | Ki(nM) | Ki(nM) | Ki(nM) | (thrombin/FXa) | (trypsin/FXa) |
| 1 | 3.7 | 9.6 | | 2.6 | |
| 2 | 4.4 | 14 | | 3.2 | |
| 3 | 1.7 | 9 | | 5.3 | |
| 4 | 2.2 | 1.4 | | 0.64 | |
| 5 | 9.6 | 0.74 | | 0.08 | |
| 6 | 0.60 | 3.4 | | 5.7 | |
| 7 | 0.44 | 5 | | 11 | |
| 8 | 3.9 | 6.1 | | 1.6 | |
| 9 | 26 | 1.1 | | 0.04 | |
| 10 | 2.2 | 1.8 | | 0.82 | |
| 11 | 0.73 | 4.7 | | 6.4 | |
| 12 | 94 | 20 | | 0.22 | |
| 13 | 23 | 900 | | 39 | |
| 14 | 4.6 | 16 | | 3.5 | |
| 15 | 1.1 | 2.8 | | 2.5 | |
| 16 | 84 | 7.8 | | 0.09 | |
| 17 | 5.1 | 11 | | 2.2 | |
| 18 | 5.2 | 17 | | 3.3 | |
| 19 | 0.76 | 7.0 | | 9.2 | |
| 20 | 44 | 3 | | 0.07 | |
| 21 | 11 | 8 | | 0.73 | |
| 22 | 11 | 60 | | 5.5 | |
| 23 | 6.5 | 12 | | 1850 | |
| 24 | 3.5 | 2 | | 570 | |
| 25 | 2 | 5 | 130 | 2500 | 65 |
| 26 | 21 | 14 | 210 | 670 | 10 |
| 27 | 12 | 2.5 | | 210 | |
| 28 | 1.8 | 9 | 150 | 5000 | 83 |
| 29 | 3 | 12 | | 4000 | |
| 30 | 8 | 14 | | 1750 | |

(A4: cyanophenylalanine scaffold)

| | Inhibition | Inhibition ability | Inhibition | | |
|---|---|---|---|---|---|
| | ability against | gainst | ability against | | |
| Compoud | Fxa | thrombin | trypsin | Selectivity | Selectivity |
| Nos(A4). | Ki(nM) | Ki(nM) | Ki(nM) | (thrombin/FXa) | (trypsin/FXa) |
| 1 | 11 | 1300 | | 118 | |
| 2 | 3.5 | 3000 | | 857 | |
| 3 | 20 | 5000 | | 250 | |
| 4 | 120 | 7300 | | 61 | |
| 5 | 13 | 1800 | | 138 | |
| 6 | 5.4 | 3000 | 250 | 555 | 46 |
| 7 | 22 | 990 | | 45 | |
| 8 | 6 | 3000 | | 500 | |
| 9 | 18 | 1700 | | 94 | |
| 10 | 120 | 1700 | | 14 | |
| 11 | 140 | 10000 | | 71 | |
| 12 | 7.4 | 510 | | 69 | |
| 13 | 44 | 1700 | | 39 | |
| 14 | 35 | 3000 | | 86 | |
| 15 | 20 | 1000 | | 50 | |
| 16 | 4.3 | 1200 | | 280 | |
| 17 | 61 | 25000 | | 410 | |
| 18 | 6 | 11000 | | 1833 | |
| 19 | 2 | 620 | | 310 | |

1. A compound represented by the following formula 1, a pharmaceutically acceptable salt a prodrug, a hydrate, a solvate or an isomer thereof: 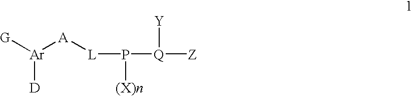
wherein,
Ar is selected from the group consisting of benzene, pyridine, thiophene, naphthalene and isoquinoline,
G is selected from the group consisting of R, F, Cl, Br, I, CN, OR, OCOR, CO₂R, and CONR₂; where R represents H or a linear, branched, cyclic or branched cyclic alkyl group having 1 to 10 of carbon atoms,
A is selected from the group consisting of A1, A2, A3 and A4 below: 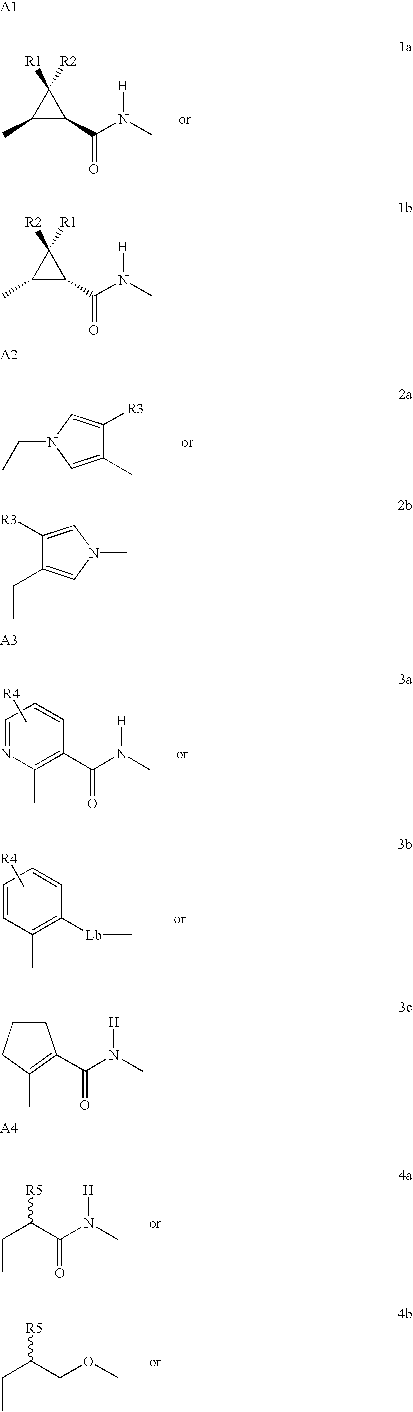
where
R1 and R2 are each independently selected from the group consisting of F, Cl, Br, I, R, CH₂OR, CH₂OCOR, CO₂R, CONR₂, CON(CH₂)ₘ_{¹} (m¹=2, 3, 4, 5, 6, 7), CO-morpholine (N—), CO-piperazine-(N4—R), and CO-piperazine-(N4—COR),
R3 is selected from the group consisting of F, Cl, Br, I, R, CH₂OR, CH₂OCOR, CO₂R, CONR₂, CON (CH₂)ₘ_{²} (m²=2, 3, 4, 5, 6, 7), CO-morpholine (N—), CO-piperazine-(N4—R), CO-piperazine (N4—COR), CONH-(amino acid), CONH-(amino acid ester), and CONH-amino acid amide),
R4 is selected from the group consisting of F, Cl, Br, I, CN, OR, and R;
R5 is selected from the group consisting of NR₂, NR(COR), NR(CH₂)ₘ_{³}CO₂R (where m³=0,1,2,3), NR(CH₂)ₘ_{³}CONR (where m³=0,1,2,3), NRCONR₂, N(R)SO₂R, and N(SO₂R)₂, or selected from one of the groups below: 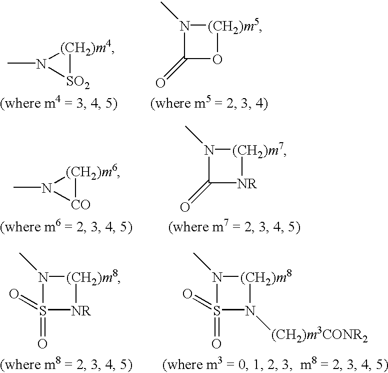
R6 is selected from the group consisting of CO₂R, CONR₂, and CH₂OR,
Lb is selected from the group consisting of CONH, CONHCH₂, CH₂NHCO, NHCONH, CH₂OCH₂, NHCOCH₂, NHCO, and CH₂CONH,
D represents —NH₂, or —CH₂NH₂; or is selected from one of the groups below: 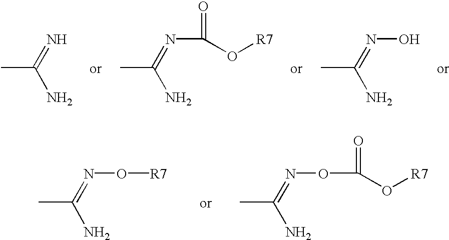
where
R7 is selected from the group consisting of a linear, branched, cyclic or branched cyclic alkyl group having 1 to 10 of carbon atoms, a phenyl group and a benzyl group
L is a simple linker and represents —(CH₂)ₘ—(m=0,1),
P is selected from the group consisting of phenyl, pyridine, pyrrole, furan, thiophene, oxazole, isoxazole, imidazole, 1,2-diazole, thiazole, isothiazole, pyridiazine (1,2-diazine), pyrimidine, pyrazine (1,4-diazine), naphthalene, quinoline, isoquinoline, benzofuran, benzothiophene, and indole,
X is selected from the group consisting of R, F, Cl, Br, I, CN, OR, CO₂R, COR, CONR₂, NR₂, NR[(C═O)R], CF₃, OCF₃, SO₂NR₂, SONR₂, SO₂R, SOR, N[(C═O)R]₂, imidazole, 1,2-diazole, thiazole, isothiazole, pyridiazine (=1,2-diazine), pyrimidine, pyrazine (=1,4-diazine), 1,2,3-triazole, 1,2,4-triazole, tetrazole, 1,3,5-triazine, (1,2)-imidazoline-2-yl, N-methyl-(1,2)-imidazoline-2-yl, and —NHC(═NR)R,
n represents a number of 0, 1 or 2,
Q represents hydrogen or is selected from the group consisting of phenyl, pyridine, pyrrole, furan, thiophene, oxazole, isoxazole, imidazole, 1,2-diazole, thiazole, isothiazole, pyridiazine(=1,2-diazine), pyrimidine, and pyrazine (=1,4-diazine), provided that when Q represents hydrogen, the substituents Y and Z are meant to be directly connected to P,
Y and Z are each independently selected from the group consisting of R, F, Cl, Br, I, CN, OR, CO₂R, COR, CONR₂, NR₂, NR[(C═O)R], N[(C═O)R]₂, CF₃, OCF₃, SO₂NR₂, SONR₂, SO₂R, SOR, imidazole, 1,2-diazole, thiazole, isothiazole, pyridiazine(=1,2-diazine), pyrimidine, pyrazine (=1,4-diazine), 1,2,3-triazole, 1,2,4-triazole, tetrazole and 1,3,5-triazine.

2. The compound of claim 1, wherein
Ar is selected from the group consisting of benzene, pyridine, naphthalene and isoquinoline,
G is selected from the group consisting of R, F, Cl, Br, I, CN, and OR; where R represents H or a linear, branched, cyclic or branched cyclic alkyl group having 1 to 10 of carbon atoms,
A is selected from the group consisting of A1, A2, A3 and A4 below: 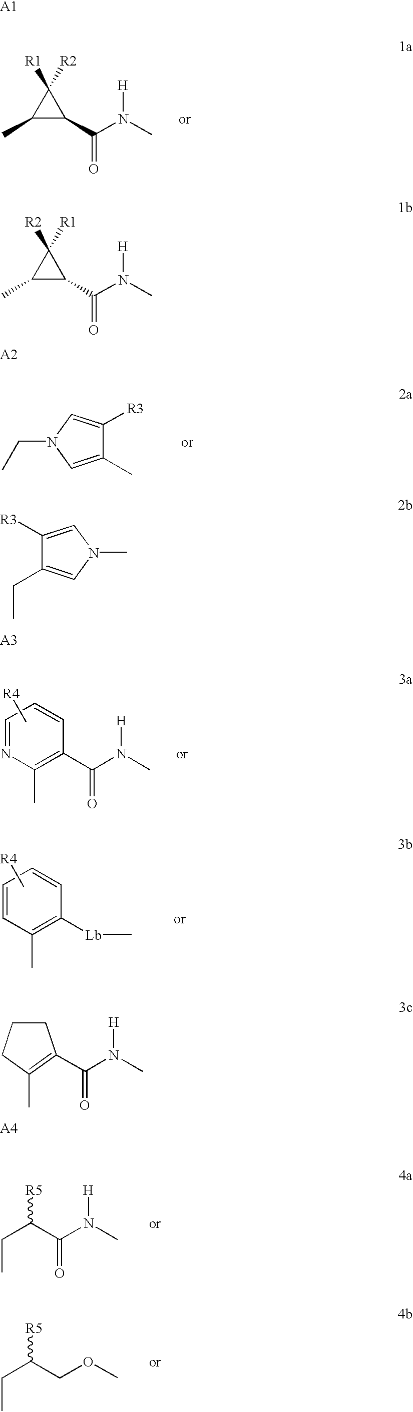
where
R1 and R2 are each independently selected from the group consisting of R, CH₂OR, CH₂OCOR, CO₂R, CONR₂, CON(CH₂)ₘ_{¹} (m¹=2, 3, 4, 5, 6, 7), CO-morpholine (N—), CO-piperazine-(N4—R), and CO-piperazine-(N4—COR),
R3 is selected from the group consisting of R, CH₂OR, CH₂OCOR, CO₂R, CONR₂, CON (CH₂)ₘ_{²} (m²=2, 3, 4, 5, 6, 7), CO-morpholine (N—), CO-piperazine-(N4—R), CO-piperazine-(N4—COR), CONH-(amino acid), CONH-(amino acid ester), and CONH-(amino acid amine),
R4 is selected from the group consisting of F, Cl, OR, and R,
R5 is selected from the group consisting of NR₂, NR(COR), NR(CH₂)ₘ_{³}CO₂R (where m³=0,1,2,3), NR(CH₂)ₘ_{³}CONR (where m³=0,1,2,3), NRCONR₂, N(R)SO₂R, and N(SO₂)R₂; or selected from one of the groups below 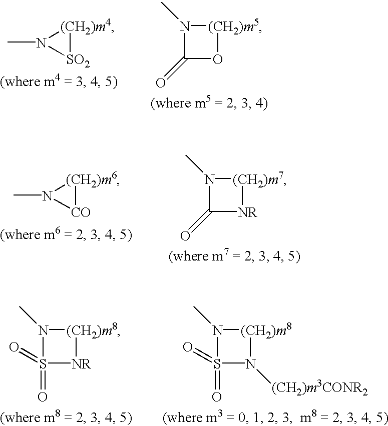
R6 is selected from the group consisting of CO₂R, CONR₂, and CH₂OR,
Lb is selected from the group consisting of CONR, CONHCH₂, CH₂NHCO, NHCONH, CH₂OCH₂, NHCOCH₂, NHCO, and CH₂CONH,
D represents —NH₂, or —CH₂NH₂; or is selected from one of the groups below: 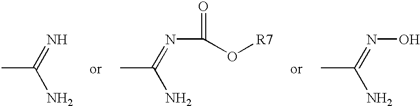
where
R7 is selected from the group consisting of a linear, branched, cyclic or branched cyclic alkyl group having 1 to 10 of carbon atoms, a phenyl group and a benzyl group
L is a simple linker, and represents —(CH₂)ₘ—(m=0,1),
P is selected from the group consisting of phenyl, pyridine, pyrrole, thiophene, thiazole, and pyrimidine,
X is selected from the group consisting of R, F, Cl, CN, OR, CO₂R, COR, CONR₂, CF₃, OCF₃, SO₂NR₂, SO₂R, imidazole, thiazole, pyrimidine, 1,2,3-triazole, 1,2,4-triazole, tetrazole, 1,3,5-triazine, (1,2)-imidazoline-2-yl, N-methyl-(1,2)-imidazoline-2-yl, and —NHC(═NR)R,
n represents a number of 0, 1, or 2,
Q represents hydrogen or is selected from the group consisting of phenyl, pyridine, pyrrole, furan, thiophene, oxazole, isoxazole, imidazole, 1,2-diazole, thiazole, isothiazole, and pyrimidine, provided that when Q is hydrogen, the substituents Y and Z are meant to be directly connected to P.
Y and Z are each independently selected from the group consisting of R, F, Cl, Br, I, CN, OR, CO₂R, COR, CONR₂, CF₃, OCF₃, SO₂NR₂, SO₂R, imidazole, 1,2-diazole, thiazole, isothiazole, pyrimidine, 1,2,3-triazole, 1,2,4-triazole, tetrazole and 1,3,5-triazine.

3. The compound of claim 2, wherein
Ar is selected from the group consisting of benzene, pyridine, naphthalene and isoquinoline,
G is selected from the group consisting of R, F, Cl, Br, I, CN, and OR; where R represents H or a linear, branched, cyclic or branched cyclic alkyl group having 1 to 10 of carbon atoms,
A is selected from the group consisting of A1, A2, A3 and A4 below: 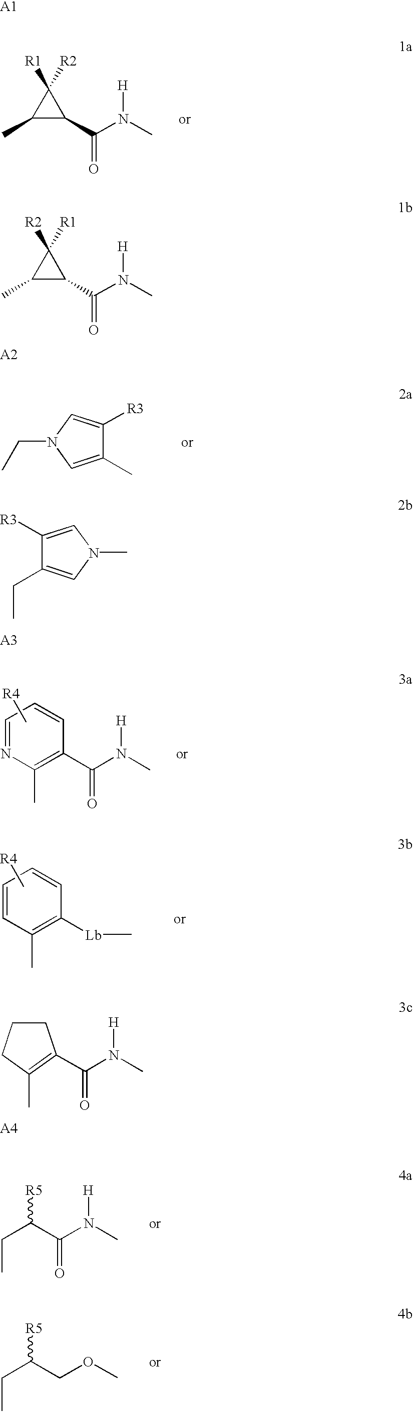
where
R1 and R2 are each independently selected from the group consisting of R, CH₂OR, CH₂OCOR, CO₂R, CONR₂, CON(CH₂)ₘ_{¹} (m¹=2, 3, 4, 5, 6, 7), CO-morpholine (N—), CO-piperazine (N4—R), and CO-piperazine (N4—COR),
R3 is selected from the group consisting of R, CO₂R, CON₂, CON(CH₂)ₘ_{²} (m²=2, 3, 4, 5, 6, 7), CO-morpholine (N—), CO-piperazine-(N4—R), CO-piperazine-(N4—COR), CONH-(Amino acid), CONH-(amino acid ester), and CONH-(amino acid amide),
R4 is selected from the group consisting of F, Cl, OR, and R,
R5 is selected from the group consisting of NR₂, NR(COR), NR(CH₂)ₘ_{³}CO₂R (where m³=0,1,2,3), NR(CH₂)ₘ_{³}CONR (where m³=0,1,2,3), NRCONR₂, N(R)SO₂R, and N(SO₂R)₂, or selected from one of the groups below: 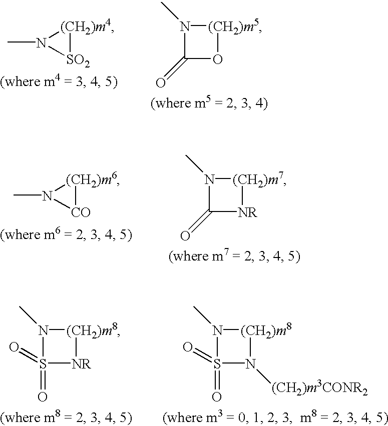
R6 is selected from the group consisting of CO₂R, CONR₂, and CH₂OR,
Lb is selected from the group consisting of CONH, CONHCH₂, CH₂NHCO, NHCONH, CH₂OCH₂, NHCOCH₂, NHCO, and CH₂CONH,
D represents NH₂, or —CH₂NH₂—; or is selected from one of the groups below: 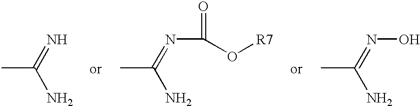
where
R7 is selected from the group consisting of a linear, branched, cyclic or branched cyclic alkyl group having 1 to 10 of carbon atoms, a phenyl group and a benzyl group
L is a simple linker, and represents —(CH₂)ₘ—(m=0,1),
P is selected from the group consisting of phenyl, pyridine, and pyrimidine,
X is selected from the group consisting of R, F, Cl, CN, OR, CF₃, OCF₃, SO₂NR₂, SO₂R, imidazole, thiazole, pyrimidine, 1,2,3-triazole, 1,2,4-triazole, tetrazole, (1,2)-imidazoline-2-yl, N-methyl-(1,2)-imidazoline-2-yl, and —NHC(═NR)R, where n is selected from 0, 1, 2,
Q is hydrogen or is selected from the group consisting of phenyl, pyridine, pyrrole, furan, thiophene, oxazole, isoxazole, imidazole, 1,2-diazole, thiazole, isothiazole, and pyrimidine, when Q is hydrogen, the substituents Y and Z are meant to be directly connected to P,
Y and Z are each independently selected from the group consisting of R, F, Cl, Br, I, CN, OR, CO₂R, COR, CONR₂, CF₃, OCF₃, SO₂NR₂, SO₂R, and imidazole.

4. The compound of claim 3, wherein it is selected from the group consisting of the following compounds:
4-(2-aminosulfonylphenyl)-phenyl trans-2-(3-aminoiminomethylphenyl)-cyclopropane-1-carboxamide mono trifluoroacetic acid salt;
4-(2-aminosulfonylphenyl)-phenyl cis-2-(3-aminoiminomethylphenyl)-cyclopropane-1-carboxamide mono trifluoroacetic acid salt;
4-(2-aminosulfonyl-5-methyl-phenyl)-phenyl trans-2-(3-aminoiminomethylphenyl)-cyclopropane-1-carboxamide mono trifluoroacetic acid salt (from less polar isomer);
4-(2-aminosulfonyl-5-methyl-phenyl)-phenyl cis-2-(3-aminoiminomethylphenyl)-cyclopropane-1-carboxamide mono trifluoroacetic acid salt (from more polar isomer);
4-(2-cyanophenyl)-phenyl cis-2-(3-aminoiminomethylphenyl)-cyclopropane-1-carboxamide mono trifluoroacetic acid salt;
4-(2-methansulfonylphenyl)-phenyl cis-2-(3-aminoiminomethylphenyl)-cyclopropane-1-carboxamide mono trfluoroacetic acid salt;
4-(2-cyanophenyl)-phenyl [1,2]-cis, [2,3]-cis-2-(3-aminoiminomethylphenyl)-cyclopropane-1-carboxamide mono trifluoroacetic acid salt;
3-aminoiminomethylbenzyl trans-2-(3-aminoiminomethylphenyl)-cyclopropane-1-carboxamide bistrifluoroacetic acid salt;
3-aminoiminomethylbenzyl cis-2-(3-aminoiminomethylphenyl)-cyclopropane-1-carboxamide bistrifluoroacetic acid salt;
4-(1-imidazolyl)-phenyl cis-2-(3-aminoiminomethylphenyl)-cyclopropane-1-carboxamide bistrifluoroacetic acid salt;
4-(2-aminosulfonyl-5-fluorophenyl)-phenyl cis-2-(3-aminoiminomethylphenyl)-cyclopropane-1-carboxamide trifluoroacetic acid salt;
5-(2-aminosulfonylphenyl)-pyridine-2-yl cis-2-(3-aminoiminomethylphenyl)-cyclopropane-1-carboxamide bistrifluoroacetic acid salt;
4-(2-cyanophenyl)-phenyl (1,2)-cis-(1,3)-cis-2-(3-aminoiminomethylphenyl)-3-carboxy-cyclopropane-1-carboxamide trifluoroacetic acid salt;
4-(2-fluorophenyl)-phenyl cis-2-(3-aminoiminomethylphenyl)-cyclopropane-1-carboxamide trifluoroacetic acid salt;
4-(2-chlorophenyl)-phenyl cis-2-(3-aminoiminomethylphenyl)-cyclopropane-1-carboxamide trifluoroacetic acid salt;
4-(2-trifluoromethylphenyl)-phenyl cis-2-(3-aminoiminomethylphenyl)-cyclopropane-1-carboxamide trifluoroacetic acid salt;
4-bromophenyl cis-2-(3-aminoiminomethylphenyl)-cyclopropane-1-carboxamide trifluoroacetic acid salt;
5-(2-methanesulfonylphenyl)-pyridine-2-yl cis-2-(3-aminoiminomethylphenyl)-cyclopropane-1-carboxamide bistrifluoroacetic acid salt;
4-(2-methanesulfonyl)-[1,3,4]-triazole-1-yl)-phenyl cis-2-(3-aminoiminomethylphenyl)-cyclopropane-1-carboxamide bistrifluoroacetic acid salt;
4-(2-methylaminosulfonylphenyl)-phenyl cis-2-(3-aminoiminomethylphenyl)-cyclopropane-1-carboxamide trifluoroacetic acid salt;
4-(2-methanesulfonylimidazole)-1-yl)-phenyl cis-2-(3-aminoiminomethylphenyl)-cyclopropane-1-carboxamide bistrifluoroacetic acid salt;
4-(2-cyano-thiophene-3-yl)-phenyl cis-2-(3-aminoiminomethylphenyl)-cyclopropane-1-carboxamide trifluoroacetic acid salt;
4-(2-aminosulfonyl-thiophene-3-yl)-phenyl cis-2-(3-aminoiminomethylphenyl)-cyclopropane-1-carboxamide trifluoroacetic acid salt;
4-(2-aminosulfonyl-5-methyl-thiophene-3-yl)-phenyl cis-2-(3-aminoiminomethylphenyl)-cyclopropane-1-carboxamide trifluoroacetic acid salt;
4-(4-cyano-thiophene-3-yl)-phenyl cis-2-(3-aminoiminomethylphenyl)-cyclopropane-1-carboxamide trifluoroacetic acid salt;
4-(2-cyanophenyl)-phenyl (1,2-cis)-2-(3-aminoiminomethylphenyl)-(1,3-trans)-3-carboxy-cyclopropane-1-carboxamide trifluoroacetic acid salt;
4-(2-methanesulfonylphenyl)-phenyl (1,2-cis)-2-(3-aminoiminomethylphenyl)-(1,3-trans)-3-carboxy-cyclopropane-1-carboxamide trifluoroacetic acid salt;
4-(2-cyanophenyl)-phenyl (1,2-cis)-2-(3-aminoiminomethylphenyl)-(1,3-trans)-3-ethoxycarbonyl-cyclopropane-1-carboxamide trifluoroacetic acid salt;
Methyl 4-(3-aminoiminomethylbenzyl)-1-benzyl-pyrrole-3-carboxylate trifluoroacetic acid salt;
Ethyl 4-(3-aminoiminomethylbenzyl)-1-benzyl-pyrrole-3-carboxylate trifluoroacetic acid salt;
Ethyl 4-(4-aminoiminomethylbenzyl)-1-benzyl-pyrrole-3-carboxylate trifluoroacetic acid salt;
Ethyl 4-(4-methoxycarbonylbenzyl)-1-(3-aminoiminomethylbenzyl)-pyrrole-3-carboxylate trifluoroacetic acid salt;
Ethyl 4-(4-aminocarbonylbenzyl)-1-(3-aminoiminomethylbenzyl)-pyrrole-3-carboxylate trifluoroacetic acid salt;
Ethyl 4-(4-methylaminocarbonylbenzyl)-1-(3-aminoiminomethylbenzyl)-pyrrole-3-carboxylate trifluoroacetic acid salt;
Ethyl 4-(4-dimethylaminocarbonylbenzyl)-1-(3-aminoiminomethylbenzyl)-pyrrole-3-carboxylate trifluoroacetic acid salt;
Ethyl 4-(4-benzylaminocarbonylbenzyl)-1-(3-aminoiminomethylbenzyl)-pyrrole-3-carboxylate trifluoroacetic acid salt;
Ethyl 4-(4-phenylaminocarbonylbenzyl)-1-(3-aminoiminomethylbenzylpyrrole-3-carboxylate trifluoroacetic acid salt;
Ethyl 4-(4-acetylaminobenzyl)-1-(3-aminoiminomethylbenzyl)-pyrrole-3-carboxylate trifluoroacetic acid salt;
Ethyl 4-benzyl-1-(4-aminoiminomethylbenzyl)-pyrrole-3-carboxylate trifluoroacetic acid salt;
Ethyl 4-benzyl-1-(3-aminoiminomethylbenzyl)-pyrrole-3-carboxylate trifluoroacetic acid salt;
Ethyl 4-(3-aminoiminomethylphenyl)-1-(2-naphthylmethyl)-pyrrole-3-carboxylate trifluoroacetic acid salt;
Ethyl 4-(3-aminoiminomethylphenyl)-1-(1-naphthylmethyl)-pyrrole-3-carboxylate trifluoroacetic acid salt;
Ethyl 4-(3-aminoiminomethylbenzyl)-1-(1-naphthylmethyl)-pyrrole-3-carboxylate trifluoroacetic acid salt;
Ethyl 4-(3-aminoiminomethylbenzyl)-1-(2-naphthylmethyl)-pyrrole-3-carboxylate trifluoroacetic acid salt;
Ethyl 4-(3-aminoiminomethylbenzyl)-1-(3-phenoxybenzyl)-pyrrole-3-carboxylate trifluoroacetic acid salt;
Ethyl 4-(3-aminoiminomethylbenzyl)-1-(4-phenoxybenzyl)-pyrrole-3-carboxylate trifluoroacetic acid salt;
Ethyl 4-(3-aminoiminomethylbenzyl)-1-(4-biphenylmethyl)-pyrrole-3-carboxylate trifluoroacetic acid salt;
Methyl 4-(4-aminoiminomethylbenzyl)-1-(3-aminoiminomethylbenzyl)-pyrrole-3-carboxylate bistrifluoroacetic acid salt;
Ethyl 4-(4-aminoiminomethylbenzyl)-1-(3-aminoiminomethylbenzyl)-pyrrole-3-carboxylate bistrifluoroacetic acid salt;
Isopropyl 4-(4-aminoiminomethylbenzyl)-1-(3-aminoiminomethylbenzyl)-pyrrole-3-carboxylate bistrifluoroacetic acid salt;
n-propyl 4-(4-aminoiminomethylbenzyl)-1-(3-aminoiminomethylbenzyl)-pyrrole-3-carboxylate bistrifluoroacetic acid salt;
n-butyl 4-(4-aminoiminomethylbenzyl)-1-(3-aminoiminomethylbenzyl)-pyrrole-3-carboxylate bistrifluoroacetic acid salt;
i-butyl 4-(4-aminoiminomethylbenzyl)-3-aminoiminomethylbenzyl)-pyrrole-3-carboxylate bistrifluoroacetic acid salt;
cyclopropylmethyl 4-(4-aminoiminomethylbenzyl)-1-(3-aminoiminomethylbenzyl)-pyrrole-3-carboxylate bistrifluoroacetic acid salt;
4-(4-aminoiminomethylbenzyl)-1-(3-aminoiminomethylbenzyl)-pyrrole-3-carboxylic acid bistrifluoroacetic acid salt;
4-(4-aminoiminomethylbenzyl)-1-(3-aminoiminomethylbenzyl)-pyrrole-3-carboxamide bistrifluoroacetic acid salt;
Ethyl 4-(4-aminoiminomethylbenzyl)-1-(3-aminoiminomethyl-6-hydroxy-benzyl)-pyrrole-3-carboxylate bistrifluoroacetic acid salt;
4-(4-aminoiminomethylbenzyl)-1-(3-aminoiminomethyl-6-hydroxy-benzyl)-pyrrole-3-carboxylic acid bistrifluoroacetic acid salt;
Methyl 4-(4-aminoiminomethylbenzyl)-1-(3-aminoiminomethylbenzyl)-pyrrole-3-carboxamide bistrifluoroacetic acid salt;
Ethyl 4-(4-aminoiminomethylbenzyl)-1-(3-aminoiminomethylbenzyl)-pyrrole-3-carboxamide bistrifluoroacetic acid salt;
Propyl 4-(4-aminoiminomethylbenzyl)-1-(3-aminoiminomethylbenzyl)-pyrrole-3-carboxamide bistrifluoroacetic acid salt;
Ethyl 2-[4-(4-aminoiminomethylbenzyl)-1-(3-aminoiminomethylbenzyl)-pyrrole-3-carbonyl oxy]-acetate bistrifluoroacetic acid salt;
Ethyl 2-[4-(4-aminoiminomethylbenzyl)-1-(3-aminoiminomethylbenzyl)-pyrrole-3-carbonyl amino]-acetate bistrifluoroacetic acid salt;
Methyl 4-(3-aminoiminomethylbenzyl)-1-(4-aminoiminomethylbenzyl)-pyrrole-3-carboxylate bistrifluoroacetic acid salt;
Ethyl 4-(3-aminoiminomethylbenzyl)-1-(4-aminoiminomethylbenzyl)-pyrrole-3-carboxylate bistrifluoroacetic acid salt;
Isopropyl 4-(3-aminoiminomethylbenzyl)-1-(4-aminoiminomethylbenzyl)-pyrrole-3-carboxylate bistrifluoroacetic acid salt;
Ethyl 2-[4-(3-aminoiminomethylbenzyl)-1-(4-aminoiminomethylbenzyl)-pyrrole-3-carbonyl amino]-acetate bistrifluoroacetic acid salt;
4-(3-aminoiminomethylbenzyl)-1-(4-aminoiminomethylbenzyl)-pyrrole-3-carboxylic acid morphorline amide bistrifluoroacetic acid salt;
Ethyl 2-[4-(3-aminoiminomethylbenzyl)-1-(4-aminoiminomethylbenzyl)-pyrrole-3-carbonyl oxy]-acetate bistrifluoroacetic acid salt;
Ethyl 4-(4-aminoiminomethylbenzyl)-1-(4-aminoiminomethylbenzyl)-pyrrole-3-carboxylate bistrifluoroacetic acid salt;
Ethyl 4-(3-aminoiminomethylbenzyl)-1-(3-aminoiminomethylbenzyl)-pyrrole-3-carboxylate bistrifluoroacetic acid salt;
Ethyl 4-(4-aminoiminomethylbenzyl)-1-(5-aminoiminomethylthiophen-2-yl-methyl)-pyrrole-3-carboxylate bistrifluoroacetic acid salt;
Ethyl 4-[4-(2-imidazoline-2-yl)-benzyl]-1-(3-aminoiminomethylbenzyl)-pyrrole-3-carboxylate bistrifluoroacetic acid salt;
Ethyl 4-(4-aminoiminomethylbenzyl)-1-(7-aminoiminomethylnaphthalene-2-yl-methyl)-pyrrole-3-carboxylate bistrifluoroacetic acid salt;
Ethyl 4-(4-bromophenyl)-1-(3-aminoiminomethylbenzyl)-pyrrole-3-carboxylate trifluoroacetic acid salt;
Ethyl 4-[4-(2-aminosulfonylphenyl)-phenyl]-1-(3-aminoiminomethylbenzyl)-pyrrole-3-carboxylate trifluoroacetic acid salt;
Ethyl 4-[4-(2-aminosulfonylphenyl)-phenyl]-1-(3-aminoiminomethylbenzyl)-pyrrole-3-carboxamide trifluoroacetic acid salt;
Ethyl 4-[4-(2-aminosulfonylphenyl)-phenyl]-1-(3-aminoiminomethyl)-6-hydroxy-benzyl)-pyrrole-3-carboxylate trifluoroacetic acid salt;
Ethyl 4-(3-biphenyl)-1-(3-aminoiminomethylbenzyl)-pyrrole-3-carboxylate trifluoroacetic acid salt;
Ethyl 4-(4-biphenyl)-1-(3-aminoiminomethylbenzyl)-pyrrole-3-carboxylate trifluoroacetic acid salt;
Ethyl 4-[4-(2-aminosulfonyl-5-fluoro-phenyl)-phenyl]-1-(3-aminoiminomethylbenzyl)-pyrrole-3-carboxylate trifluoroacetic acid salt;
Ethyl 4-[4-(2-aminosulfonyl-5-methyl-phenyl)-phenyl]-1-(3-aminoiminomethylbenzyl)-pyrrole-3-carboxylate trifluoroacetic acid salt;
4-[4-(2-aminosulfonyl-5-methyl-phenyl)-phenyl]-1-(3-aminoiminomethylbenzyl)-pyrrole trifluoroacetic acid salt;
Ethyl 4-[4-(2-pyridyl)-phenyl]-1-(3-aminoiminomethylbenzyl)-pyrrole 3-carboxylate bistrifluoroacetic acid salt,
Ethyl 4-[4-(3-pyridyl)-phenyl]-1-(3-aminoiminomethylbenzyl)-pyrrole 3-carboxylate bistrifluoroacetic acid salt;
3-aminoiminomethylphenyl 2-(3-aminoiminomethylphenyl)-phenylacetamide bistrifluoroacetic acid salt;
4-aminoiminomethylphenyl 2-(4-aminoiminomethylphenyl)-phenylacetamide bistrifluoroacetic acid salt;
4-aminoiminomethylphenyl 2-(3-aminoiminomethylphenyl)-phenylacetamide bistrifluoroacetic acid salt;
3-aminoiminomethylbenzyl 2-(4-aminoiminomethylphenyl)-benzyl ether bistrifluoroacetic acid salt;
4-aminoiminomethylbenzyl 2-(4-aminoiminomethylphenyl)-benzyl ether bistrifluoroacetic acid salt;
4-aminoiminomethylbenzyl 2-(3-aminoiminomethylphenyl)-benzyl ether bistrifluoroacetic acid salt;
3-aminoiminomethylbenzyl 2-(3-aminoiminomethylphenyl)-benzyl ether bistrifluoroacetic acid salt;
N-(3-aminoiminomethylphenyl)-N′-[2-(4-aminoiminomethylphenyl)-phenyl]urea bistrifluoroacetic acid salt;
N-(4-aminoiminomethylphenyl)-N′-[2-(4-aminoiminomethylphenyl)-phenyl]urea bistrifluoroacetic acid salt;
N-(4-aminoiminomethylphenyl)-N′-[2-(3-aminoiminomethylphenyl)-phenyl]urea bistrifluoroacetic acid salt;
N-(3-aminoiminomethylphenyl)-N′-[2-(3-aminoiminomethylphenyl)-phenyl]urea bistrifluoroacetic acid salt;
3-aminoiminomethylbenzyl 2-(4-aminoiminomethylphenyl)-benzamide bistrifluoroacetic acid salt;
4-aminoiminomethylbenzyl 2-(4-aminoiminomethylphenyl)-benzamide bistrifluoroacetic acid salt;
4-aminoiminomethylbenzyl 2-(3-aminoiminomethylphenyl)-benzamide bistrifluoroacetic acid salt;
3-aminoiminomethylbenzyl 2-(3-aminoiminomethylphenyl)-benzamide bistrifluoroacetic acid salt;
4-aminoiminomethylphenyl)-benzyl 4-aminoiminomethylbenzamide bistrifluoroacetic acid salt;
2-(4-aminoiminomethylphenyl)-benzyl 3-aminoiminomethylbenzamide bistrifluoroacetic acid salt;
2-(3-aminoiminomethylphenyl)-benzyl 4-aminoiminomethylbenzamide bistrifluoroacetic acid salt;
2-(3-aminoiminomethylphenyl)-benzyl 3-aminoiminomethylbenzamide bistrifluoroacetic acid salt;
2-(3-aminoiminomethylphenyl)-phenyl phenylacetamide trifluoroacetic acid salt;
2-(3-aminoiminomethylphenyl)-phenyl phenylmethylsulfonamide trifluoroacetic acid salt;
4-(2-aminosulfonylphenyl)-phenyl 2-(4-aminoiminomethylphenyl)-benzamide trifluoroacetic acid salt;
4-(2-aminosulfonylphenyl)-phenyl 2-(3-aminoiminomethylphenyl)-benzamide trifluoroacetic acid salt;
4-(2-aminosulfonylphenyl)-phenyl 2-(3-aminoiminomethylphenyl)-cyclopenetene-1-carboxamide trifluoroacetic acid salt;
5-(2-aminosulfonylphenyl)-pyridine-2-yl 2-(3-aminoiminomethylphenyl)-cyclopenetene-1-carboxamide trifluoroacetic acid salt;
4-(N-methylpyridinium-3-yl)-phenyl 2-(3-aminoiminomethylphenyl)-cyclopenetene-1-carboxamide trifluoroacetic acid salt;
4-(2-pyridyl)-phenyl 2-(3-aminoiminomethylphenyl)-cyclopenetene-1-carboxamide trifluoroacetic acid salt;
4-(2-aminosulfonylphenyl)-phenyl 2-(3-aminoiminomethylphenyl)-pyridine-3-carboxamide trifluoroacetic acid salt;
4-(2-aminosulfonyl-5-fluoro-phenyl)-phenyl 2-(3-aminoiminomethylphenyl)-pyridine-3-carboxamide trifluoroacetic acid salt;
4-(2-aminosulfonyl-5-methyl-phenyl)-phenyl 2-(3-aminoiminomethylphenyl)-pyridine-3-carboxamide trifluoroacetic acid salt;
4-(2-cyanophenyl)-phenyl 2-(3-aminoiminomethylphenyl pyridine-3-carboxamide bistrifluoroacetic acid salt;
4-(2-methanesulfonylphenyl)-phenyl 2-(3-aminoiminomethylphenyl)-pyridine-3-carboxamide bistrifluoroacetic acid salt;
4-(2-methanesulfonyl-imidazole-1-yl)-phenyl 2-(3-aminoiminomethylphenyl)-pyridine-3-carboxamide tris trifluoroacetic acid salt;
4-(2-methylaminosulfonylphenyl)-phenyl 2-(3-aminoiminomethylphenyl)-pyridine-3-carboxamide bistrifluoroacetic acid salt;
4-(2-cyanothiophene-3-yl)-phenyl 2-(3-aminoiminomethylphenyl)-pyridine-3-carboxamide bistrifluoroacetic acid salt;
4-(2-aminosulfonyl-5-methyl-thiophene-3-yl)-phenyl 2-(3-aminoiminomethylphenyl)-pyridine-3-carboxamide bistrifluoroacetic acid salt;
4-(2-cyanophenyl)-phenyl 2-(3-aminoiminomethylphenyl)-6-methyl-pyridine-3-carboxamide bistrifluoroacetic acid salt;
4-(2-methanesulfonylphenyl)-phenyl 2-(3-aminoiminomethylphenyl)-6-methyl-pyridine-3 carboxamide bistrifluoroacetic acid salt;
4-(2-cyanophenyl)-phenyl N-methoxycarbonyl-3-(3-aminoiminomethylphenyl)alanine amide trifluoroacetic acid salt (racemic);
4-(2-aminosulfonyl-5-fluoro-phenyl)-phenyl N-methanesulfonyl-3-(3-aminoiminomethylphenyl)alanine amide trifluoroacetic acid salt (racemic);
4-(2-aminosulfonylphenyl)-phenyl N-methoxycarbonyl-3-(3-aminoiminomethyl-6-hydroxy-phenyl)alanine amide trifluoroacetic acid salt (racemic);
4-(2-aminocarbonylphenyl)-phenyl N-methanesulfonyl-3-(3-aminoiminomethylphenyl)alanine amide trifluoroacetic acid salt (racemic);
4-(2-cyanophenyl)-phenyl N-methanesulfonyl-3-(3-aminoiminomethylphenyl)alanine amide trifluoroacetic acid salt (racemic);
4-(2-aminosulfonylphenyl)-phenyl N-methanesulfonyl-3-(3-aminoiminomethylphenyl)alanine amide trifluoroacetic acid salt (racemic);
4-(2-aminosulfonyl-5-methyl-phenyl)-phenyl N-methanesulfonyl-3-(3-aminoiminomethylphenyl)alanine amide trifluoroacetic acid salt (racemic);
4-(2-aminosulfonylphenyl)-phenyl N-methoxycarbonyl-3-(3-aminoiminomethylphenyl)alanine amide trifluoroacetic acid salt (racemic);
5-(2-cyanophenyl)-pyridine-2-yl N-methanesulfonyl-3-(3-aminoiminomethylphenyl)alanine amide trifluoroacetic acid salt (optcally active);
4-(2-cyanophenyl)-phenyl N-carboxymethyl)-3-(3-aminoiminomethylphenyl)alanine amide trifluoroacetic acid salt (racemic);
(S)-3-(3-aminoiminomethylphenyl)-1-hydroxy-propane-2-yl 4-(2-aminosulfonyl-5-fluorophenyl)-benzamide trifluoroacetic acid salt (optcally active);
(S)-N-{4-(2-cyanophenyl)-benzoyl}-3-(3-aminoiminomethylphenyl)alanine methyl ester trifluoroacetic acid salt (optcally active);
(S)-N-{4-(2-cyanophenyl)-benzoyl}-3-(3-aminoiminomethylphenyl)alanine ethyl amide trifluoroacetic acid salt (optically active);
4-(2-cyanophenyl)-phenyl (S)-N-acetyl-3-(3-aminoiminomethylphenyl)alanine amide trifluoroacetic acid salt (optically active);
(S)-N-{4-(2-cyano-5-fluoro-phenyl)-benzoyl}-3-(3-aminoiminomethylphenyl)alanine methyl ester trifluoroacetic acid salt (optically active);
(S)-N-{4-(2-aminosulfonyl-5-methyl-phenyl)-benzoyl}-3-(3-aminoiminomethylphenyl)alanine methyl ester trifluoroacetic acid salt (optcally active),
(S)-N-{4-(2-aminosulfonylphenyl)-benzoyl}-3-(3-aminoiminomethylphenyl)alanine trifluoroacetic acid salt (optcally active);
(S)-N-{4-(2-aminosulfonylphenyl)-benzoyl}-3-(3-aminoiminomethylphenyl)alanine methyl ester trifluoroacetic acid salt (optcally active);
(S)-N-{4-(2-aminosulfonylphenyl)-benzoyl}-3-(3-aminoiminomethylphenyl)alanine ethyl ester trifluoroacetic acid salt (optcally active);
4-(2-cyanophenyl)-phenyl N-methanesulfonyl-3-(3-aminoiminomethylphenyl)alanine amide trifluoroacetic acid salt (racemic);
1-[4-(2-aminosulfonylphenyl)-phenoxy]-2-methanesulfonylamino-3-(3-aminoiminomethylphenyl)-propane trifluoroacetic acid salt (racemic);
4-(2-cyanophenyl)-phenyl N-(n-propanesulfonyl)-3-(3-aminoiminomethylphenyl)-alanine amide trifluoroacetic acid salt (racemic);
4-(2-cyanophenyl)-phenyl N-ethoxycarbonyl-3-(3-aminoiminomethylphenyl)-alanine amide trifluoroacetic acid salt (racemic);
4-(2-cyanophenyl)-phenyl N-ethylaminocarbonyl-3-(3-aminoiminomethylphenyl)-alanine amide trifluoroacetic acid salt (racemic);
4-(2-cyanophenyl)-phenyl N,N-bis-methanesulfonyl-3-(3-aminoiminomethylphenyl)-alanine amide trifluoroacetic acid salt (racemic);
4-(2-methanesulfonylphenyl)-phenyl N-methyl-N-methanesulfonyl-3-(3-aminoiminomethylphenyl)-alanine amide trifluoroacetic acid salt (racemic);
4-(2-methanesulfonylphenyl)-phenyl N-methanesulfonyl-3-(3-aminoiminomethylphenyl)-alanine amide trifluoroacetic acid salt (racemic);
4-(2-aminosulfonylphenyl)-phenyl N-methyl-N-methanesulfonyl-3-(3-aminoiminomethylphenyl)-alanine amide trifluoroacetic acid salt (racemic);
(S)-N-{4-(2-methanesulfonylphenyl)-benzoyl}-3-(3-aminoiminomethylphenyl)-alanine methyl ester trifluoroacetic acid salt (optcally active);
1-{4-(2-aminosulfonylphenyl)-phenylcarbonylamino}-1-(4-ethoxycarbonylthiazole-2-yl)-2-(3-aminoiminomethylphenyl)-ethane trifluoroacetic acid salt;
N-{4-(2-cyanophenyl)-benzoyl}-3-(2-aminoiminomethylpyridine-4-yl)-alanine methyl ester trifluoroacetic acid salt (racemic);
4-(2-methanesulfonylphenyl)-phenyl N-ethyl-N-methanesulfonyl-3-(3-aminoiminomethylphenyl)alanine amide trifluoroacetic acid salt (racemic);
4-(2-cyanophenyl)-phenyl N-ethyl-N-methanesulfonyl-3-(3-aminoiminomethyl-phenyl)-alanine amide trifluoroacetic acid salt (racemic);
N-{4-(2-cyanophenyl)-benzoyl}-3-(2-aminoiminomethylpyridine-4-yl)-alanine N,N-dimethyl amide trifluoroacetic acid salt;
N-{4-(2-cyanophenyl)-benzoyl}-3-(2-aminoiminomethylpyridine-4-yl)-alanine ethyl ester trifluoroacetic acid salt;
4-(2-aminosulfonylphenyl)-phenyl N-ethyl-N-methanesulfonyl-3-(3-aminoiminomethylphenyl)-alanine amide trifluoroacetic acid salt (racemic);
4-(2-cyanophenyl)-phenyl N-ethyl-N-ethoxycarbonyl-3-(3-aminoiminomethyl-phenyl)-alanine amide trifluoroacetic acid salt (racemic);
4-(2-methanesulfonylphenyl)-phenyl 2-N-propanosultam)-3-(3-aminoiminomethyl-phenyl)-propanoic amide trifluoroacetic acid salt (racemic);
4-(2-methanesulfonylphenyl)-phenyl N-benzyl-N-methanesulfonyl-3-(3-aminoiminomethylphenyl)-alanine amide trifluoroacetic acid salt (racemic);
4-(2-cyanophenyl)-phenyl N-methyl-N-ethoxycarbonyl-3-(3-aminoiminomethylphenyl)-alanine amide trifluoroacetic acid salt (racemic);
4-(2-Cyanophenyl)-phenyl N-methyl-N-methanesulfonyl-3-(3-aminoiminomethylphenyl)-alanine amide trifluoroacetic acid salt (racemic);
4-(2-aminosulfonylphenyl)-2-chloro-phenyl N-methyl-N-methanesulfonyl-3-(3-aminoiminomethylphenyl)-alanine amide trifluoroacetic acid salt (racemic);
4-(2-cyanophenyl)-phenyl 2-(N-propanosultam)-3-(3-aminoiminomethylphenyl)-propanoic amide trifluoroacetic acid salt (racemic);
4-(2-cyanophenyl)-phenyl N-methyl-N-acetyl-3-(3-aminoiminomethylphenyl)-alanine amide trifluoroacetic acid salt (racemic);
4-(2-cyanophenyl)-phenyl N-methyl-N-propanoyl-3-(3-aminoiminomethylphenyl)-alanine amide trifluoroacetic acid salt (racemic);
4-(2-methanesulfonylphenyl)-2-chloro-phenyl N-methyl-N-methanesulfonyl-3-(3-aminoiminomethylphenyl)-alanine amide trifluoroacetic acid salt (racemic);
4-(2-cyanophenyl)-phenyl N-ethyl-N-isopropyloxycarbonyl-3-(3-aminoiminomethylphenyl)-alanine amide trifluoroacetic acid salt (racemic);
4-(2-cyanophenyl)-phenyl N-ethyl-N-propanoyl-3-(3-aminoiminomethylphenyl)-alanine amide trifluoroacetic acid salt (racemic);
4-(2-cyano-3-fluoro-phenyl)-phenyl N-methyl-N-methanesulfonyl-3-(3-aminoiminomethylphenyl)alanine amide trifluoroacetic acid salt (racemic);
4-(2-cyano-4-chloro-phenyl)-phenyl N-methyl-N-methanesulfonyl-3-(3-aminoiminomethylphenyl)alanine amide trifluoroacetic acid salt (racemic);
4-(2-cyanophenyl)-phenyl 2-(N-oxazolidin-2-one)-3-(3-aminoiminomethyl-phenyl)-propanoic amide trifluoroacetic acid salt (racemic);
4-(2-methanesulfonylphenyl)-phenyl 2-(N-oxazolidin-2-one)-3-(3-aminoiminomethylphenyl)-propanoic amide trifluoroacetic acid salt (racemic);
4-(2-cyanophenylphenyl)-2-(N-butyrolactam)-3-(3-aminoiminomethylphenyl)-propanoic amide trifluoroacetic acid salt (racemic);
4-(2-methanesulfonylphenyl)-phenyl 2-(N-carboxymethyl-N-methanesulfonyl)amino-3-(3-aminoiminomethylphenyl)-propanoic amide trifluoroacetic acid salt (racemic);
4-(2-cyanophenyl)-2-chlorophenyl N-methyl-N-methanesulfonyl-3-(3-aminoiminomethylphenyl)-alanine amide trifluoroacetic acid salt (racemic);
4-(2-cyanophenyl)-phenyl 2-[N-(4,6-tetrahydro-1,3-oxazin-2-one)]-3-(3-aminoiminomethylphenyl)-propanoic amide trifluoroacetic acid salt (racemic);
4-(2-cyanophenyl)-phenyl 2-(N-carboxymethyl-N-methanesulfonyl)amino-3-(3-aminoiminomethylphenyl)-propanoic amide trifluoroacetic acid salt (racemic);
4-(2-cyano-4-chlorophenyl)-phenyl N-methyl-N-methanesulfonyl-3-(3-aminoiminomethylphenyl)-alanine amide trifluoroacetic acid salt (racemic);
4-(2-cyano-5-fluorophenyl)-phenyl N-methyl-N-methanesulfonyl-3-(3-aminoiminomethylphenyl)-alanine amide trifluoroacetic acid salt (racemic);
4-(2-cyano-4-methylphenyl)-phenyl N-methyl-N-methanesulfonyl-3-(3-aminoiminomethylphenyl)-alanine amide trifluoroacetic acid salt (racemic);
4-(2-cyanophenyl)-phenyl 2-[N-(1,3-oxazolidin-2-one)]-3-(1-aminoisoquinoline-7-yl)-propanoic amide trifluoroacetic acid salt (racemic);
4-(2-methanesulfonylphenyl)-phenyl 2-(N-propanosultam)-3-(1-aminoisoquinoline-7-yl)-propanoic amide trifluoroacetic acid salt (racemic);
4-(2-aminosulfonylphenyl)-phenyl 2-(N-propanosultam)-3-(1-aminoisoquinoline-7-yl)-propanoic amide trifluoroacetic acid salt (racemic);
4-(2-cyanophenyl)-phenyl 2-[N-propanosultam]-3-(1-aminoisoquinoline-7-yl)-propanoic amide trifluoroacetic acid salt (racemic);
4-(2-methanesulfonylphenyl)-phenyl N-carboxymethyl-N-methanesulfonyl-3-(1-aminoisoquinoline-7-yl)-alanine amide trifluoroacetic acid salt (racemic);
4-(2-methanesulfonylphenyl)-phenyl cis-2-(3-amino[ethoxycarbonylimino]methylphenylcyclopropane-1-carboxamide;
4-(2-methanesulfonylphenyl)-phenyl cis-2-(3-amino[hydroxyimino]methylphenyl)-cyclopropane-1-carboxamide;
4-(2-aminosulfonylphenyl)-phenyl cis-2-(3-amino[hydroxyimino]methylphenyl)-cyclopropane-1-carboxamide trifluoroacetic acid salt;
4-(2-aminosulfonyl-5-fluorophenyl)-phenyl cis-2-(3-amino[hydroxyimino]methylphenyl)-cyclopropane-1-carboxamide trifluoroacetic acid salt;
4-(2-aminosulfonyl-5-methylphenyl)-phenyl 2-(3-amino[hydroxyimino]methylphenyl)-pyridine-3-carboxamide bistrifluoroacetic acid salt;
4-(2-cyanophenyl)-phenyl 2-(3-amino[hydroxyimino]methylphenyl)-pyridine-3-carboxamide bistrifluoroacetic acid salt;
4-(2-methanesulfonylphenyl)-phenyl N-methanesulfonyl)-N-methyl-3-(3-amino[hydroxyimino]methylphenyl)-alanine amide trifluoroacetic acid salt (racemic);
4-(2-cyanophenyl)-phenyl 2-(3-amino[ethoxycarbonyloxyimino]methylphenyl)-pyridine-3-carboxamide;
4-(2-methanesulfonyl-imidazol-1-yl)-phenyl cis-2-(3-amino[hydroxyimino]methylphenyl)-cyclopropane-1-carboxamide bistrifluoroacetic acid salt;
4-(2-methanesulfonylphenyl)-phenyl 2-(3-amino[hydroxyimino]methylphenyl)-pyridine-3-carboxamide bistrifluoroacetic acid salt;
4-(2-aminosulfonylphenyl)-phenyl 2-(3-amino[hydroxyimino]methylphenyl)-pyridine-3-carboxamide bistrifluoroacetic acid salt;
4-(2-methanesulfonyl-5-fluoro-phenyl)-phenyl 2-(3-amino[hydroxyimino]methylphenyl)-pyridine-3-carboxamide bistrifluoroacetic acid salt;
4-(2-aminosulfonylphenyl)-phenyl N-(methanesulfonyl)-N-methyl-3-(3-amino[hydroxyimino]methylphenyl)-alanine amide trifluoroacetic acid salt (racemic);
4-(2-methylaminosulfonylphenyl)-phenyl 2-(3-amino[hydroxyimino]methylphenyl)-pyridine-3-carboxamide bistrifluoroacetic acid salt;
4-(2-methylaminosulfonylphenyl)-phenyl cis-2-(3-amino[hydroxyimino]methylphenyl)-cyclopropane-1-carboxamide trifluoroacetic acid salt;
4-(2-cyanophenyl)-phenyl cis-2-(3-amino[hydroxyimino]methylphenyl)-cyclopropane-1-carboxamide trifluoroacetic acid salt;
4-(2-methanesulfonyl-imidazole-1-yl)-phenyl 2-(3-amino[hydroxyimino]methylphenyl)-pyridine-3-carboxamide tris trifluoroacetic acid salt;
5-(2-aminosulfonylphenyl)-pyridine-2-yl cis-2-(3-amino[hydroxyimino]methylphenyl)-cyclopropane-1-carboxamide bistrifluoroacetic acid salt;
4-(2-methanesulfonylphenyl)-phenyl N-ethyl-N-methanesulfonyl-3-(3-amino[hydroxyimino]methylphenyl)-alanine amide trifluoroacetic acid salt (racemic);
4-(2-cyanophenyl)-phenyl cis-2-(3-amino[ethoxycarbonylimino]methylphenyl)-cyclopropane-1-carboxamide trifluoroacetic acid salt;
4-(2-cyanophenyl)-phenyl 2-(3-amino[hydroxyimino]methylphenyl)-6-methyl-pyridine-3-carboxamide bistrifluoroacetic acid salt;
4-(2-aminosulfonylphenyl)-phenyl N-ethyl-N-methanesulfonyl-3-(3-amino[hydroxyimino]methylphenyl)-alanine amide trifluoroacetic acid salt (racemic);
4-(2-cyanophenyl)-phenyl N-ethyl-N-methanesulfonyl-3-(3-amino[hydroxyimino]methylphenyl)-alanine amide trifluoroacetic acid salt (racemic);
4-(2-cyanophenyl)-phenyl N-ethyl-N-ethoxycarbonyl-3-(3-amino[hydroxyimino]methylphenyl)-alanine amide trifluoroacetic acid salt (racemic);
4-(2-methanesulfonylphenyl)-phenyl 2-(N-propanosultam)-3-(3-amino[hydroxyimino]methylphenyl)-propanoic amide trifluoroacetic acid salt (racemic);
4-(2-cyanophenyl)-phenyl N-methyl-N-ethoxycarbonyl-3-(3-amino[hydroxyimino]methylphenyl)-alanine amide trifluoroacetic acid salt (racemic);
4-(2-aminosulfonylphenyl)-2-chloro-phenyl N-methyl-N-methanesulfonyl-3-(3-amino[hydroxyimino]methylphenyl)-alanine amide trifluoroacetic acid salt (racemic);
4-(4-cyano-thiophene-3-yl)-phenyl cis-2-(3-amino[hydroxyimino]methylphenyl)-cyclopropane-1-carboxamide trifluoroacetic acid salt;
4-(2-cyanophenyl)-phenyl (1,2-cis)-2-(3-amino[hydroxyimino]methylphenyl)-(1,3-trans)-3-carboxy-cyclopropane-1-carboxamide trifluoroacetic acid salt;
4-(2-cyanophenyl)-phenyl (1,2-cis)-2-(3-amino[hydroxyimino]methylphenyl)-(1,3-trans)-3-ethoxycarbonyl-cyclopropane-1-carboxamide trifluoroacetic acid salt;
4-(2-cyanophenyl)-phenyl 2-(N-propanosultam)-3-(3-amino[hydroxyimino]methylphenyl)-propanoic amide trifluoroacetic acid salt (racemic);
4-(2-cyanophenyl)-phenyl N-ethyl-N-isopropyloxycarbonyl-3-(3-amino[hydroxyimino]methylphenyl)-alanine amide trifluoroacetic acid salt (racemic);
4-(2-cyanophenyl)-phenyl N-ethyl-N-propanoyl-3-(3-amino[hydroxyimino]methylphenyl)-alanine amide trifluoroacetic acid salt (racemic);
4-(2-cyanophenyl)-phenyl 2-(N-oxazolidin-2-one)-3-(3-amino[hydroxyimino]methylphenyl)-propanoic amide trifluoroacetic acid salt (racemic);
4-(2-methanesulfonylphenyl)-phenyl 2-(N-oxazolidin-2-one)-3-(3-amino[hydroxyimino]methylphenyl)-propanoic amide trifluoroacetic acid salt (racemic);
4-(2-cyano-phenyl)-2-chlorophenyl N-methyl-N-methanesulfonyl-3-(3-amino[hydroxyimino]methylphenyl)-alanine amide trifluoroacetic acid salt (racemic);
4-(2-methanesulfonylphenyl)-phenyl 2-(N-carboxymethyl-N-methanesulfonyl)amino-3-(3-amino[hydroxyimino]methylphenyl)-propanoic amide trifluoroacetic acid salt (racemic);
4-(2-methanesulfonylphenyl)-phenyl 2N-ethoxycarbonylmethyl-N-methanesulfonyl)amino-3-(3-amino[hydroxyimino]methylphenyl)-propanoic amide trifluoroacetic acid salt (racemic);
4-(2-methanesulfonylphenyl)-phenyl 2-(3-amino[hydroxyimino]methylphenyl)-6-methyl-pyridine-3-carboxamide bistrifluoroacetic acid salt;
4-(2-methanesulfonylphenyl)-phenyl (1,2-cis)-2-(3-amino[hydroxyimino]methylphenyl)-(1,3-trans)-3-carboxy-cyclopropane-1-carboxamide trifluoroacetic acid salt (racemic);
4-(2-methanesulfonylphenyl)-phenyl (1,2-cis)-2-(3-amino[hydroxyimino]methylphenyl)-(1,3-trans)-3-ethoxycarbonyl-cyclopropane-1-carboxamide trifluoroacetic acid salt (racemic);
4-(2-cyanophenyl)-phenyl 2-[N-(4,6-tetrahydro-1,3-oxazin-2-one)]-3-(3-amino[hydroxyimino]methylphenyl)-propanoic amide trifluoroacetic acid salt (racemic);
4-(2-cyanophenyl)-phenyl 2-(N-carboxymethyl-N-methanesulfonyl)amino-3-(3-amino[hydroxyimino]methylphenyl)-propanoic amide trifluoroacetic acid salt (racemic); and
4-(2-cyanophenyl)-phenyl 2-(N-ethoxycarbonylmethyl-N-methanesulfonyl)amino-3-(3-amino[hydroxyimino]methylphenyl)-propanoic amide trifluoroacetic acid salt (racemic).

5. A pharmaceutical composition for preventing blood coagulation and treating thrombosis, which comprises a compound of claim 1, a pharmaceutically acceptible salt, a prodrug, a hydrate, a solvate or an isomer thereof as an effective ingredient together with a pharmaceutically acceptable excipient.
